(19) United States
(12) Patent Application Publication
(10) Pub. No.: US 2014/0360891 A1
(43) Pub. Date: Dec. 11, 2014

(54) SYSTEM AND METHOD FOR USING ADSORBENT/ABSORBENT IN LOADING, STORING, DELIVERING, AND RETRIEVING GASES, FLUIDS, AND LIQUIDS

(71) Applicants: Bret E. Kline, Columbus, OH (US); Mitchell J. New Delman, De Belgique (MC); John A. Sanders, Granbury, TX (US)

(72) Inventors: Bret E. Kline, Columbus, OH (US); Mitchell J. New Delman, De Belgique (MC); John A. Sanders, Granbury, TX (US)

(21) Appl. No.: 14/206,963

(22) Filed: Mar. 12, 2014

Related U.S. Application Data
(60) Provisional application No. 61/851,681, filed on Mar. 12, 2013.

(51) Int. Cl. B65D 85/00; F17C 11/00

(52) U.S. Cl. CPC B65D 85/70; F17C 11/00
USPC 206/7

(57) ABSTRACT

A system and method for placing as much of adsorbent/absorbent as possible in a container to allow for the maximal adsorption or absorption of targeted molecular constituents in gases, fluids, liquids or mixture thereof. A system and method for loading, unloading, packing, storing, delivering, and retrieving gases, fluids, liquids, or mixtures thereof.

A system for containing, loading, storage, delivery, and retrieval of gases, fluids, liquids, or mixtures thereof, containing a molecular density adsorbent/absorbent material; one or more Lattices each containing the molecular density adsorbent/absorbent material; wherein each of the one or more Lattices permits circulation of air flow from more than two sides to allow for adsorption, absorption or desorption of a constituent in the gases, fluids, liquids, or mixture thereof; and wherein the one or more Lattices is housed within a Vessel.

A system for containing, loading, storage, delivery and retrieval of gases, fluids, liquids, or mixtures thereof, having a molecular density adsorbent/absorbent material; and one or more Lattices each containing the molecular density adsorbent/absorbent material; wherein the one or more Lattices is housed within a Cartridge wherein the Cartridge is placed within a Vessel.

This application claims priority to U.S. Provisional Patent Application Ser. No. 61/851,681, entitled “METHOD AND/OR SYSTEM FOR DEPLOYMENT, RE-LOADING AND RETRIEVAL OF MOLECULES AFTER SEPARATION, SEGREGATION, TRANSFORMATION, REFORMATION, PURIFICATION, DE-CONTAMINATION OR OTHER AMENDMENTS USING MOLECULAR ADSORBENTS OF KNOWN OR TAUGHT CHEMISTRIES OR SHAPES WHICH METHOD AND/OR SYSTEM FACILITATES USE, DISPOSAL OR RECOVERY OF SEGREGATED MOLECULES,” filed on Mar. 12, 2013, the entire content of which is hereby incorporated by reference.

### BACKGROUND

The present invention relates generally to a system and method for handling and/or delivering of molecular density materials (“MDM”) in a unique manner to facilitate its specific placement to maximize and to allow for its effective contact with targeted molecular constituents within gases, fluids, liquids, or a mixture thereof. The system of the present invention allows, facilitates, promotes, or enhances the adsorption or absorption of gases, fluids, or liquids by MDM under different environments, different constraints, and different space limitations. The present invention also pertains to packing, loading, unloading, storing, delivering, separating, and retrieving gases, fluids, liquids, or mixtures thereof. More specifically, the present invention relates to a system for handling or placing MDM in a unique manner to facilitate or promote its contact with targeted molecular constituents within gases, fluids, liquids or mixtures thereof; to allow gases, fluids, liquids, or mixtures thereof to be absorbed or adsorbed by MDM packed in containers with different shapes and structures, as dictated by the need, whose containers are then stored in structural cages or Cartridges and placed in one or more Vessels. The Vessels can be installed in motor vehicles and other mobile applications.

Typically, gases and fluids are stored in Vessels under high pressure. The Vessels are fixed-shape cylinders or spheres formed of high-strength metals. Such metallic cylinders or spheres involve a number of problems and safety hazards. Firstly, such metallic cylinders or spheres are relatively heavy compared to the gases or fluids that they contain. Secondly, the pressurized cylinders or spheres contain all the gases or liquid in a single space. If a pressurized metallic cylinder or sphere should rupture, the entire cylinder or sphere is destroyed and can cause violent explosion, harming the surrounding space and people, and could even cause secondary fires. Thirdly, the metallic cylinders or spheres have a definite shape and cannot be adapted to fit readily in many space-constrained applications.

The present invention was designed to solve the inherent problems of conventional gas or liquid storage and transport discussed above.

### SUMMARY

One aspect of the present invention relates generally to a system and method for allowing, facilitating, enhancing, maximizing, or promoting the adsorption or absorption of gases, fluids, or liquids by molecular density materials (“MDM”) under different environments, different limitations, and different spaces. Different adsorption/absorption materials, or MDM, adsorb or absorb different gases or fluids with different efficiency. By packing and loading the largest possible amount of MDM in a container of the present invention, and by strategically placing MDM according to the present invention, the amount of stored gas, fluid, liquid, or mixtures thereof, is increased substantially with respect to a fixed tank or Vessel volume. The present invention allows a larger quantity, compared to a conventional fixed tank, of the gas or fluid to be stored in cavities formed in MDM held in the Lattices, Bags, Cartridges, or Vessels. The amount of stored gas or liquid can increase even more if the system of the present invention is pressurized. The containers, the structural cages or Cartridges, and the Vessels of the present invention can be made to conform to a variety of shapes. The result of this design is that the containers, Cartridges, and the Vessels of the present invention can be readily formed into a variety of useful shapes to accommodate one or more special applications. The containers, Cartridges, and the Vessels of the present invention make loading, unloading, storage, retrieval, separation, purification, decontamination, and transport of gases and fluids easy to carry out. Reloadable Vessels can be installed in motor vehicles and other mobile means. The system of the present invention also permits the fluids or gases stored within the Lattices, Cartridges or Vessels to be vibrated, cooled, or heated, depending upon the need. The system of the present invention can be lightweight and adaptable to a variety of spaces to accommodate some special or unusual applications. Moreover, even under pressure, it is inherently safer if there should be a rupture of the system.

### BRIEF DESCRIPTION OF THE DRAWINGS

FIG. 1A is a view of an exemplary Cylinder Vessel With A Cage, Wave Spring, and MDM Populated Cartridges;

FIG. 1B is a view of an exemplary Assembled Cylinder Vessel With A Cage, Wave Spring, and MDM Populated Cartridges;

FIG. 2A is a view of an exemplary Cylinder Vessel With A Cage, Exploded View of Triangular Lattices and Cartridge Assembly, and MDM Populated Cartridges;

FIG. 2B is a view of an exemplary of FIG. 2A that is being loaded with an assembled series of Cartridges;

FIG. 3A is a view of an exemplary irregularly-shaped squircle Vessel with a cage, exploded Lattice and Cartridge assembly, and MDM-populated Cartridges;

FIG. 3B is a view of an exemplary irregularly-shaped squircle Vessel with a cage, exploded view of Lattices and Cartridge assembly, and MDM-populated Cartridges;

FIG. 4A is a view of an exemplary irregularly-shaped squircle Vessel with a cage, and sheet-formed Lattice dimple-cup MDM-populated Cartridges;

FIG. 4B is a view of an exemplary irregularly-shaped squircle Vessel with a cage, exploded sheet-formed Lattices and Cartridge assembly, and MDM-populated Cartridges;

FIG. 5A is a view of an exemplary irregularly-shaped squircle Vessel with a cage, and MDM-populated Cartridge assembly;

FIG. 5B is a view of an exemplary irregularly-shaped squircle Vessel with nesting Cartridges, exploded Cartridge assembly, and MDM-populated Cartridges;

FIG. 6A is a view of an exemplary Vessel holding a series of wire frame Cartridges in the shape of a circle, which could be of any shape shown in FIG. 130;

FIG. 6B is a view of an exemplary wire frame Cartridge in the shape of a circle, with Fixed Center Column, which could be of any shape shown in FIG. 130;

FIG. 7A is a view of an exemplary Vessel with a placed Cartridge Lattice structures with a singular center tube support, with two half sections of wall supports for load transfers;

FIG. 7B is a view of an exemplary Cartridge Lattice structure with a singular center tube support, with two half sections of wall supports for load transfers;

FIG. 8A is a view of an exemplary cylinder Vessel with a cage, and MDM-populated roller Cartridge assembly;

FIG. 8B is a view of an exemplary exploded view of cylinder-shaped roller Cartridge assembly, with dimple-cup Lattices, and MDM-populated Cartridges;

FIG. 9A is a close-up view of an exemplary of an irregularly-shaped squircle tray CAP Plate for the handling of MDM films;

FIG. 9B is an exemplary close-up view of an irregularly-shaped squircle bottom plate and perforated reinforcement column for the handling of MDM films;

FIG. 9C is an exemplary close-up view of a rounded collar for an irregularly-shaped squircle tray, which fits over the bottom plate column for the handling of MDM films;

FIG. 9D is a view of an exemplary irregularly-shaped squircle Lattice tray and vertical or horizontal Vessel if rotated for the handling of MDM Films or MDM Sheets;

FIG. 10A is a view of an exemplary exploded view of spherical Vessel with an assembled rigid or semi-rigid Bag assembly which is self-supporting and can be made in other shapes found in FIG. 130;

FIG. 10B is a view of an exemplary Completed View of Spherical Vessel shown in FIG. 10A;

FIG. 10C is a view of an exemplary Close Up View of Spherical Populated and Assembled Lattice shown in FIG. 10A;

FIG. 10D is a view of an exemplary Close Up View of Spherical Populated and Assembled Lattice Tessellated Wrapping shown in FIG. 10A;

FIG. 11A is a view of an exemplary perforated in situ load plate Vessel;

FIG. 11B is a view of an exemplary cut through of an assembled perforated load plate in situ Vessel;

FIG. 11C is a view of an exemplary Vessel that has the ability to replace the MDM without welding;

FIG. 12A is a view of an exemplary cylinder Vessel with a cage, and MDM semi-rigid continuous Lattices-populated Cartridges;

FIG. 12B is a view of an exemplary exploded view of a MDM semi-rigid continuous populated Lattices and variable adjustable Cartridge floor heights, with base plate exterior ribs;

FIG. 13A is a view of an exemplary assembled cylindrical pressure Vessel for fluids;

FIG. 13B is a view of an exemplary exploded cylindrical pressure Vessel with Cartridge assemblies and components for amendment of fluids;

FIG. 14A is a view of an exemplary rectangular Vessel for fluids with cylindrical Cartridge assemblies that are populated with semi-rigid continuous Lattices;

FIG. 14B is a view of an exemplary detailed cut away of a rectangular Vessel for fluids with cylindrical Cartridge assemblies that are populated with semi-rigid continuous Lattices;

FIG. 15A is a view of an exemplary section view B-B of the Vessel in FIG. 15B, a populated Cartridge assembly, and associated components;

FIG. 15B is a view of an exemplary top with section view B-B of the Vessel in FIG. 15A, a populated Cartridge assembly, and associated components;

FIG. 16 is a view of an exemplary exploded view of a housing with ribs and columnar posts for Lattice Bags called (“the Cartridge”) Cartridge;

FIG. 17A is a view of an exemplary rectangular Cartridge with radius edges assembled without top plate or Bags;

FIG. 17B is a view of an exemplary rectangular Cartridge with radius edges assembled with top plate without Bags;

FIG. 17C is a view of an exemplary rectangular Cartridge with radius edges assembled with top plate: assembled and loaded with Lattice Bags;

FIG. 18A is a view of an exemplary exploded Lattice and Cartridge assembly in a pillowed shape also known as a squircle or rounded rectangle;

FIG. 18B is a view of an exemplary top plate of the Lattice and Cartridge assembly 18A;

FIG. 18C is a view of an exemplary structural members of the Lattice and Cartridge assembly 18A;

FIG. 19A is a view of an exemplary ellipse Cartridge assembly;

FIG. 19B is a view of an exemplary front view of an ellipse Cartridge assembly in a horizontal position;

FIG. 19C is a view of an exemplary ellipse Cartridge loaded and assembled with Lattices, with repeatable keystone Bags, and repeatable irregular shaped fill ins;

FIG. 20A is a view of an exemplary assembled pillowed Cartridge;

FIG. 20B is a view of an exemplary exploded view of a multiple interlocking Cartridge plates and curved ribs and Lattices;

FIG. 21A is a view of an exemplary exploded Lattice and triangular shaped Cartridge assembly in a pillowed triangle variation shape;

FIG. 21B is a view of an exemplary orthographic view of the populated Cartridge;

FIG. 22A is a view of an exemplary Lattice structure and Cartridge assembly. These keystones, which are semi-rigid Bags that have self-reinforcements for load transfers, are further offset to promote weight load distributions that avoid crushing the MDM, and may be made of conductive material or laminate. The mortar offset patterns can enable heating. Material is deployed to the outer edge of the Cartridge, thus enabling maximum deployment of potential volume adsorbed constituent material;

FIG. 22B is a view of an exemplary Lattice structure and Cartridge assembly in 22A with elevated Bags to demonstrate custom shapes to form arcs of different diameters that are inscribed. These keystones, which are semi-rigid Bags that have self-reinforcements for load transfers, are further offset to promote weight load distributions that avoid crushing the MDM, and may be made of conductive material or laminate. The mortar offset patterns can enable heating, material is deployed to the outer edge of the Cartridge, thus enabling maximum deployment of potential volume adsorbed constituent material;

FIG. 23A is a view of an exemplary cylinder-shaped Cartridge and Lattice assembly with segmented variations of shapes of figures shown in FIG. 130; the Cartridge assembly is shown without its top plate;

FIG. 23B is an exemplary exploded elevated view of cylinder-shaped Cartridge and Lattice assembly with segmented variation of shapes of figures shown in FIG. 130;

FIG. 23C is a view of an exemplary cylinder-shaped Cartridge with Segmented Variations of Shapes;

FIG. 23D is an exemplary exploded elevated view of FIG. 23C cylinder-shaped Cartridge and Lattice assembly with segmented variation of shapes of figures shown in FIG. 130;

FIG. 24A is a view of an exemplary Lattice structure and Cartridge assembly in 24A with continuous flexible or semi-rigid spiral Lattice Bag;

FIG. 24B is a view of an exemplary elevated Lattice structure and Cartridge assembly in 24A with inscribed spiral Bag or structure that is elevated to demonstrate continuous custom shapes;

FIG. 24C is a view of an exemplary Lattice structure and Cartridge assembly in 83A with elevated Bags to demonstrate custom shapes to form pie-shaped arcs of different diameters that are inscribed;

FIG. 24D is a view of an exemplary Lattice structure and Cartridge assembly in 24C with inscribed pie Lattice sections, Bags or structures that are elevated to demonstrate custom shapes and stacking vertically on a Y plane;

FIG. 25A is a view of an exemplary assembled pillow-shaped rounded square hybrid of composite and non-composite components of a Lattice assembly;

FIG. 25B is an exemplary exploded view of a composite Lattice and Cartridge assembly;

FIG. 25C is an exemplary exploded view of a Lattice assembly in pillowed square shape;

FIG. 26 is a view of an exemplary composite manufactured Cartridge and pillowed Lattice assembly;

FIG. 27A is a view of an exemplary frontal orthographic view of the composite top plate first seen in FIG. 26 2625, without MDM structures or Bags population;

FIG. 27B is a view of an exemplary joint of a structural tube bonded to the Cartridge plate, inner skin and outer skin that 2701 clamps down to which skins are bonded together;

FIG. 27C is a view of an exemplary Cartridge plate bond joint;

FIG. 27D is a view of an exemplary joint of a structural tube bonded to the bottom Cartridge plate. All elements are bonded creating strength at shear bond joints;

FIG. 27E is a view of an exemplary assembled composite Cartridge structure without populated Lattices;

FIG. 28 is a view of an exemplary Pillow-shaped assembly of Lattice components and Cartridge;

FIG. 29A is a view of an exemplary Cartridge that could be housed in a pressure or non-pressurized Vessel or in situ;

FIG. 29B is a view of an exemplary Cartridge that could be housed in a pressure or non-pressurized Vessel;

FIG. 30A is a view of an exemplary wire frame Cartridge in the shape of a square, which could be of any shape shown in FIG. 130;

FIG. 30B is a view of an exemplary wire frame Cartridge in the shape of a circle, which could be of any shape shown in FIG. 130;

FIG. 30C is a view of an exemplary exploded view of a non-loaded wire frame Cartridge in the shape of a square, which has a wing feature for load transfer, which could be of any shape shown in FIG. 130;

FIG. 31A is a view of an exemplary heating plate for a structural pallet to heat specific MDM that need thermal assistance to release their captive adsorbed element from the MDM surface area;

FIG. 31B is a view of an exemplary heating plate to heat the MDM;

FIG. 31C is a view of an exemplary close up view of orifice for flange;

FIG. 31D is a view of an exemplary top view of FIG. 31A;

FIG. 31E is a view of an exemplary close up view of flange in FIG. 31A 3120A;

FIG. 32 is a view of an exemplary line packing MDM Cartridge assembly;

FIG. 33 is a view of an exemplary view of a line packing or Vessel heating coil with Cartridge;

FIG. 34A is an exemplary view of line packing Cartridge with heating apparatus and associated weight load distribution system;

FIG. 34B is an exemplary close-up view of line packing Cartridge with heating apparatus and associated weight load distribution system;

FIG. 35A is a view of an exemplary line packing Cartridge and Lattice assembly with center void flow area for heating gas;

FIG. 35B is an exemplary view of line packing Cartridge and Lattice assembly with center void flow area for heating gas;

FIG. 36A is an exemplary view of an inscribed rounded rectangle variation of FIG. 130 rounded rectangle, which is a Rectangle showing a grid pattern of square and irregular sized rectangle and corner triangles;

FIG. 36B is an exemplary view of an inscribed hexagon variation of FIG. 130 rounded Hexagon showing a circular pattern of keystone Bags within an irregular geometric Vessel shape;

FIG. 37A is an exemplary view of a cylinder Cartridge with roller assembly in channels populated by pie-shaped dimple-cups—a variation of FIG. 130, a triangle;

FIG. 37B is a view of an exemplary close up view of top plate in FIG. 37A 3705A;

FIG. 37C is a view of an exemplary close up view of Lattice in FIG. 37A 810B (1);

FIG. 37D is a view of an exemplary close up view of Cartridge bottom plate and Lattice support structures in FIG. 37A;

FIG. 38A is an exemplary view of a wire cage Cartridge with rigid Lattice Bags;

FIG. 38B is a view of an exemplary close up view of top plate and flange of Cartridge assembly as seen in FIG. 38A;

FIG. 38C is a view of an exemplary close up view of repeatable Lattice shapes shown in Cartridge assembly in FIG. 38A;

FIG. 38D is a view of an exemplary close up view of bottom component of Cartridge assembly in FIG. 38A;

FIG. 39A is a view of exploded view of an assembled of circular Cartridge with sinusoidal truss rib;

FIG. 39B is an exemplary view of a Lattice Bag assembly;

FIG. 39C is an exemplary view of stanchion ribs;

FIG. 39D is an exemplary view of stanchion ribs with support column;

FIG. 40A is an exemplary exploded view of FIG. 20A components;

FIG. 40B is an exemplary view of a populated Cartridge inside a squircle shaped Vessel;

FIG. 40C is an exemplary view of details of a populated Cartridge;

FIG. 41A is an exemplary view of the top of a sheet-formed Lattice;

FIG. 41B is an exemplary view of permeable or perforated layers FIG. 41A and FIG. 41C;

FIG. 41C is an exemplary view of the bottom half of a sheet-formed Lattice

FIG. 42A is an exemplary exploded view of a Populated Cartridge assembly with Sheet Forms and Shock Protectors;

FIG. 42B is an exemplary close-up view of Top Plate;

FIG. 42C is an exemplary view of a close-up of sheet-formed Lattices Dimple Cups;

FIG. 42D is an exemplary close-up view of horizontal columnar Cartridge assembly shock absorber protectors;

FIG. 43A through 43H are exemplary views of a vacuum-formed Lattice round cup, that can be made of any of the shapes in FIG. 3; made of materials such as thermoplastic polyamides, composites, ceramic fiber polyethylene, biodegradable plastics; the cups would have a variable height such that for each MDM that has a compression point that could damage the material, the evacuated cup would be of a height such that the additional material compacting into the second cup did not damage the MDM. FIG. 43 can be vac formed, with holes that can be solubly coated as in FIG. 41, and then filled.

FIG. 43A is an exemplary exploded view of an unfilled single Dimple Cup;

FIG. 43B is an exemplary exploded view of a single Dimple Cup with a cross section of FIG. 43A;

FIG. 43C is an exemplary view of an assembled filled single Dimple Cup;

FIG. 43D is a cutaway view of FIG. 43C;

FIG. 43E is an exemplary view of a filled and assembled, with compression, vibration and/or evacuation, Dimple Cup;

FIG. 43F is a cutaway view of FIG. 43E;

FIG. 43G is an exemplary view of two stacked and nested Dimple Cups;

FIG. 43H is a cutaway view of FIG. 43G;

FIG. 44A is a view of an exemplary panel insert with rigid Lattice structure, such as a flexible panel or rigid panel insert, such as a graphene and water separation and adsorption device;

FIG. 44B is an exemplary view of an exploded series of a graphene and water separation and adsorption device;

FIG. 44C is a view of another view exemplary of an Exploded Series of a Graphene and Water Separation and Adsorption Device;

FIG. 45A is an exemplary exploded view of a panel insert with rigid Lattice structure, such as a flexible panel or rigid panel insert, graphene and water separation device;

FIG. 45B is an exemplary view of an exploded series and cut-through of a permeable material such as graphene used as a separation device;

FIG. 46 is an exemplary exploded view of a structural cage pallet;

FIG. 47A is an exemplary exploded view of a grid Lattice assembly shape, within a pillowed rectangle structural pallet Cartridge, which is self-contained and has the option of perforations between Lattice cells and the MDM may be inserted with or without Bags (“Structural Pallet Cartridge”), shape first seen in FIG. 130 247;

FIG. 47B is an exemplary exploded view of a grid Lattice first seen in FIG. 46;

FIG. 47C is an exemplary view of a flanged top shown originally in FIG. 4715A;

FIG. 47D is an exemplary view of a cut through a tube for vacuum: these can be machined metal;

FIG. 48A is an exemplary exploded view of an Interlocking, or welded, or molded or cast, structural pallet Cartridge Lattice grid assembly shape first seen in FIG. 130 225, within a pillowed rectangle structural pallet Cartridge shape first seen in FIG. 130 247;

FIG. 48B is an exemplary view of an assembled interlocking, or welded, or molded or cast, structural pallet Cartridge Lattice grid;

FIG. 48C is an exemplary view of a locking collar that is sandwiched between the top plate and the Lattice structural pallet Cartridge grid which could be made from materials such as corrosion-resistant aluminum;

FIG. 48D is an exemplary view of a tube for vacuum without collar;

FIG. 48E is an exemplary view of a tube for vacuum with collar in place between top plate and Lattice grid structural pallet Cartridge;

FIG. 49A is an exemplary exploded view of a Lattice grid and structural pallet Cartridge assembly first seen in FIG. 47A represented by the rounded rectangle shape in FIG. 130 235;

FIG. 49B is an exemplary view of a component set of top plate, assembled grid, and vacuum enclosure for Lattice grid structural pallet Cartridge assembly;

FIG. 49C is an exemplary view of a close-up of detail of 4921A of a tray assembly shown originally in FIG. 47A;

FIG. 49D is an exemplary view of a close-up of alignment pins, vacuum and vibration features;

FIG. 50A is an exemplary exploded view of a Lattice grid and structural pallet Cartridge assembly first seen in FIG. 47A represented by the rounded rectangle shape in FIG. 130 235, with excess material above the Lattice grid plane, pre vibration and/or evacuation;

FIG. 50B is an exemplary exploded view of a Lattice grid and structural pallet Cartridge assembly first seen in FIG. 47A represented by the rounded rectangle shape in FIG. 130 235, with excess material above the Lattice grid plane, pre-vibration and/or evacuation where the top plate is placed;

FIG. 50C is an exemplary view of a close-up of MDM surrounding a chamfered tube without locking pin;

FIG. 50D is an exemplary view of a close-up of MDM surrounding a chamfered tube with locking pin;

FIG. 51A is an exemplary view of a grid Lattice structural pallet Cartridge assembly being vibrated and evacuated;

FIG. 51B is an exemplary view of a completed grid Lattice structural pallet Cartridge;

FIG. 51C is an exemplary view of a cut through of an assembled Lattice grid, after vibration and/or vacuum;

FIG. 51D is an exemplary view of a cut through of an assembled Lattice grid, after vibration and/or vacuum;

FIG. 52 is an exemplary view of a pillowed shaped structural pallet Cartridge assembly and vibration and/or vacuum table;

FIG. 53A is a view of an exemplary Exploded View of a Structural Cage Assembly With Irregularly Shaped, Self-Interlocking, Polygon Grid;

FIG. 53B is a view of an exemplary Structural Cage Assembly With Irregularly Shaped, Self-Interlocking, Polygon Grid;

FIG. 53C is a view of an exemplary close up of a Structural Cage Assembly With Irregularly Shaped, Self-Interlocking, Polygon Grid;

FIG. 53D is a view of an exemplary close up of a Structural Cage Irregularly Shaped Polygon Grid Components prior to Interlock;

FIG. 53E is a view of an exemplary close up of a Structural Cage Irregularly Shaped Polygon Grid Components that are Interlocked;

FIG. 54A is an exemplary view of a Vessel assembly without Cartridge;

FIG. 54B is a view of an exemplary close up view of an inlet orifice as seen in FIG. 54A;

FIG. 54C is a view of an exemplary close up view of Ridge Band and Locking Fixture for Heating Assembly as seen in FIG. 54A;

FIG. 55 is an exemplary view of a Vessel assembly with Cartridge and optional thermal heating unit;

FIG. 56A is an exemplary view of an exploded tri-chamber Vessel with Cartridge and optional thermal heating units;

FIG. 56B is a view of an exemplary close up view of an inlet orifice for heating system as seen in FIG. 56A 5637A. Also shown in the “grid” is the water jet cut hole pattern in the aluminum sheet to let the gas into the Cartridge. 5625A as labeled in FIG. 56A is a spun aluminum or thermal conduction pad;

FIG. 57A is an exemplary view of a modular Vessel wrapper and optional insulation;

FIG. 57B is an exemplary view of a modular Vessel wrapper and optional insulation, outlet view;

FIG. 57C is an exemplary view of a Lifting Fixture and Vessel Cartridge Collar;

FIG. 58A is an exemplary view of a Cartridge plate or plate segment and Lattice structure in the form of one of the FIG. 130 225 shapes a square;

FIG. 58B is an exemplary view of a Cartridge plate or plate segment and Lattice structure in the form of one of the FIG. 130 217 shapes a hexagon;

FIG. 58C is an exemplary view of a Cartridge plate or plate segment and Lattice structure in the form of one of the FIG. 130 201 shapes a circle;

FIG. 58D is an exemplary view of a Cartridge plate or plate segment and Lattice structure in the form of one of the FIG. 130 209 shapes a triangle;

FIG. 59A is an exemplary view of an Npolygon—a squircle Vessel as shown in FIG. 58B, fixed assembly structural pallet;

FIG. 59B is an exemplary view of an Npolygon—a hexagon as shown in FIG. 58B, fixed assembly structural pallet;

FIG. 59C is an exemplary close up view of a hexagonal perforated lattice tube and structural pallet;

FIG. 60A is an exemplary view of a Lattice Cartridge plate. Cartridge plates can act as holders, and as closures;

FIG. 60B is an exemplary view of a cylindrical pie plate or triangular Cartridge plate for the purpose of acting as a heat transfer device, which is corrosion-resistant aluminum or any conductive metal;

FIG. 60C is an exemplary view of a segment of a cylindrical sectioned pie plate or triangular Cartridge plate for the purpose of use as a heat transfer device, which can be manufactured by taking two coils of material, wrapping them into a single plane spiral against a plate, then cutting the material into the appropriate shape and dimension, with materials such as corrosion-resistant aluminum or copper and/or graphene;

FIG. 61A Lattice cylinder and Cartridge sectional plate or triangular Vessel Cartridge plate shown;

FIG. 61B Lattice cylinder and holding Cartridge plate shown;

FIG. 61C Lattice cylinder and holding Cartridge plate shown;

FIG. 62 is a view of an exemplary perforated fixed assembly Lattice structure showing different shapes, and optional caps, with circle perforations that are one of the shapes in FIG. 130 for perforations, which could be made by extruded, injection molded or roll-formed out of metals, ceramics, composites, plastics, aramid or polyamides; folding that shows multiple shape iterations based on some of the shapes in FIG. 130;

FIG. 63 is an exemplary view of a perforated cylinder Lattice fixed assembly structure and optional caps and perforations, which could be roll-formed, cast, extruded, and in the case of the caps some could be stamped; all of which could be made from steel, carbon steel, borosilicate or chahalogen glass, polyamides, ceramics, composites, plastics, or corrosion-resistant aluminum, whose shape and perforation shapes could be in the shape of any of the components of FIG. 130;

FIG. 64 is an exemplary view of Lattice Bags;

FIG. 65A is an exemplary view of some of the shapes of possible Lattice Bags. A critical advantage of this technology is that we do not have to add binders to contain the material. Additionally the crush density of the material can be protected by variable pressure, or variable vacuum formation, along with the material. Further, the Cartridge system protects the material from load crushing as it is stacked in the Vessel, and after adsorption, the Lattice Bags can be manufactured via extrusion, injection molded, stamped or roll-formed out of metals, corrosion-resistant aluminum, chahalogen glass, ceramics, composites, plastics, aramid, polyamides, or laminated films, previously identified base shapes in FIG. 130;

FIG. 65B is an exemplary view of keystone Lattice Bags shapes and variations of shapes, which when placed the top and bottom walls have nested arc capacity whose shape enables a circular ring pattern by the creation of equal relational arcs and can be manufactured via extrusion, injection molded or roll-formed out of metals, corrosion-resistant aluminum, chahalogen glass, ceramics, composites, plastics, aramid or polyamides, or laminated films, previously identified base shapes in FIG. 130. If Bags are formed from laminated materials and optionally perforated they may or may not have perforations on the side walls. As in FIG. 65 above those perforations are shown as solubly coated;

FIG. 66A is an exemplary view of nesting, stacking, and interconnected Lattice structures, which can be stamped, injection molded or die cast, and can be made of materials such as corrosion-resistant aluminum, steel, polyamides, aramid, and/or composites. The MDM can be un-compressed or pre-formed for insertion or compressed within the structure. In this iteration it is a rectangular shape with round corners as shown in FIG. 130 233;

FIG. 66B is an exemplary view of nesting, stacking, and interconnected Lattice structures with fins and sleeve which can be stamped, injection molded or die-cast, and can be made of materials such as corrosion-resistant aluminum, polyamides, aramid, and/or composites. The MDM can be un-compressed or pre-formed for insertion or compressed within the structure. In this iteration it is a rectangular shape with round corners as shown in FIG. 130 201;

FIG. 66C is an exemplary view of nesting, stacking, and interconnected Lattice structures which can be stamped, extruded or die-cast, and which can be made of materials such as corrosion-resistant aluminum, polyamides, aramid, and/or composites. The MDM can be in un-compressed or pre-formed Bags for insertion or compressed within the structure. A rod is driven through the slots to keep it together as an interference fit. A lid could be made of film or stamped or machine cut aluminum with photo-etching and can have a thermal adhesive perimeter, this structure as all structures can be made in any shape of FIG. 130;

FIG. 66D is a view of an exemplary view of nesting, stacking, and interconnected Lattice structures which can be stamped, extruded or die-cast, and which can be made of materials such as corrosion-resistant aluminum, polyamides, aramid, and/or composites. The MDM can be un-compressed or pre-formed for insertion or compressed within the structure. The end caps in this illustration can be injection molded or stamped, and caps are interference fit and/or affixed with thermal cycled adhesive;

FIG. 67A A Lattice structure component of inscribed shapes to create a maximum fill of MDM within a Vessel or Cartridge geometry that fits Cartridges within this filing such as any cylinder or if in an unwound position any rounded rectangle, for MDM or a holding structure spirals of a COM, if an MDM such as a COM compressed barrier carpet, can be filled with buckyballs, or simply compressed or uncompressed MDM out of FIG. 67A. Can be unwound as a prophylactic barrier or attached to a backer to form a membrane, or the pieces of the carpet exterior can be sealed together via adhesive, welding or a zipper to form a membrane. Spiral can be made out of polyamides, composites, laminates of plastic and metal films, and a ceramic polyethylene composite if necessary for reasons such as radiation amendment to incinerate the Lattice and the contents. If it is to be left in place it could be made of a biodegradable plastic. A laminate peelable plastic or paper as a protective barrier or EVOD or soluble paper can also be attached as a protective barrier or to allow a vacuum if necessary for compaction in lieu of roller compaction. If MDM needs a heat component to assist adsorption or to assist with the release of gas or liquid from it, then a metal conductive foil such as corrosion-resistant aluminum may be used. In this case FIG. 41 may need to be deployed so that the spiral coil electrostatic charges are neutralized;

FIG. 67B A Lattice structure component that is a spiral of material which can be filled with MDM via impregnation of materials, such as an open extruded polyamide filament wool celled material that enables the MDM to be stored. Another iteration of this would be a corrosion-resistant aluminum wrap with adhesive so the MDM is adhered to the surface of the metal, the adhesive could be soluble;

FIG. 68A is an exemplary view of an SMC, stamped, molded, or die cast Lattice Series;

FIG. 68B is an exemplary view of an SMC, stamped, molded, or die cast for continuous Lattice Bag(s) variation series;

FIG. 68C is an exemplary view of an SMC, stamped, molded, or die cast for continuous Lattice Bag(s) variation series;

FIG. 68D is a view of an exemplary SMC, stamped, molded, or die cast for continuous Lattice Bag(s) variation series;

FIG. 69A is an exemplary view of a dual material SMC packaging process;

FIG. 69B is an exemplary view of multiple MDM and/or additives material SMC packaging process, which exploits at least could be two, segregated or mixed components;

FIG. 70A is an exemplary view of a single material SMC packaging process;

FIG. 70B is an exemplary view of a multiple material SMC packaging process;

FIG. 71A is an exemplary view of a single MDM material SMC packaging process;

FIG. 71B is an exemplary view of a single MDM material SMC packaging process;

FIG. 72 is an exemplary view of a tube made of materials such as polyamide, which is then converted to a Lattice Bag; this is another Lattice iteration and these forms do not depend on binders, which provides the advantage of not damaging the material by the addition of the binder, the expense of the binder, the added weight of the binder and added volume of the binder, which is subtractive from the total volume of potential adsorption capacity of the populated Vessel;

FIG. 73A is an exemplary view of an X-shaped Lattice insert reinforcement structure, with panels and/or panel insets that may be rigid or flexible;

FIG. 73B is an exemplary view of a process to assemble a Lattice, with components such as inserts, and rod or rail;

FIG. 74A is an exemplary view of an X-shaped Lattice reinforcement structure;

FIG. 74B is an exemplary view of a circular disk spoke-shaped Lattice reinforcement structure;

FIG. 75A is an exemplary view of a keystone Lattice with four posts as reinforcement to the structure;

FIG. 75B is an exemplary view of a hexagon Lattice reinforcement structure;

FIG. 76A is an exemplary view of a Lattice Bag composed of a rolled sheet;

FIG. 76B is an exemplary view of a semi-rigid Lattice Bag with double roll insert;

FIG. 76C is an exemplary view of a semi-rigid Lattice Bag with tent fold insert;

FIG. 76D is a view of an exemplary close up view of Lattice Bag composed of a rolled sheet as seen in FIG. 76B 7603B;

FIG. 77A is an exemplary view of a semi-rigid Lattice Bag with oval insert;

FIG. 77B is an exemplary view of a semi-rigid Lattice Bag with double tube insert;

FIG. 77C is an exemplary close-up view of Double Tube Insert;

FIG. 78A is an exemplary view of an unformed Lattice Bag or structure that is in the shape of a tube variation, which could be any shape within FIG. 130;

FIG. 78B is an exemplary view of a Lattice Bag or structure that is in the shape of keystone variation which came from 78A, which could be any shape within FIG. 130;

FIG. 79A is an exemplary view of a Bag or structure lid with vacuum feature;

FIG. 79B is an exemplary close-up view of a vacuum chuck feature;

FIG. 79C is an exemplary view of a cut of 79B;

FIG. 80A is a view of an exemplary close up view of Lattice Bag ratchet;

FIG. 80B is a view of an exemplary exploded view of FIG. 80C;

FIG. 80C is a view of an exemplary Rigid Lattice Structure Evacuated Ratchet Assembly, which could have photo etched, laser or water jet micro holes that are filled or laminated with a soluble coating, and can be outfitted with a sleeve on the inside of the Lattice assembly;

FIG. 80D is a view of an exemplary side and front view of FIG. 80C;

FIG. 81A is a view of an exemplary side and front views of FIG. 81B;

FIG. 81B is a view of an exemplary Rigid Lattice Structure Evacuated Ratchet Assembly, which has photo etched, CAD knife, laser or water jet micro holes in the Lattice assembly; the assembly in this case is shown without soluble laminate or coating which is optional;

FIG. 81C is a view of an exemplary exploded view of FIG. 81B;

FIG. 81D is a view of an exemplary close up of ratchet fixture as seen in FIG. 81A;

Lattice Bag that can be made from plastics and or metalized conductive films

FIG. 82A is an exemplary view of a compression ratchet without optional vacuum rigid Lattice structure with laser cut or air cut or photo etched holes that are coated with soluble material, or the figure is fitted with a soluble coated perforated Bag liner shown earlier in FIG. 10E 1015. Volume of material is variable, dependent on the crush delta of the MDM;

FIG. 82B is an exemplary view of a compression ratchet without vacuum rigid Lattice structure with molded holes, such as injection molded holes that are coated with soluble material, or the figure is fitted with a perforated Bag that may be so coated. Volume of material is variable, dependent on the crush delta of the MDM;

FIG. 83A is an exemplary view of a series of repeatable Lattice structures that is comprised of seven keystone shape variations as seen in FIGS. 130 245 and 237/268, Lattice placements are staggered to promote weight load distributions, avoid crushing material, and when of value facilitate thermal transfer;

FIG. 83B is an exemplary view of seven repeatable Lattice structures or Bags comprised of seven keystone shape variations as seen in FIGS. 130 245 and 237/283;

FIG. 84A is an exemplary view of a Lattice Bag or Structure and a volumetric scale per anticipated “Assay Strata” or “Strata Positioning”. “Strata Positioning” means the placing of Modules into known density and/or volume stratum within a Vessel, intended to treat or capture multiple constituents. Dosing or doping can mean purposefully processed with one or more doped chemicals, and/or elements or metals (even silver). These Lattice forms do not depend on binders, which provides the advantages of not damaging the material by the addition of the binder, saving the expense of the binder, and avoiding the added weight and volume of the binder, which is subtractive from the total volume of potential adsorption capacity of the populated Vessel;

FIG. 84B is an exemplary view of a Lattice shown with different nonbinding additives for specific dosing purposes;

FIG. 85A is an exemplary view of a filling system without pressure compaction;

FIG. 85B is an exemplary view of a filing system with pressure compaction, showing a cutaway;

FIG. 86 is an exemplary view of a mold shaping and filling process;

FIG. 87 is an exemplary view of a flexible Lattice Bag filling where optional soluble coating has been applied. Illustration shows a process for FIGS. 88, 89, 90, and 91. Bag can be in placed in a mold such as show in FIG. 86 or come to us extruded in this shape;

FIG. 88A is a view of an exemplary Lattice Bag that can be made from plastics and/or metalized conductive films;

FIG. 88B is a view of an exemplary close up view of FIG. 88A 8813A showing vacuum chuck and valve;

FIG. 88C is a view of an exemplary side and front view of FIG. 88A;

FIG. 88D is a view of an exemplary close up cross section view of FIG. 88A 8813A showing vacuum chuck and valve;

FIG. 88E is a view of an exemplary close up cross section view of FIG. 88C 8821C, with a ferrule flange;

FIG. 89A is a view of an exemplary nonrigid or flexible Lattice Bag;

FIG. 89B is a view of an exemplary close up of FIG. 89 8907A;

FIG. 89C is a view of an exemplary front view of FIG. 89A;

FIG. 89D is a view of an exemplary side view of FIG. 89A;

FIG. 89E is a view of an exemplary close up cross section view of spline and ferrule flange, wherein 8928E is an O-Ring Band that is stretched around FIG. 89 8903A holding FIG. 89 8909A into a groove in FIG. 89 8903A;

FIG. 89F is a view of an exemplary close up cross section view of FIG. 89A 8911A showing vacuum chuck and valve;

FIG. 90A is a view of an exemplary nonrigid or flexible Lattice Bag;

FIG. 90B is a view of an exemplary side and front view of FIG. 90A;

FIG. 90C is a view of an exemplary close up view of the Q feature ferrule as seen in FIG. 90B;

FIG. 90D is a view of an exemplary close up cross section view of FIG. 90A showing vacuum chuck and valve;

FIG. 90E is a view of an exemplary close up cross section view of FIG. 90B 9025B showing vacuum chuck and valve;

FIG. 91A is a view of an exemplary rigid Lattice assembly;

FIG. 91B is a view of an exemplary side and front view of FIG. 91A;

FIG. 91C is a view of an exemplary close up of lid, perforations, vacuum chuck and valve;

FIG. 91D is a view of an exemplary close up cross section of top lid interlocking hem with vacuum chuck and valve;

FIG. 91E is a view of an exemplary close up cross section of bottom lid interlocking hem with vacuum chuck and valve;

FIG. 91F is a view of an exemplary close up of rolled form interlocking hem;

FIG. 92A is a view of an exemplary rigid Lattice assembly;

FIG. 92B is a view of an exemplary close up of vacuum chuck and valve;

FIG. 92C is a view of an exemplary front view of rigid Lattice assembly;

FIG. 92D is a view of an exemplary side view of rigid Lattice assembly;

FIG. 92E is a view of an exemplary close up of lid closed as seen in FIG. 92D 9219D;

FIG. 92F is a view of an exemplary close up cross section view of FIG. 92A showing vacuum chuck and valve;

FIG. 93A is a view of an exemplary rigid Lattice assembly, with thermal conductive lid;

FIG. 93B is a view of an exemplary front and side view of FIG. 93A;

FIG. 93C is a view of an exemplary close up of vacuum chuck and valve;

FIG. 93D is a view of an exemplary cross section of top thermal conductive lid with vacuum chuck and valve;

FIG. 93E is a view of an exemplary close up of thermal conductive lid with vacuum chuck and valve;

FIG. 93F is a view of an exemplary cross section of bottom thermal conductive lid with vacuum chuck and valve;

FIG. 94A is a view of an exemplary Lattice Bag assembly, that has a reverse can opener crimp seal lid;

FIG. 94B is a view of an exemplary front and side view of FIG. 94A;

FIG. 94C is a view of an exemplary vacuum chuck and valve;

FIG. 94D is a view of an exemplary cross section of lid with vacuum chuck and valve;

FIG. 94E is a view of an exemplary close up of reverse can opener crimp seal lid;

FIG. 95A is an exemplary view of a formed monolith without binders or additives to form the shape and is an exploded assembly, which can be any shape in FIG. 130;

Like our Lattices, these forms do not depend on binders, which provides the advantages of not damaging the material by the addition of the binder, saving the expense of the binder, and avoiding the added weight and volume of the binder which is subtractive from the total volume of potential adsorption capacity of the populated Vessel;

FIG. 95B is an exemplary view of a formed monolith and is an exploded assembly, which can be any shape in FIG. 130;

FIG. 96A is an exemplary view of a Lattice Bag film laminating process, which could be enhanced with more roller assemblies or by passing the material through the same process multiple times;

FIG. 96B is an exemplary view of a Lattice Bag film after laminating process;

FIG. 96C is an exemplary view of a Lattice Bag film with perforations before the laminating or perforation covering process;

FIG. 97A is an exemplary view of a process to marry films such as polyamide to metalized film of a corrosive resistant Al alloy;

FIG. 97B is an exemplary flow chart of a process to marry films such as polyamide to metalized film of a corrosive resistant Al alloy, which also shows a perforation process;

FIG. 98A is an exemplary flow chart of a process to marry films such as polyamide to metalized film of a corrosive resistant Al alloy, with a laminate coating that is soluble, such as EVOD;

FIG. 98B is an exemplary flow chart of a process to marry films such as polyamide to metalized film of a corrosive resistant Al alloy, which also which also shows a perforation process, with a spray coating that is soluble;

FIG. 99A is an exemplary flow chart of a process to spray Lattice structures made of materials such as polyamide, to composites or rigid metal Lattices of a corrosive resistant Al alloy, with a spray coating that is soluble, such as EVOD;

FIG. 99B is an exemplary flow chart of a process to spray Lattice structures made of materials such as polyamide, to composites or rigid metal Lattices of a corrosive resistant Al alloy, with a spray coating that is soluble, such as EVOD, which also shows a perforation process;

FIG. 100A is an exemplary view of a Cartridge Lattice structure within a vertical pillow Vessel or, if rotated, a horizontal Vessel that holds films, MDM sheets, or Lattice Bags as in SMC types. Purposes include separation, amendment, storage, transformation, and deployment of inhibitors, poisons and promoters. The Lattice Cartridge fastener and weights are machined from a rod of material such as transitional metals, steel, corrosion resistant aluminum or a composite of polyamide and aramid;

FIG. 100B is an exemplary view of a Lattice structure within a vertical pillow Vessel or any defined shape Vessel or, if rotated, a horizontal Vessel that holds films, MDM sheets, or Lattice Bags and metal or channel bars for the purpose of catalysis such as the Haber process with iron or other transitional catalysis processes with nickel, or any transitional metal, or other reactor capacities. The Lattice fastener and weights are machined from a rod of material such as transitional metals, steel, corrosion resistant aluminum or a composite of polyamide and aramid;

FIG. 100C is a view of an exemplary close up of Lattice fixture in an open position with perforated front and back sheet;

FIG. 100D is a view of an exemplary close up of Lattice fixture in a closed position with perforated front and back sheet;

FIG. 100E is a view of an exemplary close up of Lattice fixture in an open position;

FIG. 100F is a view of an exemplary Lattice fixture in a closed position;

FIG. 101A is an exemplary view of a pressurized sheet formed Lattice Dimple Cup sheet;

FIG. 101B is an exemplary view of a sheet formed Lattice Pressurized Dimple Cup sheet;

FIG. 101C is an exemplary view of half of an assembled Dimple Cup Vessel;

FIG. 101D is an exemplary view of an assembled Dimple Cup Vessel;

FIG. 102A is an exemplary view of a Exploded Pressurized Dimple Cup Sheet;

FIG. 102B is an exemplary view of a Nested Pressurized Dimple Cup Sheet;

FIG. 103A is an exemplary view of a nested variation of a triangle shape Pressurized Sheet Form Dimple Cup Lattice shown in FIG. 130 of a 2 Chamber Vessel in a Vessel populated with MDM Nested Pressurized Dimple Cup Sheet;

FIG. 103B is an exemplary view of the nesting of FIG. 103A;

FIG. 104A is an exemplary view of an interlocking structural cage pallet;

FIG. 104B is an exemplary view of an interlocking structural cage pallet;

FIG. 105A is an exemplary view of an exploded view of an interlocking structural pallet vessel;

FIG. 105B is an exemplary view of an interlocking structural pallet vessel;

FIG. 106A is an exemplary view of an exploded closeup of one interconnected segment of repeating structural pallet segments;

FIG. 106B is an exemplary view of repeating structural pallet segments, assembled but not interconnected;

FIG. 106C is a closeup detail of a part of FIG. 106A; 10603A;

FIG. 106D is a top view of a single pallet sans FIG. 106A; 10601A(1);

FIG. 107A is an exemplary view of a vehicle Vessel in Vessel storage;

FIG. 107B is an exemplary view of a vehicle storage Vessel cut away showing a two segment Vessel with serpentine continuous Lattice;

FIG. 108 is an exemplary view of a Vessel with Cartridge, and serpentine continuous Lattice system;

FIG. 109A is an exemplary view of an irregularly shaped Cartridge with optional heating assembly within a Vessel which could be of any shape, FIG. 130 showing one possible placement;

FIG. 109B is an exemplary view of a vehicle structure with Vessel placement;

FIG. 109C is an exemplary view of a connected heat source to an irregularly shaped Cartridge with optional heating assembly within a Vessel;

FIG. 110A is an exemplary view of a heating fluid system for a Vessel;

FIG. 110B is an exemplary view of a close-up of fins for a heating fluid system for a Vessel;

FIG. 111 is an exemplary view of an irregularly-shaped with Lattice wells, Vessel made with materials such as Corrosion resistant Aluminum and Polyamide and/or Graphene and Polyamide;

FIG. 112A is an exemplary view of a truck fuel tank with assembled MDM-populated Lattice and Cartridge;

FIG. 112B is an exemplary rear view of truck fuel tank with assembled MDM-populated Lattice and Cartridge;

FIG. 113A is an exemplary view of a truck MDM fuel tank with heating assembly;

FIG. 113B is an exemplary view of a cut through showing gasket and heating fins;

FIG. 113C is an exemplary view of a cut through showing liquid channels and heating fins;

FIG. 114 is an exemplary view of a fuel Vessel with assembled MDM-populated Lattices and Cartridge, shown with optional heating element;

FIG. 115A is an exploded view of Vessel with Cartridge hose manifold reel assembly;

FIG. 115B is a view of a cross section of hose manifold Cartridge, FIG. 115A; 11515A and 11519A;

FIG. 115C is a close-up view of FIG. 115D;

FIG. 115D is a close-up of pull wire to pull populated MDM tubular Lattice;

FIG. 115E is a close-up of connection between two reels in FIG. 115A; 11517A;

FIG. 115F is a close-up in FIG. 115A, 11521A;

FIG. 116A is an exemplary view of a Vessel in a Vessel hose manifold;

FIG. 116B is an exemplary view of a cut-through of a hose manifold Vessel that is not populated with MDM;

FIG. 116C is an exemplary view of a hose manifold Vessel pulling MDM through;

FIG. 116D is an exemplary view of a several methods of loading MDM;

FIG. 117A is an exemplary view of a cylinder which could be made in any shape in FIG. 130, a Vessel that is thin walled made of materials such as a composite polyamide and graphene, composite construction to the pipe or Vessel;

FIG. 117B is an exemplary view of a cylinder which could be made in any shape in FIG. 130, a Vessel that is thin but not as thin walled as FIG. 117A, made of materials such as a composite polyamide and grapheme. The wall of this Vessel is more rigid and not as flexible as FIG. 117A;

FIG. 117C is an exemplary view of a Vessel or pipe;

FIG. 118A is an exemplary view of a Vessel in Vessel Hose manifold single chamber;

FIG. 118B is an exemplary view of a Vessel in Vessel hose manifold four chamber Vessel with three MDM Chambers and one heating fluid chamber;

FIG. 118C is an exemplary view with three heating fluid and one MDM chamber;

FIG. 118D is a view of an exemplary of a filled Lattice populating FIG. 118A;

FIG. 118E is a view of an exemplary of a filled Lattice populating FIG. 118B;

FIG. 118F is a view of an exemplary of a filled Lattice populating FIG. 118C;

FIG. 119A is a view of an exemplary Structural Cage Pallet Thermal Metal Conduits first seen in FIG. 31A, FIG. 31B, FIG. 31C, FIG. 31D, and FIG. 31E;

FIG. 119B is a view of an exemplary close up heating assembly and cross section of Vessel with Structural Cage Pallet Thermal Metal Conduits;

FIG. 119C is a view of an exemplary heating assembly and cross section of Vessel with Structural Cage Pallet Thermal Metal Conduits;

FIG. 119D is a view of an exemplary close up of inlet or outlet feature of Structural Cage Pallet Thermal Metal Conduits;

FIG. 120A is an exemplary view of a Lifting Fixture with looped wire under shoulder collar of top plate;

FIG. 120B is a view of an exemplary Cartridge Assembly with Top View of three lifting fixtures plus center lifting fixture;

FIG. 121A is a view of an exemplary showing a male threaded bolt and female threaded fixture;

FIG. 121B is a view of an exemplary female threaded bolt and male threaded fixture;

FIG. 121C is a view of an exemplary Cartridge Assembly with threaded columns and fixtures;

FIG. 122A is an exemplary view of a Drum in an air berm pool;

FIG. 122B is an exemplary view of a weighted suction device;

FIG. 122C is an exemplary view of a Vessel with removable lid or cap;

FIG. 122D is an exemplary view of an assembly of MDM suction device, not shown with steam suction option;

FIG. 123A is an exemplary view of a Liner with MDM;

FIG. 123B is a view of a cut away close-up of interior portion of liner and MDM filing;

FIG. 124A is an exemplary view of a liner with Cartridge;

FIG. 124B is an exemplary view of a liner;

FIG. 124C is a view of a cut away which is a close-up of a Liner;

FIG. 125A is a view of an exemplary Steel Compression Ring with pipe or Vessel;

FIG. 125B is an exemplary view of iterations of bumper rings that are spacers between compression rings;

FIG. 125C is an exemplary view of versions of steel compression rings;

FIG. 125D is an exemplary view of a Vessel or pipe with compression ring and spring-washer;

FIG. 126A is an exemplary view of a transport guard protection for Cartridge assembly;

FIG. 126B is an exemplary view of a close-up of transport protection guard for Cartridge assembly;

FIG. 126C is a view of an exemplary Transport Guard Protection for Cartridge Assembly made from materials such as rubber;

FIG. 126D is a view of an exemplary Wave or Leaf Spring Transport Guard Protection for Cartridge Assembly;

FIG. 126E is a view of an exemplary coil Spring Transport Guard Protection for Cartridge Assembly;

FIG. 126F is a view of an exemplary notched metal ring with rubber bumper leaves Transport Guard Protection for Cartridge Assembly;

FIG. 127A is an exemplary view of a shock protection device;

FIG. 127B is an exemplary view of a shock protection device;

FIG. 127C is an exemplary exploded view of a squircle Cartridge with shock protection device;

FIG. 127D is a view of an exemplary Cartridge Assembly with Shock Protection Device;

FIG. 127E is a view of an exemplary is close up view of an injection molded, composite bumper;

FIG. 128A is another exemplary close-up view of a cylindrical Lattice tube structure, which could be in the shape of any of the FIG. 130 shapes, for the handling of MDM films;

FIG. 128B is another exemplary close-up view of a triangular Lattice tube structure, which could be in the shape of any of the FIG. 130 shapes, for the handling of MDM micro granulated materials;

FIG. 128C is another exemplary close-up view of a triangular Lattice tube structure, which could be in the shape of any of the FIG. 130 shapes, for the handling of MDM tubed shaped materials;

FIG. 128D is another exemplary close-up view of a triangular Lattice tube structure, which could be in the shape of any of the FIG. 130 shapes, for the handling of MDM sphere shaped materials such as COM or any MDM formed or extruded monolith or granular sub-Lattice filled section;

FIG. 128E is another exemplary close-up view of a triangular Lattice tube structure, which could be in the shape of any of the FIG. 130 shapes, for the handling of MDM pellet shaped materials such as COM or any MDM formed or extruded monolith or granular sub-Lattice filled section, the shapes of the material can also be of any shape that is found FIG. 130;

FIG. 128F is another exemplary close-up view of a triangular Lattice tube structure, which could be in the shape of any of the FIG. 130 shapes, for the handling of MDM hollow tube-shaped materials such as zeolites;

FIG. 128G is another exemplary close-up view of a triangular Lattice tube structure, which could be in the shape of any of the FIG. 130 shapes, for the handling of MDM preformed shaped materials such as COM or any MDM formed or extruded monolith or granular sub-Lattice filled section, the shapes of the material can also be of any shape that is found FIG. 130;

FIG. 128H is another exemplary close-up view of a triangular Lattice tube structure, which could be in the shape of any of the FIG. 130 shapes, for the handling of MDM preformed shaped materials such as any MDM formed or extruded BAR monolith or granular sub-Lattice filled section; the shapes of the material can also be of any shape that is found FIG. 130;

FIG. 128I is another exemplary close-up view of a triangular Lattice tube structure, which could be in the shape of any of the FIG. 130 shapes, for the handling of MDM foam or sub-Lattice foam filled section; the shapes of the material can also be of any shape that is found FIG. 130;

FIG. 129 is a view of a conceptual representation of “MDM”. “MDM” means Molecular Density Materials or any adsorbent such as atomic particles, carbon nanotubes, catalysis, charred organic matter, clays, graphene, metal organic frameworks (MOF), nanoparticles, nano-structured materials, polymeric organic frameworks, silica, silica gel, upsalite, zeolites or other adsorbents of known or taught chemistries, combinations of sorption materials, or hybrids with non-sorption materials, in any form or shapes;

FIG. 130 is an exemplary view of shapes for monoliths, panel inserts, Lattices, caps, lids, plates, plate inserts, grids, Cartridges, Vessels, and perforations, which can be any polygon with equal or unequal side lengths and/or any number of sides, whose sides could linear, concave or convex;

FIG. 131A is an exemplary view of an irregularly-shaped squircle Vessel and nine cylinders that fit within the irregularly-shaped squircle Vessel;

FIG. 131B is a sectioned orthographic view of nine cylinders that fit within the irregularly-shaped squircle Vessel;

### DETAILED DESCRIPTION OF THE PREFERRED EMBODIMENTS

Although adaptable to laboratory scales, the present invention is principally intended as a separation, segregation, transformation, storage, transport, and/or purification means for exploiting the properties of MDM in one or more systems or sub-systems of the present invention for real life, outside of a laboratory environment.

The following definitions and descriptions of the systems, devices and components are used in this application. The definitions and the descriptions also apply to the drawings depicting various embodiments of the present invention:

“Amend” means to change or modify for the better, to alter formally by modification, deletion or addition.

“Bags” hold MDM. Certain types of Bags by fabrication method and/or materials.

Bags are always intended to be placed into Cartridges as further described herein.

Continuous Lattice Bags can be constructed using known industrial techniques such as a Sheet Molding Compound (“SMC”) machine. Continuous Lattice Bags offer the benefits of high-speed production at low cost. They offer many variations in output topology, construction, and perforated or non-perforated film sheet material selection. Continuous Lattice Bags may consist of one or more layers or film sheets, at least one of which must be perforated, or non-perforated and a Depository film sheet for the deposition of at least one type of MDM or at least one type of additive. The film sheet material or materials may be made of film or paper derived from materials, engineered for the environment, such as polyamide, polyethylene, aramid, Tyvek®, or composite films or paper made with such material as fibers, fillers, or other materials such as PET, glass, aramid, or acetylated films, aluminum fibers, and others to enhance material properties such as film tensile strength, tear strength, modulus, thermal conductivity, or processing. Soluble and non-soluble coating or coatings may be post applied or in-line applied to the film or films in an engineering pattern via screen or roll coating or other known techniques to allow for virgin bonds between the film sheets. Film Sheets may contain metalized coatings or metal films such as aluminum, copper, zinc, etc. applied with known techniques such as vacuum metalizing or laminating.

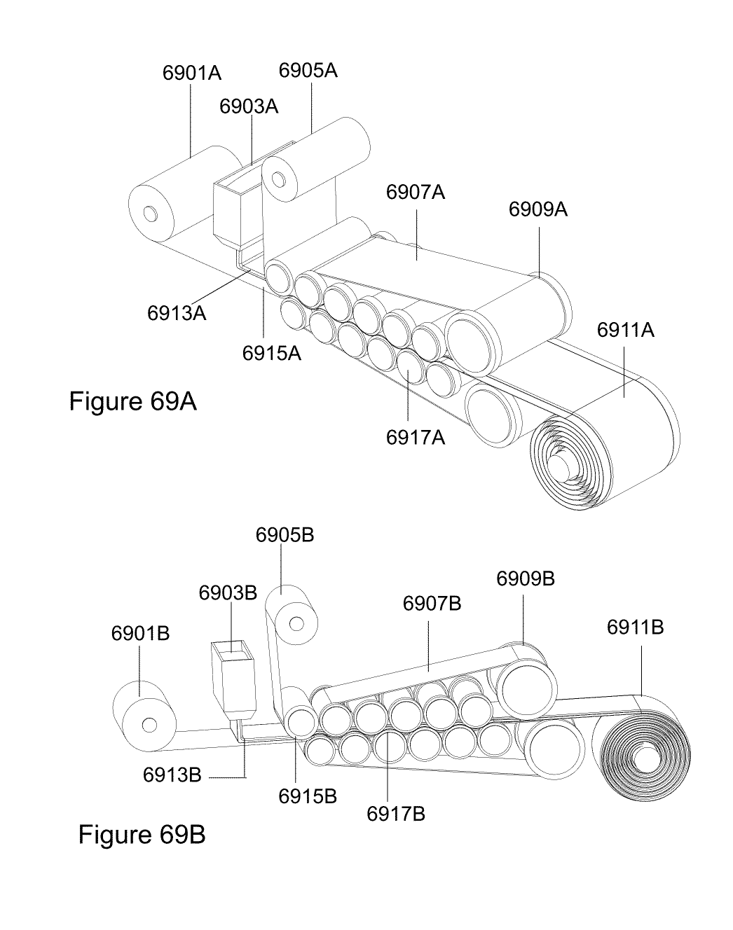

Continuous Lattice Bags may be fabricated with one or more deposition sheets and zero, one, or more encapsulating sheets that may be joined to sandwich the deposited MDM or other complementary material by known industrial techniques such as welding or with adhesives rendering a finished Continuous Lattice Bag having specified flexibility, X axis and/or Y axis firmness or rigidity with either a sealed or an unsealed end of roll. The dispensing orifice or orifices, below 6903A/B (FIG. 69B), maybe programmed to dispense MDM or other complementary material in a uniform manner or in any variable pattern such as tessellated rows, circles or triangles to suit the specified purposes of the Continuous Lattice Bag. Continuous Lattice Bags, by their construction, may be able to maintain a vacuum.

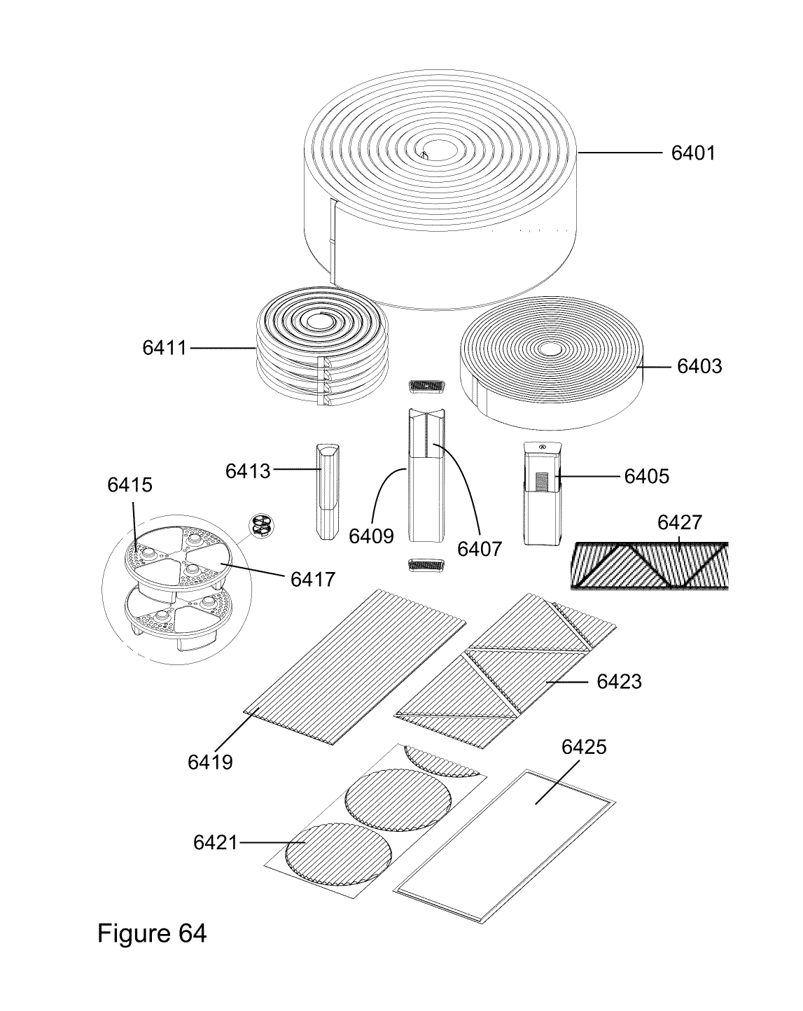

Flexible Continuous Lattice Bags contain MDM sandwiched between at least 2 film sheet(s) bonded around the entire perimeter and are not self-supporting. Flexible Continuous Lattice Bags may be produced flat (see (6419A FIG. 64A) or in spiral roll configurations (see 6401A or 6411A, FIG. 64A).

Semi-rigid Continuous Lattice Bags contain MDM sandwiched between at least 2 film sheets bonded around the entire perimeter and may be produced flat (see 6419A, FIG. 64A) or in self-supporting spiral roll configurations (see 6401A and/or 6411A, FIG. 64A). A semi-rigid, depository film sheet or rigid insert film or paper may be used to increase the sheet rigidity.

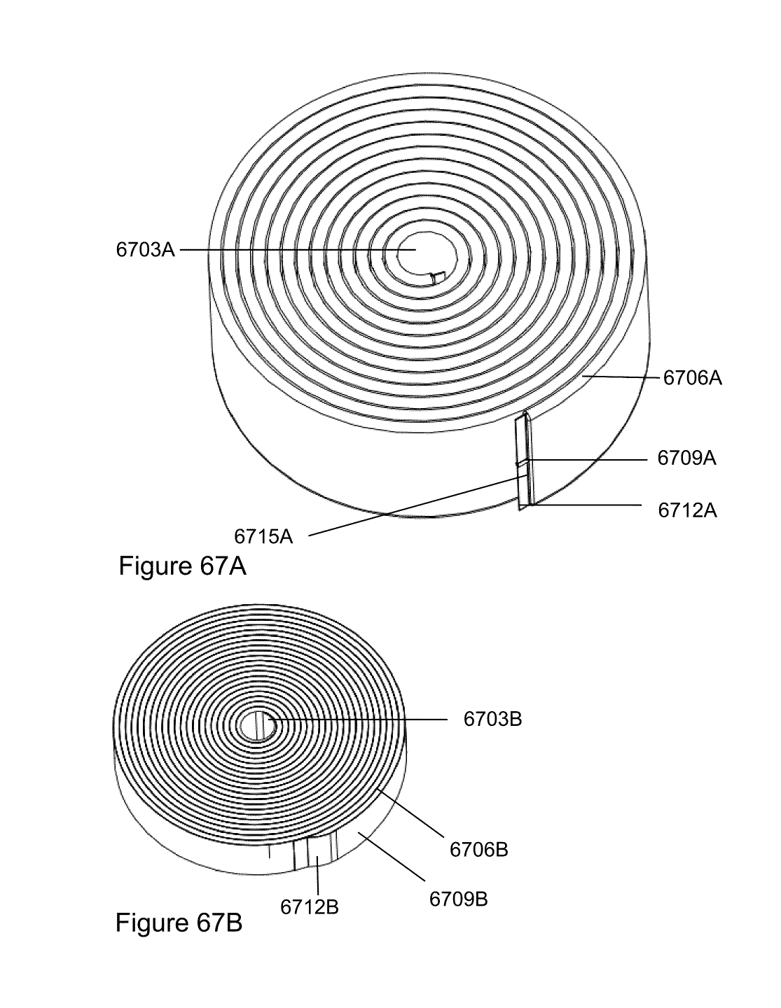

Tape Roll Continuous Lattice Bags contain MDM that is adhered to a flexible or semi-rigid, depository film sheet. There is no second film sheet in this Continuous Lattice Bag construction. A Tape Roll Continuous Lattice may be spiral rolled to protect and retain the MDM, or may be produce in individual sheet(s), and may be self-supporting when spiraled, see FIG. 67B.

Tessellated Continuous Sheet is the same as a Flexible Continuous Lattice Bag or a Semi-rigid Continuous Sheet with the addition of a variable pattern, in this case a tessellated pattern of circles, see 6421A FIG. 64A, or triangles, see 6423A FIG. 64A.

A Bag can be rigid, semi-rigid, or flexible. A semi-rigid Bag can have pocket-shape container made of plastic film attached to a substrate. The plastic film can contain perforations or an inlet and an outlet. Preferably the size of the perforation should be in a range that forms a film when a liquid passes through the perforation. The relationship of the size of the perforation and the surface tension of a liquid can be represented by the following formula:

Surface tension=F/2L=FΔₓ/2LΔₓ=W/ΔA

F=force required to stop side from sliding

L=length of movable side

Δₓ=distance side is moved/slid

W=work done by force (F) in moving side by distance Δₓ

ΔA=increase of total area of side

ΔA=2LΔₓ

“Bands” are a fixture or series of fixtures that enable compressive hoop strength around the Cartridge. Bands are a tensioning mechanism on the exterior of a Cartridge, containment cage or structural pallet and made from materials such as a woven plastic ribbons or fibers, aramid, ferrous or non-ferrous metal strips, or other materials specially adapted to the content/environment, bands maybe inboard or outboard of sleeve or against the structure or the Cartridge or Bags.

The benefits: bands protect the Cartridge contents. Bands maintain the X, Y positions of the Lattice Bags or containers within the Cartridge, containment cage or structural pallet. Bands, if made thicker and under tension may become flush with perimeter of the Cartridge plate. Then coating with a low friction coefficient such as fluoropolymer or acetal facilitates Cartridge loading or unloading.

Bands that are made from metal or film with a metalized coating enhance thermal conductivity.

When under tension, the Bands pack the materials tight, reducing content motion from shock or vibration on the assembly. Bands may be multi-color coded to identify items such as contents, or coatings such as anti-static coatings such as any conducting polymer (plastic) and a solvent made from deionized water and alcohol or PVA (polyvinyl alcohol), to protect the material. Sleeves could have coatings such as Cu or a biocide. Ferrous or nonferrous fibers that would indicate strain or fracture post deployment that with a G-sensor in transit or pre-loading could detect shock. Sleeves may be a permeable barrier that still allow for adsorption. In a fabric such as an aramid or metal textile iteration sleeves are a lightweight solution that lowers the tare weight of the assembly. The sleeve could protect the material from welding and thermal transfer and/or spray.

“Bio-Char” or Charred Organic Materials (“COM”) is a substance that has remarkable properties of adsorbing/absorbing cationic and/or anionic materials. It can encapsulate, isolate, adhere, absorb, (adsorption/absorption), amend or transform soils, ashes, fly-ash, sands, rocky muds and tailings, wet and dry gases, liquids, aqueous or non-aqueous, heavy metals, hydrocarbons, or mixtures thereof. Examples include black carbon and charred agricultural products and by-products such as ashes of sugar beets, charred sugar beets, charred rye grass, others, and combination thereof.

“Bottom Plate” is the closure mechanism or lid of a Cartridge, containment cage or structural pallet. In the case of a vertical Vessel or when loading a horizontal Vessel in a vertical position the bottom plate is designed to pick up the load of the Cartridge, containment cage or structural pallet assembly from the populated adsorbed constituent Lattices from the columns and ribs into the bottom plate. As used herein, “populated” means filled with MDM; while “unpopulated” means not filled with MDM.

It could be made of materials such as; if metal, corrosion resistant aluminum, ferrous and non ferrous metals, or other alloys, if plastic; polyamide and/or polyamide composite or a combination of metal and plastic.

If metal, it could be made via stamping, laser or water jet cut sheet, or if plastic or composite, RTM, or deposition printed.

It contains hole patterns for circulation, to facilitate adsorption of constituents and weight reduction.

It may contain slots for ribs or circular ribs, which enable mating to the Cartridge, containment cage or structural pallet to generate an X and Y axis lock for the Cartridge assembly. The effect of this is to transfer Lattice Bag assembly loads from the ribs to the bottom plate. These slots create rib locators for welding, joining or bonding.

It may contain holes for column attachment to the Cartridge, containment cage or structural pallet to tie the entire assembly together, and transfer loads off the Lattice Bag assembly. By tying the columns together it keeps the columns rigid and transfers loads off the Bag, while keeping the deflection within the material and weld(s) or bond yield limits

The Columns could be attached via methods such as welding or bonding to the bottom plate.

It may have additional reinforcing structure(s) such as linear or circular ribs, which could be attached via methods such as welding or bonding to the top or bottom or perimeter of the plate.

“Cartridge” or “Cartridges” are structural platforms used to retain, protect, and transport loose or pre-containerized MDM. They aid in the loading/unloading, storage, and transportation of a Vessel and may be stacked on top of and/or adjacent of each other and fastened and/or interlocked together to maximize MDM volume within a Vessel. A Cartridge can be of any shape of perforated material or in the form of an open hard woven fixed, flexible or collapsible cage for the purpose of holding either MDM in bulk, or Lattices with or without the use of any Rails or Rods; and may include notches or mechanical keys to help manipulate the Cartridges within a Vessel.

A Cartridge consists of a horizontal plate with or without a perimeter edge band rib. The Cartridge may contain vertical linear and/or circular ribs that provide additional structure to the horizontal plate, provide pockets or cells for the containment and protection in both vertical and horizontal orientations of loose or pre-containerized MDM, while providing a method for transferring loads through the Cartridge allowing for Cartridge stacking without damage to the MDM, and provide a conductive heat transfer mechanism. The linear or circular ribs may be attached to the horizontal plate via welding, bonding, and/or mechanical attachment, or may be loose. All surfaces may or may not be perforated to allow for constituent flow. An additional horizontal plate may be assembled on top of the vertical ribs to trap the MDM inside of the pockets or cells and to add additional structure to the Cartridge assembly. A Cartridge may include MDM barriers such as perforated film, continuous fiber spun sheet, metal or plastic fabrics that may be woven, and/or plastic paper with or without a soluble coating, which may be used as an additional barrier to entrap loose MDM inside of the Cartridge while maintaining constituent flow.

A Cartridge enables the MDM placement to outside perimeter of the Vessel, enabling the maximum volume of adsorbents to be deployed and thereby achieving the maximum volume of adsorbed constituents.

Cartridges when enveloped by a non-permeable container, with an inlet and/or an inlet and outlet, maybe a Vessel or a Vessel in a Vessel and/or a chamber. These inner Vessels and/or chambers may be placed inside a second Vessel that may or may not be pressurized.

A single Cartridge may contain additional features such as attached support columns and “keying” features such as holes or notches. A single Cartridge with support columns may be used to contain and lift multiple stacked Cartridges utilizing holes, threads, and/or notches that “key” into the support columns; in this iteration the Cartridge becomes the structural pallet, which when assembled with top plates and fasteners enables structural integrity during loading and residence inside the Vessel in both horizontal and vertical positions. The support columns may include a mechanical fastener attachment at the end of column, such as a male and/or female thread. This allows attachment of threaded fasteners such as nuts or lifting devices to the columns to retain individual Cartridge assemblies to the support columns. This retains the individual Cartridge when the Cartridge Assemblies are used in a vertical to horizontal position.

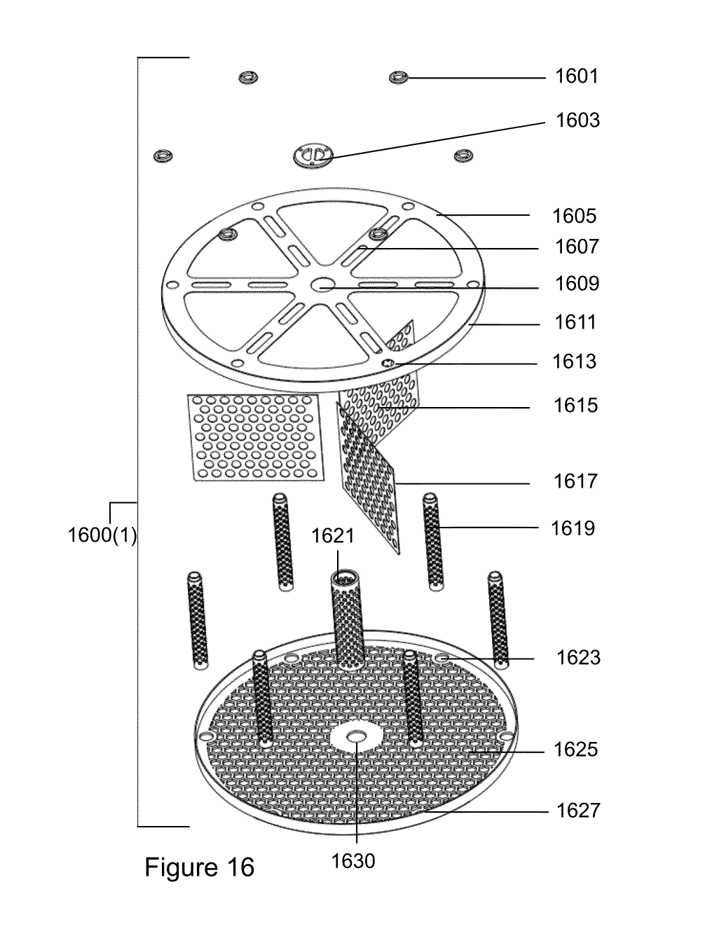

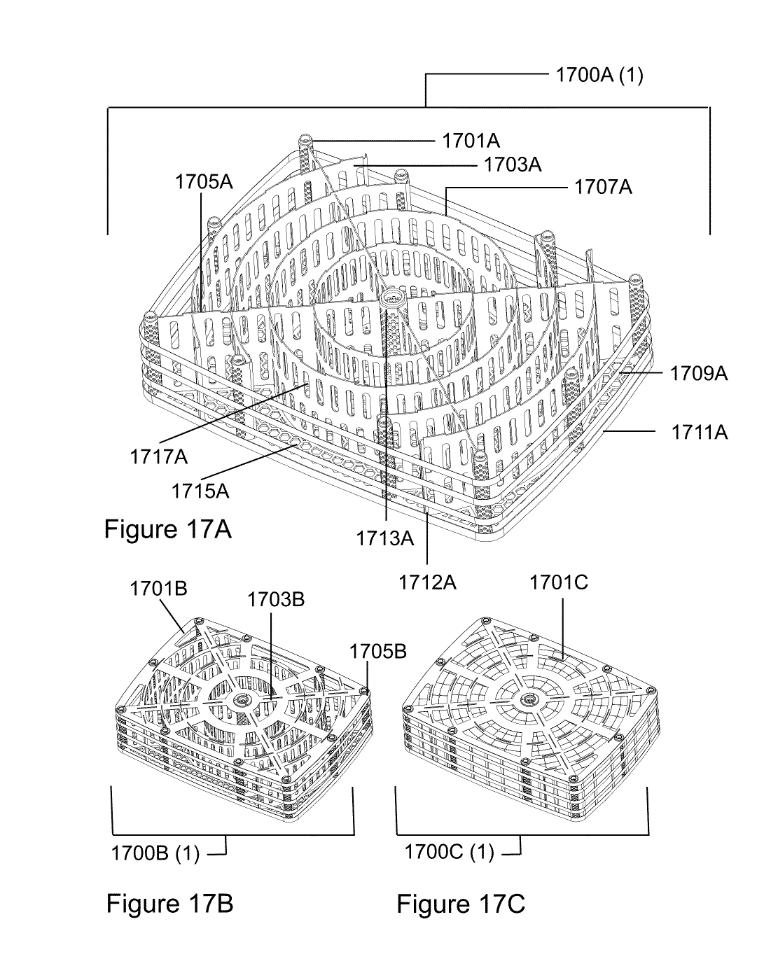

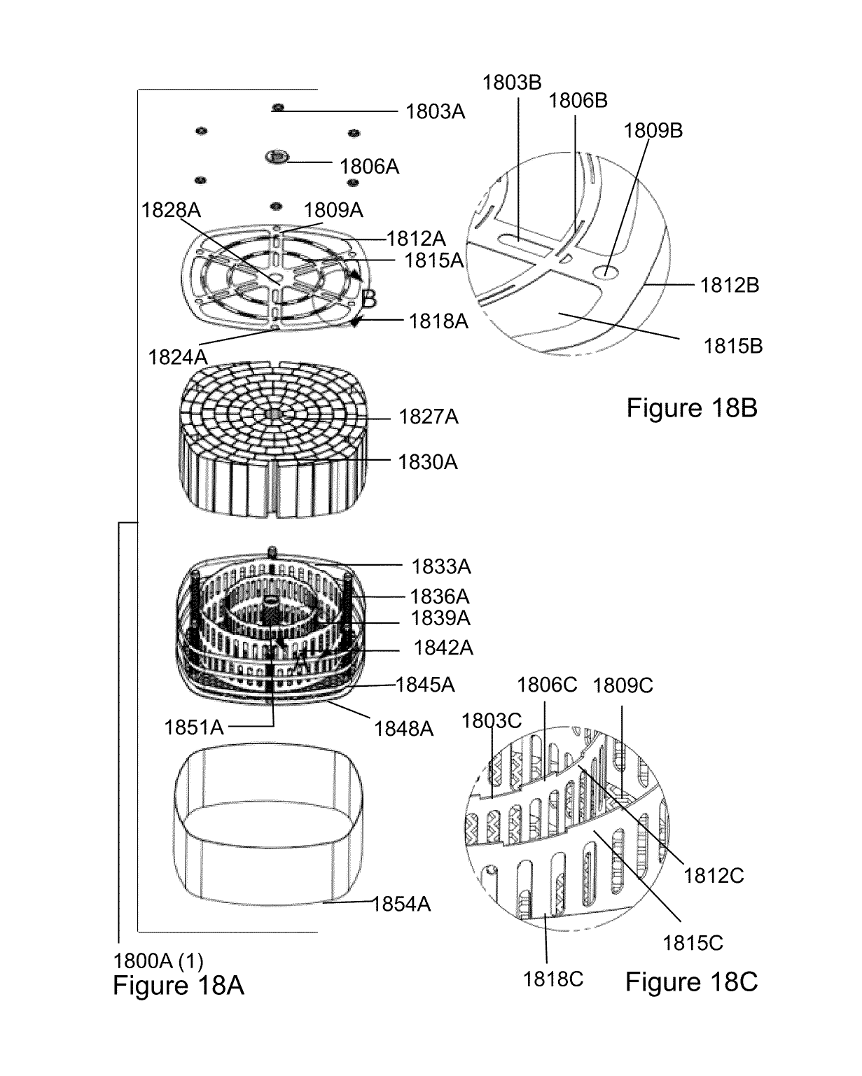

Cartridges shown in FIGS. 16, 17, and 18 progressively show some of the structural construction variations from a simple and basic (FIG. 16) to increasing complexities shown in FIG. 17 and FIG. 18. However, all are structural platforms used to retain, protect, and transport loose or pre-containerized MDM.

The configurations are made to maximize the amount of MDM that could be contained within any specified Cartridge given the nature of the application.

Besides almost limitless structural configurations, Cartridges, and any internal reinforcement element, may be made from any type of metal or metal alloy, plastics, polyamide, nylon, polyethylene, ABS, polycarbonate, glass and ceramic, polyamide, aramids, carbon fibers or compatible advanced materials that eventually become commercially available.

“Dimple Cup” means a Sheet Formed Lattice (“SFL”).

SFL that contain Dimple Cups can tessellate or tile. The Lattices are concave for containment of MDM, or with a perimeter flange could be filled on the side of the sheet convex.

When flipped and stacked 180 degrees, the convex side of one nests inside the Concave side of the other. They may be a concave or convex shape of any circle or n-polygon.

SFL can be made via methods such as thermoforming, dipping, stamped, drawn or high velocity metal forming. They may be made from plastics such as polyamide or aramids. If made from plastics, methods such as thermoforming, dipping, or spraying may be used. If made from sheet metals such as corrosion-resistant aluminum or stainless steel, methods such as stamping, drawing or high velocity metal forming may be used. If pressed or molten glass, or in some cases metal, the SFL can be manufactured via methods such as sand casting or die-casting.

Holes can be cut into the sheet for structural supports to fit within and utilized as a locator alignment feature.

SFL can be perforated with methods such as: if metal, high velocity metal forming; if plastic, with an iron maiden, or cad knife.

“Fluids” means any material or substance whose shape or direction is changed uniformly in respond to an external force applied upon it. The term encompasses not only liquids, but also gases and finely divided solids.

“Gases” includes either elements (such as hydrogen, deuterium, helium or nitrogen) or compounds (such as methane, carbon dioxide, or volatile hydrocarbon).

“Lattice” or “Lattices” means any structure capable of holding MDM or multiple MDM types with varying densities, in a specific position during the period such MDM is in direct contact with gases, fluids, or liquids having different molecular constituents. Lattices are intended to be manipulated to fit within a Cartridge or within a Vessel. A Lattice can be a Bag, a Dimple Cup, a hose spiral, or a structural tray. Cartridges or Lattices will facilitate insertion and holding of unsaturated MDM, and eventually, will allow for removal of MDM to collect valuable targets adsorbed or absorbed thereon. It will also allow the collection of the adsorbed or absorbed contaminants for proper disposal.

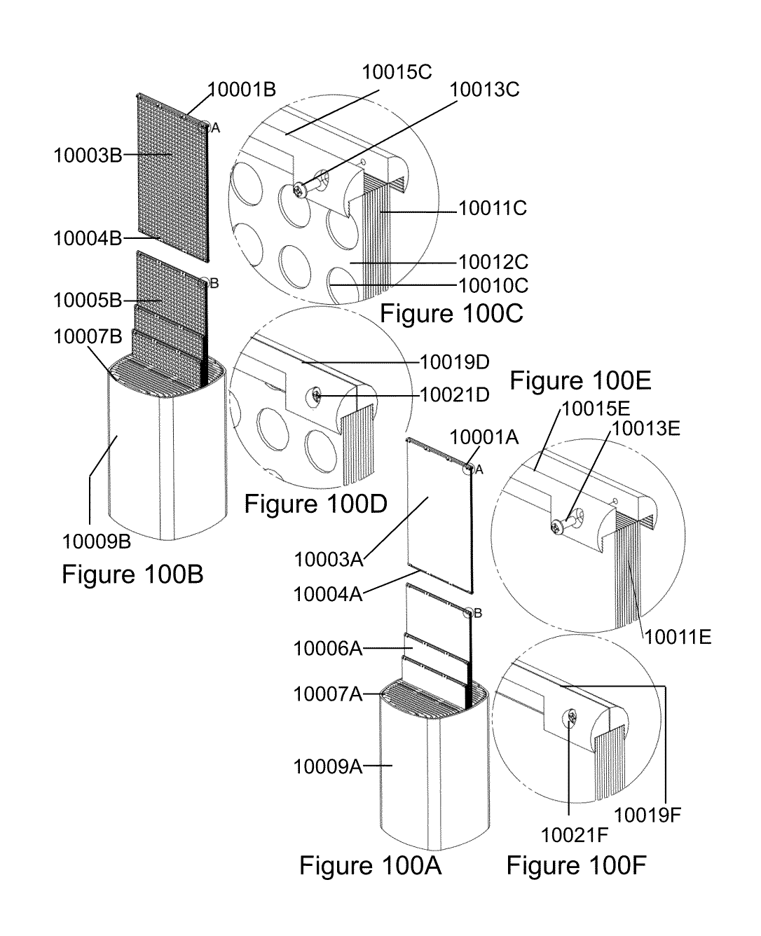

Hanging Lattice drape is a method of suspending uncoiled or flat segments of continuous flexible sheets, continuous semi-rigid sheets or any other MDM-filled or MDM-adhered-to film sheets with or without transitional metal plates or any combinations thereof, in a vertical orientation inside a pressurized or non-pressured vertically oriented Vessel as shown in FIGS. 100A and 100B. It utilizes a 2-piece Lattice Cartridge fastener, as shown in 10015A, that may be attached together with mechanic fasteners, 10013A, allowing horizontal sheets edges to be trapped, compressed, and retained between the 2 halves of the Lattice Cartridge fastener (see 10019B). Lattice Cartridge fasteners may also be used as a weighting device

“Lifting Component” can have multiple configurations such as a hollow male threaded bolt that has a cap with an orifice and at least one cross bar.

Another iteration: the Lifting Component may be a locking cap with fixtures such as a stranded or braided wire, cable, or rope that affixes or loops underneath the heads of the hollow male threaded bolt or a nut to the columns, which in turn affixes to the top plat, which is connected by a wire/cable under the shoulder of the bolt to a counterpart so that a hook can interleaf to it and lift the Cartridge assembly. The bolt head could also be an eyebolt fixed or removable. Lifting components have a lower profile than a conventional nut or bolt head.

Made of materials such as corrosion-resistant aluminum or any ferrous or non-ferrous metals. If die cast it could be made of material such as ferrous and non-ferrous metals and alloys, or glass.

It is manufactured via methods such as lathed, turned or forged.

Lifting component benefits include: holding the assembly together, distributing weight load, lower profile taking up less space and allowing more material within the Vessel, enabling loading so the Cartridge maintains its integrity when in horizontal or vertical positions.

“Liner” means a type of Cartridge or Lattice that is made to conform to the shape of all or part(s) of the interior surface of a Vessel, whether affixed mechanically, chemically (adhesives) or by pressure; and whether or not also attached to a further Cartridge or Lattice within the same Vessel. There could be a liner for the entire Vessel.

“Liquid(s)” means aqueous or non-aqueous solutions including vapor states from other liquids or gases.

“MDM” means Molecular Density Materials capable of adsorbing/absorbing one or more constituents in a gas, fluid, liquid, or a mixture thereof. Examples include atomic particles, carbon materials, activated carbon, carbon nanotubes, catalysis, graphene, metal organic frameworks (“MOF”), nanoparticles, nano-structured materials, polymeric organic frameworks, silica, silica gel, clay, zeolites, other adsorbents/absorbents, or combination thereof. Useful adsorbents/absorbents, such as carbon materials, have high surface areas and a high density of pores with optimal diameter. MDM can be different types of Metal-Organic Frameworks (“MOF”). MDM may also be combinations that vary by type(s) of metal ions and/or organic material(s) used, and may be made in molecular clusters or molecular chains to obtain the desired quality, i.e. type of adsorption/absorption, and volume capacity in terms of a desired porosity. Examples of MDM also include Bio-Char, or Charred Organic Materials (“COM”).

“Module” or “Modules” means a Cartridge or a Lattice loaded with specified MDM and may also refer to separate Vessels within an interconnected system of Vessels. A Module can be used for the separation, segregation, purification, phase change, reformation, transformation, or other forms of amendments within a Vessel or an interconnected system of Vessels, either in series and/or in parallel, during storage, transmission, or transport.

“Pallet” means a rigid or semi-rigid plate that may hold Bags or loose MDM and may enhance structural integrity of a Lattice or Cartridge.

“Perforations” are holes or a break, which may be any polygon with equal or unequal side lengths and/or any number of sides, whose sides could be linear, concave, convex or any Platonic solids, such as a tetrahedron (4-sided pyramid), cube, octahedron, dodecahedron, and the icosahedron.

Any perforation shape can be tiled or tessellated or any combination of shapes that can be tiled or tessellated in one or more dimensional planes.

Any combination of Perforation shapes that can produce a pattern or random pattern.

When Perforated sheets are stacked their tessellated, tiled, or repeating hole patterns may be offset to one another, thus creating a smaller and unique 3-dimensional hole. These perforation holes may be any polygon with equal or unequal side lengths.

Perforation holes could include shapes that will not perfectly tessellate but leave a small gap, such as an irregular shaped pentagon.

Single perforation sizes or perforation hole sizes may be sizes such as 0.01 nm up to 3 inches. The perforation hole size and shape are dependent upon the MDM. Perforation size should be slightly smaller than MDM specific to environment and by surface tension may keep the MDM in place but allow constituent flow.

Perforation patterns may have knockout areas for purposes such as bond seams, affixing the Lattice to itself, or sheet formed cups.

Perforations may be made or created by methods such as photo-etching, air, water jet, cad knife, laser, plunge rolled, or perforated die.

Perforations specific to the MDM and environment may act as a key way to allow the constituent to adsorb while keeping the MDM within the structure.

Perforations can also mean permeable materials such as woven textiles, graphene, metal textiles, expanded metal, perforated pulled plastic sheets.

Distinct multi-dimensional shape perforations maybe created by methods such as interlacing, stacking, offsetting, with rolls or sheets, or any combination of two or more perforated sheets or fabrics by offsetting them thus creating keyways and perforation patterns for specific constituent adsorption. This enables a smaller or distinct multi-dimensional shape perforations that cannot be economically manufactured any other way. This potentially would enable certain non-targeted constituents to pass by and not be adsorbed.

“Rail” or “Rod” means one or more displacement components including appropriate jacks, notches and/or impellers or lifting devices by which a Cartridge or a Lattice moves or is pushed/plunged/pulled into or out of a compatible Vessel; or, by which means a Lattice moves into or out of a Cartridge.

“Secondary Utilities” means the additional uses of the current invention, such as biocide prophylactics, adjacent exploitation of cryogenic fractions in a further Vessel or in an isolation wrap of a Vessel to achieve one or more secondary utilities, such as reduction of energy inputs. Also, such as use of known anti-corrosion material to protect the interior surfaces of the Vessel. Further examples include using a cylindrical shaped Cartridge with specified MDM that is positioned flush against some part or all of a Vessel interior surface that acts as a liner-type Cartridge, regardless if it is attached to another Cartridge or Lattice within the same Vessel.

“Segments” means any partial segment, such as 30° or 60° pie-shaped segmentation of a 360° Cartridge or cylindrical Lattice; or other segmentation of the coating or liner applied to a Vessel interior surface to facilitate strata positioning.

“Segregation” means controlled isolation of separated molecules and/or sequencing of such segregation.

“Sleeve” means any material around the exterior of a Cartridge, containment cage or structural pallet, if flexible; made from materials such as a woven plastic ribbons or fibers, aramid or other materials specially adapted to the content/environment; if inelastic, made from materials such as corrosion-resistant aluminum, polyamide composites or other materials specially adapted to the content/environment; if flexible; it could be an aramid paper that may or may not be perforated, it could be film of materials such as polyamide, vinyl, film with metal laminates that may or not be perforated. It can be made from processes such as weaving or deposition printing; if inelastic it can be manufactured with methods such as stamping or resin transfer molding. If die cast it could be made of materials such as ferrous and non-ferrous metals and alloys, or glass. Sleeves may include slits or holes to accommodate optional hardware that extends outside of the perimeter of the Cartridge, containment cage or structural pallet. The sleeve could be contained by Band(s). A sleeve could contain perforations. If the sleeve envelopes the entire Cartridge and is sealed to form a constituent tight enclosure with an inlet and/or an outlet it could be a Vessel in a Vessel; the Vessel could be pressurized or non-pressurized. Sleeve, if flexible, means any material on the exterior of a Cartridge, containment cage or structural pallet, and is made from materials such as a woven plastic ribbons or fibers, aramid or other materials specially adapted to the content/environment. It can be made from processes such as weaving, or deposition printing.

If inelastic, a sleeve is made from materials such as corrosion-resistant aluminum, polyamide composites or other materials specially adapted to the “Content/Environment.” It can be stamped or resin transfer molded. Environment would refer to a pressured or non-pressurized Vessel. It is an acid (gas) under compression, or other Liquids under compression or other Fluids under compression or under cryogenic conditions.

The term “Content/Environment” includes but is not limited to the following:

If it is a gas, it could be: acid gas; corrosive gas; cryogenic gas, or cryogenic liquid.

If it is a liquid, it can be a soluble and corrosive acid.

If it is a non-pressurized liquid, it can be a soluble and corrosive acid.

A sleeve protects the contents of the Cartridge, it contains the contents of a Cartridge in the case of a rupture of a Lattice Bag. If coated with a low friction coefficient, such as Teflon or acetal, it facilitates Cartridge loading and unloading. If it is made from or coated with such a material, it can enhance or suppress thermal conductivity. It can reduce vibration on the assembly. It also reduces the manufacturing tolerances variations by filling gaps. It may be color coded to identify the items, such as its contents, environment, target constituents, and other information. It could be coated with anti-static coatings so as not to damage the material therein. The coating materials can be, for example, Cu, as a biocide, or contain a G-sensor in transit and/or pre-loading. Other coating materials include ferrous or non-ferrous fibers that would indicate strain or fracture post deployment.

“Strata” or “Strata Positioning” means the placing of Modules into known density and/or volume stratum within a Vessel intended to treat or capture multiple constituents.

“Structural Tray” is sometimes referred to as a “pallet”.

“Vessel” means a permanently sealed container or tank capable of being put under compression or pressure which Vessel can be oriented in any physical position but which has special properties due to its one or several types of bulk MDM contained therein or contained in one or more Cartridges, one or more Lattices whether or not the Vessel also has rods, rails or otherwise also exploits its interior surface. Or

Any entirely hard-walled compression device, similar atmospheric pressure device, or any non-porous soft Bag-like or balloon-like container or tank with at least one hard feature being an orifice that can be repeatedly opened and closed, which can also be oriented in any physical position but which has any number or purposes of inlets or outlets and is capable of being opened and closed repeatedly to load and retrieve Cartridges and/or Lattices holding MDM, and the Vessel is more or less held in place, with or without the use of the rails or rods. Or

Any section of any pipe or conduit made of any material with or without compression that is closed to the outside atmosphere at both ends, or having at least one end thereof connectable to another pipe, conduit or inlet/outlet connection of any further pipe, conduit or device, which could have its interior walls or surface area coated with one or more specified types of MDM and/or used as a spacer anchor or abutment to allow for internal gas circulation.

A Vessel can contain Cartridge(s) or Lattice(s) holding one or multiple specified types of MDM in a manner to allow contact with the MDM either entirely or by strata.

Vessels can be a reactor or phase change system of Vessels that operates using variable heat and pressures levels. They could be fabricated by technologies such as extrusion or emerging techniques such as 3D printing or similar sculpting of a mono block of materials that generate a uniform device that could include a Cartridge or a Lattice as part of its fabrication design.

Also, a Vessel can be a naturally occurring or artificially formed or similar fabricated structure above or below ground destined as a gas or liquid storage or transformation facility that has an aperture device to allow for the regular insertion and removal of Cartridges and/or Lattices holding specified MDM without significant loss of compression of gas or liquid release.

Also, a Vessel can be an open vat that allows for the regular insertion and removal of Cartridges and/or Lattices holding specified MDM into liquids.

The Vessels and/or Cartridges and/or Lattices can be made from weight reduction materials of any type such as carbon and/or glass fiber or similar filament wound structures that reduce weight while retaining strength properties similar to steel.

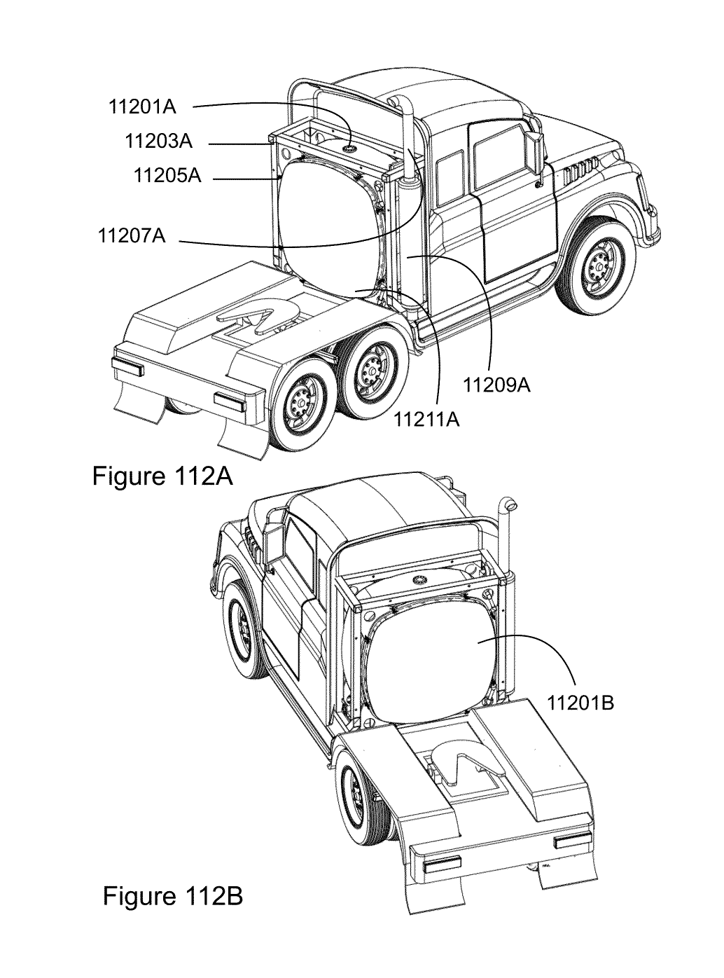

Modular Vessel is a Pillow-shaped Vessel containing one or more MDM populated Cartridges. A modular Vessel can be in any shape (See FIG. 112A/B). In this single module/Cartridge embodiment, the Vessel requires a structural cage, typically made from tubular steel or aluminum. The cage is to be fastened with mechanical fasteners through holes, as shown at 11202A in FIG. 112B, to the end use environment such as a semi truck cab.

A heating element, as shown at 11317A, and the heating conduit, shown at 11319A, are affixed to a thermally conductive metal plate that is the exterior planar wall of the modular Vessel. The heating elements allow for thermal transfer from the heating conduit to the exterior planar wall, which in turn transfers heat to the Cartridge and constituent. A heating element may be attached with such mechanical attachment methods as weld studs with nuts Finally, the heating assembly is covered with a fitted insulation blanket.

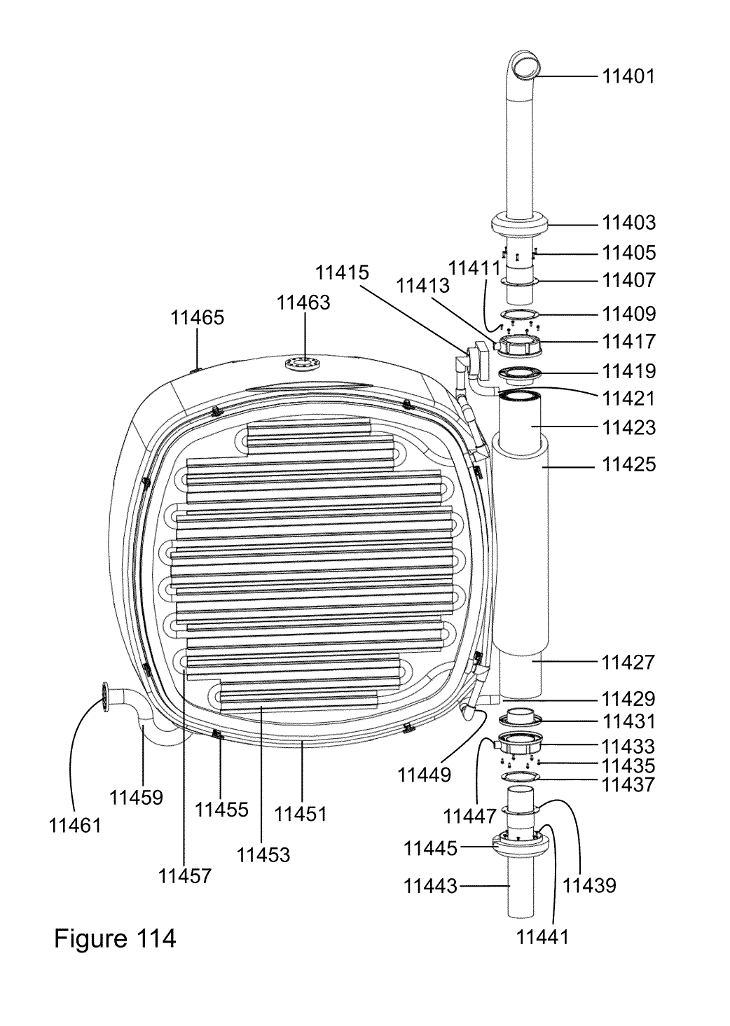

The assembled heating unit is shown in 11453A and 11457A, and may be in any configuration as shown in FIG. 114A.

The heating system is a closed loop system that captures waste heat from the truck exhaust. It functions by using a known thermal transfer liquid driven by an electrical pump, shown at 11415A, in a clockwise or counterclockwise direction depending on the juxtaposition of the exhaust pipe. As shown in FIG. 114A, the circulation is clockwise with heated liquid entering the system at 11449A, and after heat extraction exiting the system at 11415A, for return to the heat exchanger, generally shown in 11309A.

A Modular Vessel with Optional Integrated Heat (“MVOIH”) is similar to the Modular Vessel with External Heat with the following differences being the use of internal chambers between Cartridges to house. Heat element is shown at 11901A(1) and 11903A(2).

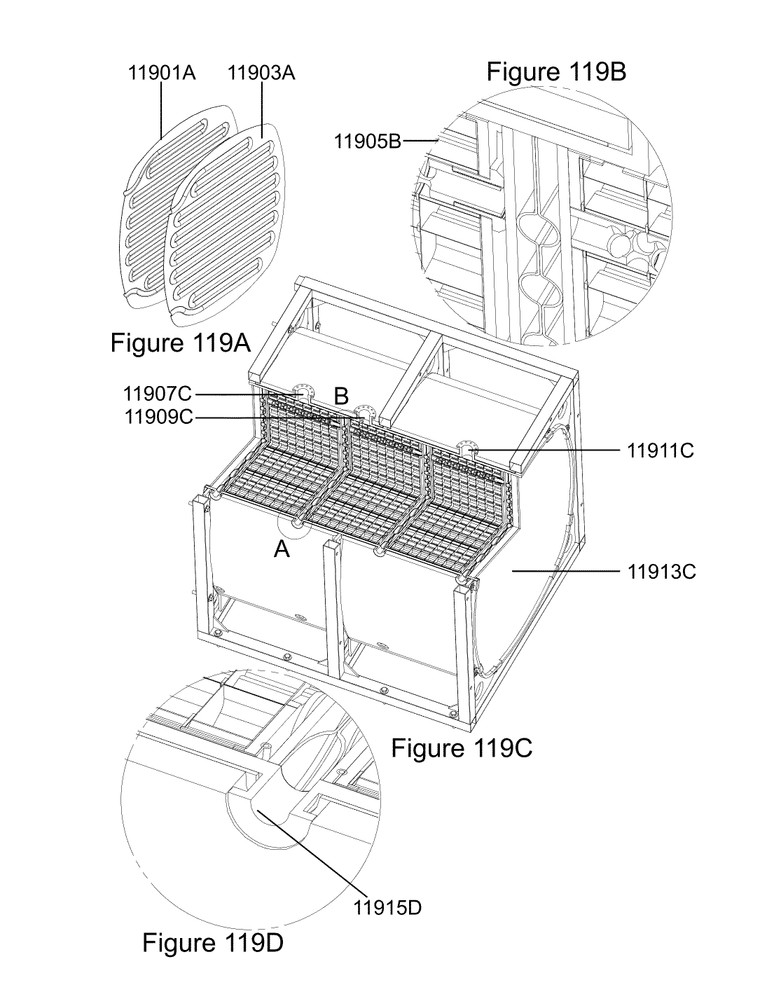

The cutaway view in FIG. 119A shows a Vessel with three Cartridges with four heating elements placed between the Cartridges and Vessel outer walls. In this multi Cartridge embodiment, the Vessel requires a structural cage, typically made from tubular steel or aluminum. The cage is to be fastened with mechanical fasteners through holes, as shown at 11919A on FIG. 119A, to the end use environment such as a skid, truck or trailer bed, slab, or to additional Vessels.

One or more heating element, as shown at 11901A and 11903A may be die cast or stamped aluminum plates with a half formed heating channel. By assembling the 2 pieces via water tight perimeter weld, a heating fluid channel is formed to allow the passage of a heating fluid to transfer heat from its chamber to the adjacent Cartridges.

An external heat source of any kind is required to heat the heating fluid that enters and exits the Vessel at apertures such as shown 11915A.

MVOIH may be used for both gravimetric and volumetric MDM.

MVOIH may house multiple chambers for concurrent inlet or outlet flows.

MVOIH may house multiple chambers with separate inlets and outlets.

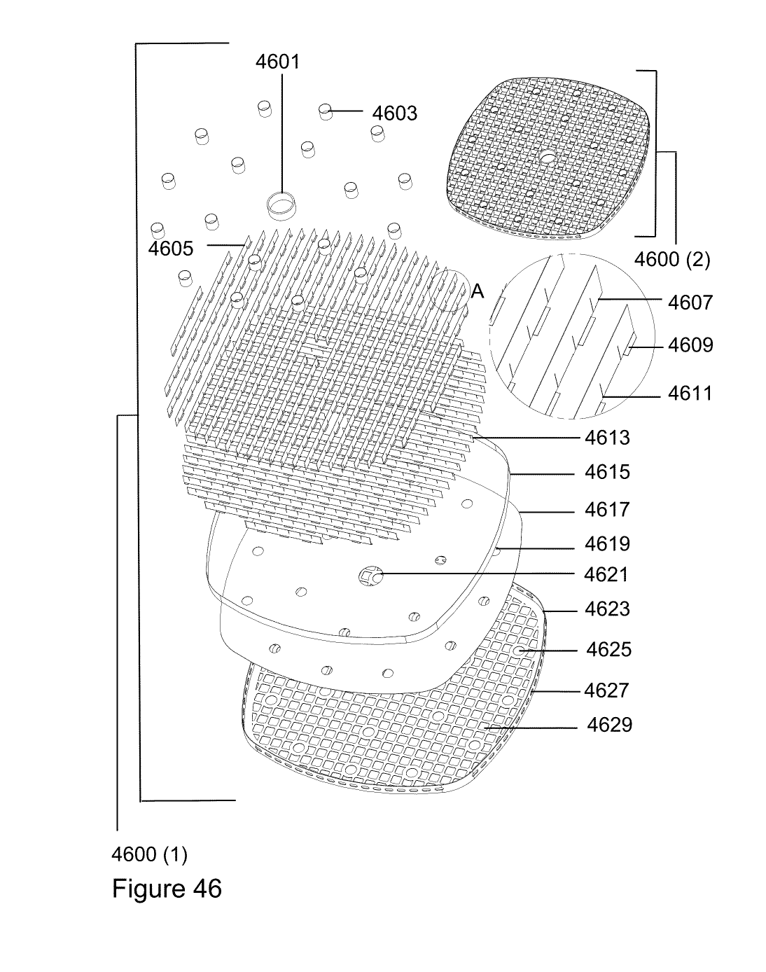

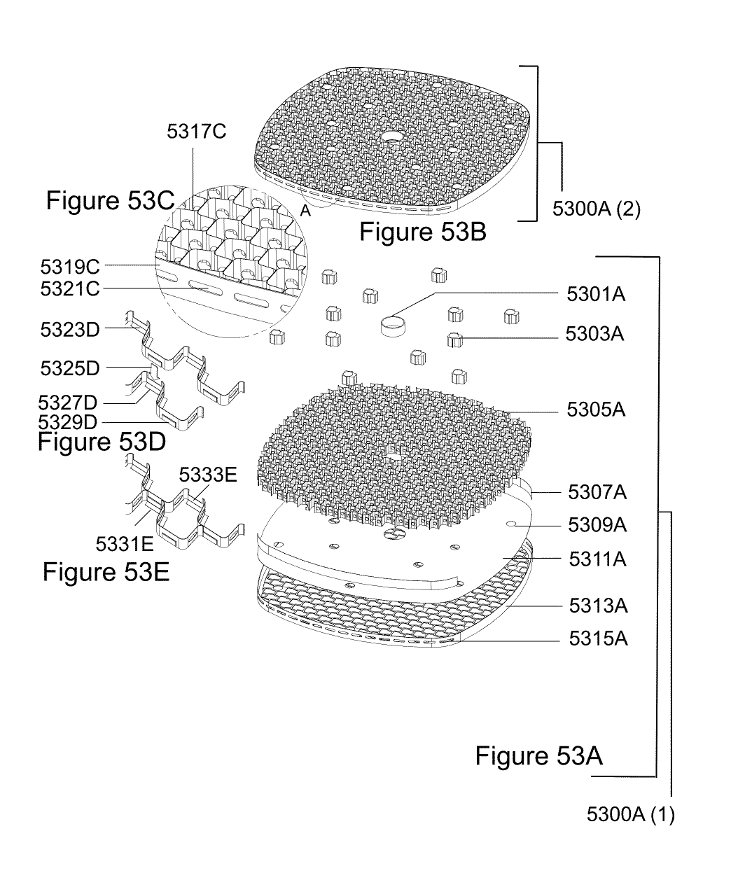

MVOIH may be composed of Cartridge assemblies such as FIG. 46 and FIG. 53A.

MVOIH Cartridge Assemblies if MDM needs heat for desorption may be built from thermal conductive materials as described above.

MVOIH modular nature allows for interlocking multiple MVOIH Vessels together for transport and disembarkation.

MVOIH may contain heating panels as seen in FIG. 119 11901A and 11903A that can be inboard to the MVOIH or latch onto the exterior of the MVOIH.

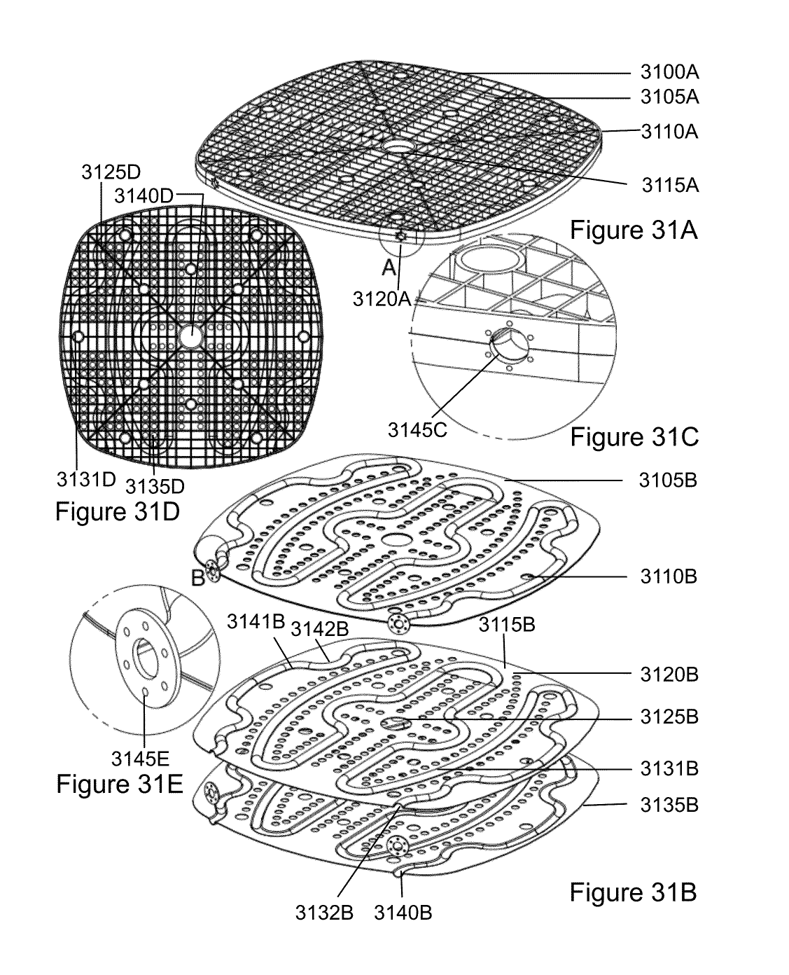

MVOIH may contain heating panels, which were first seen in FIG. 31A. FIG. 31A is a view of an exemplary heating plate for Structural Pallet to heat specific MDM that need thermal assistance to release its captive adsorbed element from the MDM surface area.

As seen in FIG. 119, 11901A and 11903A, heating panels can be inboard to the MVOIH or latch onto the exterior of the MVOIH as seen in FIG. 119 11913A.

MVOIH may contain a cradle feature. It may contain shock absorbers and wave spring.

A Vessel in a Vessel “VNV” may be a pressurized sealed “Internal” Vessel, with at least one pipe that could be an inlet and outlet pipe and/or valve. The “Internal” Vessel is housed within another “External” Vessel. The internal Vessel will house any MDM or Cartridge. The external Vessel may or may not be pressurized and/or evacuated. It may or may not hold MDM, and it may or may not contain gasses or liquids.

The advantages of a VNV include: protection of internal Vessel, supplemental protection of accidental leaks from the internal Vessel, permits multiple types of containment materials, allows for thermal transfer or insulation.

A VNV can contain heating elements such as conductive materials and/or abutting thermal heated plates or coils.

A VNV may be made of plastics, such as polyamide or polyamide composites, epoxy, etc. A VNV may be made of metals: corrosion-resistant aluminum, steel, alloys, ferrous and non-ferrous, etc.

A VNV may be manufactured with methods and materials described previously.

A VNV may be a removable device that is externally connected to another Vessel under pressure.

A VNV may also be one or more fixed or flexible pipes or pipe coils or internal Vessels within an external Vessel.

A VNV may be a Vessel in Vessel two piece manifold.

A VNV may be a pressurized a structural cage pallet or a repeating structural cage pallet segments.

A VNV may contain multiple gases, with one being external at a higher pressure than MDM chambers. The additional external gases to the VNV may create additional structural integrity to the VNV. Additional gas or gases may also be used as a fuel mixture.

VNV may serve as a method as a final chamber within a Vessel or in parallel for the external gas to pass through so it amends the external gas and captures specific targeted constituents that would not exit to the outlet or cascade.

“Vessel Interior Surface” means a potential active area for surface coating with MDM, as an inactive surface for fixing an interior Liner by any means, including pressure; which coating or Liner is MDM or other material intended to react with; supplement or complement the MDM held within. Such liner may be a separate element of any shape or part of the outer extremities of a Cartridge or Lattice for specific purposes such as corrosion prevention, abrasion prevention and/or caking prevention.

Molecular constituents are present in all sorts of acid gases, wet and dry gases, cryogenic gases, and in water and other liquids. For example, natural gas (“NG”), natural gas liquids (“NGL”), and other industrial gases, occurring naturally or generated from the use of additives or catalysts during extraction, processing or otherwise prior to combustion or other usage, can contain unwanted different constituents. Some constituents are toxic environmental contaminants to be reduced or eliminated, if possible; and certain other constituents, if not reduced or eliminated can cause undesirable effects on engines, machinery or other equipment.

MDM is very fragile. It can easily be damaged by improper handling, such as pressing together, shaking, or crushing. Once damaged, MDM loses its efficacy in adsorbing/absorbing gases, fluids, or liquids. One object of the present invention is to prevent, or minimize, damages to MDM when packed, loaded, or stored in a Cartridge of the present invention, so that MDM can perform its functions most effectively. The integrity of MDM must be preserved as much as possible.

Another object of the present invention is to create containers, such as Vessels, Cartridges, Bags, Vessels, and Dimple Cups, to have maximal volume to house as much MDM as possible, and consequently obtain as much amount or volume of adsorbed or absorbed constituents. This allows for as maximal adsorption/absorption of targeted constituents of gases, fluids, liquids, or mixtures thereof. Cartridges can be of any shape or size, including the shape of a cylinder or a polyhedron.

Because MDM functions at moderate pressure levels, ways or methods to achieve the goals of packing as much as possible of MDM without damage to the MDM in a container include: using thin-walled containers; doing away with binder or binders; using proper vibration or evacuation; and, especially, modifying the shapes of the container, such as the shape of a polyhedron to squircle. These shape modifications will permit the MDM to fill up the perimeter of the cylinder or polyhedron, modified or un-modified. The inside perimeter of the container is where the volume of the container is largest. When appropriately placed, the constituents (gases, fluids, liquids, or mixtures thereof) will adsorb/absorb to the MDM as it travels to the perimeter of the container. Alternatively, the perimeter inner surface of the container can be lined with MDM.

As discussed above, certain modifications to the shape of a cylinder or a polyhedron can increase the available space to store an MDM. Thus, for example, by rounding the corners of a polyhedron Cartridge, the MDM-packing capacity of this modified polyhedron Cartridge can increase by from about a few percent to about 30% or more.

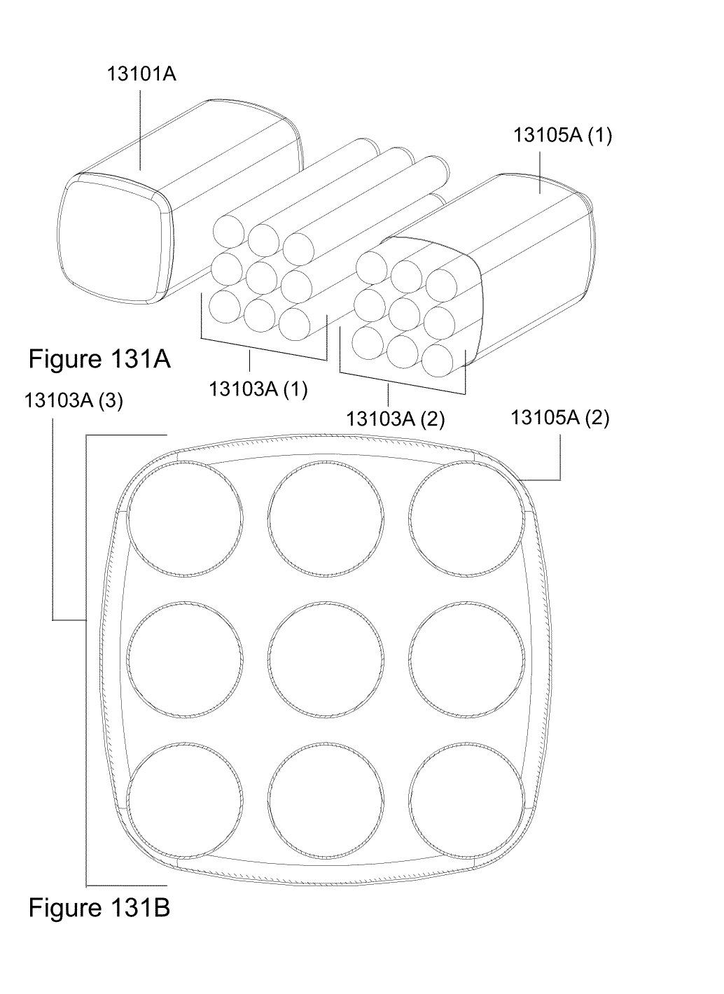

For a first example: a known cylindrical tank having a 93 inch diameter; a 216 inch length and wall thickness of ½ inch has an interior space of 713.1 cubic feet, whereas a modified cylindrical shape known as a Pillow or squircle shape as shown at FIG. 131A having the same 3-D footprint has an interior space of 909 cubic feet. A second example as shown as FIG. 131B results in an enhanced interior space of 1152 cubic feet for the shown squircle, compared to 440.1 cubic feet for the combined total of the nine shown traditional cylinders.

Similarly, vibration of a Cartridge can significantly increase the loading capacity of an MDM, up about 1% to about 25%, or more, depending on the MDM used. Also, by eliminating the use of a binder or binders, the MDM-loading capacity of a Cartridge can increase by up to 20%, or higher, depending on the MDM used.

In summary,

(1) Due to the relatively low pressure requirements, thin-walled containers can be used. This makes the containers relatively easy to handle and to transport.

(2) A thin-walled container has more volume to house more MDM.

(3) Likewise, Bags and Cartridges are modified, or designed, to attain maximal volume within so that more MDM can be housed therein.

(4) Again, to attain more volume in a Vessel, hence, more MDM contained therein, Bags are placed as close as possible to the perimeter of the Vessel.

(5) MDM is packed via evacuation, vibration, or both, without the use of one or more binders, again consequently increasing the volume for storing more MDM which in turn can adsorb or absorb constituents of gases, fluids, or liquids.

(6) Cartridges and Bags are designed to protect MDM from compressive loads of constituents, thus preventing its damage.

(7) Rigid Bags also protect MDM from compressive loads.

In one aspect, this invention pertains to a device that is an enclosed tank, pipe, Bag, balloon or similar holding Vessel of any shape and of any size having one or more input and output valves and that might also have various atmospheric pressure ratings (Vessel) and specified MDM depending upon the particular known constituents of the input gases, fluids, and/or liquids. The Vessel is capable of being opened and closed repeatedly to add fresh MDM and to remove the Cartridges and/or Lattices holding volumes of partially or completely saturated MDM or MDM that has stopped functioning, or “expired” for subsequent recuperation of economically valuable constituents or for proper disposal of the waste. In a further embodiment, the Vessel is permanently sealed, particularly a pressure Vessel with specified MDM within for specific amendment purposes (including Cartridges that allow for Strata or segmented amendment); and then, if and when the enclosed MDM stops functioning for any reason, the Vessel can be removed and replaced.

In another aspect, the present invention pertains to mechanical devices with spacing rails or rods that can push, plunge, pull, raise, lower, heat, cool, inject or remove a gas, fluid, or and/or liquid. The mechanical devices can manipulate Cartridges or Lattices containing MDM, and in some systems, the device can be manipulated to press out or release the MDM in a manner that such spent material can be collected for re-use, further extraction of valuable constituents or safe disposal. Rods or rails can be a medium to transfer in or extract out heat, cold, or electrons from or to a Vessel, or be hollow and perforated to allow the injection (input) into the Vessel or for outgassing.

Yet another aspect of the invention relates to a method to facilitate the separation, segregation, transformation, reformation and/or sequestration (hence amendment) of a gas, fluid, or liquid, by exploiting the unique adherence or absorbing properties of MDM within a Vessel, which MDM can thereafter be recycled with no significant release of VOC's due to the unique loading and discharging systems of the Cartridges and Lattices within the Vessel, and also with no significant wear and tear or other damage to the Vessel. The undesirable contaminants can be separated and properly and safely discarded. The valuable by-products (captured or sequestered constituents within the saturated and removed MDM) can be collected using standard methods, such as the use of a solvent, centrifugation, graphite membrane filtration, gas to liquids techniques, pressurization, ultra-sound, use of a catalyst, or magnetic separation.

Because of the Cartridges, Lattices, and Vessels of the present invention, still another aspect of the present invention pertains to following:

(1) Allowing close to absolute control of the VOC's during the time the contaminated un-amended gasses, fluids, and/or liquids are in contact with MDM within the Vessel.

(2) A single or several secondary Vessel(s) can be connected to manage and manipulate all flows through or in contact with MDM; especially where different types of MDM are used for different purposes in the series of connected Vessels.

(3) The ability to open and close repeatedly any Vessel containing MDM to facilitate the removal of the partially or fully saturated MDM and the replacement with unsaturated MDM of the same or different type back into the Vessel.

(4) The ability to capture boil off gases utilizing a secondary Vessel or Cartridge loaded with MDM.

(5) The shape of the Cartridge or Lattice and use of spacers can improve circulation of gas (and/or liquids) within the Vessel.

(6) For special uses, such as in a sealed salt dome storage facility, Cartridges of the present invention can have interlocking handles and/or cords so that when discharging from Vessels, Cartridges can be removed one at a time or by removal of the whole interlocked string of Cartridges; these maneuvers (including any further maneuvers required) can be assisted by a rail system within Vessels and/or discharging carriers using a fixed rail upon which the Cartridges can be slid, screwed, rotated, latched, snapped as a male-female inter-fitting puzzle-piece, or rolled or slid in and out. These abilities are particularly useful in occasional in situ applications.

(7) The Rail could be heated or perforated to enable heating, air or any type of fluid injection to promote circulation and/or to introduce additive element or chemical constituents (such as mercaptan or other markers if required) or remove gases (and/or liquids) from Cartridges and/or Vessels and/or to adjust internal pressure.

(8) The input nozzle could be attached to the center hollow Rail that acts as a diffuser of gases (and/or liquids) within the Vessel which naturally gravitate to the Vessel interior surfaces thereby mechanically forced gas flow and/or molecular attraction to mass flow channels gas flows from the center core of the Vessel to the interior surfaces of the Vessel walls; and/or reverse evacuation of gas (or liquids) through the same nozzle; or through the rail or rod system.

(9) Multiple Vessels, each containing differing MDM, can be connected in parallel or in series to specifically segregate identified molecular constituents for subsequent harvesting or treatment since each Vessel in such a “train” can be closed off, opened, unloaded with unsaturated MDM, and reloaded with fresh unsaturated MDM and then subject the partially or fully saturated MDM to harvesting or disposal of the molecules first intended to be held by the specified MDM.

(10) Smaller versions of the multiple Vessels described can be used to collect Volatile Organic Compounds (VOC's), liquids or other gas that boils off as temperatures vary; such as the known methane-ethane issues concerning tank storage.

(11) Appropriately sized Vessels with MDM held within could be adapted to one or more ‘secondary Vessels’ to capture Liquefied Natural Gas (LNG) boil-off (sometimes referred to alone as ‘venting’); the secondary Vessel could very economically lead to a Vessel to store and, if useful, also amend such boil-off gases for later use such as transfer to another appropriate Vessel. This is a vapor return capture and/or segregation system with a Vessel buffer capable of both storage and constituent amendment if desired.

(12) Vessels such as LNG ships or large terrestrial LNG storage tanks at liquefaction or re-gasification terminals could be adapted to first purify the natural gas by separating the natural gas away from the residual non-methane constituents such as liquid ethane or nitrogen. Since ethane is a wet gas, segregation of methane and ethane is achieved by technically removing the methane, a major constituent of LNG, while leaving behind ethane, a minor constituent for separate storage and use.

(13) Vessels referred to in (9) and in (10) above could be subjected to useful internal cryogenic (cold), thermal (heat) or atmospheric (pressure) adjustments to accelerate (increase adherence of molecules onto MDM); maintain (more steadily hold molecules in place on MDM) or provoke release of molecules adhered to MDM.

(14) MDM packed Pipe-Vessel designs for gas (or liquid) flow-through can also be useful as in a pre-compression (or pre-combustion in non-diesel motor types) filter for certain fuels such as diesel engines to reduce the burden on post combustion urea devices. These devices could be sealed and replaced when saturated; or be a housing or sleeve in the fuel line between fuel tank and combustion that can be opened for the replacement of saturated Cartridges holding MDM with Cartridges holding unsaturated MDM.

(15) The primary and/or secondary Vessels or Cartridges containing MDM can have an incorporated impeller to push, plunge, or pull gas flows through the contained MDM and/or Cartridges holding MDM or to screw, push or pull Cartridges or Lattices holding MDM through or back and forth in a Vessel. This has utility for breathable air purification systems within enclosed habitat or similar spaces.

(16) Any Vessel with Cartridges or Lattices containing specified MDM can also have particular utility for various levels of purification requirements such as hydrogen for fuel cells; field gas or pipeline gas used for compression or combustion engines; or for other gases requiring high purity such as helium.

(17) Vessels or Cartridges described above can have mechanical, screw or other powered impellers to mechanically squeeze out saturated MDM; then release the pressed MDM either by pins, plates through holes, gravity or other means to retrieve the spent MDM for further treatment, economic retrieve of constituents, re-use or disposal.

(18) Removal of Cartridges and/or MDM from a Vessel could be accomplished by using generally known negative pressure, aspiration, gravity, springs, manual or screw mechanisms, vacuum techniques or similar known methods.

(19) Although certain constituents are not generally considered to be contaminants, valuable elements or compounds such as precious metal ions, and even water, exists within gases and could be retrieved if economically justified. The current invention allows for water in gas streams such as pipeline gas and cryogenic gases to be separated and/or segregated, thus improving purity of the NG, improving volume throughput and/or avoiding damage caused by contact with undesirable constituents such as cryogenic or acidic constituents.

(20) A Cartridge or Lattice could have segments or have a casing determined by material science to facilitate maximum adsorption that would further facilitate the separation, segregation, sequencing, or amendment processes of gases, fluids, or liquids.

(21) Where the “Vessel” is an underground gas storage structure or an above ground gas storage facility with a known airlock antechamber to allow for insertion and retrieval of the taught Cartridges and/or Lattices holding MDM to specifically amend gases stored in situ where in situ means such underground formation or above ground structure.

(22) A Cartridge of any shape or internal Lattice could be made entirely or partially of metal or metal alloys, such as one containing copper or copper components to provide optimal anti-fouling characteristics, long-term durability and other desirable attributes from selected metal or metal alloy use in the specific application. Use of metal or metal alloys includes “fixtures” such rods, rails and in particular surface coating of the Vessel's interior wall with metals such as copper alloys that have notorious biocidal properties to control undesired bacterial, microbe, and/or fungal proliferation; especially where certain MDM has a cellular structure that might encourage microbial growth.

(23) A Cartridge, Lattice or “Fixture” (made from any one or several combined materials such as metal, glass or carbon fiber included) mentioned above could also be made of other singular or combined organic or inorganic elements, ceramics, silicates, or exotic metal or metallic alloys, including possible coating or spattering of MDM or entirely or partially of reinforced MDM itself to provide flexibility in applications. The present invention may be of particular benefit for the reformation and/or catalysis of gases or liquids, such as an alternative to a conventional Haber process whereby ammonia can be removed while still in its vapor state or wherever reactions between and among gases take place within a reactor and require temperature or pressure changes to extract out or eliminate one or several specific elements or minor gases, our teaching can accomplish desirable amendments with no or significantly less modification of heat or pressure within the reactor Vessel.

(24) The Cartridges and Lattices of the present invention can improve other factors (such as volume and purity) in known storage techniques and also in known transport (virtual pipelines, intermodal or not) tanks for natural gas such as the one known as ANG (absorbed natural gas).

(25) Another aspect of the present invention is the use of segments of any Cartridge or Lattice to allow for easily manual manipulation during removal and re-loading of such a Cartridge or a Lattice, and to test variable MDM and hybrid MDM, especially where complex constituents requires close analysis of the adsorption levels along varying levels or sequences within a Vessel, Cartridge, or Lattice.

(26) Yet another aspect of the present invention is the mounting of any Vessel onto a skid, trailer, truck, or other container, on or in a ship or barge, railcar or other means of transport so as to take advantage of or otherwise exploit the travel time required.

(26) Known sensors may be used to determine saturation levels of MDM held in any of the foregoing, but where the Vessel is physically capable of being weighed to the level of milligram differentiation, the atomic weight differential could be an accurate indication of the constituent saturation level for purposes of signaling replacement or harvesting of such molecular constituents.

All of the foregoing embodiments, iterations, and other aspects of the present invention can be multiplied or divided by one or more partial or full orders of magnitude; for example, greater orders of magnitude to a size beyond cubic kilometers that would result in strategic amendment and storage of large stockpiles of gases for space stations or similar human habitats; to dividing orders of magnitude of the invention down to sizes that could make devices requiring gas or liquids to become portable or easily moved to work places such as health care oxygen tanks or concentrators or industrial/commercial machines such as Barbieri-type machines, to even smaller applications down to or beyond devices requiring only cubic millimeters of amended and stored gases for comparably small micro or nano-sized devices; such as for human implants, pharmaceutics and other arts and sciences requiring miniaturization; such as:

(a) Oxygen or nitrogen concentrators and tanks for human portable use;

(b) Food industry processing to remove residual contaminants, toxins and/or pesticides;

(c) Hand tools that use compressed gases;

(d) Gas use within the aerospace and submarine industries;

(e) Wastewater applications; and

(f) Other commercial, industrial, agricultural, medical, pharmaceutical and/or military or harsh-environment applications benefiting from miniaturization.

Other generic examples are presented in the drawings.

The foregoing has been provided by way of introduction, and is not intended to limit the scope of this invention as defined by this specification, claims, and the drawing.

Each of the design of any Vessel, Cartridge, Lattice, liner, rod or rail, etc. has specific functionality while certain desirable functions may also require a particular shape that may or may not be obvious to somebody ordinarily skilled in the art. Vessels therefore are advantageous because there is broad flexibility of specific shapes or sizes to meet real-life requirements. As a result, the methodology and functional devices of the present invention may be designed in any size or shape or be composed of a plurality of such devices including, but not limited to, Vessels that are also heat and pressure type reactors that could be made smaller (while maintaining volume capacity) and/or more modular.

Various geometries, sizes, features and mechanical attributes of the device may be envisioned, and such modifications are to be considered within the spirit and scope of the present invention and its various embodiments. It is, therefore, apparent that a device and/or a system to retrieve constituents from gases or liquids have been disclosed.

Molecular Separation by Adsorption/Absorption

The present invention can exploit MDM properties to destroy or re-cycle the MDM contained in a Vessel. Alternatively, the present invention can destroy or re-cycle only what is in a Cartridge or Lattice utilized to hold MDM, loading MDM into an entire Vessel or by strata or segment within a Vessel, followed by unloading MDM and reloading fresh MDM into a Vessel within a Cartridge and/or a Lattice, followed by recycling or destructive processing of the partially or wholly saturated MDM to extract valuable adhered constituents, while properly disposing of the undesirable contaminants

Utility of MDM

MDM can segregate the separated gases, fluids, or liquids from natural or industrial by-product gases to provide segregated constituent gas, fluid, or liquid streams having enhanced purity.

MDM, especially Metal Oxide Frameworks (“MOF”), is an enhanced storage for molecules.

MDM can reduce smokestack pollution from a power plant. It can burn gases within structures where people work or live. It can also purify the air for breathing. Moreover, it can adsorb or absorb unwanted contaminants and constituents.

It should be noted that, over time, gases, fluids, or liquids will reduce the adsorption capacity of an MDM to as little as zero. One aspect of the invention pertains to the exploitation of retrievable and recyclable MDM that permits the re-capture of valuable molecular constituents and the appropriate disposal of contaminants generally considered as environmentally undesirable.

Another aspect of the present invention allows for recovery of adsorbed constituents for post recovery harvesting. Harvested constituents are either valuable, or worthless and must be disposed of.

With appropriately positioned primary and/or with secondary Vessels, it is possible to segregate undesirable contaminants prior to combustion in transport vehicles, or ships.

Yet another aspect of the present invention pertains to purification of breathing-air within a confined space. Different MDM would be appropriate for different specific gases or fluids or liquids to be amended.

Further, the ability to un-load and re-load MDM means that MDM can be modified as needed when re-loaded.

Obviously, MDM can be formulated to adhere specific contaminants. By carefully selecting varying MDM for known constituents within a Vessel of the current invention, constituents can be separated and segregated leaving the resulting major constituent gas or liquids at a purer state.

Pressure and heat during compression/decompression, and/or separation steps of the present invention will provide new capabilities to the pressure Vessel industry.

In one aspect, the present invention allows the fulfillment of many potential uses of MDM under different conditions and limitations.

Another application for the current invention is in the gas industry. Naturally occurring impurities and/or constituents, as well as intentionally added constituents, can each become contaminants Currently, harvestable gas is usually flared causing atmospheric pollution. In fact, flaring may be prohibited in some jurisdictions. One embodiment of the current invention is set to amend such flare gas to reduce atmospheric pollution, and even so improving the flare gas to an economically interesting level.

Also, gas holding Vessels for railroad, truck transport, and even on barges are for temporary storage only. Yet another aspect of the current invention pertains to improving gas quality while enhancing storage volume during transport. Economically valuable molecular constituents can be recuperated from partially saturated MDM of the current system.

Underground storage facilities for natural gas could be viewed as a Vessel to allow for insertion and retrieval of the Cartridges and/or Lattices to allow MDM to amend gases “in situ” where “in situ” means an underground formation. An anaerobic biogas plant could be viewed as a Vessel wherein an MDM Cartridge loaded with MDM such as one suitable for nitrogen gas adsorption, and the system would include an attached Vessel inserted through an airlock device (chambers on both sides of the anaerobic wall), or via a strata-based MDM, or an ordinary outlet pipe from the anaerobic biogas plant connected to a daughter MDM Vessel and back to the mother Anaerobic Vessel via an inlet conduit. After treatment to separate and segregate the nitrogen from the raw biogas, the nitrogen-free (or nitrogen-reduced) remaining gas returns back to the biogas plant Vessel. The nitrogen would then be harvested.

Gas transmission pipelines and smaller conduits are effectively also Vessels having an input and outflow orifices. Gas is often temporarily stored in large diameter pipelines, through a process called line packing. The compressibility of natural gas allows the use of line packing to respond to fluctuations of gas demand over time of the day or day of the week or even due to change of seasons. On the basis of forecasted consumption, a linear-programming model can yield a plan for optimal flow rate of a gas pipeline. A pipeline, seen as a Vessel that allows for Cartridges and/or Lattices holding MDM would allow increased storage capacity because of adsorption/absorption properties of MDM and thus better meet demand fluctuation within the same pipe volume. This pipe-Vessel redefines maximum storage capacity and can even be monitored by use of a permanent control algorithm of its fluctuation over time. Vessels packed with a single or more than one specific type of MDM (depending upon the known constituents within the particular NG/NGL), even compared to known Adsorbed Natural Gas (“ANG”) systems, or compared to existing Compressed Natural Gas (“CNG”) or Liquefied Natural Gas (“LNG”) compression technology would substantially increase storage volume and allow for discrete amendments required or desired (such as separation, segregation, transformation or purification).

Currently, line packing at gas fired power plants is usually performed during off peak times to meet the next day's peaking demands, a temporary short-term substitute for traditional underground or above ground storage. Because of the importance of the enhanced storage, the pipe-Vessel System of the present invention provides for an environmentally friendly and power-plant-space-efficient gas quality amendment step that enhances purity by reducing constituent contaminants that otherwise would be combusted and released into the atmosphere at the smoke stack.

Another example of the utility of MDM Strata Positioning and Segmentation for additives pertains to volumetric deployment into known strata of various constituents having differing densities. Another aspect of the current invention uses a module to store gas, including stored gas in transport mode and during transfer (filling or emptying tanks), and transformation mode (such as regasification). It can also adsorb/absorb remaining heavy metals from gas streams to reduce heavy metal pollution when such amended gas is combusted.

The removal and replacement of MDM-containing Cartridges and/or Lattices allow for post-use treatment of MDM that is has been partially saturated with constituents that are either economically valuable for recovery or are contaminants to be disposed of properly.

A permanently sealed storage tank with any sorption (adsorption or absorption) of certain constituent molecules may lose storage capacity over time since the sorption material will simply fill up over time.

In one embodiment of the present invention, it is possible to physically remove MDM when it is partially or wholly saturated with contaminants, which can then be separated and discarded properly.

Like many industries that must deal with constituent-contaminants, the gas industry strives to apply Best Available Techniques (“BAT”) provided the costs of any proposed BAT is close to the then current acceptable practice. This is a critical point since treating saturated MDM to recuperate valuable economic constituents could reduce overall costs and thereby economically justify the use of MDM materials for amendment, alone or regularly in conjunction with storage.

MDM-filled Cartridges in proportionately smaller connected Vessels could be used in situations where gases boil off and are vented, such as after an LNG Vessel having been filled venting thereafter necessarily occurs. As one embodiment of the present invention, an appended Vessel with a Cartridge would capture boil-off VOC's to reduce explosion and inhalation risks, thereby preventing quantifiable fuel losses and preventing atmospheric pollution by such boiled-off VOC's, while storing such captured vented gas for later use. Such Vessel at least partially filled with a specific MDM (with or without an internal rail or Lattice) could therefore capture, separate and segregate various boil-off gas, and thus reduce or eliminate venting into the atmosphere.

Vessel packed with appropriate MDM can be used to capture certain molecules such as H2S (hydrogen sulfide).

Compared to methane, the minor fractions of LNG, such as ethane, propane and/or butane are undesirable when LNG boil-off results in an increase in the relative fraction of ethane to the total stored gas. Too high ethane levels in fuels can destroy an engine. Therefore, by a reverse analysis of separating out constituent molecules, large LNG regasification facilities can use the current invention to capture the major constituent in re-gasified LNG, namely, methane; thereby leaving behind the separated liquid ethane for higher-value use as ethane.

Currently, the predominant known method to amend contaminated gases, and/or liquids with gas in solution use costly synthetic membrane filters.

NG/NGL streams often contain wet gases, and even oil and/or water. Standard treatment exploits an amine course, water filtration, and membrane separation of the wet gas from the dry gas. There is no known economical method to retrieve value from the above mentioned waste by-products removed, except perhaps, recyclable water.

By using a proper MDM, or a mixture of MDM's, the current invention can be used to remove the waste by-product. The techniques to economically separate valuable by-products (captured or sequestered constituents within the saturated and removed MDM) can be accomplished though known technologies such as the use of solvents and/or mechanical centrifuge techniques, or through emerging technologies such as graphite membrane filtration, gas to liquids techniques, pressurization, ultra-sound or magnetic separation with or without catalysts. The residual MDM material after removal of constituents can be disposed of in any known safe manner depending upon the final chemical analysis of such residue MDM. In some cases it could be recycled and re-used as MDM.

The unexpected advantages of the present invention include: (a) providing a modular system for the separation of discrete constituents in a gas, fluid or liquid; (b) reducing tensile stress on MDM by using Cartridge segments; (c) providing wire or perforated frame supports for gas circulation where Cartridges or Lattices are suspended or placed in a Vessel; (d) providing interior Rod or Rail to which Cartridges or Lattices can be attached; (e) providing rail and roller that facilitate loading into as well as retrieval from the Vessel containing Cartridges or Lattices; (f) strata positioning of Cartridges and Lattices systems to enable stored or transported gas, fluid, or liquid to be amended in a horizontal position when the Vessel is in any degree of vertical or horizontal position; and (g) providing method for facilitating removal of partially or fully saturated MDM from the target gas, fluid, or liquid in an appropriate Vessel.

For example, for multiple moles within a Well Assay, the current invention provides a way of suing a plurality of Vessels loaded with specifically positioned Cartridges or Lattices, each containing specific MDM, to adsorb substantially all separated and segregated gases, fluids, or liquids, thereby meeting the transport logistics.

Some gases, such as methane, require purification and the removed constituents have no commercial value. On the other hand, some gases, such as helium, require a high level of purification generating small amounts of waste constituents. The present system can be used in such purification steps. Because of the ease of removing saturated MDM and the ease of re-loading “fresh,” or unsaturated, MDM, the present invention is useful in the purification processes discussed above.

Small MDM-filled Cartridges connected to a Vessel can be used in situations where gases boil off and are vented. The System could capture boil-off VOC's, thus reducing explosion, inhalation risks and air pollution, as well as preventing fuel losses. The captured vented gas can be stored for later use. The present System could therefore capture, separate, and segregate various boil-off gases, and consequently reduces venting pollutants into the atmosphere.

Large Pressure Vessels at moderate PSI Gauge (“PSIG”) (under 1000 PSIG) can be designed using the teachings of the present invention to enhance the amount of Natural Gas that can be contained therein. Such a device can be named “Large Enhanced Volume Vessel” (“LEVV”). An LEVV having an outside dimension of a known large 20-foot natural gas storage Vessel with a volume capacity of about 123.6 million standard cubic feet (“MSCF”) at 3250 PSIG, could contain, depending upon the type of MDM used therein, between 130% of 123.6 MSCF (+/−160 MSCF) to as much as 800% of the 123.6 MSCF (+/−988 MSCF) and this volume enhancement is accomplished at or under 1000 PSIG. As volume enhancement levels approach the maximum, a container cargo ship loaded with LEVV within stackable maritime shipping containers could become a highly competitive alternative sea transport method for natural gas compared with maritime transport of LNG.

Each design of the Vessel, Cartridge, Lattice, liner, rod or rail, and others, has specific functionality, while certain desirable functions may also require a particular shape or size. Vessels therefore are advantageous because there is broad flexibility of specific shapes or sizes to meet specific real-life needs. As a result, the current methodology and functional devices may be designed in any size or shape or be composed of a plurality of such devices including Vessels that are also heat- and pressure-type reactors and that could be made smaller while maintaining volume capacity and/or modularity.

The invention will now be described with reference to the embodiments shown in the drawings. Definitions and description of the components (represented by numbers) have been described and defined above.

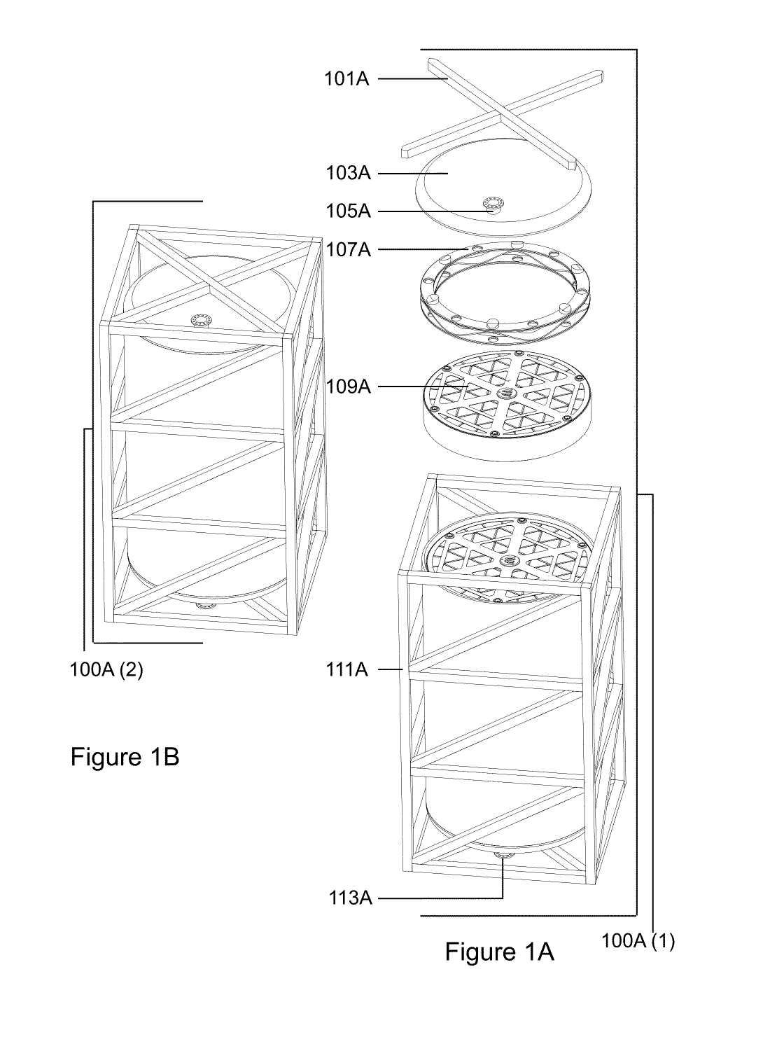

FIG. 1A

100A (1) Vessel exploded view

### 101A Structural Cross-Brace

### 103A Knucklehead

### 105A Inlet Orifice or Valve

### 107A Wave Washer

109A Populated Cartridge assembly

### 111A Cage

### 113A Outlet Orifice or Valve

FIG. 1B

### 100A (2) Assembled Vessel

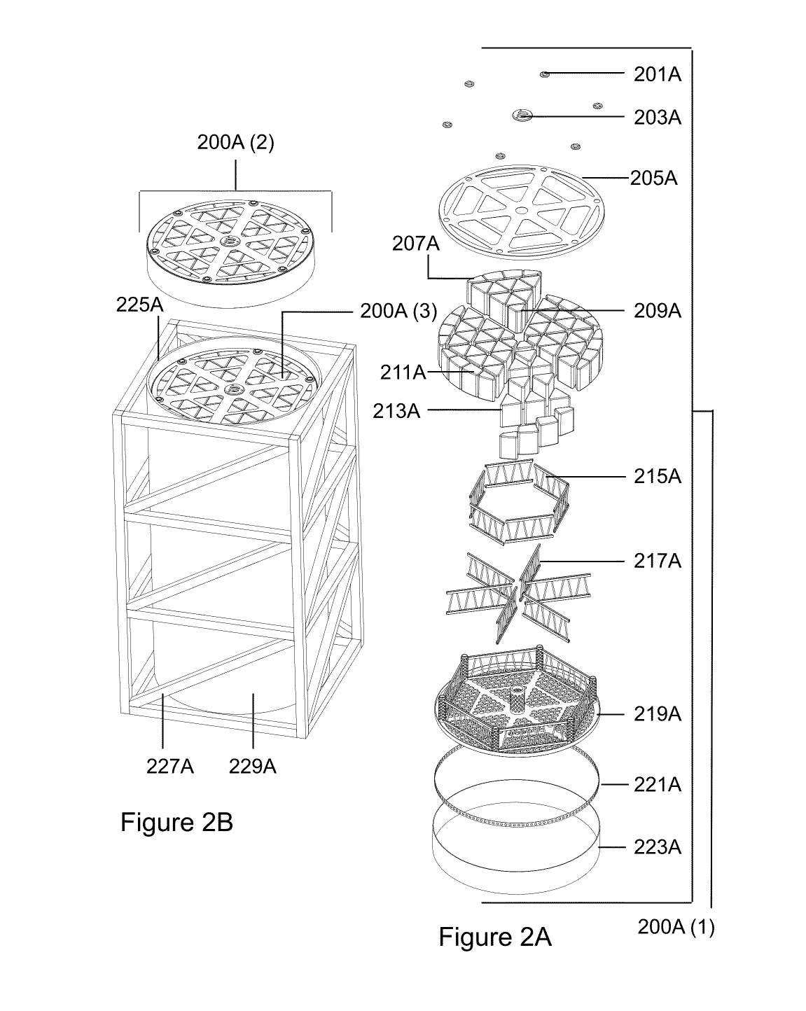

FIG. 2A

200A (1) Exploded View of Populated Cartridge assembly

### 201A Nut

### 203A Lifting Fixture

### 205A Top Plate

207A Semirigid Noncontinuous Bag, one of four distinct repeating shapes to create this Lattice assembly
209A Semirigid Noncontinuous Bag, two of four distinct repeating shapes to create this Lattice assembly
211A Semirigid Noncontinuous Bag, three of four distinct repeating shapes to create this Lattice assembly
213A Semirigid Noncontinuous Bag, four of four distinct repeating shapes to create this Lattice assembly

### 215A Linear Rib

### 217A Linear Rib

219A Structural Bottom Plate w/Ribs and Columns

### 221A Band

### 223A Sleeve

FIG. 2B

200A (2) Populated Cartridge assembly
200A (3) Populated Cartridge assembly

### 225A Vessel Wall

227A Structural cage

### 229A External Vessel Wall

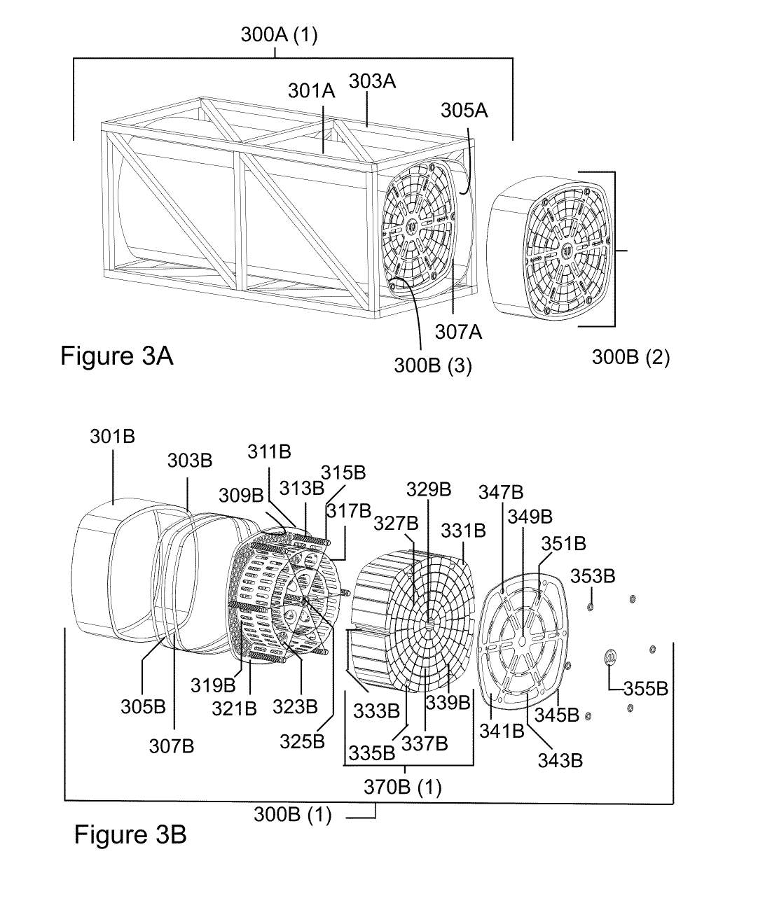

FIG. 3A

300A (1) Vessel assembly without Knucklehead, Structural Cross Brace, and Wave Washer

### 301A Outside of Vessel

303A Structural cage

### 305A Vessel Interior Wall

300B (2) Populated Cartridge assembly
300B (3) Populated Cartridge assembly

FIG. 3B

300B (1) Exploded View of Populated Cartridge assembly

### 301B Sleeve

### 303B Band

### 305B Band

### 307B Band

### 309B Flange

311B Structural Bottom Plate with Ribs and Columns

### 313B Structural Column

### 315B Structural Column Threaded End

### 317B Circular Rib Tab

### 319B Slot

### 321B Bottom Plate

### 323B Hexagonal Hole Pattern

### 325B Center Structural Column

### 327B Void for Circular Rib

### 329B Hole for 325B

### 331B Irregular-Shaped Semi-rigid Lattice Bag

### 333B Void for Structural Column

### 335B Void for Structural Column

### 337B Keystone-Shaped Semi-rigid Lattice Bag

### 339B Void for Circular Rib

### 341B Void

### 343B Slot

### 345B Top Plate

### 347B Hole for Structural Column

### 349B Hole for Center Structural Column

### 353B Nut

### 355B Lifting Fixture

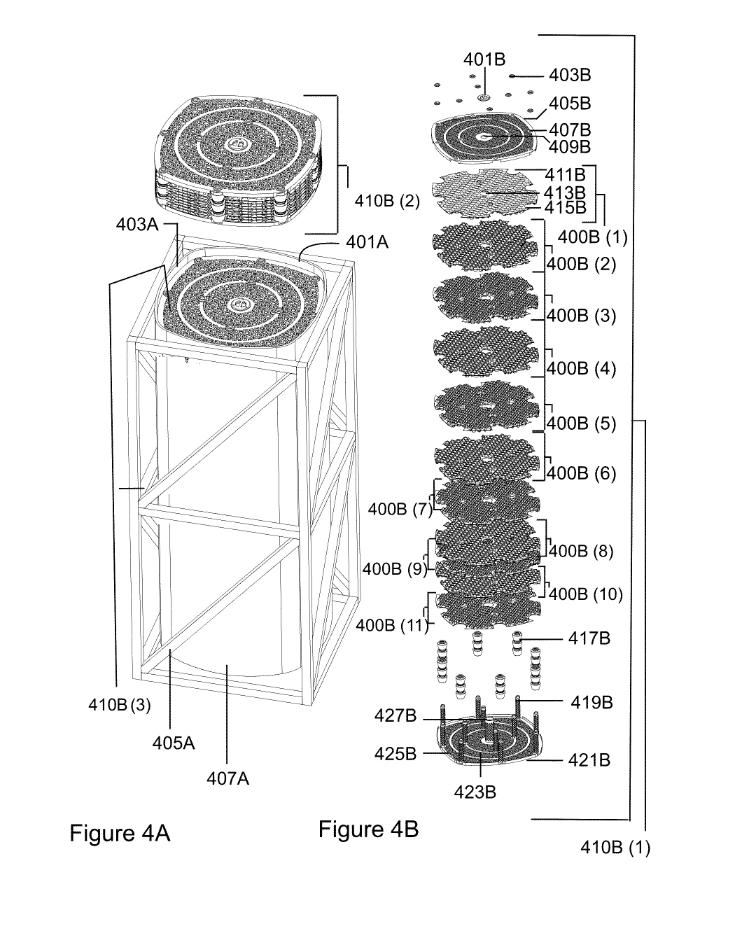

FIG. 4A

### 401A Vessel

### 403A Vessel Interior

### 405A Structural Frame

### 407A Vessel Exterior

410B (2) Populated Cartridge assembly

### 410B (3) Hexagonal Hole Pattern

FIG. 4B

### 400B (1-11) Sheet Formed

### 401B Lifting Fixture

### 403B Nut

### 405B Top Plate

407B Hole for Structural Column, one of eight

### 409B Hole for Center Structural Column

410B (1) Exploded View Cartridge assembly

### 411B Notch for Structural Column

### 413B Hole for Center Structural Column

415B Hole for Structural Column, one of eight

### 417B Shock Absorbers

419B Structural Column, one of eight

### 421B Bottom Plate

### 423B Bottom Plate Reinforcement Ring

### 425B Hole Pattern

### 427B Center Structural Column

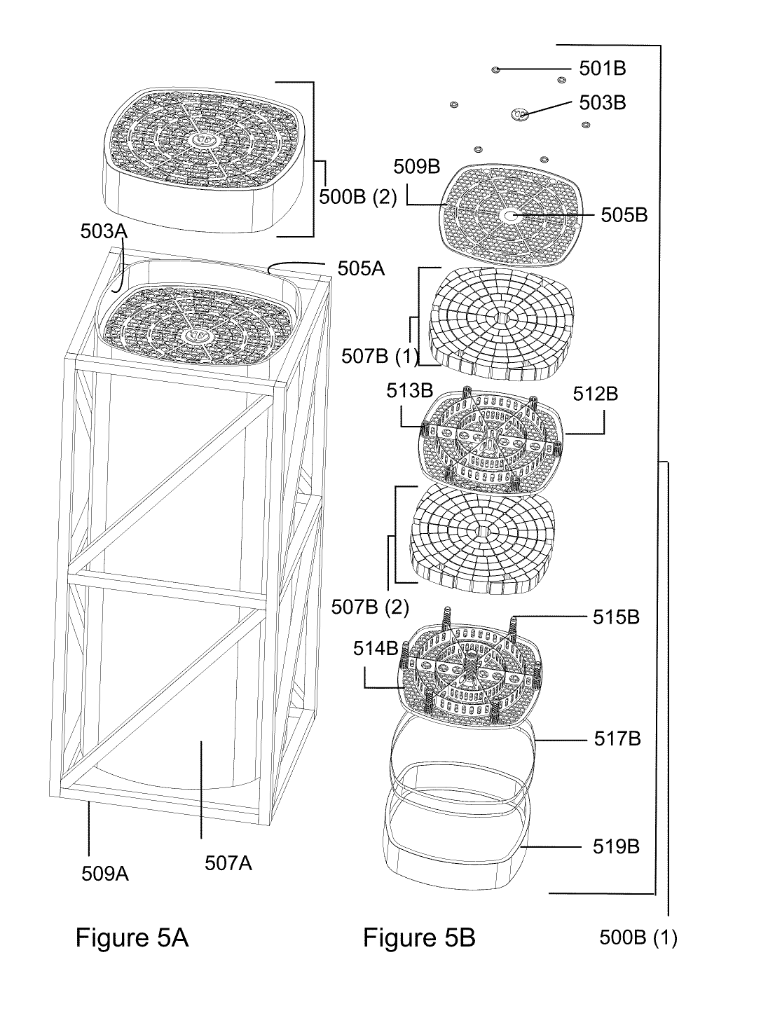

FIG. 5A

### 503A Vessel Interior Wall

### 505A Vessel

### 507A Vessel Exterior

509A Structural cage

FIG. 5B

500B (1) Exploded View of Populated Cartridge assembly
500B (2) Populated Cartridge assembly

### 501B Nut

### 503B Lifting Fixture

### 505B Orifice for Center Structural Column

507B (1) Cartridge assembly
507B (2) Exploded View of Cartridge assembly

### 509B Hole for Structural Column, one of six

### 512B Bottom Plate

### 513B Column Spacer

### 514B Bottom Plate

### 515B Structural Column

### 517B Band

### 519B Sleeve

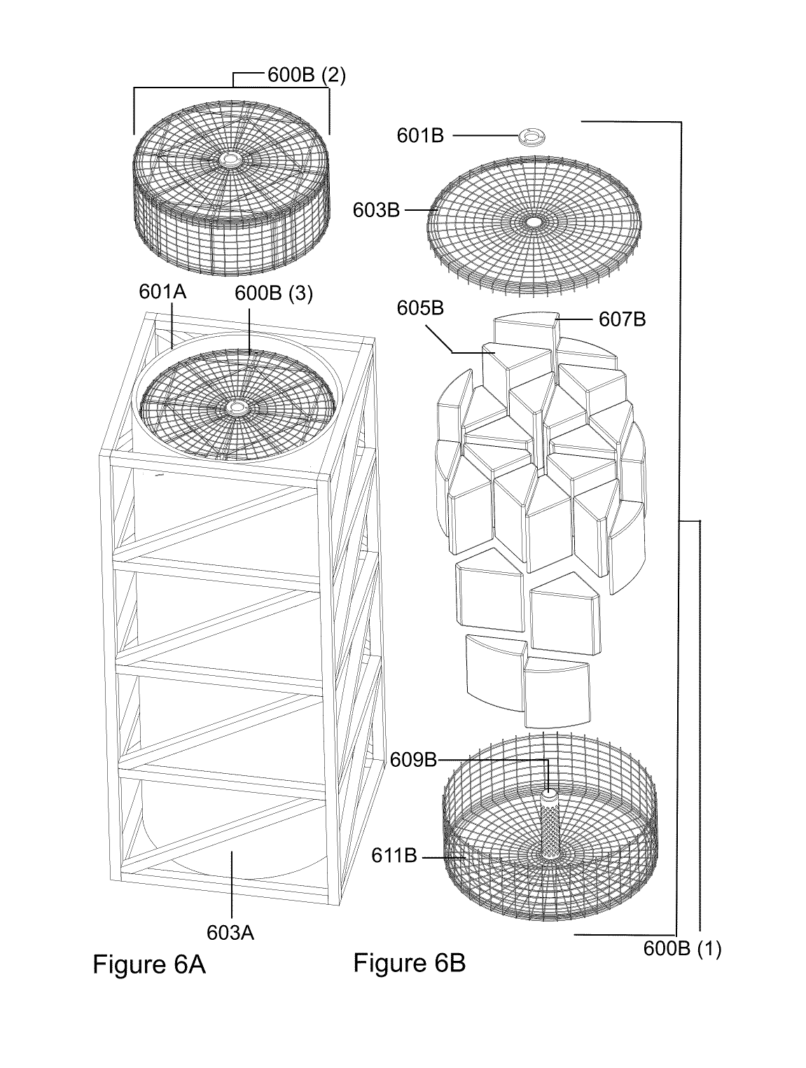

FIG. 6A

600B (2) Cartridge assembly Populated
600B (3) Cartridge assembly Populated

### 601A Interior Vessel Wall

### 603A Exterior Vessel Wall

FIG. 6B

600B (1) Cartridge assembly Populated
601B Center Collar Nut Threaded that ties Lattice plates and flat cap together, which center slot with panel can act as a lifting device
603B Top Plate With Lip Flange of Interlaced Spoke Wire Frame Cartridge that has voids to promote adsorption and eliminate weight of Plate. Plate can be made of heat conductive metal or alloy to promote release of adsorbed constituents. Top Plate has circulation voids in the shape of inscribed circles with cross wire reinforcements whose holes promote adsorption
605B One of two triangular repeating shapes, that are tiled or laid out via a tessellation pattern. Could be any shape that creates a tessellation pattern
607B The second of two triangular repeating shapes, that are tiled or laid out via a tessellation pattern. Could be any shape that creates a tessellation pattern
609B Center Structural Orifice that is threaded and may be perforated to enhance adsorption or save weight; it is also structural to transfer weight loads from the Bags back into the plates and bands; it may be made of a conductive metal to convey heat to promote release of adsorbed constituent from MDM. Connects to 603B
611B Base of Cylindrical Wire cage

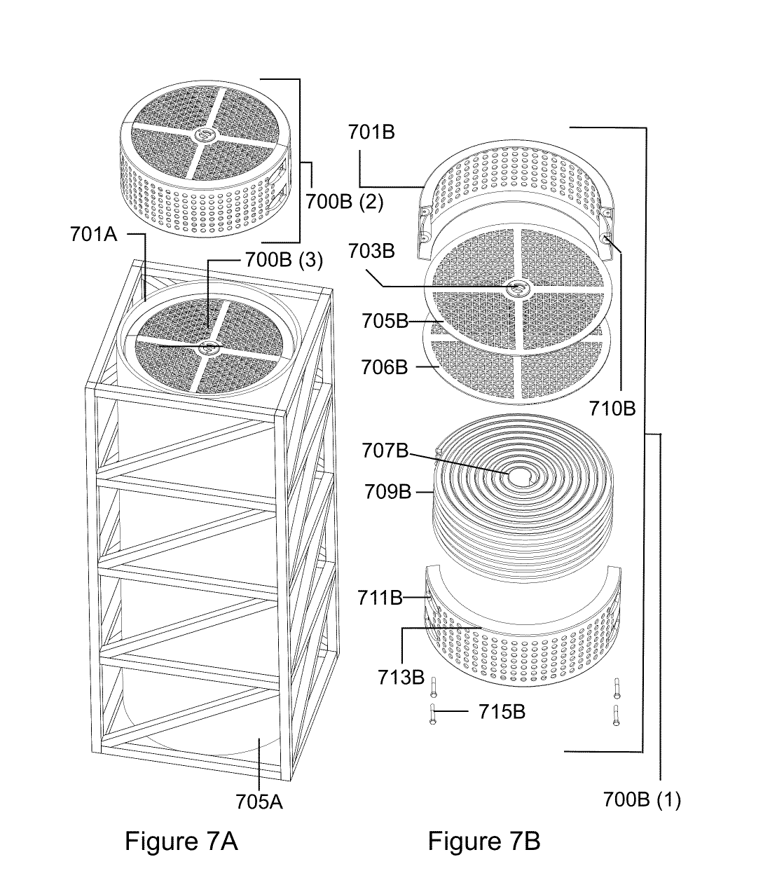

FIG. 7A

700B (2) Populated Cartridge assembly
700B (3) Populated Cartridge assembly

### 701A Interior Wall of Vessel

### 705A Exterior of Vessel

FIG. 7B

700B (1) Exploded View of Populated Cartridge assembly
701B Flange on half of Structural Cartridge Box
703B Lifting Fixture, which is connected to Center Structural Column

### 705B Top Plate

### 706B Bottom Plate

### 707B Hole for Center Structural Column

### 709B Semirigid Continuous Roll Lattice

### 710B Threaded Hole

### 711B Hole

713B Flange on half of Structural Cartridge Box

### 715B Threaded Fastener

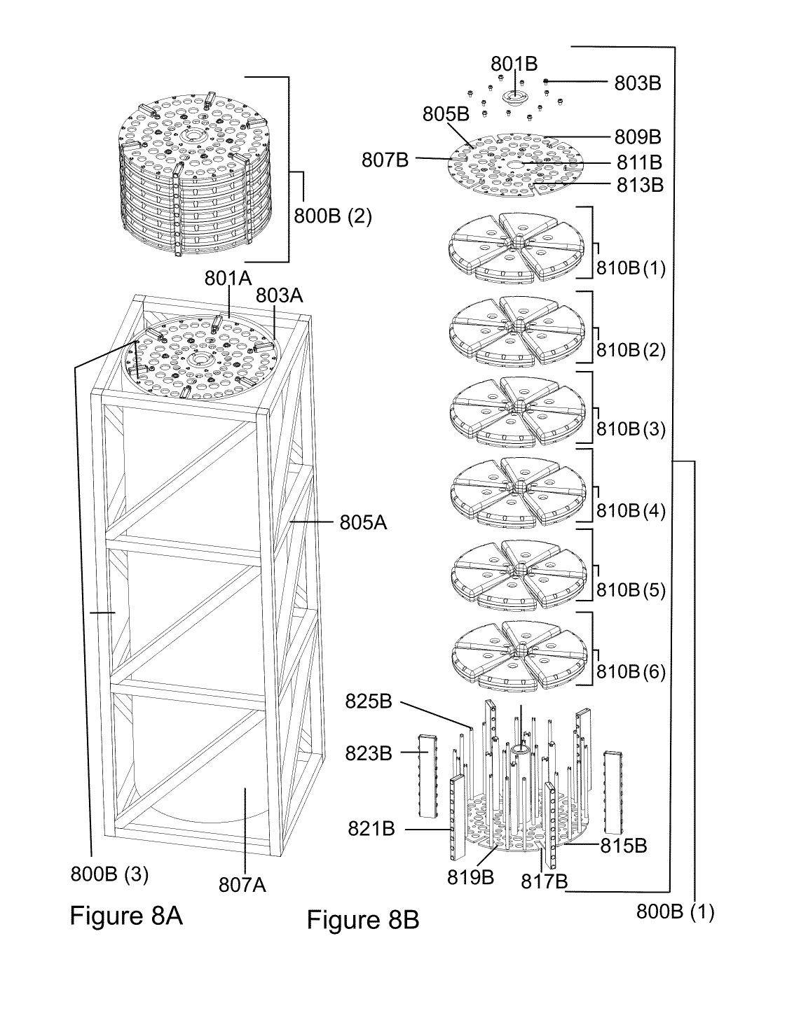

FIG. 8A

800B (2) Populated Cartridge assembly
800B (3) Populated Cartridge assembly

### 801A Interior Wall of Vessel

### 803A Vessel

805A Structural cage

### 807A Vessel Exterior Wall

FIG. 8B

800B (1) Exploded View of Populated Cartridge assembly

### 801B Nut

### 803B Fastener

### 805B Hole Pattern

### 807B Notch for 823B

### 809B Hole

810B (1) Rigid Bag Lattice assembly, one of six
810B (2) Rigid Bag Lattice assembly, two of six
810B (3) Rigid Bag Lattice assembly, three of six
810B (4) Rigid Bag Lattice assembly, four of six
810B (5) Rigid Bag Lattice assembly, five of six
810B (6) Rigid Bag Lattice assembly, six of six

### 811B Hole for Center Structural Column

### 813B Right-Angle Tab

### 815B Bottom Plate

### 817B Notch

### 819B Hole Pattern

### 821B Roller

### 823B Structural Support Column

### 825B Structural Column

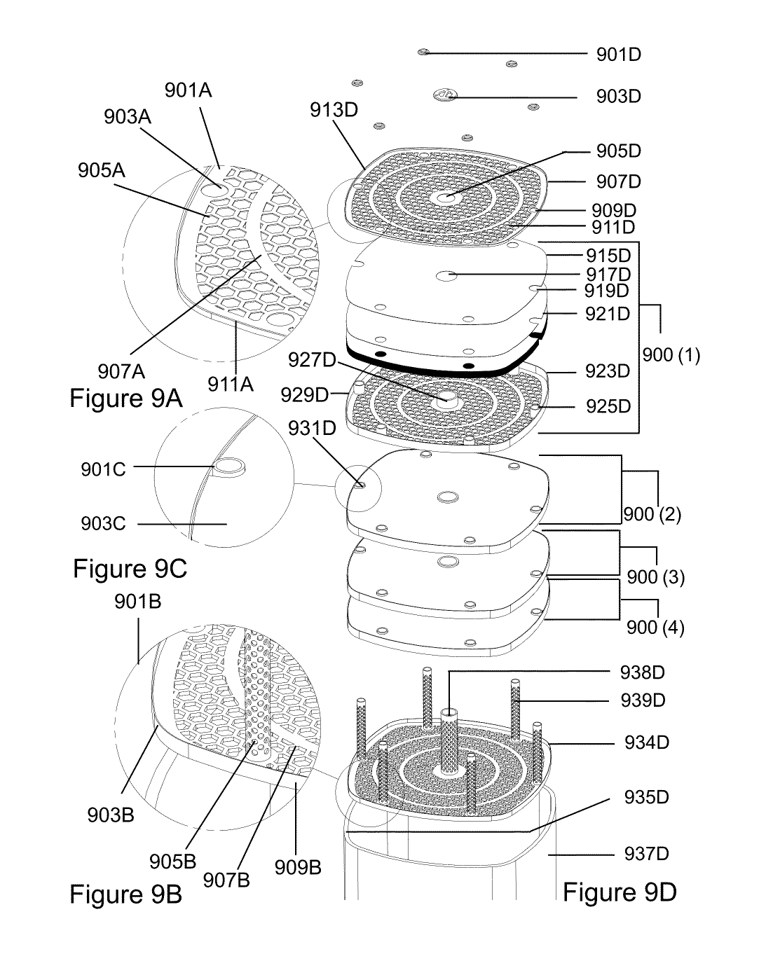

FIG. 9A

### 901A Close-Up of Top Plate

### 903A Close-Up of Structural Column Hole

### 905A Close-Up of Hexagonal Hole Pattern

### 907A Close-Up of Lattice Tray Reinforcing Ring

### 911A Close-Up of Tray Flange

FIG. 9B

### 901B Close-Up of Rounded Rectangular Lattice Tray

### 903B Close-Up of Flange of Bottom Lattice Tray

### 905B Close-Up of Structural Column

### 907B Close-Up of Lattice Tray Reinforcing Ring

### 909B Close-Up of Bottom Plate Lip

FIG. 9C

### 901C Close-Up of Rounded Shoulder

### 903C Close-Up of MDM Film

FIG. 9D

900 (1) Exploded View of Cartridge and Lattice assembly

### 901D Nut

### 903D Lifting Fixture

### 905D Hole for Center Structural Column and 927D

### 907D Top Plate

### 909D Hole

### 911D Hole Pattern

### 913D Top Plate Flange

### 915D MDM Film Sheet

### 917D Center Hole

### 919D Hole for Structural Column

### 921D MDM Film Sheet

### 923D Lattice Tray

### 925D Structural Column Spacer

### 927D Center Hole Spacer

### 929D Lattice Tray Flange

### 931D Spacer Rounded Shoulder

### 934D Bottom Plate

### 935D Edge of Vessel Wall

### 937D Exterior Vessel Wall

### 938D Center Structural Column

### 939D Structural Column, one of six

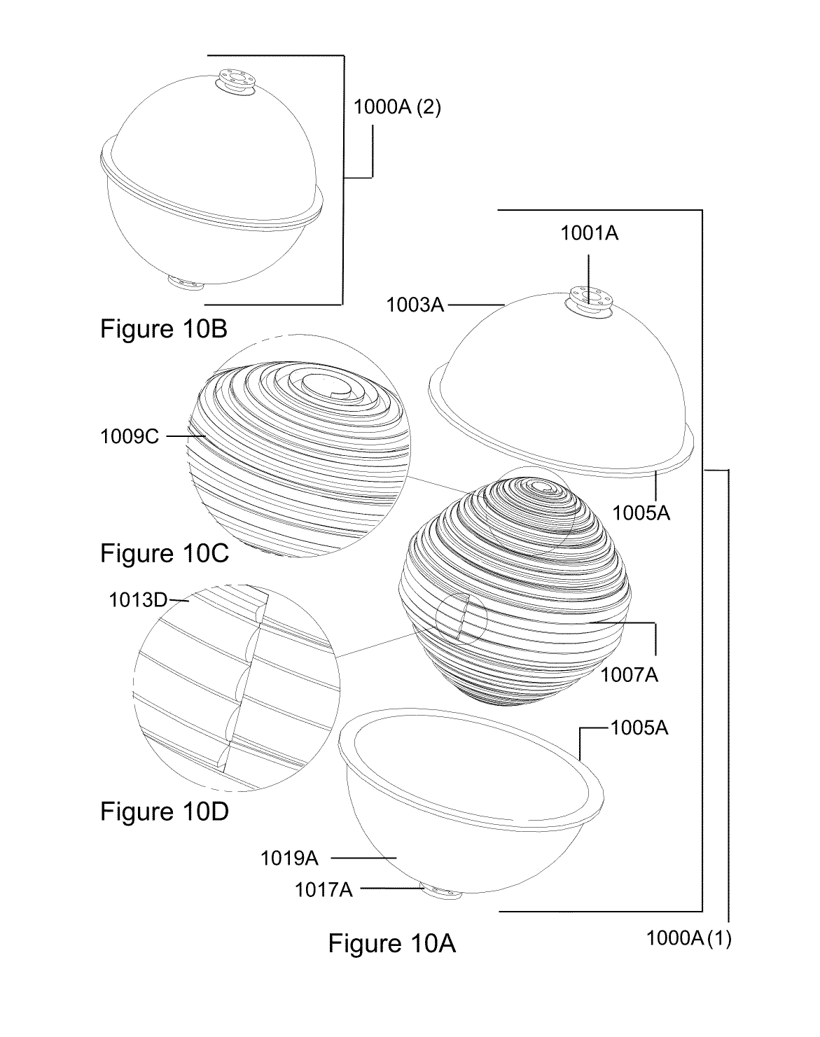

FIG. 10A

1000A (1) assembly of Spherical Vessel, and Semi-rigid Continuous MDM-populated Lattice assembly composed of 1001A, 1003A, 1005A, 1007A, 1019A, and 1017A.

### 1001A Inlet Orifice

### 1003A Top Hemisphere of Vessel

### 1005A Bond or Weld Flange

### 1007A MDM-populated Semi-rigid or Flexible Continuous Lattice Bag

### 1017A Outlet Orifice

### 1019A Bottom Hemisphere of Vessel

FIG. 10B

### 1000A (2) Non Exploded View of 1000A (1)

FIG. 10C

### 1009C MDM Flexible Continuous Lattice Bag

FIG. 10D

### 1013D Close-up Flexible Continuous Lattice Bag Furrows

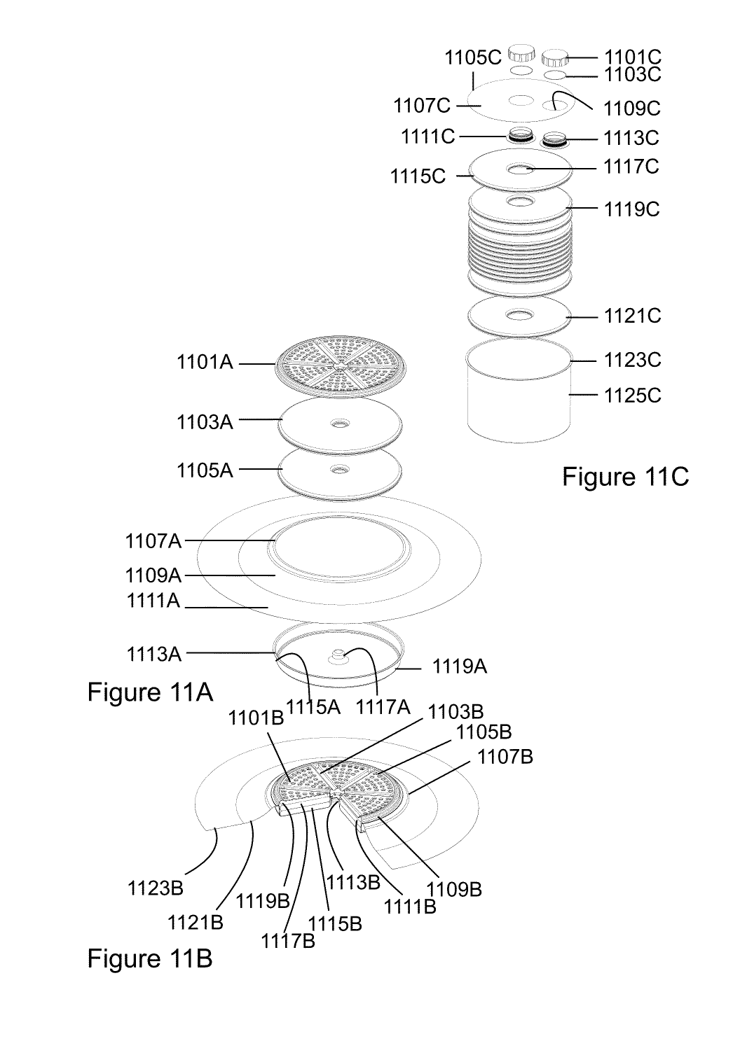

FIG. 11A

1101A Perforated In situ Load Plate to transfer load from weight of Vessel or Structure away from the MD. Load Plate also has a center orifice that interfaces with 1117A, could be die cast, stamped, extruded or an injection molded composite. If radioactive material it could be made from a polypropylene and ceramic fiber composite that could be pyrolized or otherwise incinerated.
1103A Soluble Coated or Laminated (could have perforations not coated) SMC manufactured Plate of MDM
1105A Another Soluble Coated or Laminated (could have perforations not coated) SMC manufactured Plate of MDM
1107A Apron Lip that is affixed to structure by overlapping into the flange of 1113A and 1101A weight on top
1109A Inner Apron Circle which could have an optional coating of MDM or be manufactured via SMC with a thin sandwich of MDM inside
1111A Outer Apron Circle which could have an optional coating of MDM or be manufactured via SMC with a thin sandwich of MDM inside
1113A Flange of Structural In situ Vessel
1115A Bottom plate of Structural In situ Vessel which could be could be die cast, stamped, extruded or an injection molded composite. If radioactive material it could be made from a polypropylene and ceramic fiber composite that could be pyrolized or otherwise incinerated.
1117A Load transfer tube of Structural In situ Vessel which interfaces to 1113B
1119A Side of Structural In situ Vessel

FIG. 11B

### 1101B Load Transfer Plate

### 1103B Inclined Plane Channel in Load Transfer Plate

### 1105B Perforations in Load Transfer Plate

### 1107B Flange of Load Transfer Plate

1109B Apron Lip that is affixed to structure by overlapping into the flange of 1113A and 1101A weight on top
1111B Apron within Flange
1113B Load transfer tube of Structural In situ Vessel which interfaces to 1117A

### 1115B MDM

### 1117B MDM

1119B Apron within Flange
1121B Inner ring of Apron
1123B Outer ring of Apron

FIG. 11C

### 1101C Sealable Caps for Connection to Vacuum

### 1103C Gasket

1105C Edge that fits into flange area of 1123C
1107C Removable Lid to facilitate re-loading and harvesting, or it could be welded or heat sealed or glued or mechanically attached not shown

### 1109C Orifice for 1113C

1111C Threaded force fit bushing
1113C Threaded force fit bushing

### 1117C Center Orifice of MDM SMC Lattice

1115C MDM SMC Lattice that is shown in a soluble coated state or with micro perforations
1119C MDM SMC Lattice that is shown in a soluble coated state or with micro perforations
1121C MDM SMC Lattice that is shown in a soluble coated state or with micro perforations
1123C Vessel Flange that 1105C fits into

### 1125C Removable Vessel

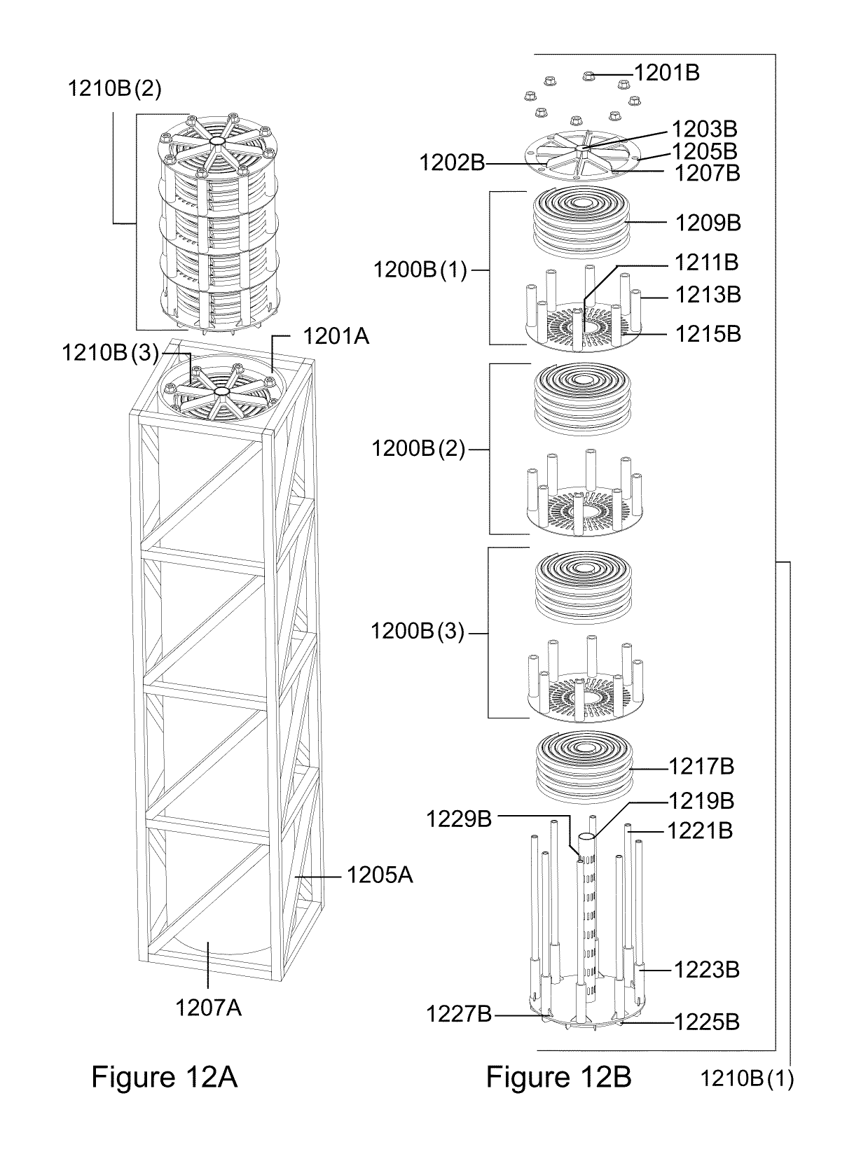

FIG. 12A

### 1201A Interior Wall of Vessel

1205A Vessel cage

### 1207A Exterior Wall of Vessel

1210B (2) Composed of four 1200B (1)
1210B (3) Bottom Plate and Spacers composed of 1213B and 1215B

FIG. 12B

1200B (1) Bottom Plate and Spacers composed of 1213B and 1215B
1200B (2) Bottom Plate and Spacers composed of 1213B and 1215B
1200B (3) Bottom Plate and Spacers composed of 1213B and 1215B
1210B (1) Composed of four 1200B (1)

### 1201B Nut or Fixture

### 1203B Center of Top Plate

### 1205B Structural Column Hole

### 1207B Top Plate Reinforcement Rib

### 1209B Populated Semi-rigid Flexible Continuous Lattice Bag

### 1211B Center Structural Column Hole

### 1213B Spacers

### 1215B Bottom Plate With a Hole Pattern

### 1217B Bottom Position Populated Semi-rigid Flexible Continuous Lattice Bag

### 1219B Center Structural Column With Optional Perforations

### 1221B Structural Column

### 1223B Spacers

1225B Rib Reinforcements to help with stability and load transfers

### 1227B Bottom Plate

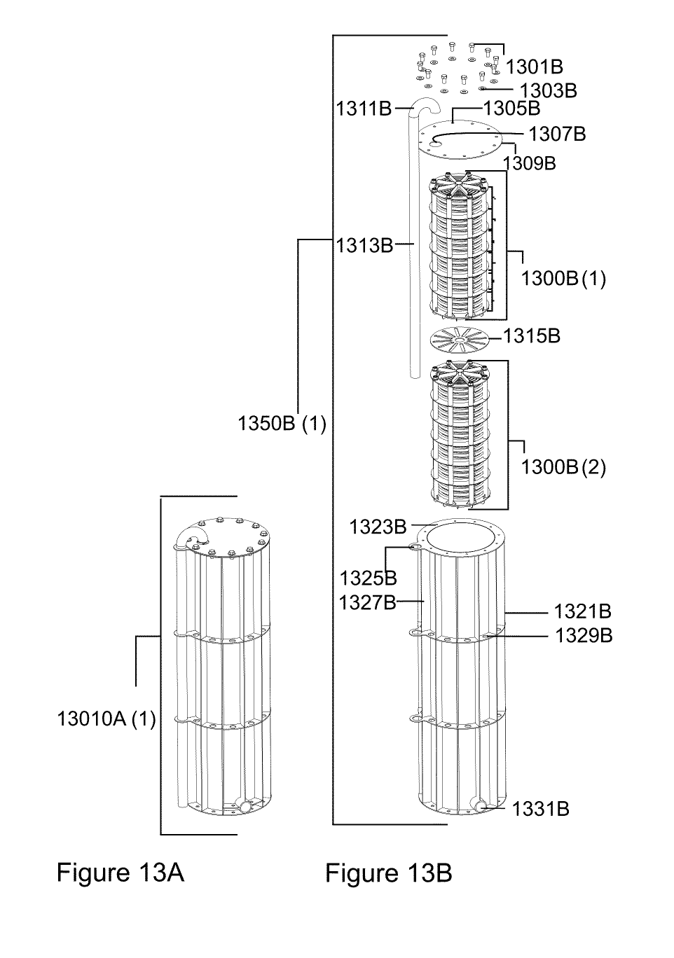

FIG. 13A

### 1310A (1) An Assembled Vessel Comprised of 1350B

FIG. 13B

### 1300B (1) Six FIG. 12 Assemblies 1200B (1)

### 1300B (2) (1) Six FIG. 12 Assemblies 1200B (1)

### 1301B Fastener Fixture

### 1303B Washer

### 1305B Hole for Fastener Fixture

### 1307B Orifice for 1311B

### 1309B Top Plate of Vessel

1311B Elbow to connect 1311B

### 1313B Connect 1311B

### 1315B Load Plate

### 1321B Rib on Vessel Exterior Wall

### 1323B Top of Plate

### 1325B Holding Slot Fixture for 1313B

1327B Inset feature for Pipe 1313B

### 1329B Circular Reinforcement

### 1350B (1)

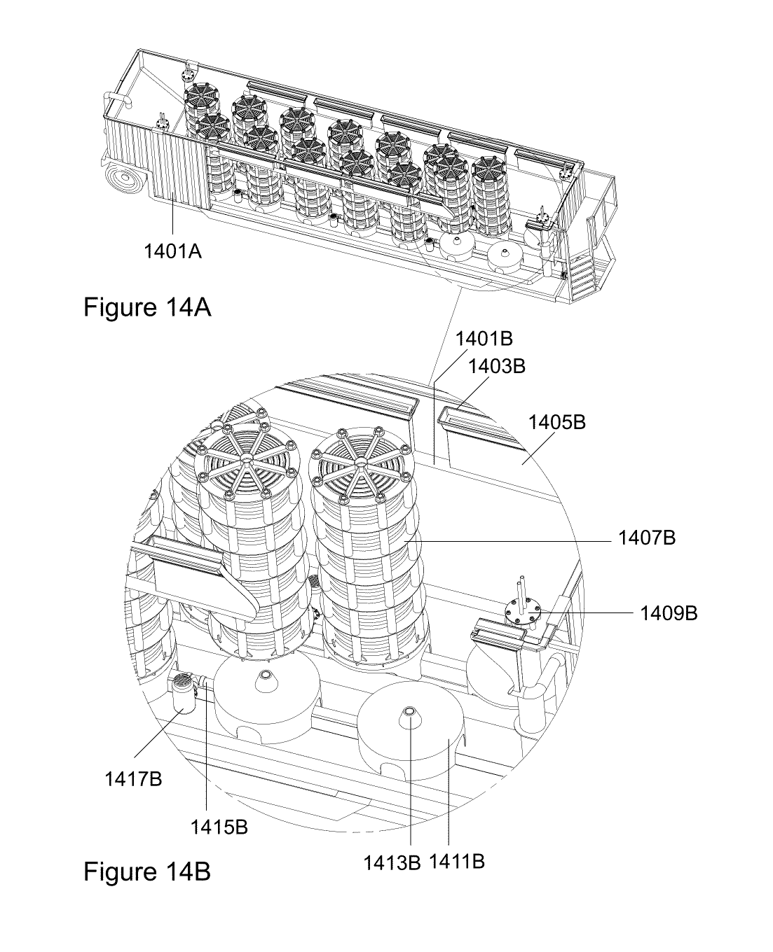

FIG. 14A

### 1401A Rectangular Vessel

FIG. 14B

### 1401B Skimmer Box Outlet Pipe

### 1403B Skimmer Box Float

### 1405B Support Channel

1407B Cartridge assembly as seen in 1210B (1)

### 1409B Heating Fixture

### 1411B Cartridge Support Structure

### 1413B Tapered Gasket

### 1415B Circulation Pipe

### 1417B Pump

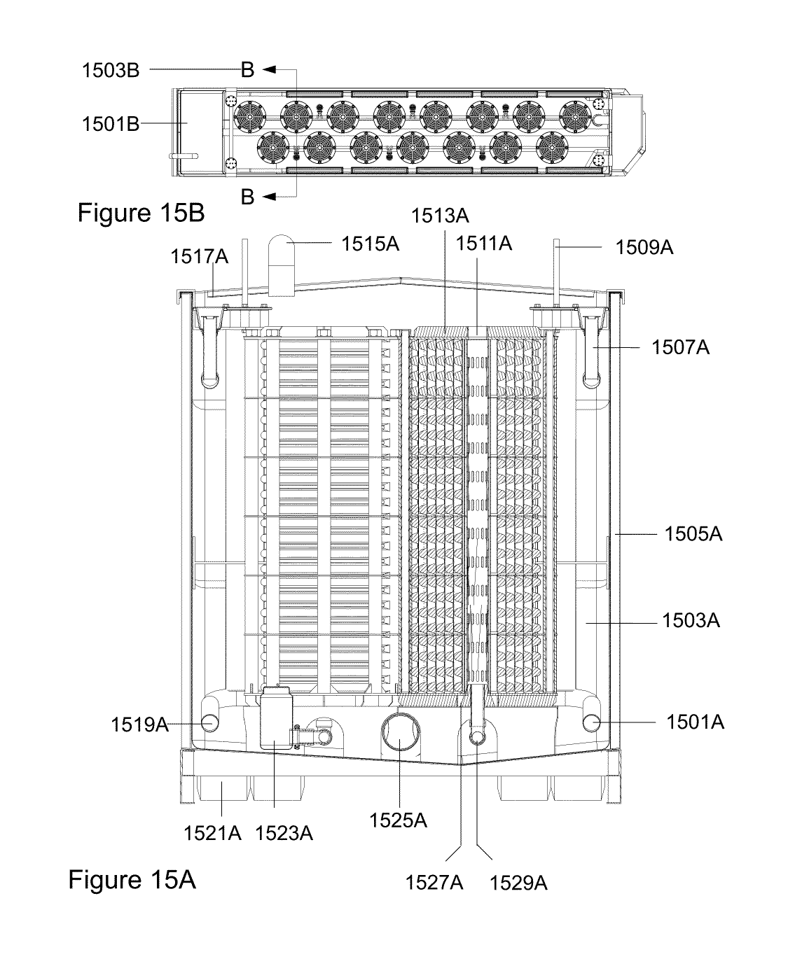

FIG. 15A

1501A Flush Pipe that has connected nozzle sprayers

### 1503A Heating Element

### 1505A Exterior Vessel Side Wall

### 1507A Skimmer Support

1509A Input and/or Outlet for heater

### 1511A Structural Column Tube

1513A Populated Cartridge assembly

### 1515A Inlet Fluid Pipe

### 1517A Top Exterior Vessel Wall

### 1519A Input for Nozzle Sprayers

### 1521A Chassis

### 1523A Pump

### 1525A Clean Out Pipe

### 1527A Tapered Gasket

### 1529A Fluid Circulation Pipe

FIG. 15B

1501B Rectangular View of Vessel without Top Enclosure

### 1503B The Section of the Blow Up Area of FIG. 15A. Labeled B-B

FIG. 16

1600(1) Cartridges are structural platforms used to retain, protect, and transport loose or (pre) containerized MDM. They aid in the loading/unloading of a Vessel and may be stacked on top of and/or adjacent to each other and fastened and/or interlocked together to maximize MDM volume within a Vessel.

### 1601 Column Post Threaded Nuts

1603 Center Collar Nut Threaded that ties Lattice plates and flat cap together, which center slot with panel can act as a lifting device
1605 Top Plate of Cartridge that has voids to promote adsorption and eliminate weight of plate. Plate can be made of heat conductive metal or alloy to promote release of adsorbed constituents

### 1607 Slit for Rib Locking

1609 Hole for Center Collar Nut Threaded that ties Lattice plates and flat cap together, which center slot with panel can act as a lifting device

### 1611 Flange of Top Cap

1613 Hole for nut to attach to 1619

### 1615 Adsorption Enhancement and Weight Reduction Void

### 1617 Load Transfer Wing and Heat Conduit (if Conductive) Material

1619 One of Six Outer Structural Perforated side tubes whose placement transfers loads from the Bags and tubes. They have machined or cut circulation voids whose weight-reducing side holes promotes adsorption via its voids. Structure if made from conductive material may through transfer enable heating the Cartridge

### 1621 Center Structural Load Tube

### 1623 Orifice for 1619

1625 Machined or cut circulation voids in the shape of a hexagon grid whose holes promote adsorption
1627 Bottom Flange Lip plate of Lattice Cartridge assembly, which handles load transfers and is perforated for less weight and circulation and can act as a heat conduit for heating adsorbed MDM
1630 Bottom Plate hole for structural post

FIG. 17A

1700A (1) Cartridge assembly without Top Plate
1701A One of ten Outer Structural Perforated side tubes whose placement transfers loads from the Bags and tubes. Have machined or cut circulation voids to reduce weight. Side holes promote adsorption via its voids. Structure if made from conductive material may through transfer enable heating the Cartridge
1703A One of six Ring or Ring Segments of structural load reinforcement in Lattice assembly, with voids for constituent adsorption flows.
1705A One of four Ribs Segments forming an X of structural load reinforcement in Lattice assembly, with voids for constituent adsorption flows.
1707A Interlocking Tab feature of Ribs to tie plate together, which promotes structural load transfers and thermal transfers
1709A One of three bands
1711A Bottom plate with lip of Lattice Cartridge assembly, which handles load transfers and is perforated for less weight and circulation and can act as a heat conduit for heating adsorbed MDM
1712A Opposite Plane Ring Segments Wrap of structural load reinforcement in Lattice assembly affixed to 1701A
1713A Center Structural Orifice that is threaded and may be perforated to enhance adsorption and save weight. It is also structural to transfer weight loads from the Bags back into the plates and bands, and may be made of a conductive metal to convey heat to promote release of adsorbed constituent from MDM. The center slot with panel can act as a conduit connector between Cartridges, for thermal transfers, gas flows, or as a connector for a lifting device.
1715A Machined or cut circulation voids in the shape of a hexagon grid whose holes promote adsorption and/or circulation and lessen weight of the structure, allowing more gas to be stored and transported.
1717A Machined or cut circulation voids in the shape of an ellipse grid whose holes promote adsorption and/or circulation and lessen weight of structure, allowing more gas to be stored and transported.

FIG. 17B

1700B (1) Unpopulated Cartridge assembly
1701B Top Plate of Cartridge that has voids to promote adsorption and reduce weight of plate. Plate can be made of heat conductive metal or alloy to promote release of adsorbed constituents
1703B Slot for 1707A to interface with
1705B One of ten Outer Structural Perforated side tubes whose placement transfers loads from the Bags and tubes. Have machined or cut circulation voids to reduce weight. Side holes promote adsorption via its voids. Structure if made from conductive material may through transfer enable heating the Cartridge.

FIG. 17C

1700C (1) Cartridge assembly as seen in 1700B (1) now populated with MDM Lattice Bags
1701C Rectangular Cartridge assembled and loaded with Lattices

FIG. 18A

1800A (1) Cartridge assembly

### 1803A Nut for 1836A

1806A Center lifting fixture and assembly closure

### 1809A Mounting Hole(s) for Structural Support Perforated Reinforcement Column Post

### 1812A Edge of Top Plate

1815A Slot for Joint with Outer Ring
1818A Top Plate Cartridge that has voids to promote adsorption and eliminate weight of plate. Plate can be made of heat conductive metal or alloy to promote release of adsorbed constituents

### 1824A Mounting Hole(s) for Structural Support Perforated Reinforcement Column Post

1827A Center orifice of Lattice assembly
1828A Center orifice of Lattice assembly and Cartridge that fixture 1806A rests within
1830A Outer band of standard repeatable Lattice Bag assembly that 1842A resides on the exterior, a close-up of which is shown in FIG. 18C
1833A Bands for structural support and load transfer which can also be made of a thermal conductive material
1836A One of six Outer Structural Perforated side tubes whose placement transfers loads from the Bags. Tubes have machined or cut circulation voids to reduce weight. Side holes promote adsorption via its voids; structure if made from conductive material may through transfer enable heating the Cartridge.
1839A Center Structural Orifice that is threaded and may be perforated to enhance adsorption, save weight; it is also structural to transfer weight loads from the Bags back into the plates and bands. It may be made of a conductive metal to convey heat to promote release of adsorbed constituent from MDM.
1842A Slots for Structural Support Perforated Reinforcement Column Post that fit into 1815A

### 1845A Circulation Voids

1848A Bottom Plate with Flange Feature that can transfer heat if made from thermal conductive material or can act as a load transfer mechanism
1851A Center Structural Orifice that is threaded and may be perforated to enhance adsorption and save weight. It is also structural to transfer weight loads from the Bags back into the plates and bands. It may be made of a conductive metal to convey heat to promote release of adsorbed constituent from MDM. The center slot with panel can act as a conduit connector between Cartridges, for thermal transfers, gas flows, or as a connector for a lifting device.
1854A Aluminum or Fabric sleeve or liner to facilitate loading, made of polyamide or aramid or composite blend via extrusion or molding or sewn/woven. If MDM needs to be heated, liner could be made of conductive metal such as corrosion-resistant aluminum and could be striped or fully coated on one or both sides with Teflon or titanium or other element to reduce loading friction, act as a vibration isolator, and improve fit between the Cartridge and tank walls of the Cartridge. This feature can also act as a sleeve to protect the MDM from sparks and heat from welding the Vessel.

FIG. 18B

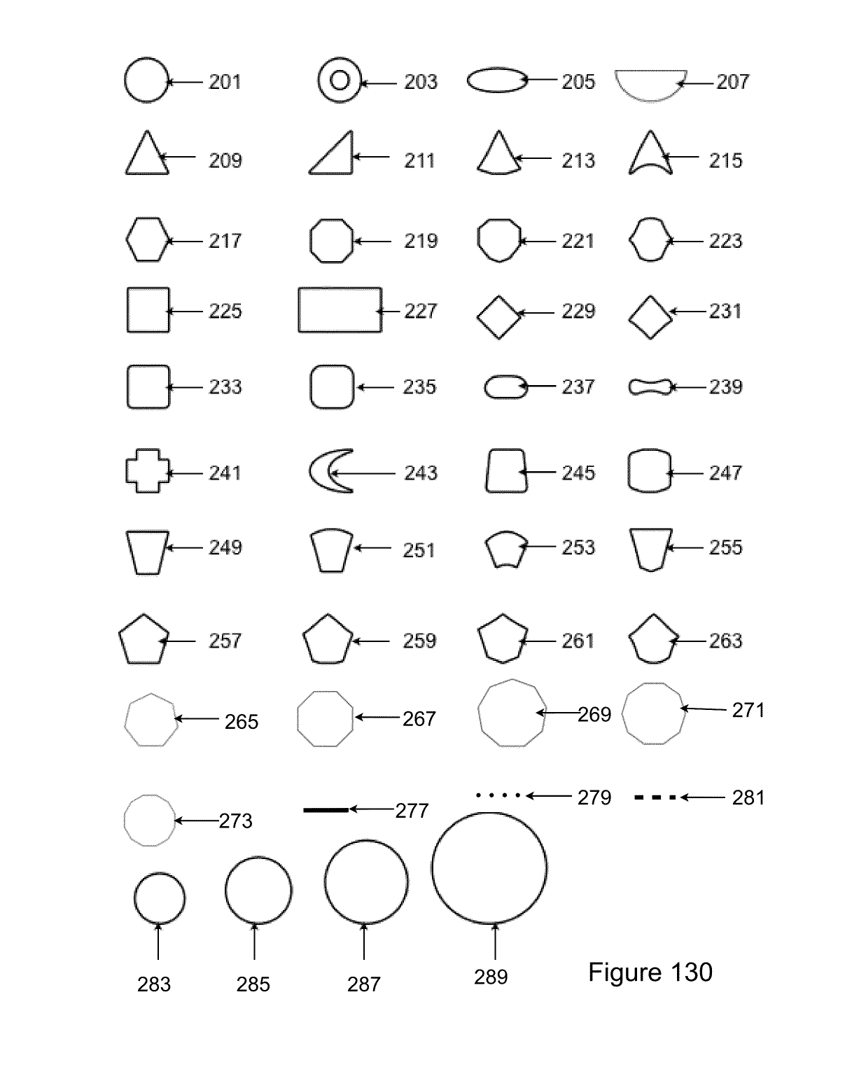

1803B Orifice that in some cases can interlock Cartridge plates or act as a weight reducer and enable adsorption
1806B A close-up of top plate slot that interfaces into 1809A
1809B A close-up of top plate Mounting Hole(s) for Structural Support Perforated Reinforcement Column Post
1812B Top Plate edge with flange feature of Lattice Cartridge assembly, which if made from a heat conductive metal can act as a heat conduit
1815B Void that can be of any shape in FIG. 130 to eliminate weight, promote adsorption and/or circulation

FIG. 18C

1803C Close-up of partial orthographic view of flush fit portion of circular (can be any shape) ribbon
1806C Close-up of partial orthographic view of protrusion portion of circular (can be any shape) ribbon as seen in 1839A
1809C Close-up of machined or cut circulation voids in the shape of a hexagon grid whose holes promotes adsorption

### 1812C Same as 1803C

1815C A front view of similar feature of 1806C
1818C Bottom Base plate of Cartridge

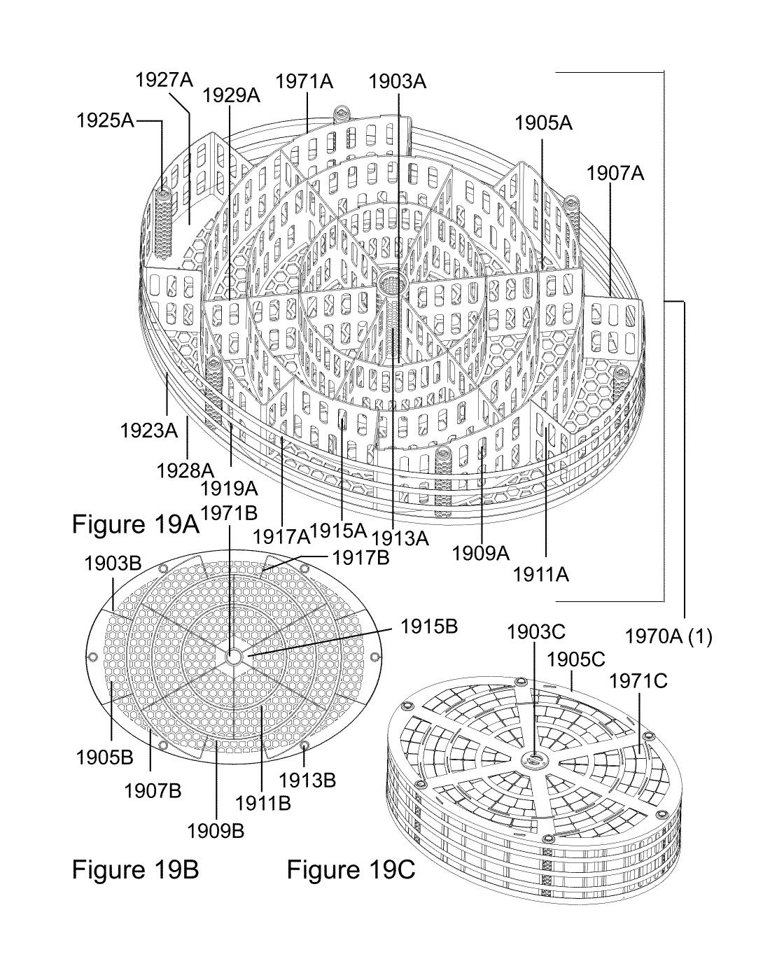

FIG. 19A

1970A (1) Entire Unpopulated Cartridge assembly without the top plate
1971A Interlocking Slot feature of Wing and Rings to tie plate together, which promotes structural load transfers, and thermal transfers
1903A Solid Plate Structural Area around Center Post which enhances structural integrity, load transfers, and thermal transfers.
1905A Machined or cut circulation voids in the shape of a circular grid (which can be of any shape in FIG. 130, whose holes promotes adsorption and/or circulation, and lessens weight of structure, allowing more gas to be stored and transported
1907A One of Four Wing Segments forming an horizontal angled of structural load reinforcement in Lattice assembly, with voids for constituent adsorption flows
1909A Void in one of four Wing Segments of structural load reinforcement in Lattice assembly, the voids enhance constituent adsorption flows
1911A Void in one of four Ring or Ring Segments of structural load reinforcement in Lattice assembly; voids enhance constituent adsorption flows
1913A Center Structural Orifice that is threaded and may be perforated to enhance adsorption and save weight. It is also structural to transfer weight loads from the Bags back into the plates and bands. It may be made of a conductive metal to convey heat to promote release of adsorbed constituent from MDM. The center slot with panel can act as a conduit connector between Cartridges, for thermal transfers, gas flows, or as a connector for a lifting device.

### 1915A Hole in a Circular Rib

1917A One of four Ring or Ring Segments of structural load reinforcement in Lattice assembly, with voids for constituent adsorption flows
1919A One of Two Centered Solid (without voids) Wing Segments at 47 Degrees which is part of structural load reinforcement in Lattice assembly, a solid reinforcement which can enhance thermal transfers.
1928A Bottom plate with lip of Lattice Cartridge assembly, which handles load transfers and is perforated for less weight and more circulation and can act as a heat conduit for heating adsorbed MDM
1923A One of three structural bands
1925A One of six perforated columnar support tubes that enable load transfers
1927A Solid Elliptical Ring of Bottom Plate for added reinforcement and load transfer
1929A One of 4 cross member X Ribs or Wings for support and that enable load transfers

FIG. 19B

1971B Center Structural Orifice that is threaded and may be perforated to enhance adsorption and save weight, It is also structural to transfer weight loads from the Bags back into the plates and bands. It may be made of a conductive metal to convey heat to promote release of adsorbed constituent from MDM. The center slot with panel can act as a conduit connector between Cartridges, for thermal transfers, gas flows, or as a connector for a lifting device
1903B One of Four Wing Segments forming a horizontal angle of structural load reinforcement in Lattice assembly, with voids for constituent adsorption flows
1905B Machined or cut circulation voids in the shape of a circular grid (which can be of any shape in FIG. 130, whose holes promotes adsorption and/or circulation, and lessens weight of structure, allowing more gas to be stored and transported
1907B One of four Ring or Ring Segments of structural load reinforcement in Lattice assembly, with voids for constituent adsorption flows
1909B One of four Ring or Ring Segments of structural load reinforcement in Lattice assembly, with voids for constituent adsorption flows
1911B One of four Ring or Ring Segments of structural load reinforcement in Lattice assembly, with voids for constituent adsorption flows
1913B One of six Outer Structural Perforated side tubes whose placement transfers loads from the Bags. Tubes have machined or cut circulation voids to reduce weight. Side holes promote adsorption via voids. Structure if made from conductive material may through transfer enable heating the Cartridge
1915B Solid Plate Structural Area around Center Post which enhances structural integrity, load transfers, and thermal transfers
1917B One of two Centered Solid (without voids) Wing Segments at 47 Degrees which is part of structural load reinforcement in Lattice assembly, a solid reinforcement which can enhance thermal transfers.

FIG. 19C

1971C Cartridge and Lattice Ellipse assembly
1903C Threaded Center Orifice Nut that can act as a thermal transfer component or a lifting fixture component
1905C Top Plate with Lip of Ellipse Cartridge

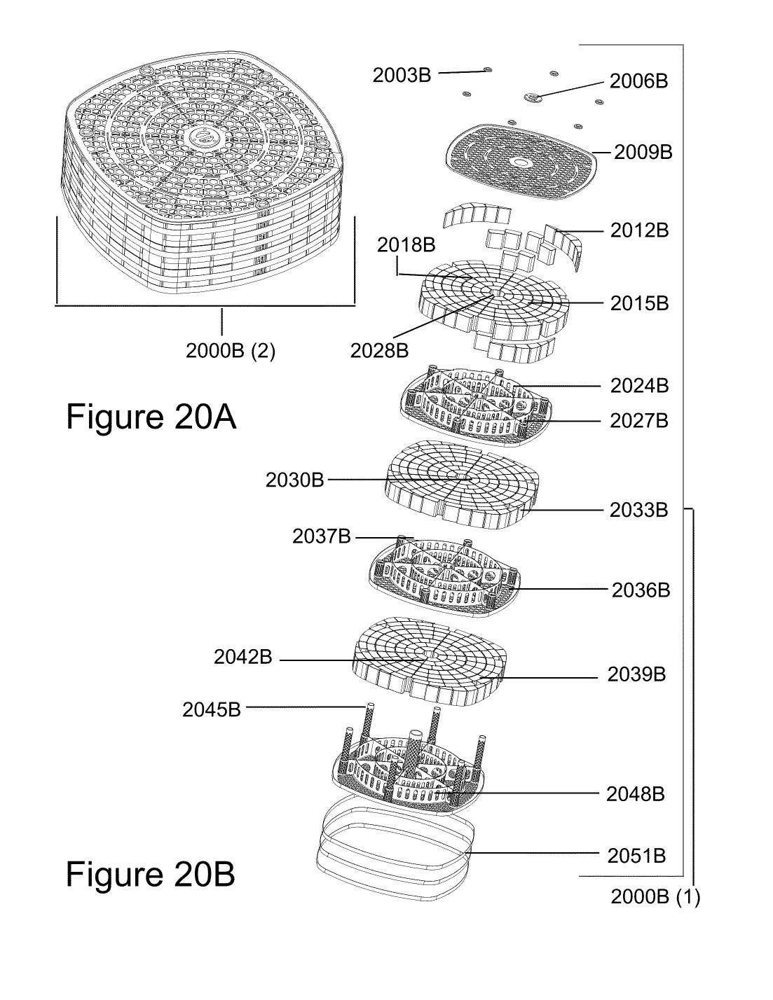

FIG. 20A

2000B (2) Completed assembly of 20B

FIG. 20B

### 2003B Nut for 2045B or

2006B Center lifting fixture
2009B Upper lifting plate assembly
2012B irregularly-shaped Inscribed Lattice Bags
2015B Short Height Pillowed Lattice assembly
2018B Repeatable same configuration inscribed rows
2028B Center orifice of Lattice assembly and Cartridge that fixture 2006B rests within
2024B Structural members. In a vertical position (as shown), reduces racking and distributes the lifting loads from the center support tube. In a horizontal position, reduces the compression loads on the bottom of most MDM Bags by transferring the vertical loads to the top and bottom plates. High material compression will damage the MDM material and Bags.
2027B Bottom component of the Cartridge plate assembly, including a lip and gas flow holes
2030B Another center orifice of Lattice assembly and Cartridge
2033B Another Short Height Pillowed Lattice assembly
2036B Another Cartridge plate and structural member assembly as shown previously in 2024B and 2027B consecutively
2037B Structural Column Tube which slips over top of 2045B
2039B Another Center orifice of Lattice assembly and Cartridge
2042B Another Short Height Pillowed Lattice assembly
2045B Structural Column Side tubes with machined ventilation and weight-reduction side holes
2048B Another Cartridge plate and structural member assembly as shown previously in 2024B and 2027B consecutively
2051B Bands that hold the Cartridge and Lattice assembly together

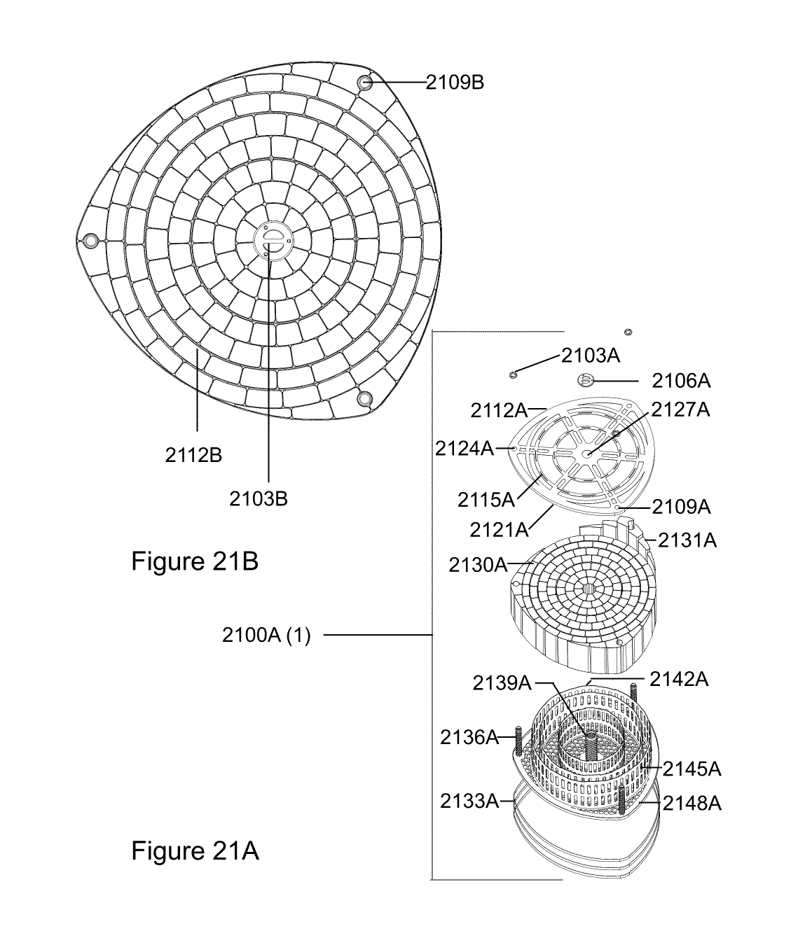

FIG. 21A

2100A (1) Exploded View of Triangular Pillowed Cartridge assembly

### 2103A Nut for 2136A

2106A Center lifting fixture and assembly closure
2109A Mounting Hole(s) for one of three Structural Support Perforated Reinforcement Column Post

### 2112A Edge of Top Plate

2115A Slot for Joint with Outer Ring
2121A Top Plate Cartridge that has voids to promote adsorption and reduce weight of plate. Plate can be made of heat conductive metal or alloy to promote release of adsorbed constituents

### 2124A Second Mounting Hole(s) for Structural Support Perforated Reinforcement Column Post

2127A Center orifice for support tube through Lattice assembly
2130A Outer band of standard repeatable Lattice Bag assembly
2131A Irregular but repeatable Lattice Bags to fill assembly with maximum volume of MDM by outer perimeter population of Vessel
2133A Bands for structural support and load transfer which can also be made of a thermal conductive material
2136A One of three Outer Structural Perforated side tubes whose placement transfers loads from the Bags. Tubes have machined or cut circulation voids whose weight-reducing side holes promotes adsorption via its voids. Structure if made from conductive material may through transfer enable heating the Cartridge.
2139A Center Structural Orifice that is threaded and may be perforated to enhance adsorption and/or save weight. It is also structural to transfer weight loads from the Bags back into the plates and bands, and may be made of a conductive metal to convey heat to promote release of adsorbed constituent from MDM. The center slot with panel can act as a conduit connector between Cartridges, for thermal transfers, gas flows, or as a connector for a lifting device.
2142A Slots for Structural Support Perforated Reinforcement Column Post that fits into 2115A

### 2145A Circulation Voids

2148A Bottom Plate with Flange Feature that can transfer heat if made from thermal conductive material or can act as a load transfer mechanism

FIG. 21B

2103B Center lifting fixture and assembly closure
2109B A close-up of top plate Mounting Hole(s) for Structural Support Perforated Reinforcement Column Post that top plate ties into
2112B Lattice Bags in repeatable patterns with mortar offset to transfer loads

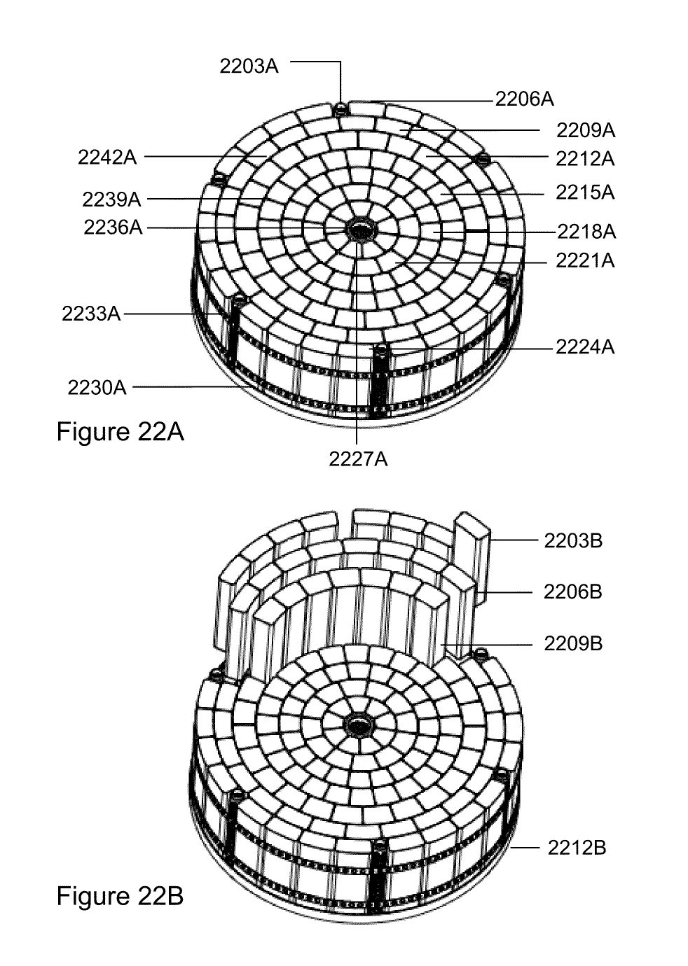

FIG. 22A

2203A Outer Structural Perforated side tubes whose placement transfers loads from the Bags. Tubes have machined circulation and weight-reducing side holes that promote adsorption via the voids. Structure if made from conductive material may through transfer enable heating the Cartridge.
2206A Outer ring of inscribed Lattice Bags or structures that are variation of a keystone shape as seen in FIG. 130 253 that are customized to fit the cylindrical form of the Cartridge and Vessel. These Lattice Bags could be created of a permeable or perforated material, or as semi-rigid Bags with inserted internal supports within the Lattice Bags.
2209A Sixth inner ring of repeatable inscribed Lattice Bags or structures that are variation of a keystone shape as seen in FIG. 130 253
2212A Fifth inner ring of repeatable inscribed Lattice Bags or structures that are variation of a keystone shape as seen in FIG. 130 253
2215A Fourth inner ring of repeatable inscribed Lattice Bags or structures that are variation of a keystone shape as seen in FIG. 130 253
2218A Third inner ring of repeatable inscribed Lattice Bags or structures that are variation of a keystone shape as seen in FIG. 130 253
2221A Second inner ring of repeatable inscribed Lattice Bags or structures that are variation of a keystone shape as seen in FIG. 130 253
2224A One of six Outer Structural Perforated Side Tubes whose placement transfers loads from the Bags. Tubes have machined or cut circulation voids whose weight-reducing side holes promotes adsorption via its voids. Structure if made from conductive material may through transfer enable heating the Cartridge.
2227A First inner ring of repeatable inscribed Lattice Bags or structures that are variation of a keystone shape as seen in FIG. 130 253
2230A Bottom plate of Lattice Cartridge assembly, which handles load transfers and is perforated and can act as a heat conduit for heating adsorbed MDM
2233A Outer Structural Perforated Side Bands that have machined circulation and weight-reducing side holes. Bands promote adsorption via voids. Structure if made from conductive material may through transfer enable heating the Cartridge. Structural bands hold the Lattice Cartridge assembly together, which ties together with the external structural and circulation tubes to transfer compression loads from the Bags to the outer structural Bags
2236A Hole for Center Collar Nut Threaded that ties Lattice plates and flat cap together, which center slot with panel can act as a lifting device
2239A Offsetting mortar placement of Lattice Bags or structures to promote weight load distributions which avoid crushing the MDM and if made of conductive material or laminate mortar offset patterns can enable heating
2242A Sixth inner ring of repeatable inscribed Lattice Bags or structures that are variation of a keystone shape as seen in FIG. 130 253

FIG. 22B

2203B Outer ring of permeable or perforated material Lattice Bags, which can be rigid Bags, or semi-rigid Bags with inserted internal supports within the Lattice Bags.
2206B Sixth ring of Lattice Bags or structure for repeatable inscribed placement
2209B Fifth ring of Lattice Bags or structure for repeatable inscribed placement
2212B Bottom Plate as described in 2230A

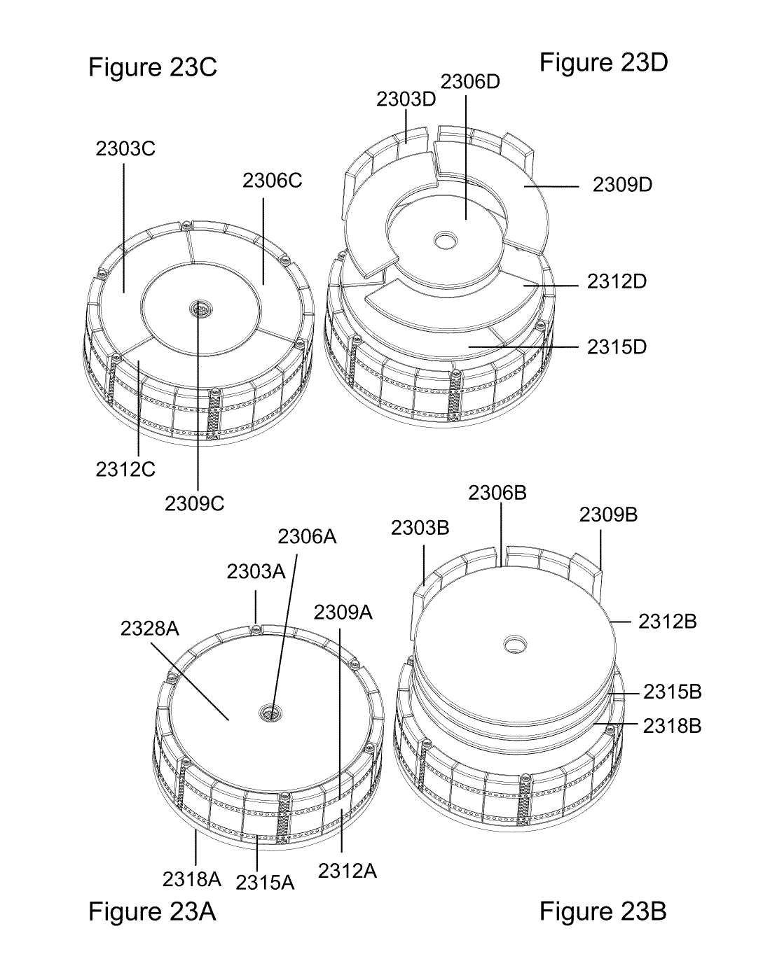

FIG. 23A

2303A One of six Outer Structural Perforated Side Tubes whose placement transfers loads from the Bags. Tubes have machined or cut circulation voids whose weight-reducing side holes promotes adsorption via its voids. Structure if made from conductive material may through transfer enable heating the Cartridge.
2306A Center Orifice that is threaded and may be perforated to enhance adsorption and/or save weight. It is also structural to transfer weight loads from the Bags back into the plates and bands, and may be made of a conductive metal to convey heat to promote release of adsorbed constituent from MDM.
2309A Top Outer Structural Perforated Side Band that has machined circulation and weight-reducing side holes to promote adsorption via its voids. Structure if made from conductive material may through transfer enable heating the Cartridge. Structural bands hold the Lattice Cartridge assembly together, that tie together with the external structural and circulation tubes to transfer compression loads from the Bags to the outer structural Bags.
2312A Irregular Repeatable Shaped Keystone Lattice Bags or Structures that fill the outside perimeter of the structure enabling more MDM material near the circumferential edge of the Vessel, thus allowing maximum volume of adsorption by the total volume of deployed material toward the outer diameter of the Vessel structure
2315A Bottom Outer Structural Perforated Side Band that has machined circulation and weight-reducing side holes to promote adsorption via its voids. Structure if made from conductive material may through transfer enable heating the Cartridge. Structural bands hold the Lattice Cartridge assembly together, that tie together with the external structural and circulation tubes to transfer compression loads from the Bags to the outer structural Bags.
2318A Bottom plate of Lattice Cartridge assembly, which handles load transfers and is perforated for less weight and circulation and can act as a heat conduit for heating adsorbed MDM
2328A Cylinder shaped pancake Lattice Bag or structure that can be manufactured via SMC or formed Bag

FIG. 23B

2303B An elevated view of irregularly-shaped Keystone Lattice Bags or Structures that fill the outside perimeter of the structure enabling more MDM material near the circumferential edge of the Vessel, thus allowing maximum volume of adsorption by the total volume of deployed material toward the outer diameter of the Vessel structure
2306B Space below elevation populated by FIG. 23A 2303A
2309B Top view of irregularly-shaped Keystone Lattice Bags or Structures
2312B Top view of one of four previously described in FIG. 23A 2328A
2315B View of two of four previously described in FIG. 23A 2328A
2318B Top view of three or four previously described in FIG. 23A 2328A

FIG. 23C

### 2303C Segmented SMC Lattice Bag

### 2306C Segmented SMC Lattice Bag

2309C Center Orifice that is threaded and may be perforated to enhance adsorption and/or save weight. It is also structural to transfer weight loads from the Bags back into the plates and bands, and may be made of a conductive metal to convey heat to promote release of adsorbed constituent from MDM

### 2312C Segmented SMC Lattice Bag

FIG. 23D

2303D Irregular Repeatable Shaped Keystone Lattice Bags or Structures that fill the outside perimeter of the structure enabling more MDM material near the circumferential edge of the Vessel, thus allowing maximum volume of adsorption by the total volume of deployed material toward the outer diameter of the Vessel structure

### 2306D Circular Platter SMC Lattice Bag

### 2309D Segmented Circular Platter SMC Lattice Bag

### 2312D Segmented Circular Platter SMC Lattice Bag

### 2315D Segmented Circular Platter SMC Lattice Bag

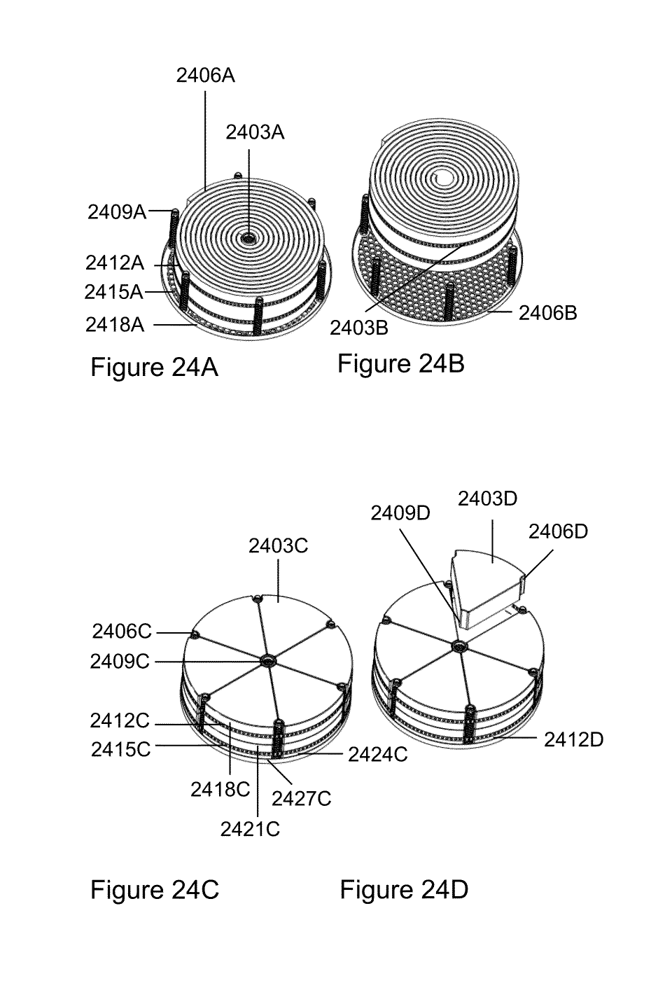

FIG. 24A

2403A Center orifice of Lattice assembly
Hole for Center Collar Nut Threaded that ties Lattice plates and flat cap together, which center slot with panel can act as a lifting device
2406A Spiral Lattice Bag of MDM or SMC Lattice Bag of MDM that may be perforated and/or temporarily sealed with soluble coating
2409A One of six Outer Structural Perforated Side Tubes whose placement transfers loads from the Bags. Tubes have machined or cut circulation voids whose weight-reducing side holes promotes adsorption via its voids. Structure if made from conductive material may through transfer enable heating the Cartridge.
2412A Outer Structural Perforated Side Bands that have machined circulation and weight reducing side holes. Band promotes adsorption via voids. Structure if made from conductive material may through transfer enable heating the Cartridge. Structural bands hold the Lattice Cartridge assembly together, which tie together with the external structural and circulation tubes to transfer compression loads from the Bags to the outer structural Bags
2415A Bottom Plate Perforation Holes to promote adsorption and circulation. Voids whose weight-reducing side holes promote adsorption via voids
2418A Bottom Plate of Cartridge Lattice assembly with a lip structure. If made from conductive material may through transfer enable heating the Cartridge.

FIG. 24B

2403B Elevated view of 2406A
2406B Bottom Plate of Cartridge Lattice assembly with a lip structure. Structure if made from conductive material may through transfer enable heating the Cartridge. Bottom Plate Perforation Holes to promote adsorption and circulation. Voids whose weight-reducing side holes promotes adsorption

FIG. 24C

2403C A Pie Section Lattice that is part of a Cartridge assembly
2406C One of six Outer Structural Perforated Side Tubes whose placement transfers loads from the Bags. Tubes have machined or cut circulation voids whose weight-reducing side holes promotes adsorption via voids. Structure if made from conductive material may through transfer enable heating the Cartridge.
2409C Hole for Center Collar Nut Threaded that ties Lattice plates and flat cap together, which center slot with panel can act as a lifting device
2412C Upper Outer Structural Perforated Side Bands that have machined circulation and weight-reducing side holes. Bands promotes adsorption via voids. Structure if made from conductive material may through transfer enable heating the Cartridge. Structural bands hold the Lattice Cartridge assembly together, which tie together with the external structural and circulation tubes to transfer compression loads from the Bags to the outer structural Bags.
2415C Bottom Outer Structural Perforated Side Bands that have machined circulation and weight-reducing side holes. Bands promotes adsorption via voids. Structure if made from conductive material may through transfer enable heating the Cartridge. Structural bands hold the Lattice Cartridge assembly together, which tie together with the external structural and circulation tubes to transfer compression loads from the Bags to the outer structural Bags.
2418C Another Top Layer of Pie Section Lattice that is part of a Cartridge assembly—one of six on this layer
2421C Lower Lattice assembly Row indicating a Pie Section Lattice that is part of a Cartridge assembly
2424C Bottom Plate Perforation Holes to promote adsorption and circulation. Voids whose weight-reducing side holes promote adsorption via voids
2427C Bottom Plate of Cartridge Lattice assembly with a lip. Structure if made from conductive material may through transfer enable heating the Cartridge

FIG. 24D

2403D An elevated Pie Section Lattice on the top row, one of six pies in that row, which is part of a Cartridge assembly
2406D Indention Inset of formed Pie Section Lattice that fits into its male counterpart in FIG. 24C 2406C
2409D Indention Inset of formed Pie Tip Section Lattice that fits into its male counterpart in FIG. 24C 2409C
2412D Bottom Plate of Cartridge Lattice assembly with a lip. Structure if made from conductive material may through transfer enable heating the Cartridge

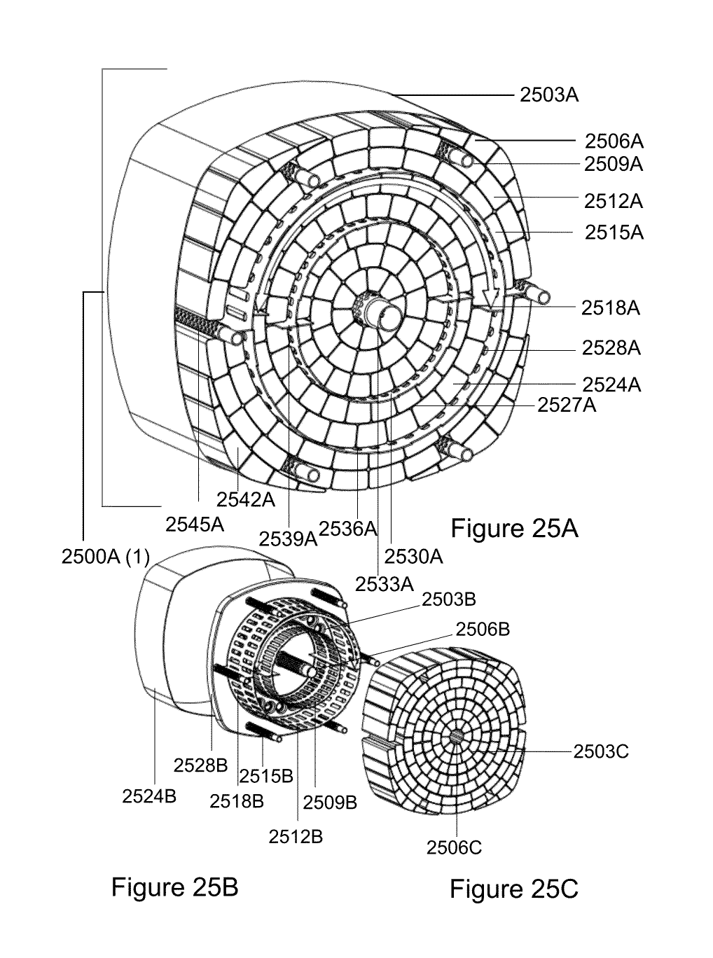

FIG. 25A

2500A (1) A complete assembly of a composite and/or hybrid with non-composite components
2503A Corrosion resistant aluminum or fabric sleeve or liner to facilitate loading, made of polyamide or aramid or composite blend via molding or sewn/woven liner. If MDM needs to be heated, could be made of conductive metal such as corrosion-resistant aluminum Could be striped or fully coated on one or both sides with Teflon or titanium or other element to reduce loading friction, act as a vibration isolator, and improve fit between the Cartridge and tank walls of the Cartridge
2506A Irregular shaped Lattice Bags or structures
2509A Outer Structural Perforated Side Tubes whose placement transfers loads from the Bags. Tubes have machined circulation and weight-reducing side holes that promotes adsorption via voids. Structure if made from conductive material may through transfer enable heating the Cartridge.
2512A Non Standard Flattened Keystone shaped Lattice Bags or structures
2515A Non Standard Flattened Keystone shaped Lattice Bags or structures
2518A Horizontal Protrusion that connects to Slot in Top Plate
2521A Outer Ring transfers Lattice Bag loads to the top and bottom plate to avoid crushing Lattice Bags and MDM material. Also stiffens the Bottom Plate and if made from a heat conductive metal can act as a heat conduit
2524A Last Ring of Standard Reproducible Inscribed Keystone Lattice assembly
2527A Mortar placement of offsetting Lattice Bags or Structures, to transfer loads, and heat
2530A Inner ring transfers Lattice Bag loads to the top and bottom plate to avoid crushing Lattice Bags and MDM material. Also stiffens the Bottom Plate and if made from a heat conductive metal can act as a heat conduit
2533A Center Orifice of Lattice assembly and Cartridge Structural Tube that is perforated to eliminate weight and allow gas or liquid circulation whose end is threaded to fit lifting fixture
2536A Protrusion to tie Top Plate to assembly
2539A Horizontal Protrusion that connects to Slot in Top Plate which transfers load onto it, keeping it off the Bags below this plate
2542A Irregular shaped Lattice Bags or structures
2545A Outer Structural Perforated Side Tubes whose placement transfers loads from the Bags. Tubes have machined circulation and weight-reducing side holes that promotes adsorption via voids. Structure if made from conductive material may through transfer enable heating the Cartridge.

FIG. 25B

2503B Hexagon Shaped Holes in Bottom Plate of Lattice Cartridge assembly. Promotes circulation while reducing weight
2506B Center Orifice of Lattice assembly and Cartridge Structural Tube that is perforated to eliminate weight and allow gas or liquid circulation. End is threaded to fit lifting fixture.
2509B Inner Ring. Transfers Lattice Bag loads to the Top and Bottom Plate to avoid crushing Lattice Bags and MDM material. Also stiffens the Bottom Plate, and can act as a heat conduit.
2512B Outer Ring. Transfers Lattice Bag loads to the top and bottom plate to avoid crushing Lattice Bags and MDM material. Also stiffens the Bottom Plate and if made from a heat conductive metal can act as a heat conduit.
2515B Outer Structural Perforated Side Tubes whose placement transfers loads from the Bags. Tubes have machined circulation and weight-reducing side holes that promotes adsorption via voids. Structure if made from conductive material may through transfer enable heating the Cartridge.
2518B Oblong Holes in structural load bands of Lattice Cartridge assembly to promote circulation of flow adsorbed constituent(s) and reduce weight
2524B Composite base plate for Cartridge and Lattice assembly
2528B Corrosion resistant aluminum or fabric sleeve or liner to facilitate loading, As shown it is made of polyamide or aramid or composite blend via molding or sewn/woven liner. If MDM needs to be heated could be made of conductive metal such as corrosion-resistant aluminum Could be striped or fully coated on one or both sides with Teflon or titanium or other element to reduce loading friction, act as a vibration isolator, and improve fit between the Cartridge and tank walls of the Cartridge.

FIG. 25C

2503C Outer ring of standard repeatable Lattice Bags or structures
2506C Center orifice of Lattice Bags or Structures

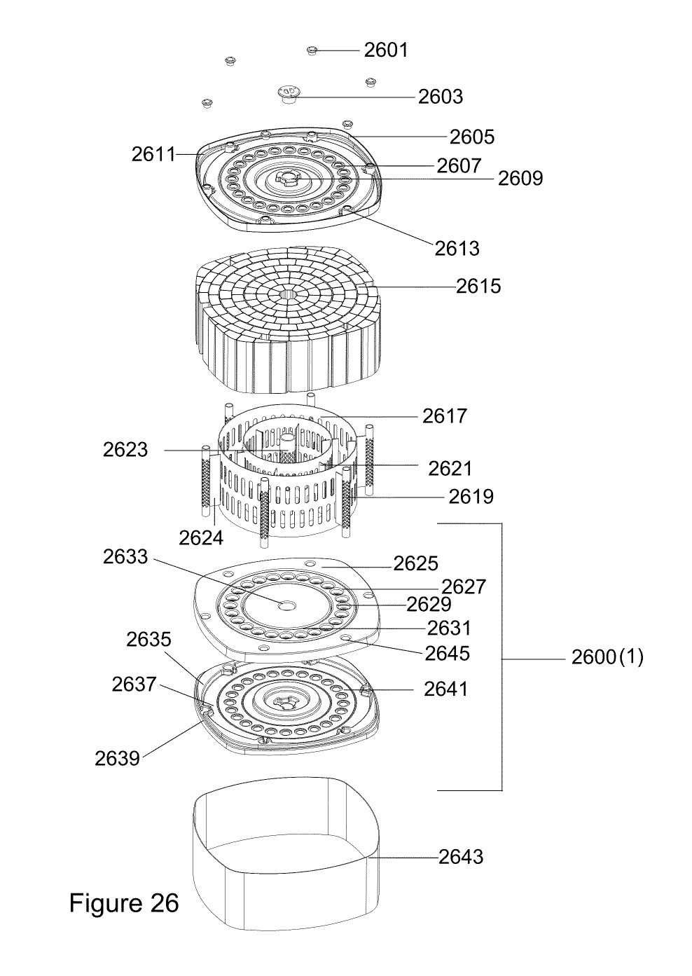

FIG. 26

2600 (1) Two Piece Top and Bottom Bonded Plate assembly

### 2601 Nut for 2619

2603 Center lifting fixture and assembly closure
2605 Upper lifting plate assembly. Bonded assembly of 2625 and 2639 and if inverted it becomes the lower lifting plate
2607 Composite structure with holes that enable gas adsorption circulation, that add strength from the creation of a box section via bond flange that is married to 2611.
2609 Center Orifice of Lattice assembly and Cartridge that fixture 2603 rests within
2611 Composite structure part of the composite box structure
2613 Bottom Orifice for 2619 to fit through and 2601 to affix and seal Cartridge assembly
2615 Pillowed Lattice assembly
2617 Composite structural rib members. In a vertical position (as shown), reduce racking and distribute the lifting loads from the center support tube. In a horizontal position, reduce the compression loads on the bottommost MDM Bags by transferring the vertical loads to the top and bottom plates. High material compression will damage the MDM material and Bags.
2619 Composite side tubes with machined ventilation and weight-reducing side holes
2621 Composite structural members. In a vertical position (as shown), reduce racking and distribute the lifting loads from the center support tube. In a horizontal position, reduce the compression loads on the bottommost MDM Bags by transferring the vertical loads to the top and bottom plates. High material compression will damage the MDM material and Bags.
2623 Composite center lifting tube
2624 One of twelve composite structural rib members which tie into 2617 and 2623
2625 Top component of the lifting plate assembly
2627 Mating bond joint groove for 2619
2629 Mating bond joint and thru hole for 2641
2631 Mating bond joint groove for 2621
2631 A Bond flange for 2641 (inner surface)
2633 Mating bond joint hole for 2623
2635 Mating bond joint groove for 2625
2637 Mating bond joint groove for 2625
2639 Bottom component of the lifting plate assembly
2641 Mating bond joint and thru hole for 2629A (outer surface)
2643 Fabric sleeve or liner to facilitate loading, and protection, made of polyamide or aramid or composite blend via molding or sewn or woven Liner. If MDM needs to be heated could be made of conductive metal such as corrosion-resistant aluminum Could be striped or fully coated on one or both sides with Teflon or titanium or other element to reduce loading friction, act as a vibration isolator, and improve fit between the Cartridge and tank walls of the Cartridge.
2645 Orifice for 2619 to fit through and 2601 to affix and seal Cartridge assembly

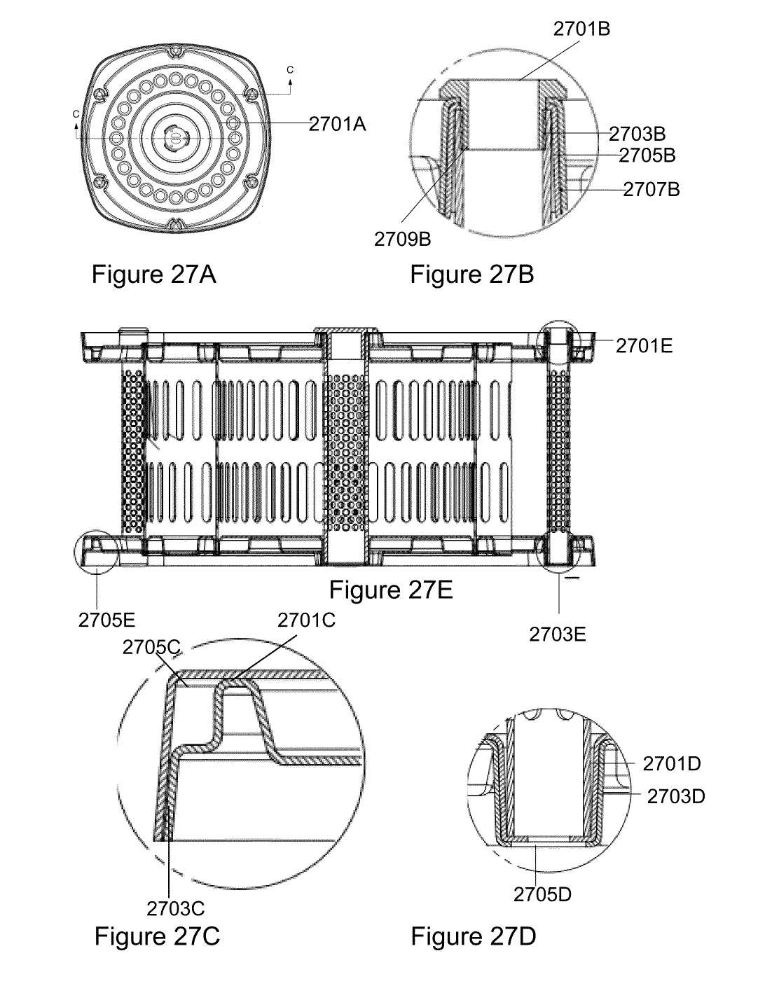

FIG. 27A

2701A Composited Outer Plate piece bonded composite assembly

FIG. 27B

### 2701B Threaded Locking Cap

2703B Perimeter Support Tubes that Thread to 2705E
2705B The Skins touching create a bond joint with an adhesive
2707B The Skins touching create a bond joint with an adhesive
2709B The Skins touching create a bond joint with an adhesive

FIG. 27C

2701C Wherever the skins touch is a bond joint for an adhesive
2703C The skins touching create a bond joint with an adhesive
2705C Open area in open left area creates a circular box beam section

FIG. 27D

2701D The Skins touching create a Bond joint with an adhesive
2703D The Skins touching create a Bond joint with an adhesive
2705D Perimeter Support Tubes that Thread to 2703E Threaded Locking Cap

FIG. 27E

2701E Joint of a structural tube bonded to the Cartridge plate. The Skins touching create a Bond joint with an adhesive
2703E Cartridge Plate Bond Joint where the skins touch it is a bond joint for an adhesive.
2705E Joint of a structural tube bonded to the bottom Cartridge plate. Perimeter Support Tubes that thread to 2707E Threaded Locking Cap

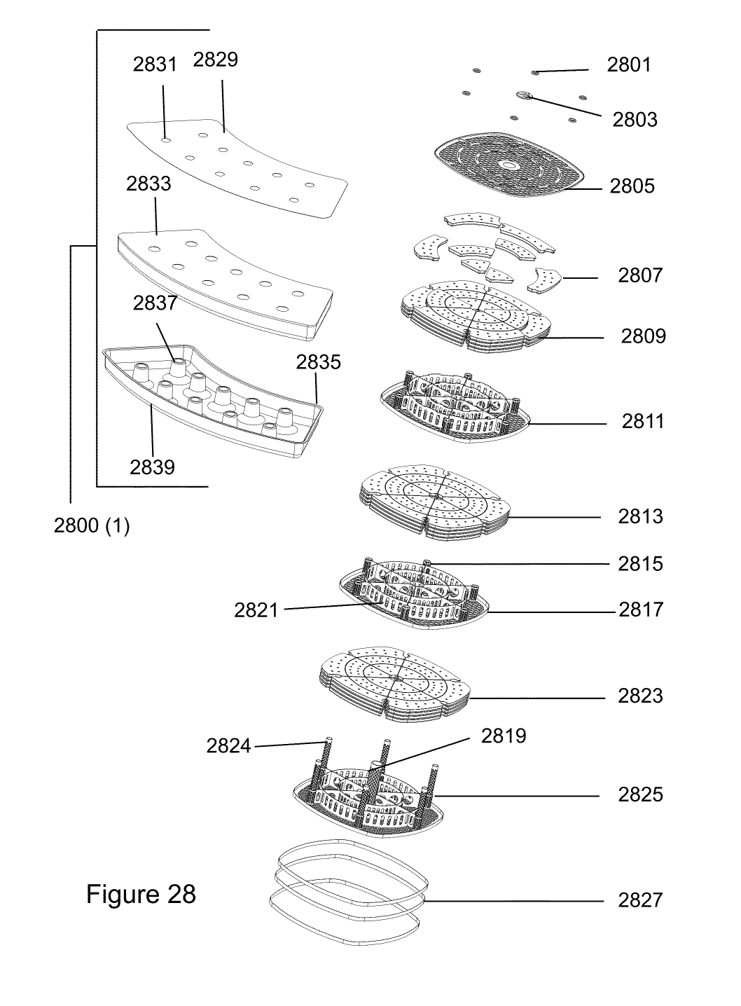

FIG. 28

2800 (1) Single Lattice assembly Bag of 2829, 2831, 2833, 2835, 2837, and 2839

### 2801 Column Post Threaded Nuts

2803 Center Collar Nut Threaded that ties Lattice plates and flat cap together, which center slot with panel can act as a lifting device

### 2805 Top Plate

### 2807 Lattice Trays Exploded

### 2809 Lattice Trays Assembled

2811 Cartridge Plate and structural load components
2813 Lattice Trays. Assembled of varying shapes including 2800 (1)
2815 Outer Structural Perforated Spacers whose placement transfers loads from the Bags and tubes. Have machined circulation and weight-reducing side holes. Promotes adsorption via its voids. Structure if made from conductive material may through transfer enable heating the Cartridge.
2817 Bottom plate of Lattice Cartridge assembly which handles load transfers and is perforated for less weight and circulation and if made of thermal conductive material can act as a heat conduit for heating adsorbed MDM
2819 Center Structural Orifice that is threaded and may be perforated to enhance adsorption and save weight. It is also structural to transfer weight loads from the Bags back into the plates and bands, and may be made of a conductive metal to convey heat to promote release of adsorbed constituent from MDM.
2821 Structural ribs. In a vertical position (as shown), reduce racking and distribute the lifting loads from the center support tube. In a horizontal position, reduce the compression loads on the bottom most MDM Bags by transferring the vertical loads to the top and bottom plates. High material compression will damage the MDM material and Bags.

### 2823 Lattice Trays Assembled

2824 Columnar Tube that allows 2815 to slip on top of its OD

### 2825 Base Plate

2827 Cartridge assembly Bands

### 2829 Top Plate of Tray

### 2831 Perforations

### 2833 MDM

### 2835 Edge of Tray Lip

2837 Structural Nipple that can be perforated to enhance adsorption
2839 Bottom of vacuum formed tray

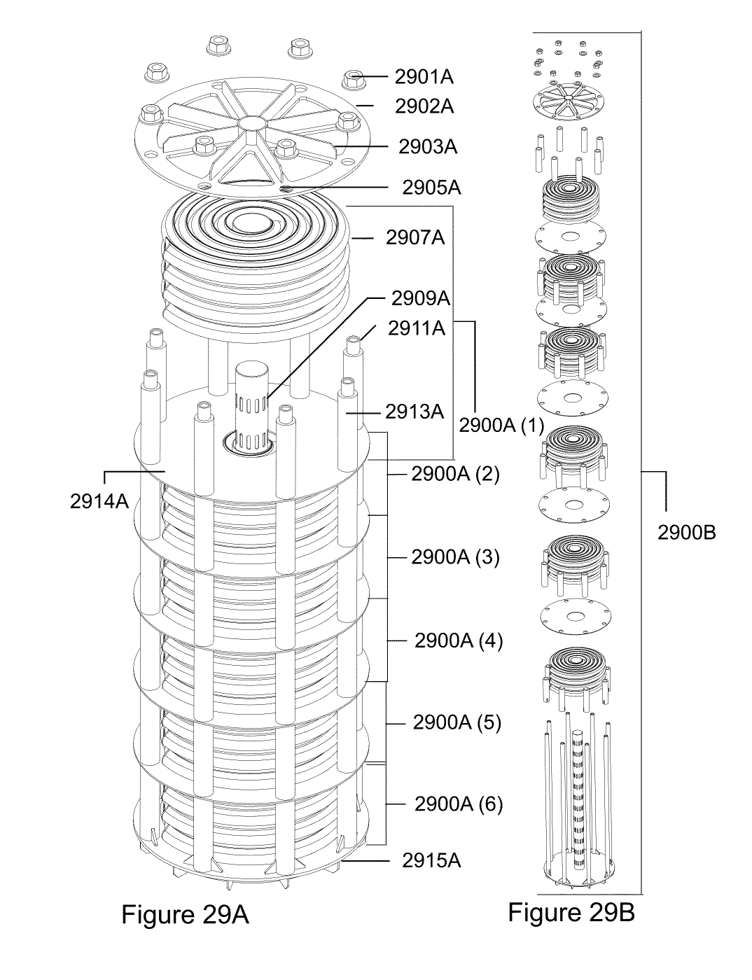

FIG. 29A

2900A (1) One of six Cartridge assembly with Semi-rigid Lattice Bags
2900A (2) Two of six Cartridge assembly with Semi-rigid Lattice Bags
2900A (3) Three of six Cartridge assembly with Semi-rigid Lattice Bags
2900A (4) Four of six Cartridge assembly with Semi-rigid Lattice Bags
2900A (5) Five of six Cartridge assembly with Semi-rigid Lattice Bags
2900A (6) Six of six Cartridge assembly with Semi-rigid Lattice Bags

### 2901A Locking Fixture

2902A Top plate with circulation orifices that also allow for less weight
2903A Rib for Cartridge stability and load transfers

### 2905A Orifice for 2911A

2907A Semi-rigid Lattice Bag loaded with MDM which has been optionally laminated with a soluble coating to cover micro-perforations
2909A Center Orifice Tube of Cartridge assembly with voids that enable circulation and can house a pump
2911A Base Rod that 2913A fits on top
2913A Reinforcement Structural Tube Cap which can optionally may have perforations which are formed via cutting or slitting, cad knife or with methods such as a laser or water jet
2914A Floor Plate (another name for a Bottom Plate)
2915A Bottom Support Plate for Cartridge that has ribs that interconnect and enable load transfers from columns to plates

FIG. 29B

2900B An exploded view of the skyscraper Cartridge

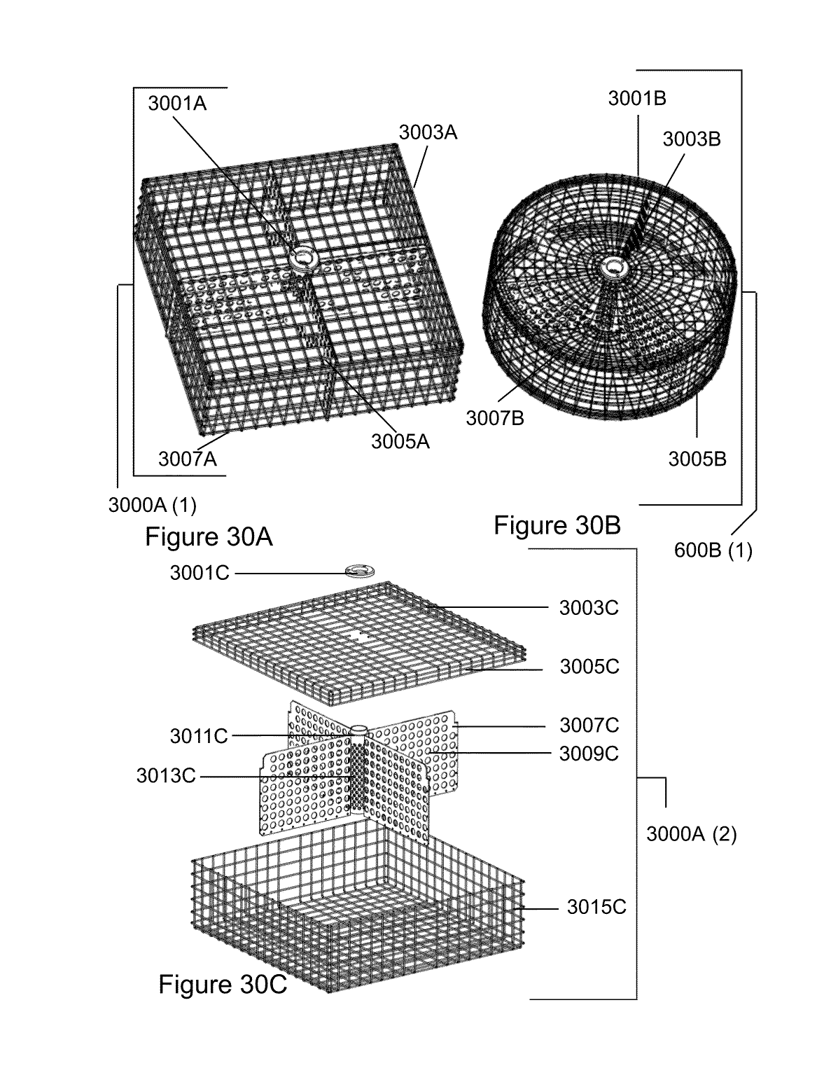

FIG. 30A

3000A (1) Wire Frame cage in the shape of a square assembled
3001A Center Collar Nut Threaded that ties Cartridge plates and flat cap together, which center slot with panel can act as a lifting device
3003A Top Plate with Lip Flange of Wire Frame Cartridge that has voids to promote adsorption and eliminate weight of plate. Plate can be made of heat conductive metal or alloy to promote release of adsorbed constituents
3005A Circulation voids in the shape of a square grid whose holes promote adsorption
3007A Structural Wire that forms the Cartridge Frame

FIG. 30B

600B (1) Assembled Circular Wire Frame cage Cartridge
3001B Top Plate with Lip Flange of Interlaced Spoke Wire Frame Cartridge that has voids to promote adsorption and reduce weight of plate. Plate can be made of heat conductive metal or alloy to promote release of adsorbed constituents. Top Plate has circulation voids in the shape of inscribed circles with cross wire reinforcements whose holes promote adsorption.
3003B Center Collar Nut Threaded that ties Lattice plates and flat cap together, which center slot with panel can act as a lifting device
3005B Base of Cylindrical Wire cage
3007B Center Structural Orifice that is threaded and may be perforated to enhance adsorption and save weight. It is also structural to transfer weight loads from the Bags back into the plates and bands, and may be made of a conductive metal to convey heat to promote release of adsorbed constituent from MDM.

FIG. 30C

3000A (2) assembly of 3001C, 3003C, 3005C, 3007C, 3009C, 3011C, 3013C, 3015C
3001C Center Collar Nut Threaded that ties Lattice plates and flat cap together, which center slot with panel can act as a lifting device
3003C Top Plate with Lip Flange of Wire Frame Cartridge that has voids to promote adsorption and reduce weight of plate. Plate can be made of heat conductive metal or alloy to promote release of adsorbed constituents.
3005C Lip of Top Plate of Wire Frame Cartridge which by its interlocking formations have circulation voids in the shape of a square or rectangular grid, whose holes promotes adsorption and/or circulation.

### 3007C Locking Inset Feature of Structural Load Transfer Wing

3009C Voids in the shape of a circle, which could be of any shape in FIG. 130, to reduce weight and promote adsorption and/or circulation
3011C Top of Structural Post that enables Center Collar Nut Threaded that ties Lattice plates and flat cap together, which center slot with panel can act as a lifting device
3013C Center Structural Orifice that is threaded and may be perforated to enhance adsorption and save weight. It is also structural to transfer weight loads from the Bags back into the plates and bands, and may be made of a conductive metal to convey heat to promote release of adsorbed constituent from MDM.
3015C Bottom base of Square Wire Cage which by its interlocking formations has circulation voids in the shape of a square or rectangular grid, whose holes promotes adsorption and/or circulation

FIG. 31A

3100A Molded heating plate and Lattice which could be made via die cast or lost wax/sand cast and could be made from materials such as Al, Al composite, or aramids
3105A Grid to hold MDM
3110A Side of Grid and Heating Plate assembly

### 3115A Center Orifice

3120A Orifice for heating fluid

FIG. 31B

3105B assembly of 3115B and 3135B
3110B Orifice for structural support
3115B Upper Plate of heating fluid channel assembly which is joined with 3135B via methods such as welding or bonding
3120B Voids to permit gas flow through heated plate and promote release of adsorbed materials
3125B Center Orifice that would marry to a Cartridge support tube

### 3131B Heating Fluid Channel

3132B Top half of heating fluid channel to orifice flange
3135B Lower Plate of heating fluid channel assembly
3140B Bottom half of heating fluid channel to orifice flange
3141B The tubular passageway is a continuous weld or bond around its inside perimeter to create the passageway.
3142B The tubular passageway is a continuous weld or bond around its outside perimeter to create the passageway.

FIG. 31C

### 3145C Orifice for 3145E

FIG. 31D

3125D Front View of heating plate and Lattice as it would appear in a horizontal Vessel
3131D Slots for one of twelve inner and outer structural perforated Side Tubes whose placement transfers loads from the Bags or grids and tubes have machined or cut circulation voids whose weight-reducing side holes promotes adsorption via its voids. Structure if made from conductive material may through transfer enable heating the Cartridge.
3135D Grid to hold MDM
3140D Center Structural Orifice that is threaded and may be perforated to enhance adsorption and/or save weight. It is also structural to transfer weight loads from the Bags back into the plates and bands, and may be made of a conductive metal to convey heat to promote release of adsorbed constituent from MDM

FIG. 31E

3145E Close-up of Orifice for heating fluid that can connect to a flange

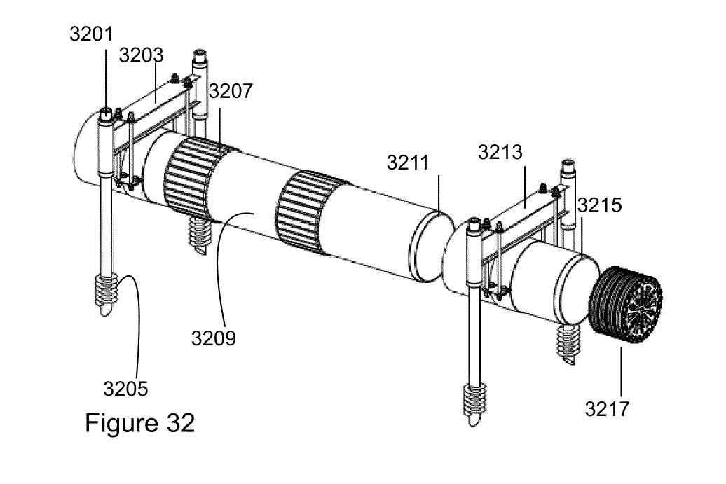

FIG. 32

3201 Post for Stability Auger assembly
3203 Cross Brace that ties Post for Stability Auger assembly

### 3205 Auger Post Threads

### 3207 Load Reinforcement Band

### 3209 Pipe

### 3211 Male Pipe End

3213 Cross Brace for Stability Auger assembly

### 3215 Pipe

3217 MDM populated Lattice Cartridge assembly

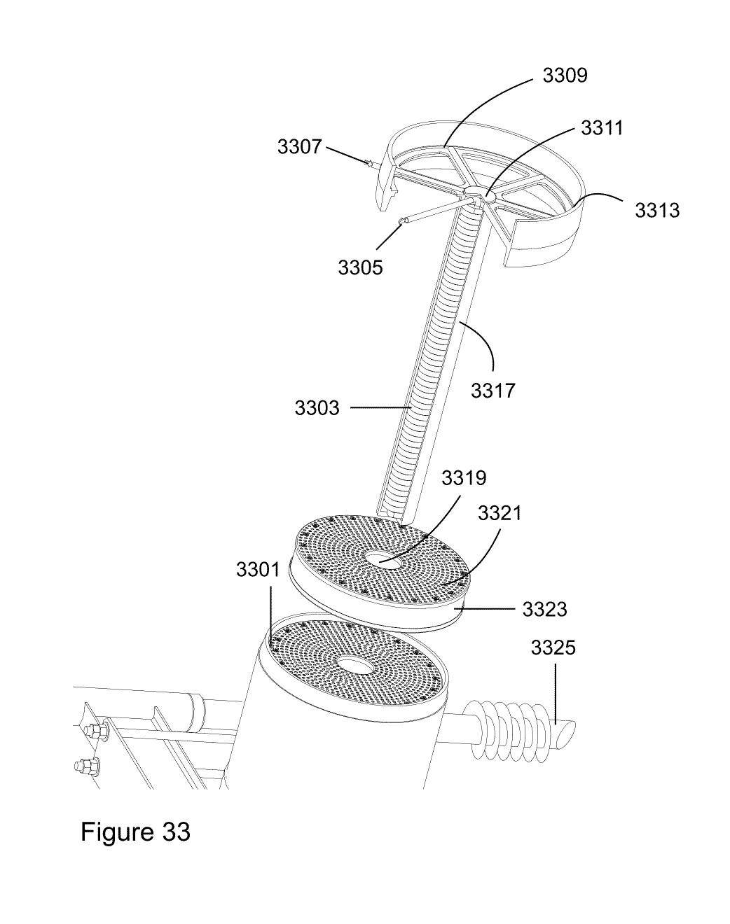

FIG. 33

3301 External Pipe or Vessel which with the support system acts as a complete assembly for load transfers
3303 Coiled heat exchanger tubing

### 3305 A Heating Oil Outlet

### 3307 A Heating Oil Inlet

3309 An End Cap of pipe coupler manifold interface between Pipes or Vessels
3311 A Pipe Coupler Manifold Center point of interface between Pipes or Vessels
3313 An external face of Pipe Coupler Manifold which also acts as heating oil element structure and seal between Vessels or joints
3317 An external sealed internal heating rail pipe
3319 A center orifice for rail coiled heat exchanger tubing
3321 A photo etched perforated front plate of assembled and populated Lattice Cartridge assembly
3323 A Side Band of an assembled and populated Lattice Cartridge assembly
3325 An Auger Stand for weight load stability

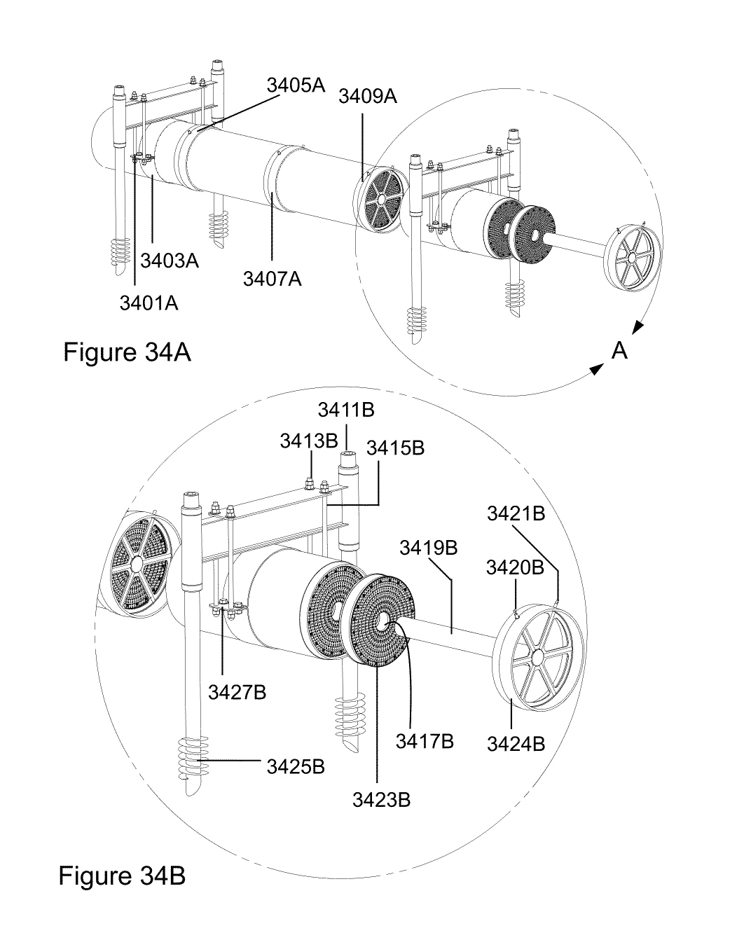

FIG. 34A

3401A Stability Rods for jacket that enables load distribution
3403A Jacket for load distribution
3405A External face of Pipe Coupler Manifold which also acts as heating oil element structure and seal between Vessels or joints
3407A External face of Pipe Coupler Manifold which also acts as heating oil element structure and seal between Vessels or joints
3409A External face of Pipe Coupler Manifold which also acts as heating oil element structure and seal between Vessels or joints

FIG. 34B

### 3411B Top of Load Distribution and Sediment Stability Auger Post

3413B Rods for Jacket for load distribution

### 3415B Auger Cross Bar for Load Distribution

3417B Center orifice for rail coiled heat exchanger tubing
3419B Rail Pipe holding coiled heat exchanger

### 3420B Heating Oil Inlet

### 3421B Heating Oil Inlet

3423B Side Band holding photo etched perforated front plate of assembled and populated Lattice Cartridge assembly
3424B Sealing Unit between Vessels and Cartridges
3425B Auger Stand for weight load stability
3427B Stability Rods for jacket that enables load distribution

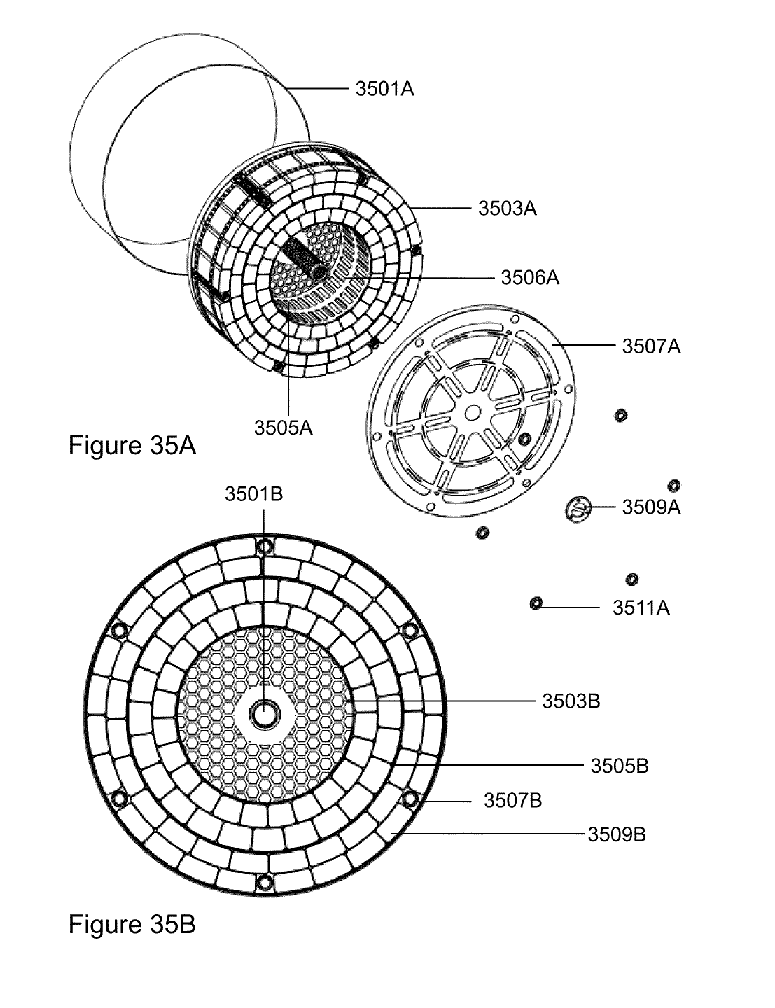

FIG. 35A

3501A A liner to facilitate loading and/or heat or heat transfer
3503A A MDM-populated Cartridge and Lattice assembly
3505A Voids for gas flow
3506A Unpopulated Lattice Bag area for gas flow post adsorption, allowing heat of new gas flow to heat and desorb MDM
3507A Top Plate of Cartridge and Lattice assembly
3509A Removable Lifting Fixture that threads to center column
3511A Nuts that fit 3507A to 3507B

FIG. 35B

### 3501B Center Column

3503B Voids for gas flow

### 3505B Structural Load Support Ribbon

### 3509B Populated MDM Lattice Bag

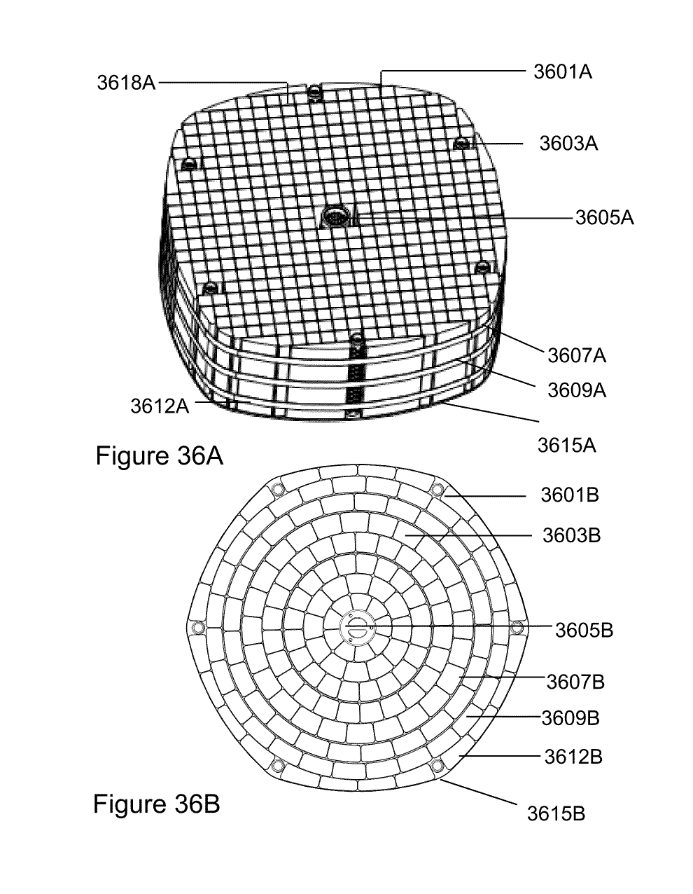

FIG. 36A

### 3601A Inscribed Rounded Rectangle

### 3603A One of six Structural Tubes

### 3605A Cartridge Center Orifice

### 3607A Load Transfer Reinforcement Belt

### 3609A Load Transfer Reinforcement Belt

### 3612A Load Transfer Reinforcement Belt

### 3615A Structural Cartridge Plate

3618A Rectangle Lattice Bags that are semi-rigid or rigid and constructed from perforated or permeable materials, some of which are triangular Bags within an irregular geometric Vessel shape. The edges of the Cartridge Lattice assembly are shaped squares and irregular shapes to fill in edges; in this case multiple Lattice insert structures are placed into the Bags creating a semi-rigid structure which enables load transfers off of the MDM creating a Lattice assembly with maximum deployment of MDM.

FIG. 36B

### 3601B Rounded Inscribed Hexagon Geometry Cartridge

3603B Repeatable Keystone Semi-rigid or Rigid Lattice Bags that are constructed from perforated or permeable materials. Lattice Bags in which the edges of the Cartridge Lattice assembly are irregular shaped squares create a Lattice assembly. In this case multiple Lattice structures or Bags are inset into a keystone Bag.
3605B Cartridge Center Orifice with lifting fixture

### 3607B A Load Transfer Reinforcement Belt

3609B Outer Load Transfer Reinforcement Belt which is the outside boundary of the repeatable standard set of inscribed Lattice Bags
3612B Irregular shaped Lattice Bag that enables maximum volume of material within Vessel out to the perimeter of the Vessel wall

### 3615B Structural Cartridge Bar

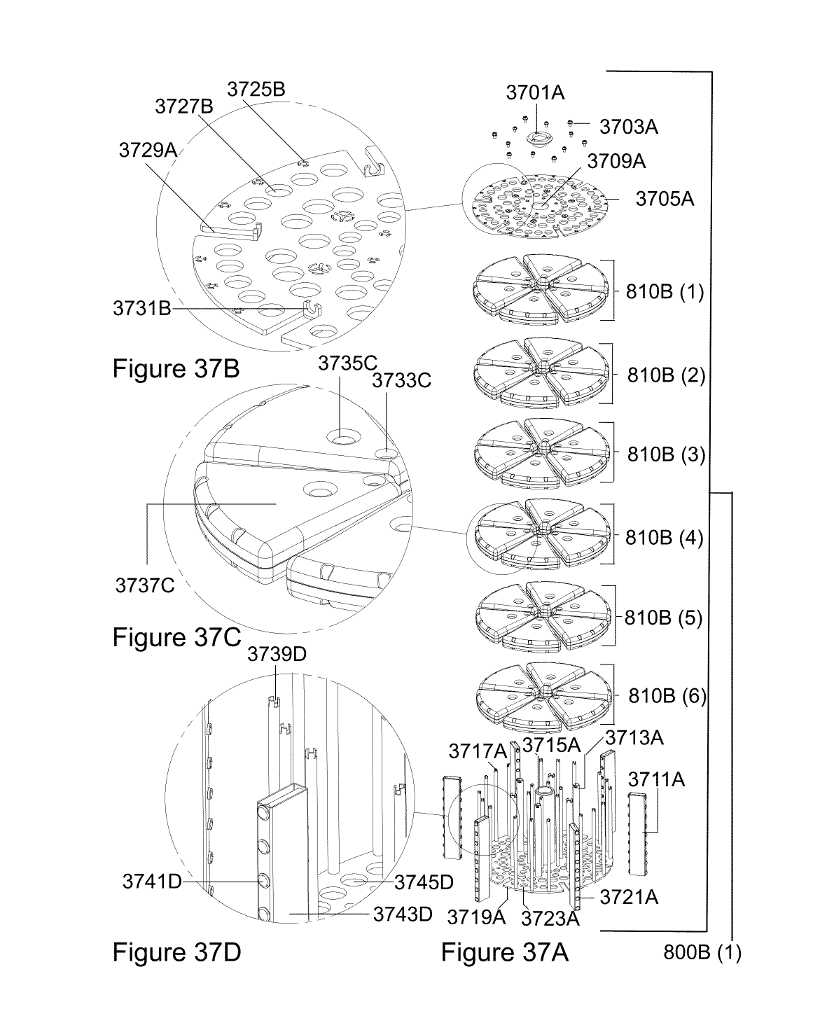

FIG. 37A

### 3701A Lifting Fixture

### 3703A Nut

### 3705A Top Plate

### 3709A Hole for Center Structural Column

### 3711A Structural Support Column

### 3713A Structural Support Column Notch

### 3715A Center Structural Support Column

### 3717A Structural Column

### 3719A Bottom Plate

### 3721A Roller

### 3723A Hole Pattern

800B (1) Exploded View of Populated Cartridge assembly
810B (1) Rigid Lattice Bag assembly, one of six
810B (2) Rigid Lattice Bag assembly, two of six
810B (3) Rigid Lattice Bag assembly, three of six
810B (4) Rigid Lattice Bag assembly, four of six
810B (5) Rigid Lattice Bag assembly, five of six
810B (6) Rigid Lattice Bag assembly, six of six

FIG. 37B

### 3725B Hole for 3739A

### 3727B Hole Pattern

### 3729A Notch for 3743A

### 3731B Right-Angle Tab

FIG. 37C

### 3733C Hole

### 3735C Hole for Structural Column

### 3737C Rigid Lattice Bag

FIG. 37D

### 3739D Structural Column

### 3741D Roller

### 3743D Structural Support Column

### 3745D Hole Pattern in Bottom Plate

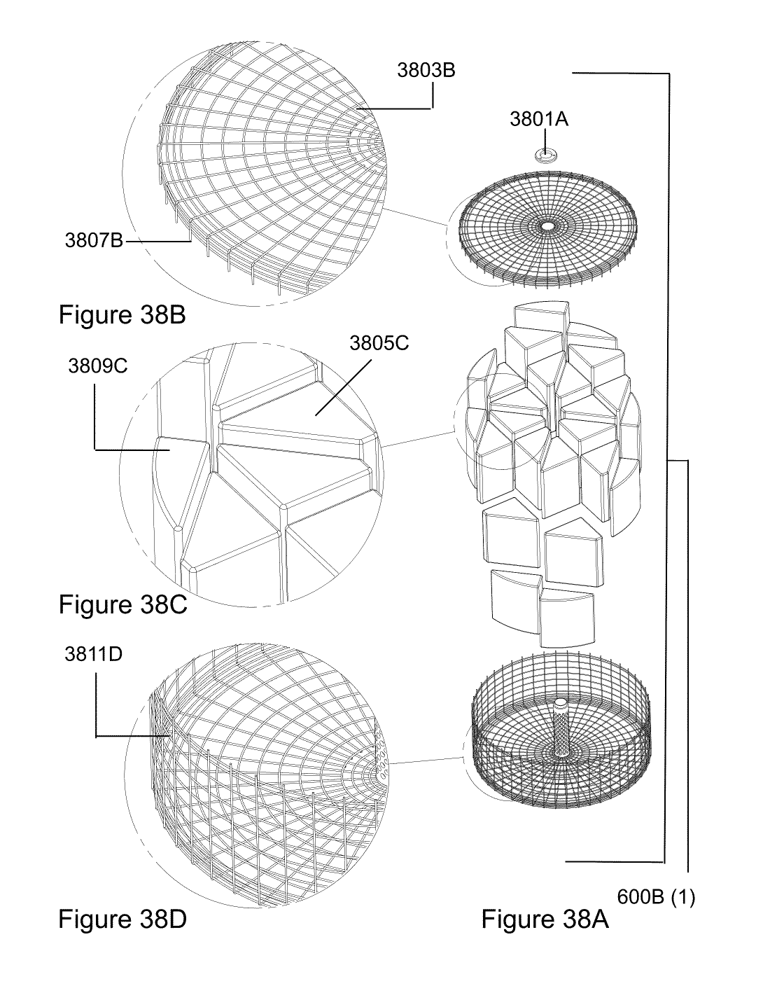

FIG. 38A

600B (1) Exploded View of Populated Cartridge assembly

### 3801A Lifting Fixture

FIG. 38B

3803B Top Plate of Cylindrical Wire cage

### 3807B Wire

FIG. 38C

3805C Semirigid Lattice Bag, one of two shapes that create Lattice assembly
3809C Semirigid Lattice Bag, one of two shapes that create Lattice assembly

FIG. 38D

3811D Base of Cylindrical Wire cage

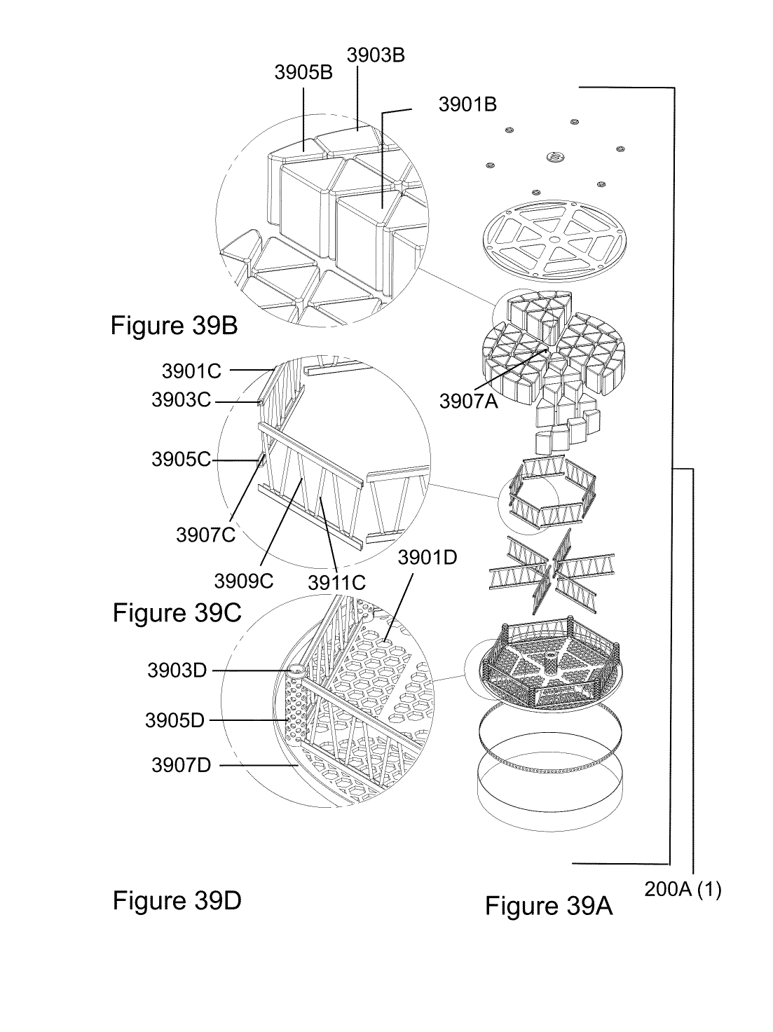

FIG. 39A

200A (1) The entire Cartridge and Lattice Bag assembly
3907A Fourth of four repeating shapes that make up the Lattice Bag assembly, in this case a truncated tip of a triangle like 3901B

FIG. 39B

3901B First of four repeating shapes that make up the Lattice Bag assembly; in this case a triangle
3903B Second of four repeating shapes that make up the Lattice Bag assembly; in this case an irregular rectangle
3905B Third of four repeating shapes that make up the Lattice Bag assembly; in this case an irregular right triangle with hypotenuse of an inscribed circle

FIG. 39C

### 3901C Linear Rib

### 3903C Support Channel for Linear Rib

### 3905C Bottom Support Channel for Linear Rib

### 3907C Hollow Feature of Support Channel

### 3909C Sinusoidal Strut

### 3911C Counterpart to 3909C

FIG. 39D

### 3901D Hexagonal Hole Pattern

3903D Structural Support Column male thread feature

### 3905D Structural Support Column

### 3907D Bottom Plate Flange

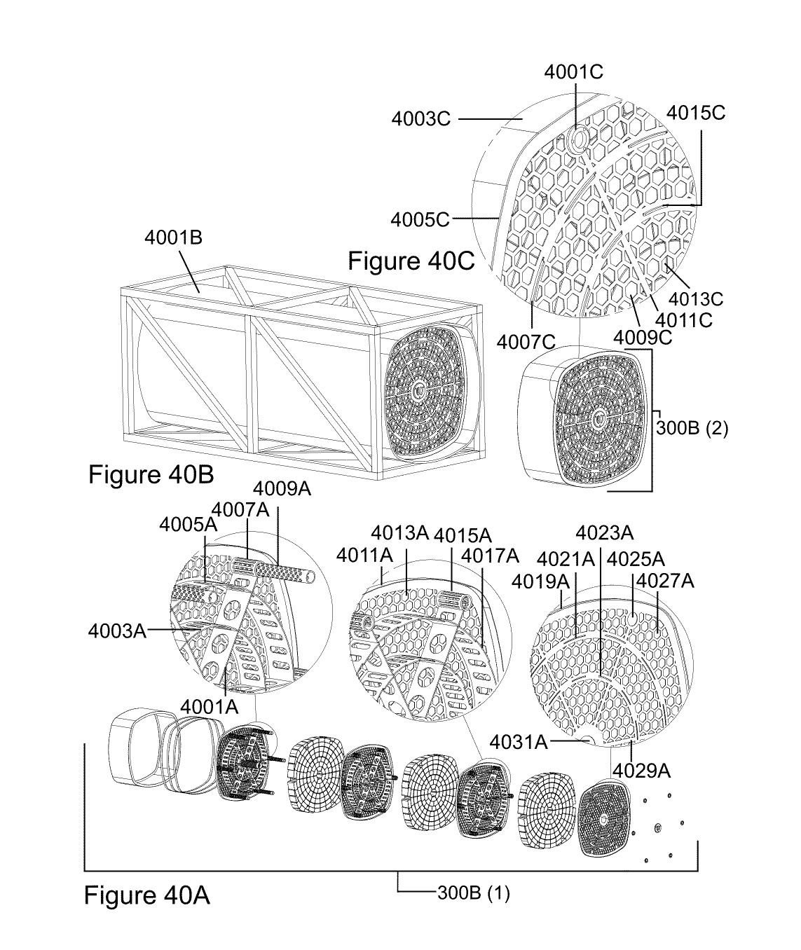

FIG. 40A

300B (1) Exploded View of populated Cartridge assembly

### 4001A Linear Rib

### 4003A Circular Rib

### 4005A Slot

### 4007A Spacer

### 4009A Structural Column

### 4011A Bottom Plate Flange

### 4013A Hexagonal Hole Pattern

### 4015A Spacer

### 4017A Circular Rib Tab

### 4019A Top Plate

### 4021A Slot

### 4023A Slot

### 4025A Hole for Structural Column

### 4027A Hexagonal Hole Pattern

### 4029A Structural Load Support Band

### 4031A Hole for Center Structural Column

FIG. 40B

### 4001B Vessel Exterior

FIG. 40C

### 4001C Nut

### 4003C Sleeve

### 4005C Flange

4007C Tab in slot

### 4009C Hexagonal Hole Pattern

### 4011C Structural Load Support Band

4013C Squircle Populated Cartridge assembly
4015C Tab in slot

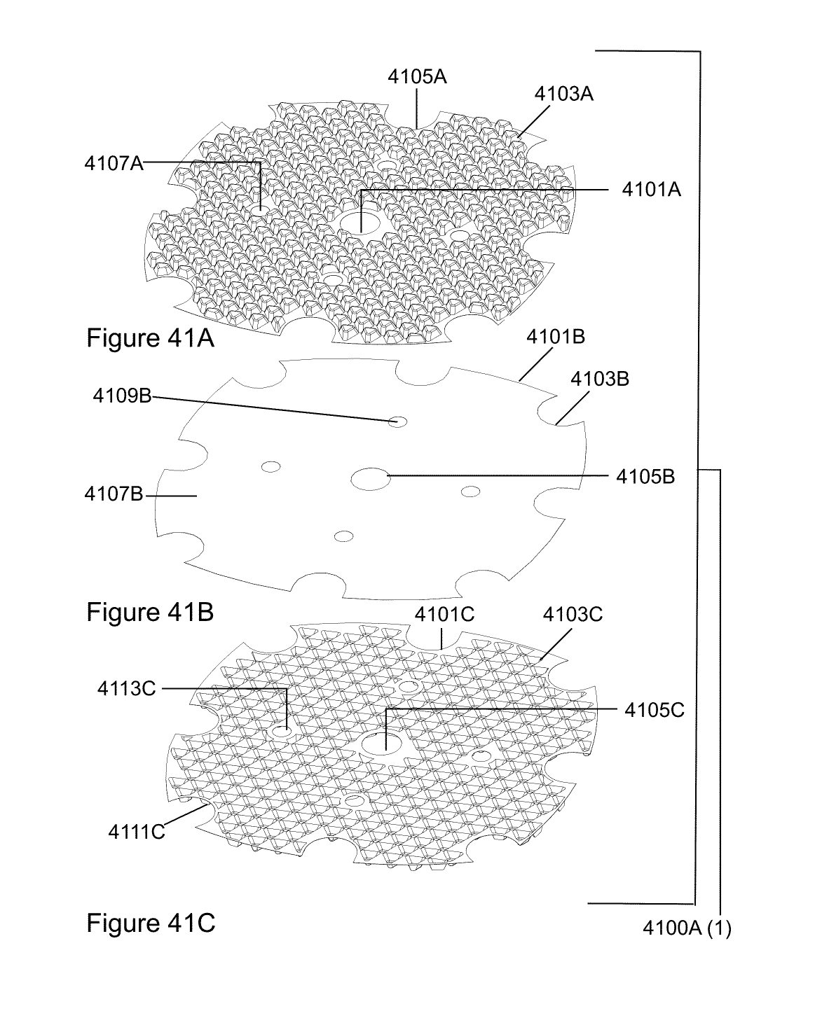

FIG. 41A

### 4100A (1) Assembly of FIG. 41A, FIG. 41B, and FIG. 41C

### 4101A Hole for Center Structural Column

### 4103A Triangular Dimple Cup

4105A Cutout for Structural Column, one of eight
4107A Hole for Structural Column, one of four

FIG. 41B

4101B Permeable or Perforated Film, edge

### 4103B Cutout for Structural Column

### 4105B Hole for Center Structural Column

4107B Perforated or Permeable Sheet. Could optionally have two permeable or perforated layers, one for each half

### 4109B Hole for Structural Column

FIG. 41C

4101C Cutout for Structural Column, one of eight

### 4103C Dimple Cup Lattice Cavity for MDM

### 4105C Hole for Center Structural Column

### 4111C Triangular Dimple Cup

### 4113C Hole for Structural Column

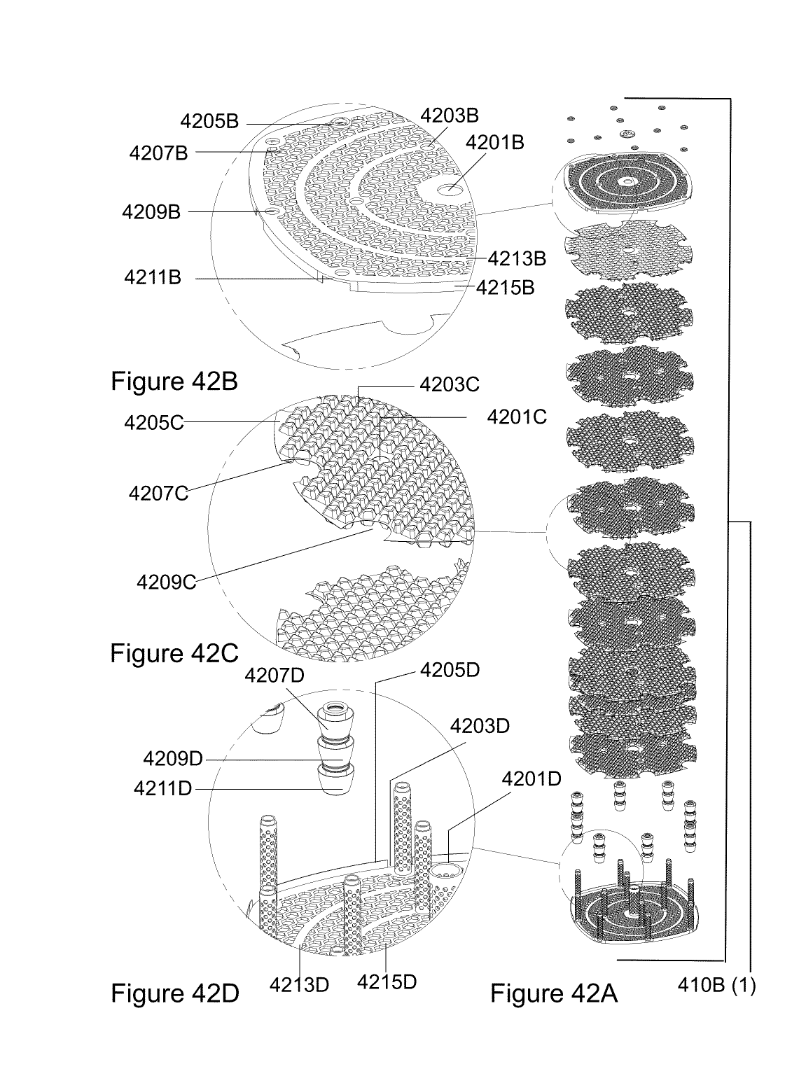

FIG. 42A

410B (1) Exploded View of Populated Sheet Formed Cartridge assembly

FIG. 42B

### 4201B Hole for Center Structural Column

### 4203B Hole for Structural Column

### 4205B Nut

### 4207B Hexagonal Hole Pattern

### 4209B Hole for Structural Column

### 4211B Notch

### 4213B Top Plate Reinforcement Ring

FIG. 42C

### 4201C Hole for Structural Column

### 4203C Triangular Dimple Cup

### 4205C Permeable or Perforated Film

### 4207C Cutout for Structural Column

### 4209C Notch

FIG. 42D

### 4201D Structural Column

### 4203D Bottom Plate

### 4205D Flange

### 4207D Shock Absorber

### 4209D Shock Absorber

### 4211D Shock Absorber

### 4213D Bottom Plate Reinforcement Ring

### 4215D Hexagonal Hole Pattern

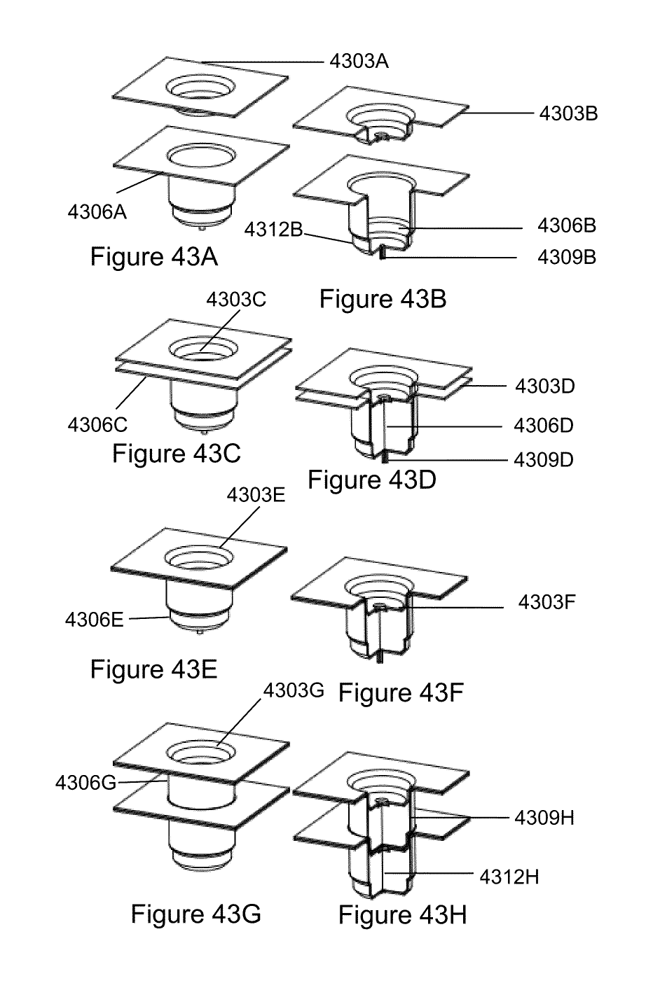

FIG. 43A

4303A Top of next nested cup
4306A Bottom first cup to be filled with MDM material

FIG. 43B

4303B Cut View of next nested Lattice Cup
4306B Cut View of the Lattice Cup drawing down
4309B Vacuum Nipple to draw down Lattice Cups

### 4312B Variable Size Compression Area

FIG. 43C

4303C Top of next nested Lattice Cup drawing down
4306C Original nested Lattice Cup drawing down

FIG. 43D

4303D Cut View of original nested Lattice Cup drawing down
4306D Cut View of original nested Lattice Cup vacuum line drawing down
4309D Cut View of vacuum nipple drawing down Lattice Cups

FIG. 43E

4303E Top of next nested Lattice Cup
4306E Bottom of base nested Lattice Cup

FIG. 43F

### 4303F Cut View of Variable Vacuum Line

FIG. 43G

4303G Next nested Lattice Cup
4306G Side of next nested Lattice Cup

FIG. 43H

4309H Cut View of side wall of next nested Lattice Cup
4312H Cut View of vacuum nipple drawing down Lattice Cup

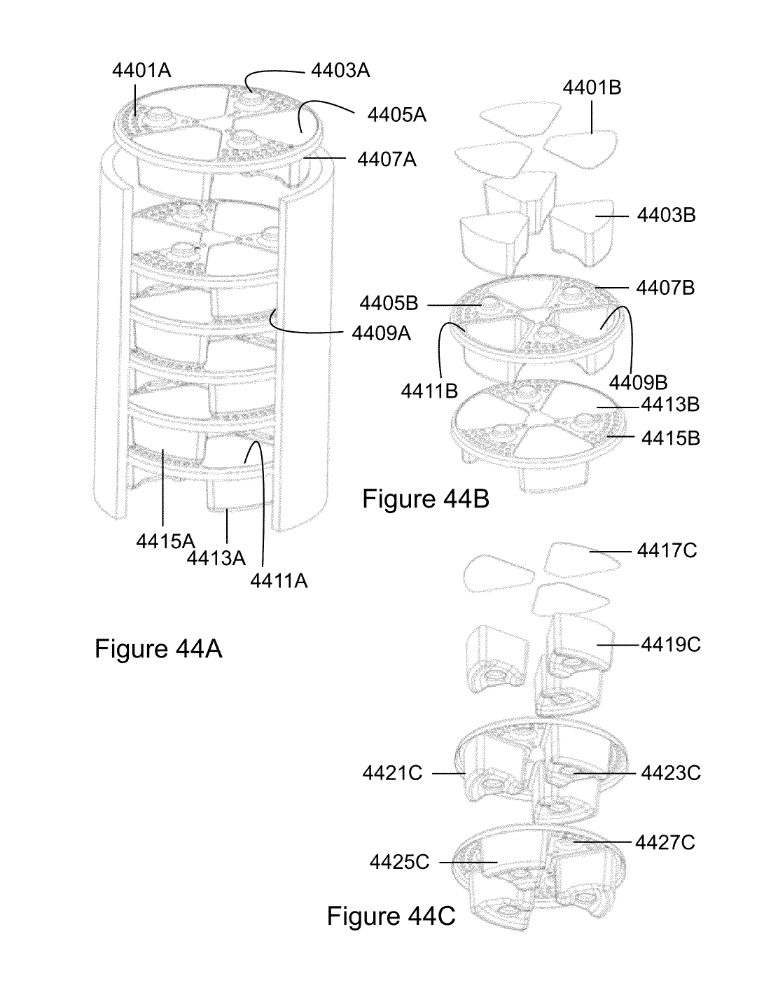

FIG. 44A

4401A Voids for Gas to pass through
4403A Alignment Orientation Lugs that interconnect the Cartridge and Lattice
4405A One of three staggered Panels or Plates such as graphene or a permeable inset panel or perforated panel inset or affixed to a rigid structure.
4407A Flange Rim for gas tight seal, which may be fitted with O-ring, glued or welded or otherwise fixed, or may be a pressure fit
4409A Inner Wall of Vessel that 4407A fits to forming a gas tight seal
4411A Graphene Plate on top of a Lattice holding adsorbent such as upsalite, zeolites or carbon
4413A Lattice for holding adsorbent such as upsalite, zeolites or carbon
4415A Staggered Lattice for holding adsorbent such as upsalite, zeolites or carbon

FIG. 44B

4401B One of three staggered graphene plates
4403B Adsorbent such as upsalite, zeolites or carbon
4405B One of three staggered Male Orientation Lugs
4407B Voids for gas to pass through
4409B Lattice Cavity for adsorbents
4411B Inner flange for 4401B to fit into with adhesive
4413B Assembled Lattice Cap with affixed graphene plates
4415B Assembled Lattice Cap with voids for gas to pass through

FIG. 44C

4417C One of three staggered graphene plates
4419C One of three staggered adsorbent such as upsalite, zeolites or carbon
4421C Alignment Orientation Lugs Cavities that interconnect the Cartridge and Lattice
4423C Female interlocking cavity for Orientation Lugs that interconnect with 4403A
4425C External back wall of Lattice Cavity
4427C Under side of one of three staggered Male Orientation Lugs

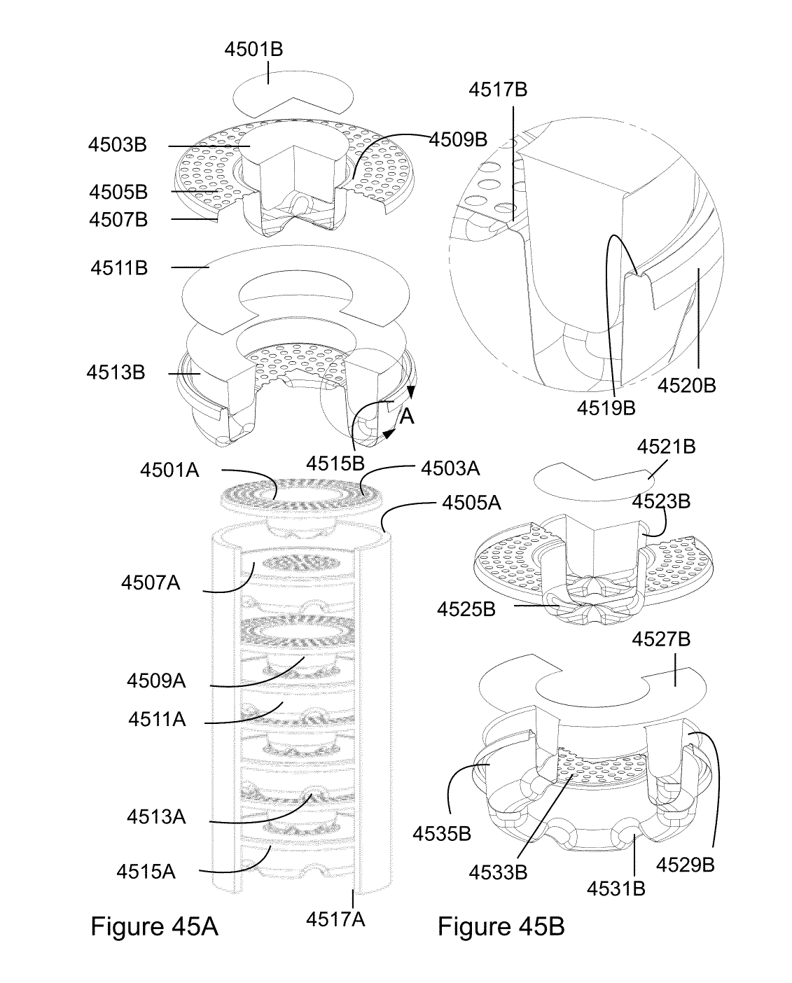

FIG. 45A

4501A Smaller graphene plate
4503A Voids for gas to pass through

### 4505A Outer Wall of Vessel

4507A Larger graphene plate
4509A Adsorbent such as upsalite, zeolites or carbon inside of Cup
4511A Adsorbent such as upsalite, zeolites or carbon inside of Cup
4513A Voids for gas to pass through
4515A Flange Rim for gas tight seal
4517A Inner Wall of Vessel that 4515A fits to forming a gas tight seal

FIG. 45B

4501B Cut Away View of smaller graphene film plate
4503B Adsorbent MDM such as upsalite, zeolites or carbon
4505B Voids for Gas to pass through

### 4507B Flexible Flange Rim for Gas Tight Seal

4509B Inner Flange for Graphene Film Plate to be affixed with an adhesive such as an Epoxy

### 4511B Larger Graphene Plate

4513B Larger Adsorbent MDM such as upsalite, zeolites or carbon

### 4515B Call out for 4517B and 4519B and 4520B

4517B Close-up of Inner Flange Rim for gas tight seal for permeable material such as graphene
4519B Close-up of Outer Flange Rim for gas tight seal
4520B Close-up of Outer Flange Rim for gas tight seal which may be optionally welded, adhesively sealed or fitted with an O-Ring

### 4521B Smaller Graphene Plate

4523B Adsorbent MDM such as upsalite, zeolites or carbon
4525B Notch Voids for constituent to pass through

### 4527B Larger Graphene Plate

4529B Larger Adsorbent MDM such as upsalite, zeolites or carbon
4531B Notch Voids for gas to pass through
4533B Voids for gas to pass through
4535B Lattice Cavity for adsorbent MDM such as upsalite, zeolites or carbon

FIG. 46

4600 (1) Exploded View of structure cage pallet assembly
4600 (2) Assembly as seen in 4600 (1)
4601 Collar for center structural column

### 4603 Support Locking Tube

### 4605 Grid Lattice Strip

4607 Strip of noncorroding aluminum, could be manufactured by methods such as extrusion or stamping; if plastic, material such as polyamide or composites. Could be manufactured by methods such as pultrusion or extrusion

### 4609 Flange

### 4611 Slot

4613 Grid Lattice Strip; slots align to form Grid Lattice assembly

### 4615 Band

4617 Bottom Film, can be made of soluble laminate or representative of a coated perforated film plate to hold vacuum and/or MDM in place

### 4619 Hole for Structural Column

### 4621 Hole for Center Structural Column

### 4623 Flange Side Wall of Lattice Bottom Plate

### 4625 Hole for Structural Column

### 4627 Slot

### 4629 Grid

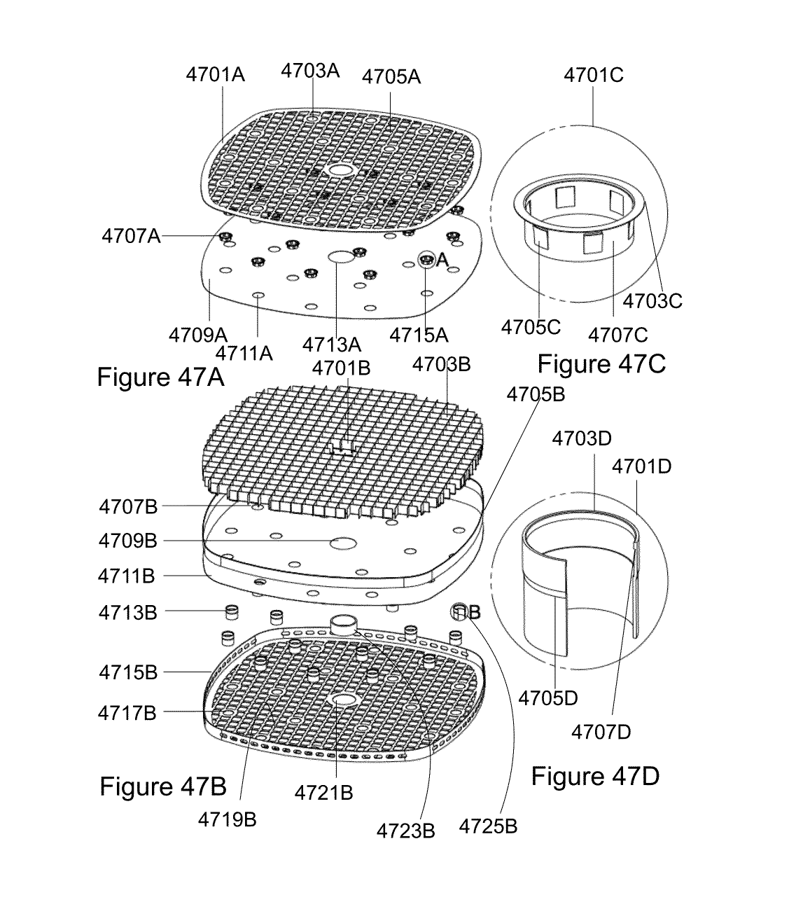

FIG. 47A

4701A Top Plate of Square Grid assembly, first seen in FIG. 46 4600 (2) within a Pillowed Rectangle Shape

### 4703A Circular Orifice for 4715A

4705A Square Grid Segment to hold MDM
4707A Flanged Insert that enables the vacuum table tubes with snap fits
4709A Soluble or permanent film to enable vacuum and if soluble adsorption through perforations; if permanent then creates a Vessel in a Vessel, which could be made of materials such as polyamides with graphene.
4711A Matching Orifice in film for 4703A
4713A Optional Center Orifice of film for Lattice assembly; when film is soluble, orifice can house a center support tube not seen in this illustration.
4715A Flanged Insert that enables the vacuum table tubes with snap fits call out for 4701C

FIG. 47B

### 4701B Center Orifice

4703B Grid Lattice structure
4705B Film side wall to hold vacuum and/or MDM in place
4707B Film Orifice for vacuum tubes
4709B Center Orifice in film
4711B Bottom film which can be made of soluble laminate or representative of a coated perforated film plate to hold vacuum and/or MDM in place
4713B Vacuum Tubes that retract
4715B Side wall of Lattice bottom plate
4717B One of Eighteen Orifices for 4713B One of Eighteen Alignment Pins, keep the MDM in the Cartridge and not in the vac table. Chamfered for easy fit into the tray and are spring loaded to retract into the base of the vac table.

### 4719B Grid Laminate

### 4721B Bottom Plate Center Orifice

4723B Bottom Plate Center Orifice Insert for structure and constituent circulation. When void is opened, if made from a conductive material it can aid thermal transfers.

### 4725B Call out for 4701D

FIG. 47C

### 4701C Flanged Top Fitting for Orifice 4703A and 4711A

### 4703C Flange

4705C Snaps to hold Flange in place inside 4701A orifices
4707C Solid area adjacent to Snaps

FIG. 47D

4701D Cut through of one of eighteen Alignment Pins. Collars and structural supports for the Cartridge, which keep the MDM in the Cartridge and not in the vac table. Chamfered for easy fit into the tray and are spring loaded to retract into the base of the vac table, assist in keeping the MDM from exiting the Lattice Cartridge assembly.
4703D Top of Chamfered Tube. Cut through for easy fit into the tray and are spring loaded to retract into the base of the Vac Table
4705D Undercut Lock Groove for snap fits featured in 4705C

### 4707D Locking Inset Groove Feature

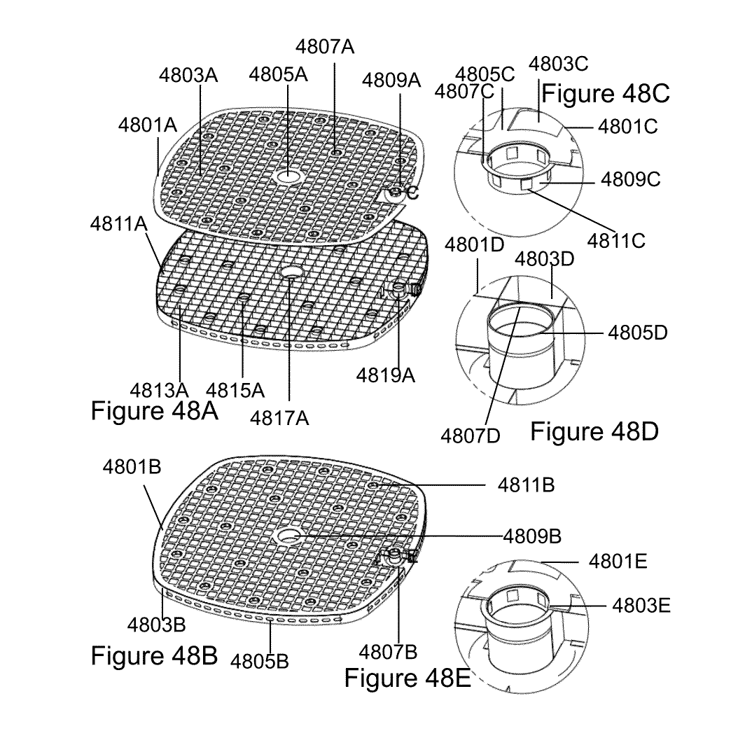

FIG. 48A

4801A Top Plate. Water-jet cut if thermally conductive. Made from material such as corrosion-resistant aluminum or materials such as polyamide or glass of Square Grid assembly within a Pillowed Rectangle
4803A Hole pattern for constituent flow-thru

### 4805A Top Plate Center Orifice

### 4807A Circular Orifice

4809A Circular Orifice for call out of 48D
4811A Flange Edge of interlocking, or welded, or molded or cast, structural pallet Cartridge Lattice Grid
4813A Void in structural pallet Cartridge Lattice Grid

### 4815A Circular Orifice

4817A Center Orifice for structural pallet Cartridge Lattice Grid

### 4819A Cutaway of 4801D

FIG. 48B

4801B Assembled Flange Edge of top plate and structural pallet Cartridge Lattice Grid

### 4803B Side Edge Lip Band

4805B Perforation cuts created by methods such as water-jet or photo etched or machined

### 4807B Cutaway of 4801E

### 4809B Center Orifice

### 4811B Circular Orifice for 4803E

FIG. 48C

4801C In place locking collar close-up
4803C Void for circulation or adsorption and weight loss
4805C Top plate
4807C Weld or bond flange
4809C Bottom of stamped aluminum locking collar

### 4811C Snap-locking tab

FIG. 48D

4801D Tube for vacuum
4803D Void for circulation or adsorption and weight loss
4805D Aluminum support/locking tube
4807D Undercut locking feature for 4811C

FIG. 48E

4801E Tube for vacuum with collar in place between top plate and Lattice grid structural pallet Cartridge

### 4803E Sandwich of Top Plate and Flange Collar

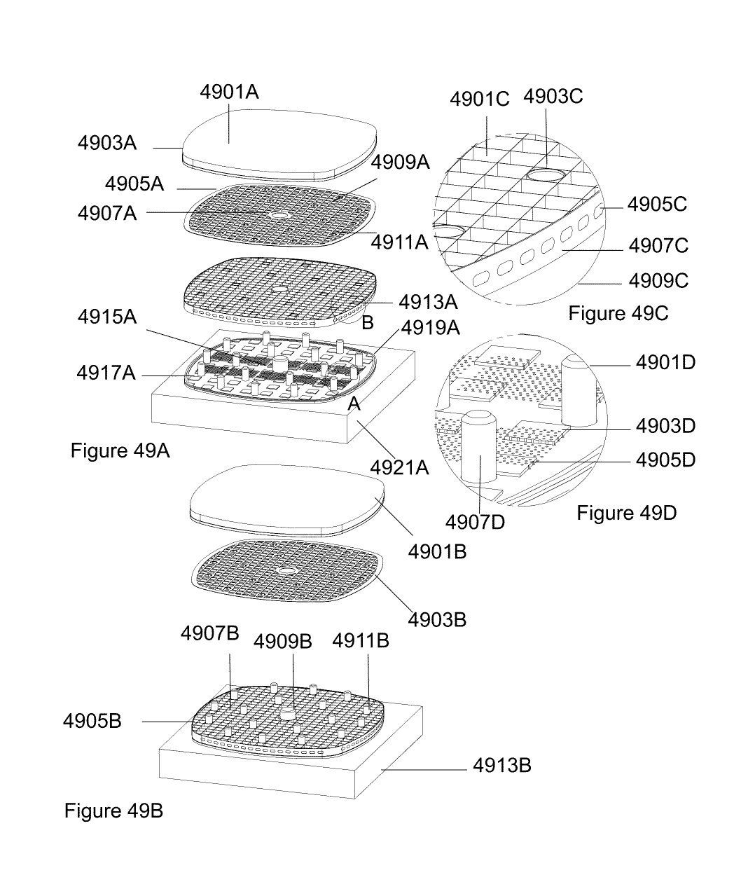

FIG. 49A

4901A Reusable Vacuum Sealing Lid for Lattice assembly

### 4903A Inflatable Perimeter Gasket

4905A Top Plate of structural pallet Cartridge assembly, with film bonded to the underside

### 4907A Center Orifice

### 4909A Square Vent Holes

4911A Structural Pallet Cartridge Column Insertion Holes for alignment
4913A Assembled Conductive or Non-conductive Tray, detailed earlier in FIG. 47
4915A Center Orifice that is pre-vacuum and vibration above the grid plane
4917A Void in Bottom Plate for vacuum
4919A Bottom Plate of assembly

### 4921A Vacuum and Vibration Table

FIG. 49B

### 4901B Top Vacuum Enclosure

4903B Soluble Film Laminated Plate to hold vacuum and/or keep MDM in place post vibration
4905B 4913A shown on the Vacuum and Vibration Table Base
4907B Lattice Grid Segment to hold MDM
4909B Center Orifice which interfaces with 4907A, as vacuum or vibration causes more density of material volume
4911B Orifice which interfaces with 4903C, as vacuum or vibration causes more density of material

### 4913B Vacuum and Vibration Table

FIG. 49C

### 4901C Lattice Grid

4903C A Machined metal or plastic tube shape with an internal perimeter locking groove
4905C Adsorption Circulation Holes for a vertical placement of tray, for constituent loading and release consistent with symmetry of input or output.

### 4907C Lattice Grid Band

4909C Perforations for Adsorption and/or Circulation Enhancement

FIG. 49D

4901D Alignment Pins to keep the MDM in the structural pallet Cartridge and not in the vac table. Chamfered for easy fit into the tray and are spring loaded to retract into the base of the vac table

### 4903D Vibration Feature of Table

4905D Vac Holes, which could populate the entire surface area

### 4907D An Alignment Pin

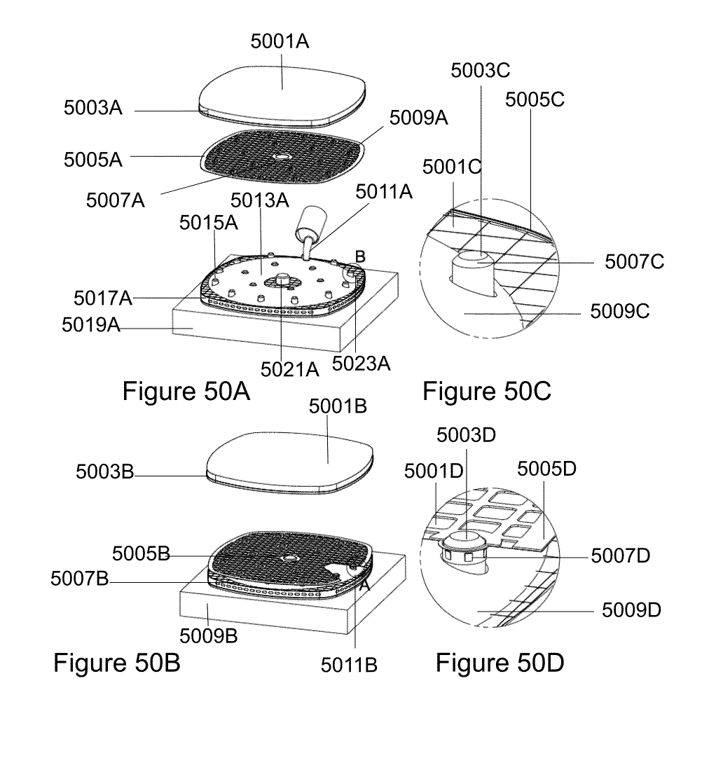

FIG. 50A

5001A Reusable Vacuum Sealing Lid for Lattice assembly. First seen in FIG. 49A

### 5003A Lip of Reusable Vacuum Sealing Lid

### 5005A Top Plate

5007A Center Orifice of Structural Pallet Cartridge assembly

### 5009A Orifice for 5003D

### 5011A MDM

5013A Excess MDM pre evacuation and/or vibration

### 5015A Is 5003D

5017A Lip Band for structural pallet Cartridge assembly
5019A Vacuum and/or Variable Vibration Table

### 5021A Is 5003C

### 5023A Is 5003D

FIG. 50B

5001B Reusable Vacuum Sealing Lid for Lattice assembly
5003B Side wall of Reusable Vacuum Sealing Lid for Lattice assembly

### 5005B Center Orifice

5007B Mounded MDM pre vibration and/or vacuum
5009B A Vac Table with Vibration Feature

### 5011B FIG. 50D

FIG. 50C

5001C Lattice Cavity that is filled with MDM

### 5003C Top of Chamfered Tube

5005C Flange Lip of Lattice Grid assembly

### 5007C Chamfered Tube Feature

5009C Mounded MDM pre vibration or evacuation above the top of the Lattice Cavity

FIG. 50D

5001D Lattice Cavity that is filled with MDM

### 5003D Top of Chamfered Tube

5005D Top Plate of Lattice assembly with photo etch screen feature.
5007D Locking Pins mounted on chamfered tube feature. Fabricated Collar composed of snap locking tabs, which sit over top of the retractable pins
5009D Mounded MDM pre vibration or evacuation above the top of the Lattice Cavity

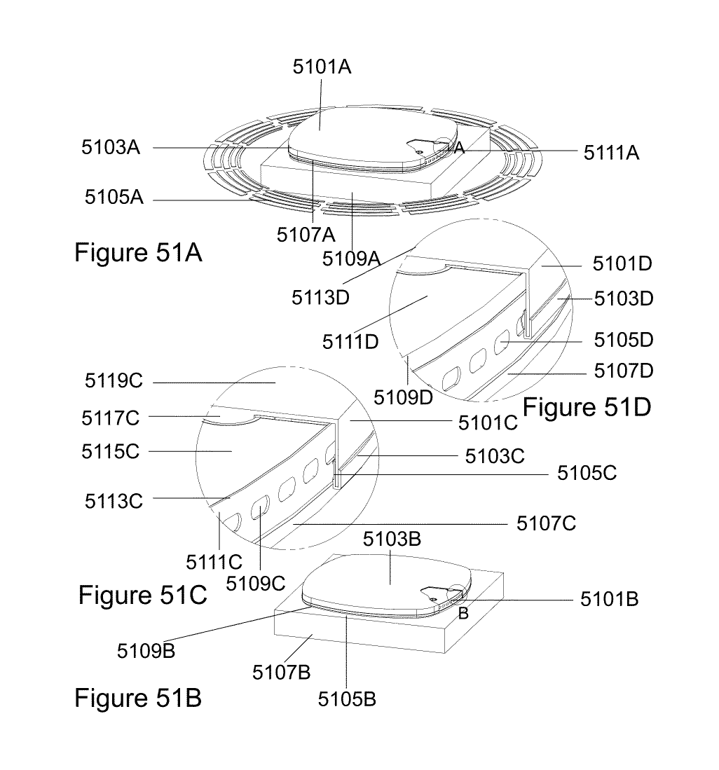

FIG. 51A

5101A Reusable Vacuum Sealing Lid for Lattice assembly first seen in FIG. 49A
5103A Side Lip Band of Reusable Vacuum Sealing Lid for Lattice assembly first seen in FIG. 49A
5105A Variable Vibration Featured if material will not be damaged by the force

### 5107A Top of Vacuum Table

5109A Vacuum and/or Variable Vibration Table
5111A Cut through shown in FIG. 51C prior to completion of vacuum and/or vibration

FIG. 51B

5101B Cut through shown in FIG. 51D
5103B Reusable Vacuum Sealing Lid for Lattice assembly first seen in FIG. 49A
5105B Side Lip Band of Reusable Vacuum Sealing Lid for Lattice assembly first seen in FIG. 49A
5107B Vacuum and/or Variable Vibration Table

### 5109B Top of Vacuum Table

FIG. 51C

5101C Close-up of Side Lip Band of reusable vacuum sealing lid for Lattice assembly first seen in FIG. 49A
5103C Top of J Channel Gasket that is PTFE coated silicone
5105C J Channel Gasket that is a Teflon coated silicone

### 5107C Bottom Base Plate

5109C Flange Lip of Structural Pallet Cartridge with optional Perforation to enhance circulation, and adsorption and can lower the weight of the structure

### 5111C Close-up of Lip Band Flange

### 5113C Close-up of Top of Lip Band Flange

5115C MDM vibrated and/or vacuumed smooth
5117C MDM covering the top of Fabricated Collar composed of snap locking tabs, as seen in closeup in FIG. 48E, which sit over top of the retractable pins
5119C Reusable Vacuum Sealing Lid for Lattice assembly first seen in FIG. 49A

FIG. 51D

5101D Close-up of Side Lip Band of reusable vacuum sealing lid for Lattice assembly first seen in FIG. 49A
5103D J Channel Gasket that is PTFE coated silicone
5105D Flange Lip of Structural Pallet Cartridge Perforation to enhance circulation, and adsorption and can lower the weight of the structure

### 5107D Bottom Base Plate

5109D MDM vibrated and/or vacuumed smooth
5111D MDM vibrated and/or vacuumed smooth above base plate

### 5113D Is 5117C

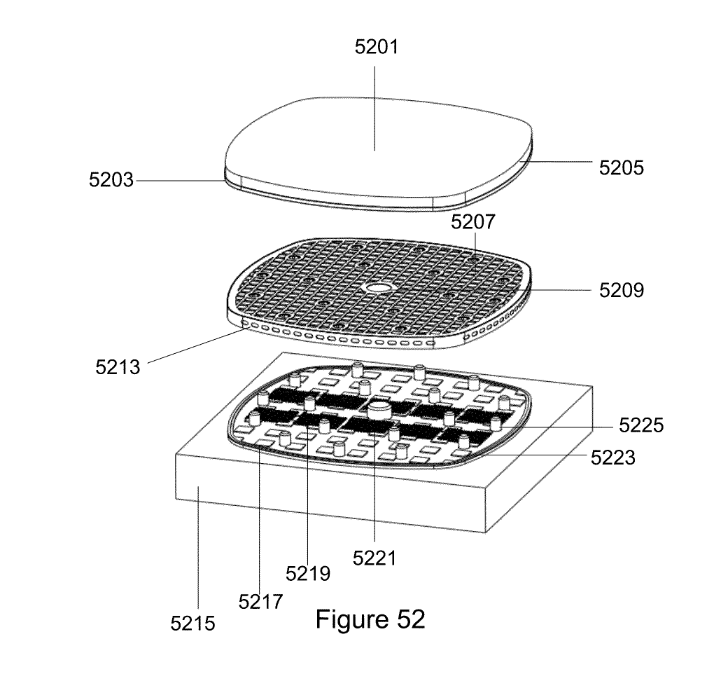

FIG. 52

5201 Reusable Vacuum Sealing Lid for Lattice assembly first seen in FIG. 49A
5203 Interlocking Side Lip Band of Reusable Vacuum Sealing Lid for Lattice assembly first seen in FIG. 49A
5205 Side Lip Band of Reusable Vacuum Sealing Lid for Lattice assembly first seen in FIG. 49A 5207 Orifice (18 places) for 5225
5209 Center Orifice of structural pallet Cartridge assembly
5213 Flange Lip of structural pallet Cartridge with optional perforation that can enhance circulation and adsorption and lower the weight of the structure
5215 A Vacuum Table with vibration feature
5217 Vacuum Sealing Gasket or Sealing Band for Lattice assembly

### 5219 Vacuum Chucks

5221 Center Orifice Pin that fits into 5209
5223 Voids in Bottom Plate shown with permeable material, soluble-coated perforated film or soluble laminate

FIG. 53A

5300A (1) Exploded View of Structural Cage Pallet also known as Structural Cell Pallet

### 5301A Collar for Center Structural Column

### 5303A Support Locking Tube

### 5305A Completed Grid Pallet

### 5307A Band

### 5309A Hole for Support Locking Tube

5311A Bottom Film, can be made of soluble laminate or representative of a coated perforated film plate to hold vacuum and/or MDM in place

### 5313A Bottom Tray Plate

### 5315A Slot

FIG. 53B

5300A (2) Assembly as seen in 5300A (1)

FIG. 53C

5317C Close-Up of Structural cage Pallet Cell

### 5319C Band

### 5321C Optional Band Slot

FIG. 53D

### 5323D Flange for Thermal Transfer

5325D Arrow showing Offset Tab insertion

### 5327D Flange for Thermal Transfer

### 5329D Offset Tab

FIG. 53E

### 5331E Flange for Thermal Transfer

### 5333E Receiving Notch for 5329D

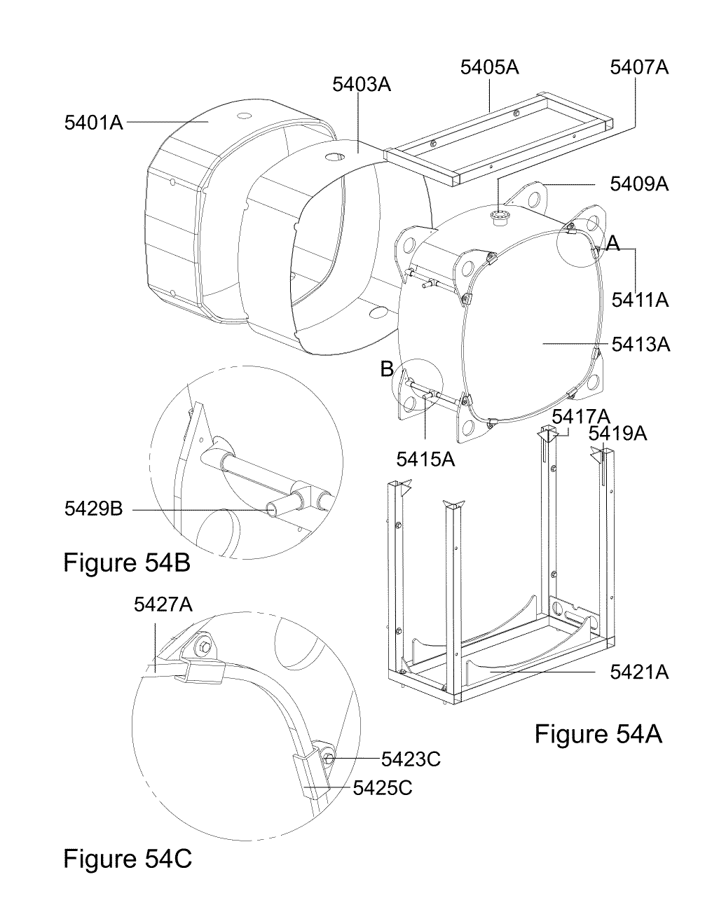

FIG. 54A

### 5401A Optional Insulation Jacket

### 5403A Filament Wound Wrap or Composite Aramid Wrap

5405A Top cage assembly

### 5407A Inlet

### 5409A Support Ear

5411A Locking Fixture for heating assembly
5413A External Jacket to heating assembly

### 5415A Outlet, one of two

### 5417A Support Bracket

### 5419A Slot for 5411A

### 5421A Cradle

FIG. 54B

### 5429B Close-Up of Outlet

FIG. 54C

### 5423C Bolt

### 5425C Locking Fixture

5427C Ridge Band for heating assembly

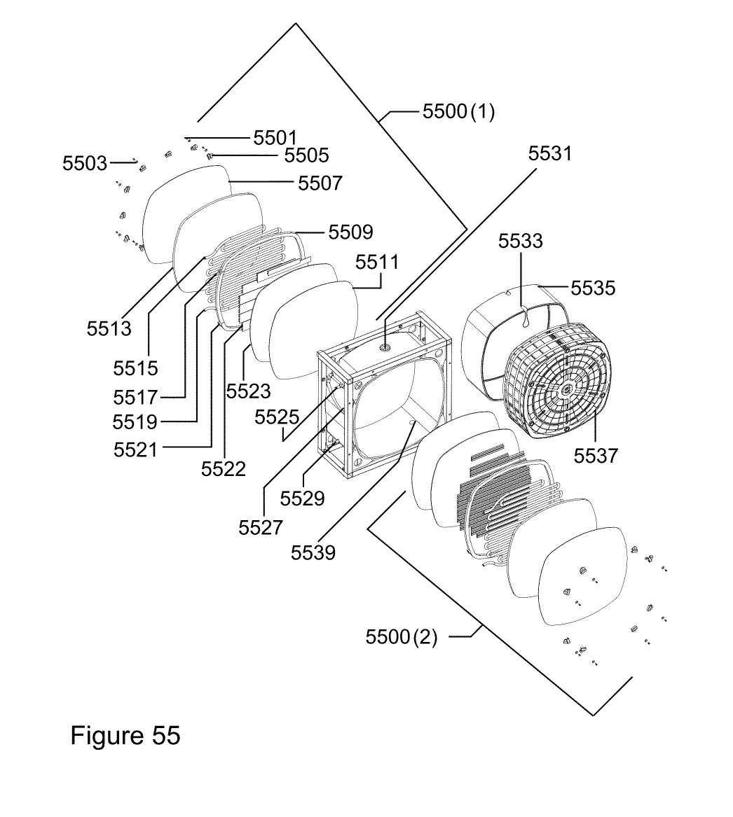

FIG. 55

5500 (1) Exploded View of Vessel Heating assembly
5500 (2) Exploded View of Vessel Heating assembly

### 5501 Screw

### 5503 Washer

### 5505 Clamping Fixture

### 5507 External Vessel Wall

### 5509 Insulation Ring

5511 Thermal Transfer Pad; spun thermal metal

### 5513 Insulation

### 5515 Inlet for Thermal Heating Coil

### 5517 Hole for Inlet for Thermal Heating Coil in the Insulation Ring

### 5519 Outlet for Thermal Heating Coil

### 5521 Hole for Outlet for Thermal Heating Coil in the Insulation Ring

5522 Heating Transfer Plate; can be extrusion of thermal metals
5523 Thermal Transfer Pad; spun thermal metal

### 5525 Inlet Plumbing for Thermal Heating Fluid

### 5527 Cutaway of Vessel Insulation

5529 Outlet Plumbing for thermal heating fluid

### 5531 Inlet for Constituent

5533 Pull String; tightens 5535 around 5537 Populated Cartridge assembly

### 5535 Sleeve

5537 Populated Cartridge assembly

### 5539 Outlet for Constituent

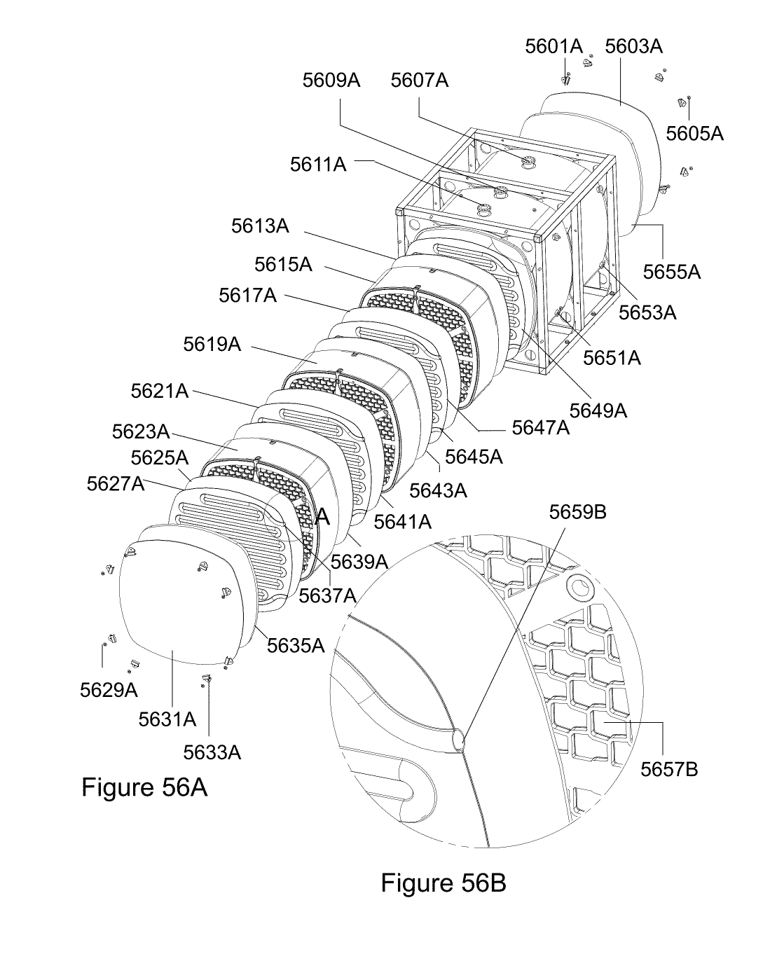

FIG. 56A

### 5601A Clamping Fixture

### 5603A Exterior Vessel Wall

### 5605A Screw

### 5607A Inlet

### 5609A Inlet

### 5611A Inlet

5613A Thermal Transfer Pad; spun thermal metal
5615A Populated Structural Pallet Grid with Sleeve
5617A Thermal Transfer Pad; spun thermal metal
5619A Populated Structural Pallet Grid with Sleeve
5621A Heating assembly
5623A Populated Structural Pallet Grid with Sleeve
5625A Thermal Transfer Pad; spun thermal metal
5627A Heating assembly

### 5629A Screw

### 5631A Exterior Vessel Wall

### 5633A Clamping Fixture

### 5635A Insulation

### 5637A Inlet of Heating Coil

5639A Thermal Transfer Pad; spun thermal metal
5641A Thermal Transfer Pad; spun thermal metal
5643A Thermal Transfer Pad; spun thermal metal
5645A Outlet for Heating assembly
5647A Heating assembly
5649A Heating assembly

### 5651A Vessel Outlet

### 5653A Vessel Outlet

### 5655A Insulation

FIG. 56B

### 5657B Close-Up of Thermally Conductive Structural Pallet Grid

### 5659B Close-Up of 5637A

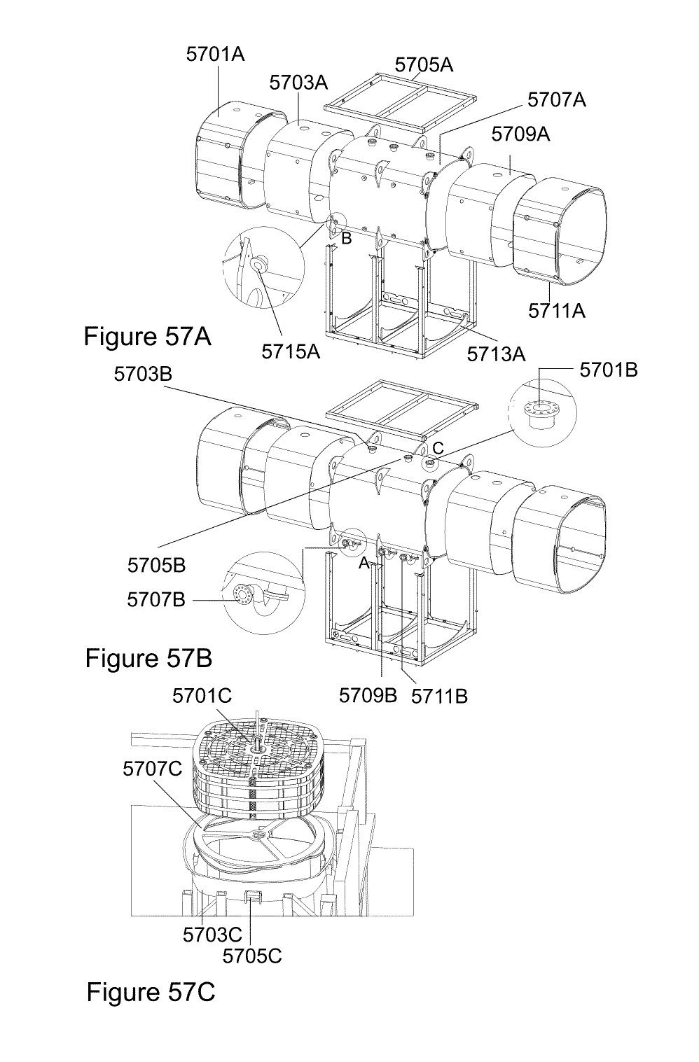

FIG. 57A

### 5701A Optional Insulation

5703A Composite Fiber Wrap made of material such as aramid, polyamide, or aluminum
5705A Top of cage

### 5707A Exterior Wall of Vessel

5709A Composite Fiber Wrap made of material such as aramid, polyamide, or aluminum

### 5711A Optional Insulation

5713A Cradle and cage

### 5715A Inlet for Heating Fluid

FIG. 57B

5701B Close-Up of 5705B, three of three
5703B Inlet for Constituent, one of three
5705B Inlet for Constituent, two of three
5707B Close-Up of 5709B, one of three
5709B Outlet for Constituent, two of three
5711B Outlet for Constituent, three of three

FIG. 57C

### 5701C Lifting Fixture

5703C Cartridge assembly Loading Collar

### 5705C Tab to Connect 5703C to Vessel

5707C Wave Washer to protect Populated Cartridge Assemblies from damage when Vessel is in a horizontal position for G-force attenuation

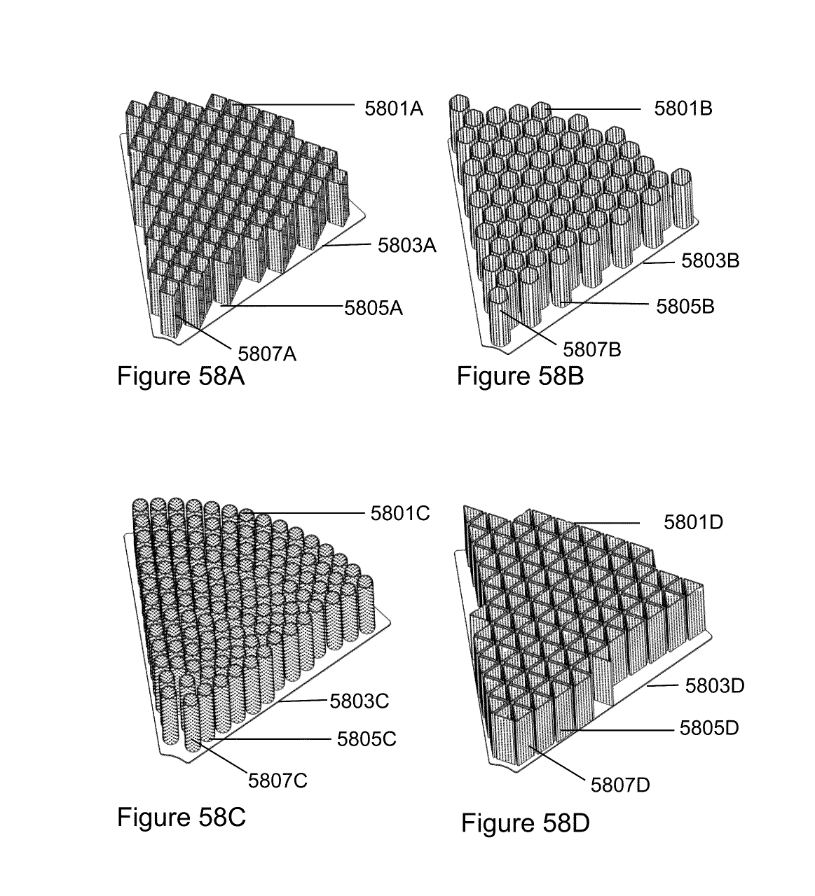

FIG. 58A

5801A Is the top opening of the rounded rectangular Lattice structure. This top opening can be sealed by another plate or plate segment or by lids or caps that are shown in FIG. 8B and FIG. 9D.
5803A Is the Cartridge plate or plate segment that 5801A fits into either by screwing or interference.
5805A Is the bottom opening of the rounded rectangular Lattice structure
5807A Are the perforations of the Lattice structure

FIG. 58B

5801B Is the top opening of the hexagon shape Lattice structure. This top opening can be sealed by another plate or plate segment or by lids or caps that are shown in FIG. 8B and FIG. 9D
5803B Is the Cartridge plate or plate segment that 5801B fits into either by screwing or interference.
5805B Is the bottom opening of the hexagon Lattice structure
5807B Are the perforations of the Lattice structure

FIG. 58C

5801C Is the top opening of the cylinder Lattice structure. This top opening can be sealed by another plate or plate segment or by lids or caps that are shown in FIG. 8B and FIG. 9D
5803C Is the Cartridge plate or plate segment that 5801C fits into either by screwing or interference.
5805C Is the bottom opening of the cylinder Lattice structure
5807C Are the perforations of the Lattice structure

FIG. 58D

5801D Is the top opening of the triangular Lattice structure. This top opening can be sealed by another plate or plate segment or by lids or caps that are shown in FIG. 8B and FIG. 9D
5803D Is the Cartridge plate or plate segment that 5801C fits into either by screwing or interference.
5805D Is the bottom opening of the triangular Lattice structure
5807D Are the perforations of the Lattice structure

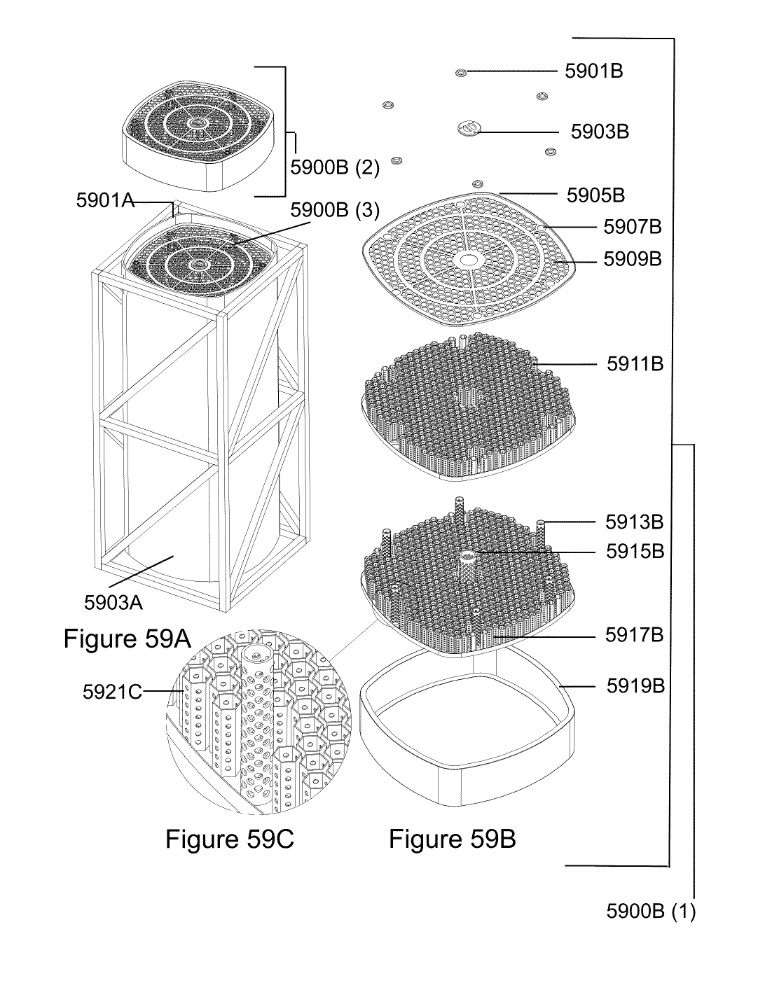

FIG. 59A

5901A Structural cage

### 5903A Vessel Exterior

FIG. 59B

5900B (1) Exploded View of Populated Cartridge assembly
5900B (2) Populated Cartridge assembly
5900B (3) Populated Cartridge assembly

### 5901B Nut

### 5903B Lifting Fixture

### 5905B Top Plate

### 5907B Hole for Structural Column

### 5909B Hexagonal Hole Pattern

### 5911B Structural Column

### 5913B Structural Column

### 5915B Center Structural Column

5917B Hexagonal Perforated Lattice Tube, fixed by such methods as welding or bonding to the bottom plate. These Hexagonal Perforated Lattice Tubes can be made with methods such as roll forming, die casting, or extrusion with materials such as aluminum alloys, stainless steel, or aramid polyamide composites. Hexagonal Perforated Lattice Tubes may have a singular height or one or more staggered heights to accommodate end caps such as knuckleheads or any domed or angled shape to deploy the maximum quantity of MDM within the Vessel.

### 5919B Sleeve

FIG. 59C

### 5921C Close-Up of 5917B and 5913B

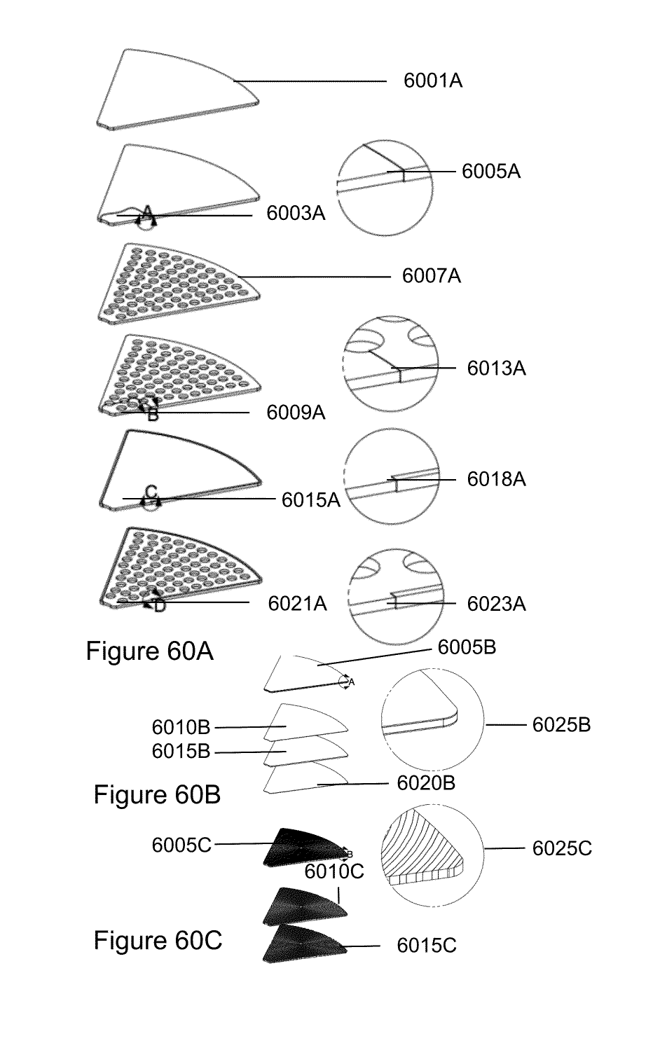

FIG. 60A In one embodiment of the present invention, the Lattice Cartridge and Cartridge Plates can be a plate base of a Cartridge that holds Lattices and can be a whole or made up of sections as viewed above, that can act as a top or bottom to a Lattice structure, this exemplar illustrates plate coatings whether sprayed, dipped and/or anodized. A Cartridge Plate may be made from materials such as Composites, Aramid, Carbon Fiber, Rubber, Latex, Polyamide, Plastics, Carbon Steel, Steel, Copper, Graphene, corrosion resistant Aluminum, Nickel, Transitional Metals, Iron, Alloys, Chaholgen Glass, or Ceramics. Materials are chosen based on the environment of the Cartridge and material, such as temperatures and temperature swings they are exposed to, acidic level, caustic levels, weight loads of the material, and biocidal levels.

6001A Solid Plate without coating, dipping, fusing, or anodization
6003A Solid Plate with coating dipping, fusing, or anodization on the surface and edges, such as Teflon or titanium to enable corrosion resistance and enabling the ease of loading into a Vessel, or copper if a biocide is needed. If anodized with copper it can act as a non-conductive insulator for some types of MDM.
6005A Close-up of coated, dipped, fused, or anodized Solid Plate
6007A Perforated Plate without coating, dipping, fusing, or anodization
6009A Perforated Plate with coating or anodization on the surface and edges, such as Teflon or titanium to enable corrosion resistance and enabling the ease of loading into a Vessel, or copper if a biocide is needed. If anodized with copper it can act as a non-conductive insulator for some types of MDM. Benefits for this include static mitigation. If heating is not an issue then anodization may be used
6013A Close-up of edge coated, fused, or anodized Perforated Plate
6015A Solid Plate with coating or anodization on the edges, such as Teflon or titanium to enable corrosion resistance and enabling the ease of loading into a Vessel, or copper if a biocide is needed. If anodized with copper it can act as a non-conductive insulator for some types of MDM.
6018A Close-up of edge coated, fused, or anodized Solid Plate
6021A Perforated Plate with coating fused, or anodization on the edges, such as Teflon or titanium to enable corrosion resistance and enabling the ease of loading into a Vessel, or copper if a biocide is needed. If anodized with copper it can act as a non-conductive insulator for some types of MDM.
6023A Close-up of edge coated, fused, or anodized Perforated Plate

FIG. 60B

### 6005B Edge of Plate

6010B Aluminum with adhesive
6015B Copper or graphene
6020B Aluminum with top of plate coated with adhesive

### 6025B Assembled Plate

FIG. 60C

### 6005C Edge of Plate

6010C Top Plate with thermal cycle adhesive
6015C Bottom Plate with thermal cycle adhesive
6025C Close-up of wire coils cut into the single plane

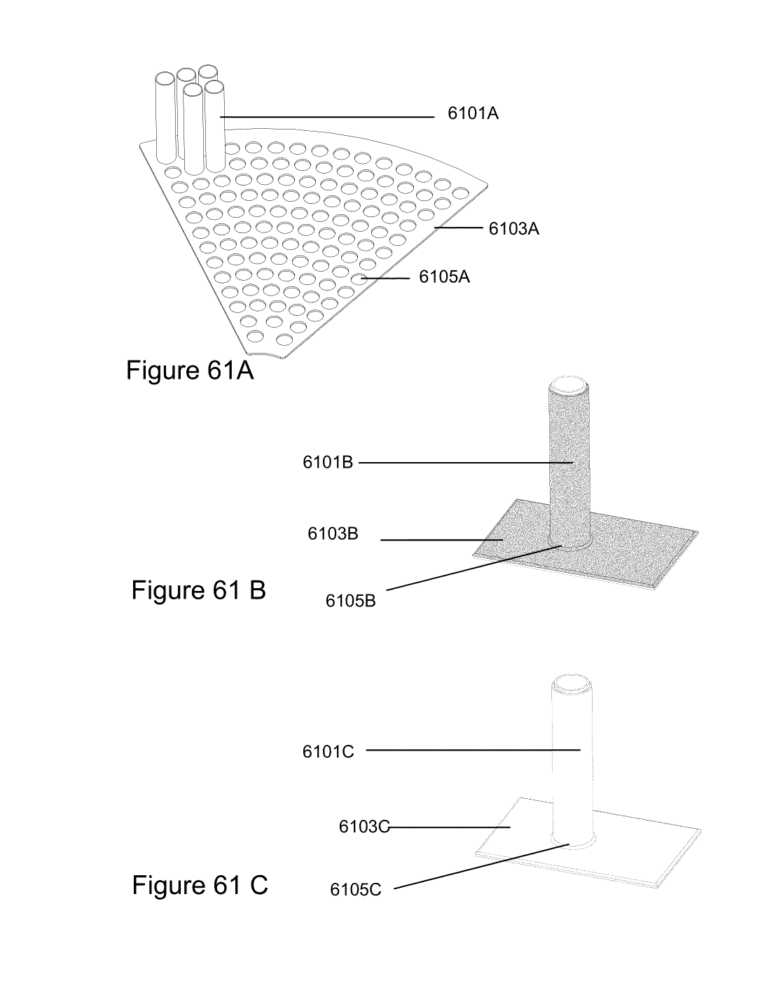

FIG. 61A

6101A Lattice work shown as a holding cylinder above permeable material Lattice cylinder, such as graphene or a permeable polyamide, plastic, porous glass, woven glass or ceramic, woven aramid or woven metal
6103A Plate in this configuration a pie segment
6105A Individual perforation of the front and/or back Lattice plates.

FIG. 61B

6101B Lattice work shown as a holding cylinder above sputtered Lattice cylinder, sputtering might be of copper or ceramic fibers for heat transfer. Material is sprayed on in a Faraday cage with an electrostatic coating mix or wet coating mix with a mixed treated air solution to mitigate electrostatic charges, and enable a thin even sputtering coat. Uneven layers of coatings add weight to the package and added weight means less gas or liquids can be transported above highway gross vehicle weights or weight the motor has to transport, which consumes parasitic energy.
6103B Lattice cylinder and holding Cartridge plate shown as 6101A of FIG. 61A

### 6105B Weld or Bond Joint

FIG. 61C

6101C Lattice work shown as a holding cylinder above coated or anodized Lattice cylinder. Coating or anodization might be of a hard coat Al, Cu as a biocide or for heat transfer material may be dipped, anodized or sprayed on or within a Faraday cage with an electrostatic coating mix or wet coating mix with a mixed treated air solution to mitigate electrostatic charges, and enable a thin even sputtering coat. Coatings add weight to the package and added weight means less gas or liquids can be transported above highway gross vehicle weights. Anodization or certain coatings such as titanium or Teflon will help preserve the structures via the corrosion resistant benefits of the coating anodization. In some cases an MDM material may need an anti-conductive holder. An anodization or coating would be deployed to help enable the Lattice, Cartridge plate, and Vessels. Since some MDM are metallic and in some cases ferrous, the coatings or anodization would help discharge electromagnetism and static electricity.
6103C Lattice holding cylinder
6105C Individual plate with one hole perforation. Anodizing the plates or in some cases coating it with treatments such as titanium or Teflon will increase the lubrication effect of the edge of the plates for loading into a Vessel. Shown with weld or bond joint.

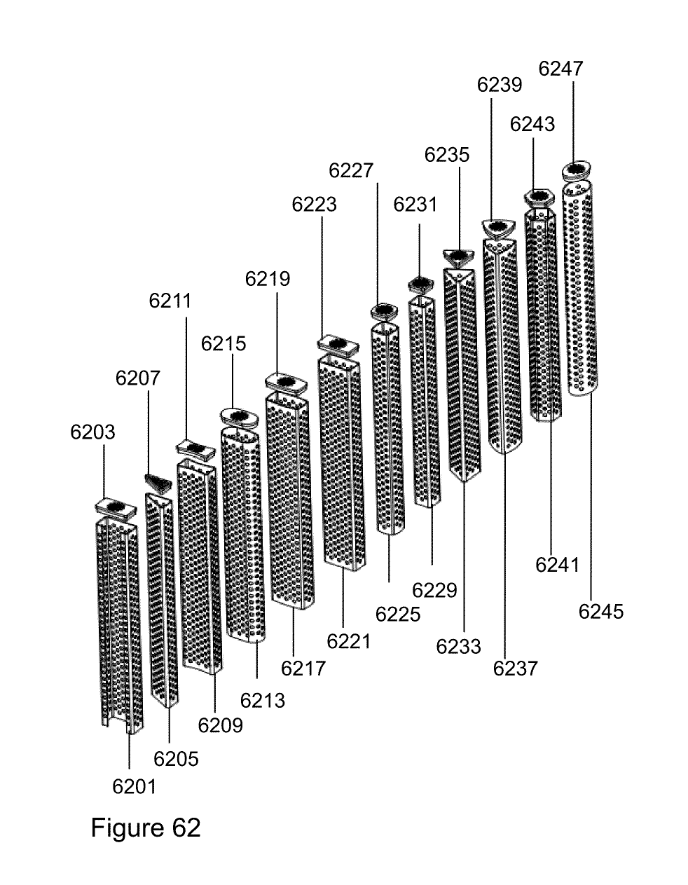

FIG. 62

6201 Lattice Tube in a rectangular open channel shape
6203 Lattice Tube Interference or Bonded Cap in a rectangular open channel shape with an adhesive inset of film or molded cap
6205 Lattice Tube in a Triangular shape
6207 Triangular Shaped Lattice Tube Interference or Bonded Cap with an adhesive inset of film or molded cap
6209 Lattice Tube in a Rectangle Shape with Concave sides
6211 Rectangle Shape with Concave Sides Lattice Tube Interference or Bonded Cap with an adhesive inset of film or molded cap
6213 Lattice Tube with a shape of Rounded Bullet Corners Rectangle
6215 Lattice Rounded Bullet Corners Rectangle Cap with Interference or Bonded Cap with an adhesive inset of film or molded cap

### 6217 Lattice Tube in a Convex Rectangular Shape

6219 Lattice Convex Rectangular Shape Cap Interference or Bonded Cap with an adhesive inset of film or molded cap
6221 Lattice Tube in a Regular Rectangle with Straight Walls
6223 Lattice Regular Rectangular Straight Walls Cap with Interference or Bonded Cap with an adhesive inset of film or molded cap
6225 Lattice Tube in a Convex Square or when rotated Diamond Shape
6227 Lattice Convex Square or when rotated Diamond Shape Cap with Interference or Bonded Cap with an adhesive inset of film or molded cap
6229 Lattice Tube in a Square or when rotated Diamond Shape
6231 Lattice Square or when rotated Diamond Shape Cap with Interference or Bonded Cap with an adhesive inset of film or molded cap

### 6233 Lattice Tube in a Equilateral Triangle Shape

6235 Lattice Equilateral Triangle with Interference or Bonded Cap with an adhesive inset of film or molded cap

### 6237 Lattice Tube in a Convex Equilateral Triangle Shape

6239 Lattice Convex Equilateral Triangle Cap with Interference or Bonded Cap with an adhesive inset of film or molded cap

### 6241 Lattice Tube in a Hexagon Shape

6243 Lattice Hexagon Cap with Interference or Bonded Cap with an adhesive inset of film or molded cap

### 6245 Lattice Tube in a Ellipse Shape

6247 Lattice Ellipse Shape Cap with Interference or Bonded Cap with an adhesive inset of film or molded cap

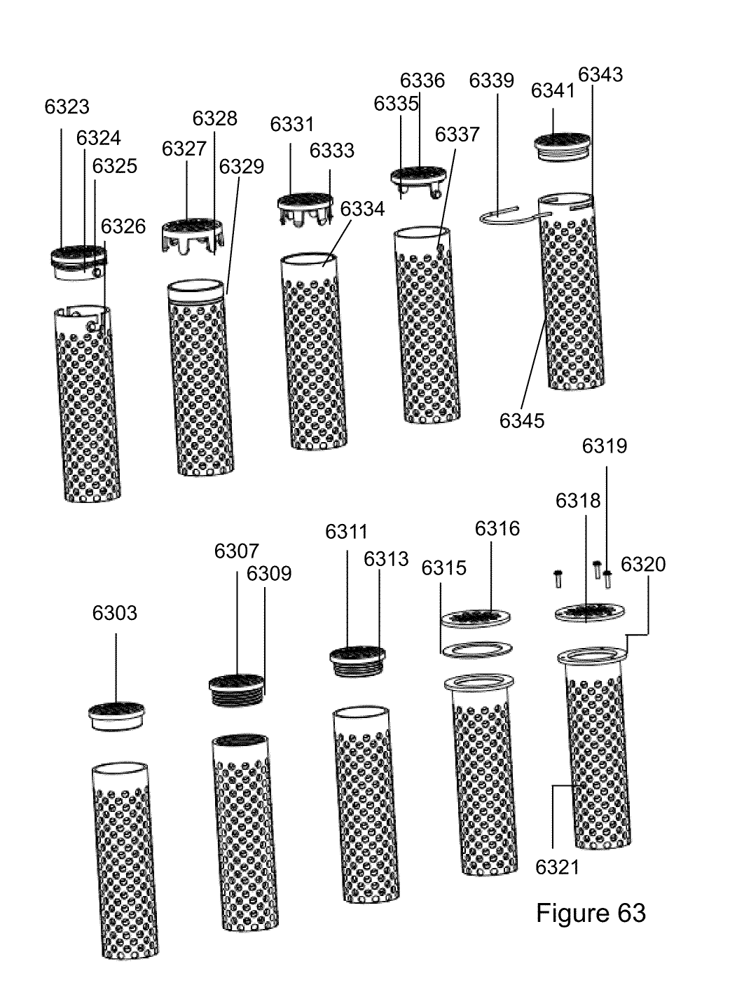

FIG. 63

6303 Round Cap with perforations interference fit for Lattice cylinder
6307 Round Cap Top with perforations for Lattice cylinder
6309 Round Cap with threads
6311 Round Cap Top with perforations for Lattice cylinder
6313 Round Cap O-Rings with or without Aramid wrapper
6315 Flat Round Cap adhesives disc—could be thermal cycling capable epoxy or tape
6316 Flat Round Cap Top with perforations for Lattice cylinder
6318 Flat Round Top with perforations for Lattice cylinder

### 6319 Threaded Screw

6320 Flat Round cylinder Flange Lip with female screw threads
6321 Round cylinder perforations in the shape of circles, which serve as conduits for circulation
6323 Round Cap with perforations for Lattice cylinder
6324 Round Cap wave washer

### 6325 Round Cap Pin

### 6326 Cylinder Key Way Slot

6327 Flat Round Cap with perforations for Lattice cylinder
6328 Flat Round Cap flexible locking tabs or snap fits
6329 Flat Round Cap groove for snap fits
6331 Flat Round Cap with perforations for Lattice cylinder
6333 Flexible locking tabs or snap fits
6334 Interior Lattice cylinder Groove for Flat Round Cap for snap fits
6335 Flexible locking tabs or snap fits
6336 Flat Round Cap with perforations for Lattice cylinder
6337 Hole for flexible snap fit tabs

### 6339 Cotter Pin Collar

6341 Flat Round Cap with perforations for Lattice cylinder
6343 Continuous Perimeter Groove below Cap Machine Cut, Laser Cut or Casting Channel Slot in Lattice cylinder
6345 Revealed Perforations which could be coated with soluble material or sleeved or lined or laminated closed

FIG. 64

6401 Flexible and/or Semi-rigid Continuous Lattice Bag in a Spiral Roll

### 6403 Tape Roll Continuous Lattice Bag in a Spiral Roll

6405 Rigid Lattice Bag with 2 Telescoping Halves

### 6407 Internal Rigid Support for Semi-rigid Lattice Bag

6409 Semi-rigid Lattice Bag with Internal Rigid Support and 2 End Caps
6411 Flexible and/or Semi-rigid Continuous Lattice Bag with Continuous Chambers for enclosed MDM in a Spiral Roll
6413 Flexible Lattice Bag with cutaway exposing internal MDM
6415 Dimple Cup assembly with a Cup, a Cap and a Film Insert. Multiple Assemblies may or may not stack and/or nest.
6417 Film Insert(s). Film Insert(s) may be adhered or insert molded. Film Insert(s) may be made from such materials as Plastic, Paper, Plastic Paper, Glass Fiber, and/or Metal Fabrics from materials as Graphene, Polyethylene, Polyamide, Arimid, Tyvek®, Glass, Aluminum, Copper, Brass, Stainless Steel, etc., and may or may not be perforated with or without a Soluble Coating.
6419 Flexible and/or Semi-rigid Continuous Lattice Bag with Continuous Chambers for enclosed MDM in the flat.
6421 Flexible and/or Semi-rigid Continuous Lattice Bag with Continuous Chambers for enclosed MDM in the flat with tessellated sealed Circles Patterns.
6423 Flexible and/or Semi-rigid Continuous Lattice Bag with Continuous Chambers for enclosed MDM in the flat with tessellated sealed Triangles Patterns.
6425 Semi-rigid Continuous Lattice Bag with Continuous Chambers for enclosed MDM created by a Semi-rigid Insert bonded between the Depository film sheet and second film Sheet
6427 Cross Section thru a Semi-rigid Continuous Lattice Bag with Continuous Chambers for enclosed MDM created by Semi-rigid Insert

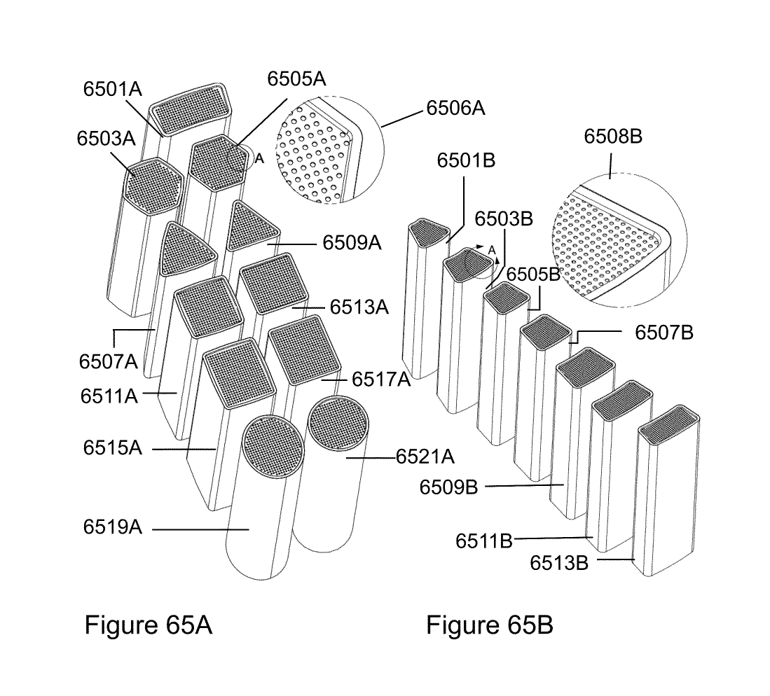

FIG. 65A

6501A An arc influenced keystone shaped Lattice Bag that has a lid
6503A An arc influenced hexagon shaped Lattice Bag that has a lid
6505A A hexagon shaped Lattice Bag that has a lid
6506A Close-up of 6505 This flanged lid with an insert component which may be photo-etched and sealed with a soluble laminate and/or coating and/or made from a permeable material such as aramid weave and/or metal textile
6507A An arc influenced triangular shaped Lattice Bag that has a lid
6509A A triangular shaped Lattice Bag that has a lid
6511A An arc influenced square shaped Lattice Bag that has a lid. When rotated it becomes a diamond.
6513A A square shaped Lattice Bag that has a lid. When rotated it becomes a diamond.
6515A An arc influenced rectangular shaped Lattice Bag that has a lid
6517A A rectangular shaped Lattice Bag that has a lid that when rotated becomes an irregular diamond
6519A An arc influenced elliptical cylindrical shaped Lattice Bag that has a lid
6521A A cylindrical shaped Lattice Bag that has a lid

FIG. 65B

6501B A keystone that is part of a Composite Ring Series as seen in FIG. 22A or FIG. 22B. This Bag segment when repeated and consecutively placed will create a completely filled nested circular perimeter as demonstrated. Shaped component Lattice Bag that has a lid, which fits within a Cartridge plate ring, to provide maximum material within a Vessel, and enable heating by fit. Conformity enables load transfers.
6503B A keystone that is part of a Composite Ring Series as seen in FIG. 22A or FIG. 22B. This Bag segment when repeated and consecutively placed will create a completely filled nested circular perimeter as demonstrated. Shaped component Lattice Bag that has a lid, which fits within a Cartridge plate ring, to provide maximum material within a Vessel, and enable heating by fit. Conformity enables load transfers.
6505B A keystone that is part of a Composite Ring Series as seen in FIG. 22A or FIG. 22B. This Bag segment when repeated and consecutively placed will create a completely filled nested circular perimeter as demonstrated. Shaped component Lattice Bag that has a lid, which fits within a Cartridge plate ring, to provide maximum material within a Vessel, and enable heating by fit. Conformity enables load transfers.
6507B A keystone that is part of a Composite Ring Series as seen in FIG. 22A or FIG. 22B. This Bag segment when repeated and consecutively placed will create a completely filled nested circular perimeter as demonstrated. Shaped component Lattice Bag that has a lid, which fits within a Cartridge plate ring, to provide maximum material within a Vessel, and enable heating by fit. Conformity enables load transfers.
6508B A close-up of a lid for a keystone Bag that is part of a Composite Ring Series as seen in FIG. 22A or FIG. 22B. This flanged lid with an insert component which may be photo-etched and sealed with a soluble laminate or coating or made from a permeable material such as aramid weave or metal cloth.
6509B A keystone that is part of a Composite Ring Series as seen in FIG. 22A or FIG. 22B. This Bag segment when repeated and consecutively placed will create a completely filled nested circular perimeter as demonstrated. Shaped component Lattice Bag that has a lid, which fits within a Cartridge plate ring, to provide maximum material within a Vessel, and enable heating by fit. Conformity enables load transfers.
6511B A keystone that is part of a Composite Ring Series as seen in FIG. 22A or FIG. 22B. This Bag segment when repeated and consecutively placed will create a completely filled nested circular perimeter as demonstrated. Shaped component Lattice Bag that has a lid, which fits within a Cartridge plate ring, to provide maximum material within a Vessel, and enable heating by fit. Conformity enables load transfers.
6513B A keystone that is part of a Composite Ring Series as seen in FIG. 22A or FIG. 22B. This Bag segment when repeated and consecutively placed will create a completely filled nested circular perimeter as demonstrated. Shaped component Lattice Bag that has a lid, which fits within a Cartridge plate ring, to provide maximum material within a Vessel, and enable heating by fit. Conformity enables load transfers.

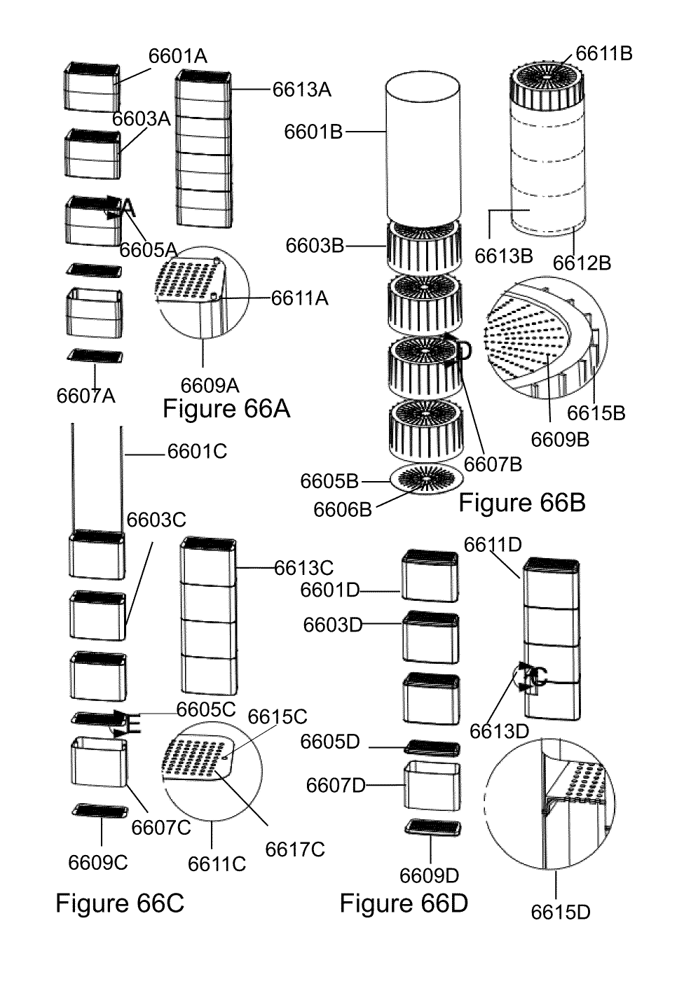

FIG. 66A

6601A Stackable Lattice assembly that is nested by joining Teats featured in 6611A into 6607A

### 6603A Nesting

### 6605A Solubly Coated or Laminated

### 6607A Bottom Lid Film Plate With Perforations Solubly Coated or Laminated

6609A Closeup of Nesting Feature with Lid Perforations shown without a coating in this iteration, with Force Fit Teats

### 6611A Closeup of Nesting Feature With Teats

### 6613A Assembled Nested Series of Lattice Structures

FIG. 66B

6601B Sleeve Wrap that holds the stacked Lattices together, can be made of Aluminum, or laminated film with aluminum to act as a thermal conduit
6603B Cake cylinder assembly
6605B Bottom Plate with Sunray Perforation Pattern
6606B Bottom Plate with Center Rod Or Rail Orifice

### 6607B Fin Feature

### 6609B Perforations in top lid

6611B Top Plate Orifice in lid with Center Rod or Rail Orifice
6612B Sleeved Lattice assembly
6613B Section of Feature Lattice assembly shown without a coating in this iteration
6615B Closeup of Fin Feature with Lid Perforations shown without a coating in this iteration

FIG. 66C

6601C Rail or Rods for stacking Lattices and interconnecting Lattice structures, can be made of a conductive material to enable release of adsorbed constituent
6603C Stackable Lattice assembly Section

### 6605C Top Lid Plate With Perforations

6607C Empty unassembled rectangular cube Lattice interconnectable section

### 6609C Bottom Lid Plate With Perforations

6611C Closeup of Top Lid Plate with Rod Hole Feature and Perforations
6613C Completed Stacked Rod Interconnected Lattice assembly
6615C Closeup of Top Lid Plate with Rod Hole Feature
6617C Closeup of Top Lid Plate with Perforations

FIG. 66D

6601D Stackable Single Section of Lattice assembly
6603D Top Lid Plate With Perforations that can be photo etched or air driven
6605D Bottom Lid Plate With Perforations that can be photo etched or air driven
6607D Stackable Unassembled Single Section of Lattice assembly

### 6609D Bottom Lid Plate With Perforations

6611D Stacked Sections of Lattice assembly

### 6613D Lid Interference Fit Feature

6615D Close-up of Lids featuring Interference Fit into the Extruded Side Wall or bonded together via an adhesive such as a thermal cycle adhesive.

FIG. 67A

6703A Cavity and the start of the Spiral Lattice

### 6706A Side Wall of the Lattice

6709A Heater Conductor or an evacuation fixture

### 6712A Crimped and Sealed, Sewn, Welded or Glued Edge of Film

6715A Perforated Edge of Lattice Bag and in some cases solubly coated MDM

FIG. 67B

6703B Start of the Spiral wrap

### 6706B MDM Material

### 6709B Lattice Structure Carrier

6712B End Cap of Spiral which can be welded, glued, stitched, or crimped and sealed

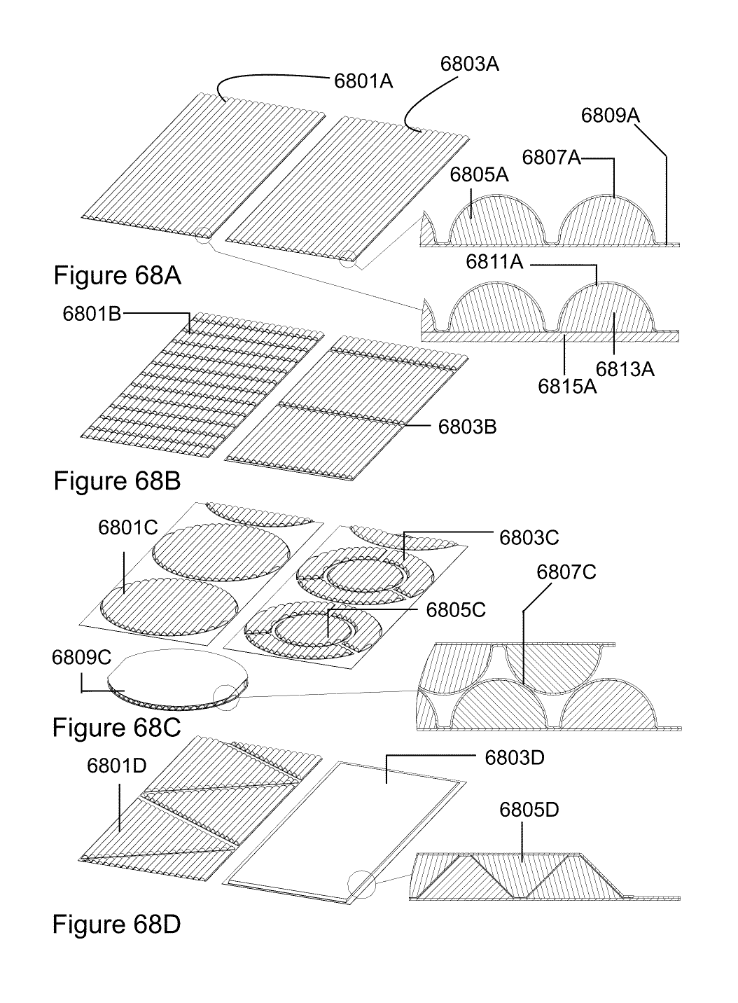

FIG. 68A

6801A Flexible Continuous Lattice Bag with Continuous Chambers for enclosed MDM in a horizontal position.
6803A Semi-rigid Continuous Lattice Bag with Continuous Chambers for enclosed MDM in a horizontal position.
6805A Entrapped MDM in Continuous Chambers or Cells shown in a cross section view
6807A Flexible Top Film Sheet Layer shown in a cross section view. May be made from such materials as Polyamide, Polyethylene, Metal Fabrics, Metalized Films, Foils, and Fiber Reinforced Films, and may or may or not be perforated with or without a soluble coating
6809A Depository Flexible Film Layer shown in a cross section view. May be made from such materials as Polyamide, Polyethylene, Metal Fabrics, Metalized Films, Foils, and Fiber Reinforced Films, and may or may not be perforated with or without a soluble coating
6811A Flexible Top Film Sheet Layer shown in a cross section view. Same as 6807A
6813A Entrapped MDM in Continuous Chambers or Cells shown in a cross section view
6815A Depository Semi-rigid Film Layer shown in a cross section view. Same as 6809A except the Film has higher modulus allowing for a self-supporting Continuous Lattice Bag when in a spiral configuration.

FIG. 68B

6801B Bond Area in a Flexible or Rigid Continuous Lattice Bag with Continuous Chambers for enclosed MDM shown in a horizontal position. The additional bond area(s) between the Depository Film Layer and the Top Film Layer creates any variation of Tessellated Patterns allowing for any variation of MDM entrapped in Chambers or Cells.
6803B Demonstrates a variation in the placement of the Bond Area between the Depository Film Layer and the Top Film Layer in a Flexible or Semi-rigid Continuous Lattice Bag with Continuous Chambers or Cells for entrapping MDM shown in a horizontal position. The additional bond area(s) between Depository Film Layer and Top Film Layer creates any variation of Tessellated MDM Chambers or Cell Patterns allowing for any variation of MDM entrapped in Chambers or Cells.

FIG. 68C

6801C Demonstrates a variation in the placement of the Bond Area between the Depository Film Layer and the Top Film Layer in a flexible or semi-rigid continuous Lattice Bag with continuous chambers or cells for entrapping MDM shown in a horizontal position. The additional bond area(s) between Depository Film Layer and Top Film Layer creates any variation—in this case a circle—of Tessellated MDM Chambers or Cell Patterns allowing for any variation of MDM entrapped in Chambers or Cells.
6803C Demonstrates a variation in the placement of the Bond Area between the Depository Film Layer and the Top Film Layer in a Flexible or Semi-rigid Continuous Lattice Bag with continuous chambers or cells for entrapping MDM shown in the flat. The additional bond area(s) between Depository Film Layer and Top Film Layer creates any variation; in this case a custom shape, of Tessellated MDM Chambers or Cell Patterns allowing for any variation of MDM entrapped in Chambers or Cells.
6805C MDM entrapped in Chamber(s) or Cell(s)
6807C Is a cross sectional view of 6809C, demonstrating the nesting function of two separate Flexible or Semi-rigid Continuous Lattice Bags. The nesting function is created by mirroring and offsetting the two separate Flexible or Semi-rigid Continuous Lattice Bags to each other. Higher MDM packing densities are achieved by using nesting.
6809C Two separate nested Flexible or Semi-rigid Continuous Lattice Bags

FIG. 68D

6801D Demonstrates a variation in the placement of the Bond Area between the Depository Film Layer and the Top Film Layer in a Flexible or Semi-rigid Continuous Lattice Bag with continuous chambers or cells for entrapping MDM shown in a horizontal position. The additional bond area(s) between Depository Film Layer and Top Film Layer creates any variation; in this case a triangle, of Tessellated MDM Chambers or Cell Patterns allowing for any variation of MDM entrapped in chambers or cells.
6803D Demonstrates a Semi-rigid Continuous Lattice Bag in a horizontal position.
6805D Is a cross sectional view of 6803 illustrating a Three Dimensional Rigid or Semi-rigid Plastic or Paper Insert separating and bonding to the flexible Depository Film Layer and Top Film Layer. MDM is entrapped between the chamber(s) or cell(s) created by the bonded three dimensional Rigid or Semi-rigid Plastic or Paper Insert and flexible Depository Film Layer and Top Film Layer. The Three Dimensional Rigid or Semi-rigid Plastic or Paper Insert may be made from such materials as polyamide, aramid, aluminum, metalized films, or fiber reinforced films and may or may not be perforated with or without a soluble coating.

FIG. 69A

6901A Deposition Roll of coated or soluble laminated pre-perforated film that is threaded through to form one facing side of a Continuous Lattice Bag. Perimeter edges are coated with a thermal adhesive.
6903A Compartmented hopper with at least one dispensing orifice for one or more types of MDM and/or type of additive.
6905A Encapsulating Roll of coated or soluble laminated pre-perforated film that is threaded through to form the other opposing facing side of a type of Lattice Bag known as a Continuous Lattice Bag.

### 6907A Oversized Variable Tension Belt and Pressure Heat Roller

6909A Variable heat and pressure roller
6911A Rewind roll of completed Continuous Lattice Bags at least partially filled with MDM
6913A Place in the Process where at least one type of MDM is laid down to a uniform or variable height depending on material that can be compressed without damage
6915A Threaded Film with at least one type of MDM deposited thereon before entering Oversized Variable Tension Belt and Pressure Heat/Compaction Roller

### 6917A Variable Pressure Heat Roller

FIG. 69B

6901B Deposition Roll of coated or soluble laminated pre-perforated film that is threaded through to form one facing side of a Continuous Lattice Bag. Perimeter edges are coated with thermal adhesive.
6903B Compartmented hopper with at least two dispensing orifices—at least one such orifice for dispensing MDM and at least one other orifice for dispensing a second material such as transformational metal, or conductive material, or biocide.
6905B Encapsulating Roll of coated or soluble laminated pre-perforated film that is threaded through to form the other facing side of a Continuous Lattice Bag

### 6907B Oversized Variable Tension Belt and Pressure Heat Roller

6909B Variable heat, tension and pressure roller
6911B Rewind roll of completed Continuous Lattice Bags filled with at least one type of MDM
6913B Place in the Process where at least one type of MDM is laid down to a uniform or variable height depending on material that can be compressed without damage

### 6915B Oversized Variable Tension Belt and Pressure Heat Roller

### 6917B Variable Tension and Pressure Heat Compaction Roller

In one embodiment, Continuous Lattice Bags are constructed using known industrial techniques such as a Sheet Molding Compound (SMC) machine. Continuous Lattice Bags may consist of one or more layers or sheets, at least one of which must be a Depository sheet for the deposition of at least one type of MDM or at least one type of complementary additive. Continuous Lattice Bags may be fabricated with one or more deposition sheets and either zero, one or more Encapsulating sheets that may be joined to sandwich the deposited MDM or other complementary material by known industrial techniques such as welding or with adhesives rendering a finished Continuous Lattice Bag having specified flexibility, X axis and/or Y axis firmness or rigidity with either a sealed end of roll or an unsealed end of roll. The dispensing orifice(s) below 6903A and 6903B may be programmed to dispense MDM or other complementary material in a uniform manner; or, in any variable pattern such as tessellated rows, circles or triangles to suit the specified purposes of the Continuous Lattice Bag.

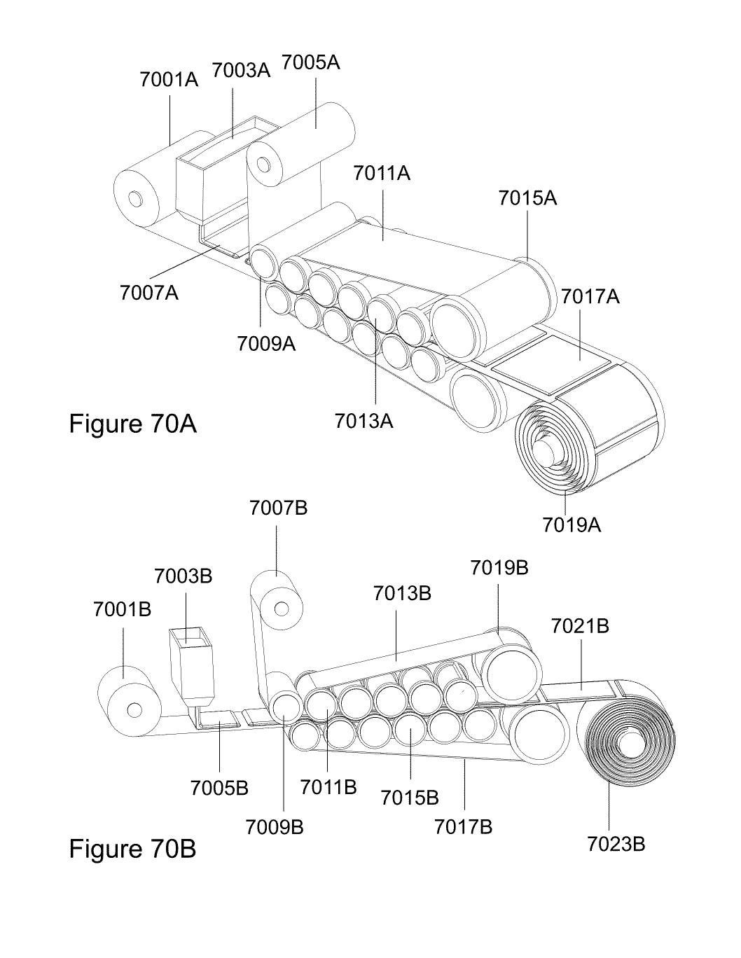

FIG. 70A

7001A Roll of coated or solubly laminated pre-perforated film that is threaded through to form bottom of Lattice Bag. Perimeter edges are coated with thermal cycled adhesive.

### 7003A MDM

7005A Roll of coated or solubly laminated pre-perforated film that is threaded through to form top of Lattice Bag
7007A MDM being laid down to a variable height depending on material that can be compressed but not damaged
7009A Variable heat and pressure roller

### 7011A Variable Pressure Tension Belt

### 7013A Variable Pressure Heat Roller

### 7015A Oversized Variable Tension Belt and Pressure Heat Roller

7017A Sealed MDM Lattice Bag shown with optional space on all four sides of perimeter
7019A Rewind roll of completed Lattice Bags filled with MDM

FIG. 70B

7001B Roll of coated or solubly laminated pre-perforated film that is threaded through to form bottom of Lattice Bag, perimeter edges are coated with thermal cycled adhesive
7003B Two types of MDM or MDM and a second material such as transformational metal, or conductive material, or biocide.
7005B MDM being laid down to a variable height depending on material that can be compressed but not damaged
7007B Roll of coated or solubly laminated pre-perforated film that is threaded through to form top of Lattice Bag
7009B Variable heat, tension and pressure roller
7011B Variable heat, tension and Pressure Roller

### 7013B Variable Pressure Tension Belt

### 7015B Pressure Heat Roller

### 7017B Oversized Variable Tension Belt

### 7019B Oversized Variable Tension Belt and Pressure Heat Roller

7021B Sealed MDM Lattice Bag shown with optional space on all four sides of perimeter
7023B Rewind roll of completed Lattice Bags filled with MDM

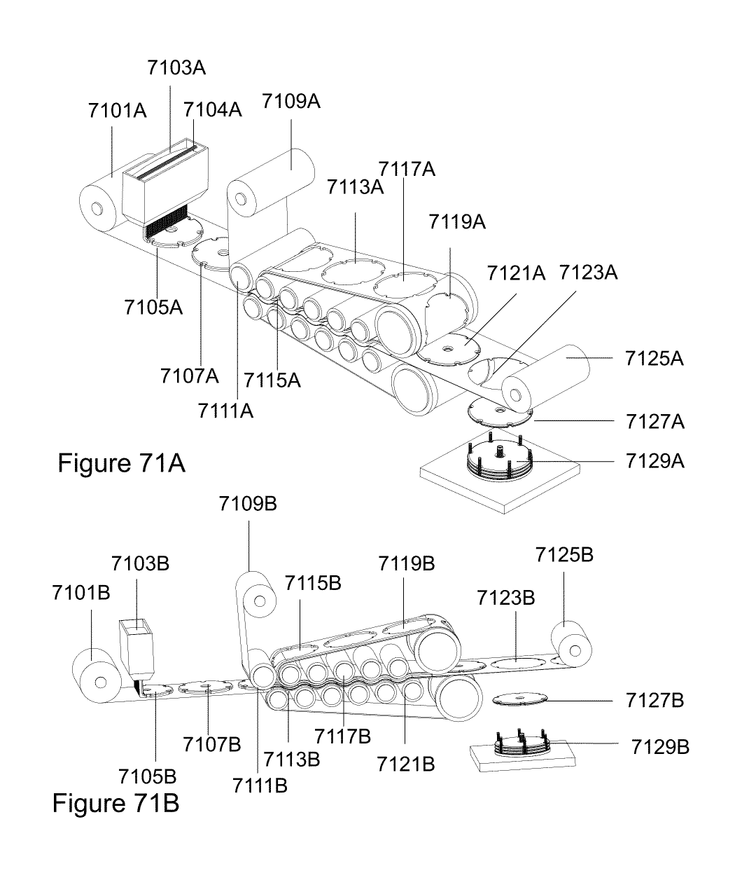

FIG. 71A

7101A Roll of coated or solubly laminated pre-perforated film that is threaded through to form bottom of Lattice Bag, perimeter edges are coated with thermal cycled adhesive
7103A MDM Compartment 1 for one type of MDM
7104A Compartment 2 for one type of MDM or dosed additive such as a Mercapten adsorbent or Cu as a biocide or Al as thermal conductor

### 7105A Pattern of MDM

### 7107A Completed Pattern of MDM

7109A Roll of coated or solubly laminated pre-perforated film that is threaded through to form top of Lattice Bag
7111A Variable heat, tension and pressure roller
7113A Die Cut Shape of any shape of FIG. 130, Variable Pressure Tension Belt
7115A Married Laminated films combined with MDM
7117A Die Cut Shape of any shape of FIG. 130, Variable Pressure Tension Belt
7119A Die Cut Shape of any shape of FIG. 130, Variable Pressure Tension Belt Releasing Seal and cut of MDM Lattice Bag

### 7121A Sealed and Die Cut MDM Lattice Bag

### 7123A Release Sealed MDM Lattice Bag

### 7125A Tension Rewind of Excess Roll Material

### 7127A Falling Completed MDM Lattice Bag

7129A Packaging or Permanent Cartridge holding Lattice Bags

FIG. 71B

7101B Roll of coated or solubly laminated pre-perforated film that is threaded through to form bottom of Lattice Bag, perimeter edges are coated with thermal cycled adhesive
7103B Dual Bin or more Bins of different MDM or other additives

### 7105B Pattern of MDM

### 7107B Completed Pattern of MDM

7109B Roll of coated or solubly laminated pre-perforated film that is threaded through to form top of Lattice Bag
7111B Variable heat, tension and pressure roller
7113B Married Laminated films combined with multiple MDM
7115B Die Cut Shape of any shape of FIG. 130, Variable Pressure Tension Belt

### 7117B Upper Compaction Roller

7119B Die Cut Shape of any shape of FIG. 130, Variable Pressure Tension Belt Releasing Seal and cut of MDM Lattice Bag

### 7121B Upper Compaction Roller

### 7123B Release Sealed MDM Lattice Bag

### 7125B Tension Rewind of Excess Roll Material

### 7127B Falling Completed MDM Lattice Bag

7129B Packaging or Permanent Cartridge holding Lattice Bags

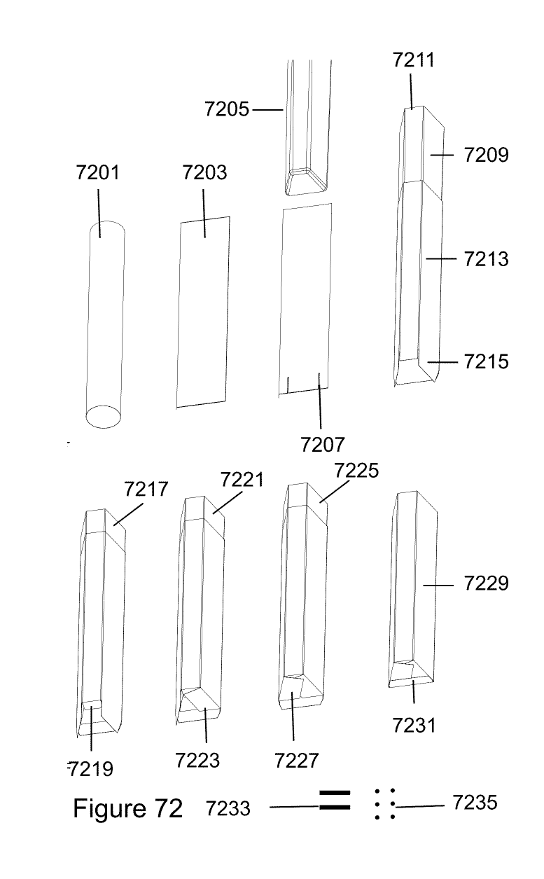

FIG. 72

Another Lattice iteration. These forms do not depend on binders, which provides the advantages of not damaging the material by the addition of the binder, and the expense, added weight and added volume of the binder which is subtractive from the total volume of potential adsorption capacity of the populated Vessel.

7201 Pliable, Shapeable tube

### 7203 Flattened Tube

### 7205 Shaping Mold

7207 Tube Showing Die-cuts for flaps. Not pictured are perforations created in Bag at point of die cutting post flattening in 7203 or secondary process of photo-etching
7209 Top of Shaping Mold as it descends
7211 Descended Mold into Bag
7213 Shaped Bag with unsealed flaps
7215 Unsealed flaps
7217 Fully Descended Mold into Bag
7219 First Flap folded
7221 Fully Descended Mold into Bag
7223 Second Flap folded in
7225 Fully Descended Mold into Bag
7227 Third Flap folded in
7229 Removal of Fully Descended Mold from Bag
7231 Fourth Flap folded in

### 7233 Adhesive

### 7235 Dots of Epoxy Adhesive

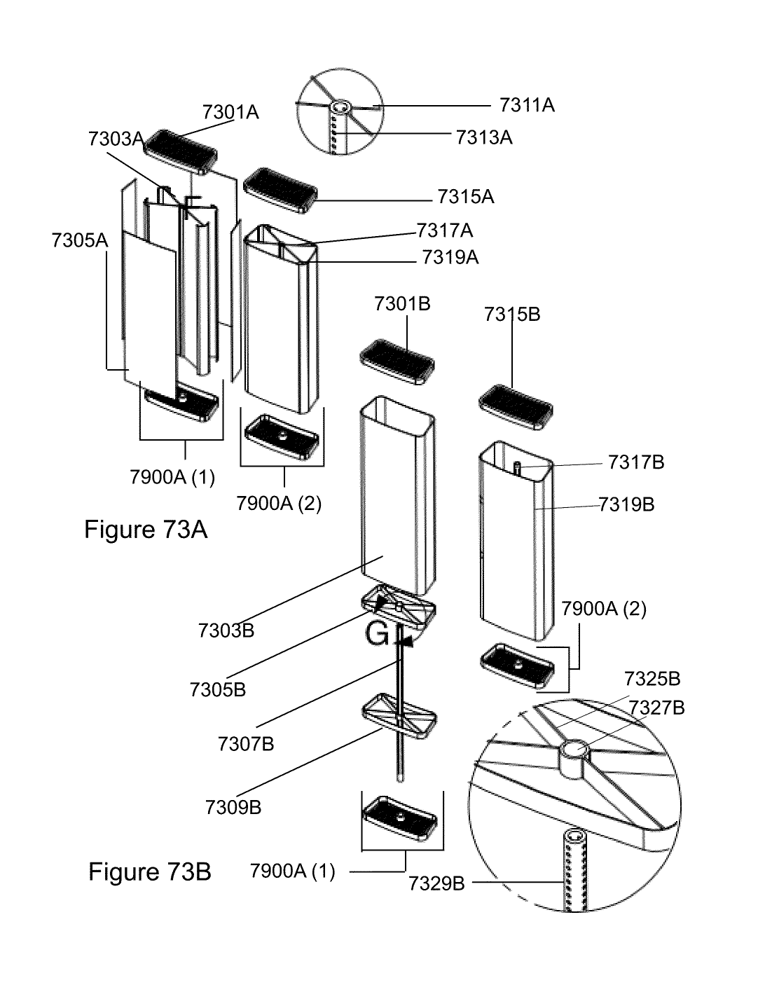

FIG. 73A

7900A (1) Lid assembly with Vacuum Chuck and Valve
7301A Top Lid of Lattice assembly
7303A X-Shaped Reinforcement Structure for Lattice Bag or Structure with Radius End Point Wings. The X shape if sealed to the interior Bags and manufactured of a permeable material such as graphene can act as an a separation or amendment chamber.
7305A Exploded Frontal View of Lattice assembly Panels with perforations shown in a soluble coated state. This is a separate panel that is attached via methods such as welding and/or adhesive.
7311A Close-up of Center Connections to Structural Tube X-Shaped Reinforcement Structure with Radius End Point Wings, which if made from a conductive metal or material can be a thermal conduit
7313A Center Structural Tube that is hollow and perforated to promote adsorption via the X-Shaped Reinforcement Structure with Radius End Point Wings
7315A Top Lid of Lattice assembly

### 7317A 7303A Inserted

7319A Reinforced Edge of Lattice assembly Bag or Structure via Wings on 7303A

### 7323A Vacuum Chuck in Bottom Lid

7900A (2) Lid assembly with Vacuum Chuck and Valve

FIG. 73B

7900A (1) Lid assembly with Vacuum Chuck and Valve
7301B Top Lid of Lattice assembly
7303B Front Panel of Lattice assembly
7305B X-Shaped Reinforcement Structure that matches the interior fenestration for Lattice Bag or Structure with Radius End Point, with a height similar to 7301B
7307B A Perforated Rail with stops and/or spacers for multiple 7305B inserts
7309B A second reinforcement identified in 7305B
7315B Top Lid of Lattice assembly
7317B Rail previously identified in 7311B
7319B Reinforced Corner of Lattice assembly
7325B Close-up of Bar within X-Shaped Reinforcement Structure that matches the interior fenestration for Lattice Bag or Structure with Radius End Point, with a height similar to 7301B
7327B Close-up of Central Orifice for Rail within X-Shaped Reinforcement Structure that matches the interior fenestration for Lattice Bag or Structure with Radius End Point, with a height similar to 7301B
7329B Close-up of Rail in this iteration. It is hollow with perforations to promote adsorption previously identified in 7311B
7900A (2) Lid assembly with Vacuum Chuck and Valve

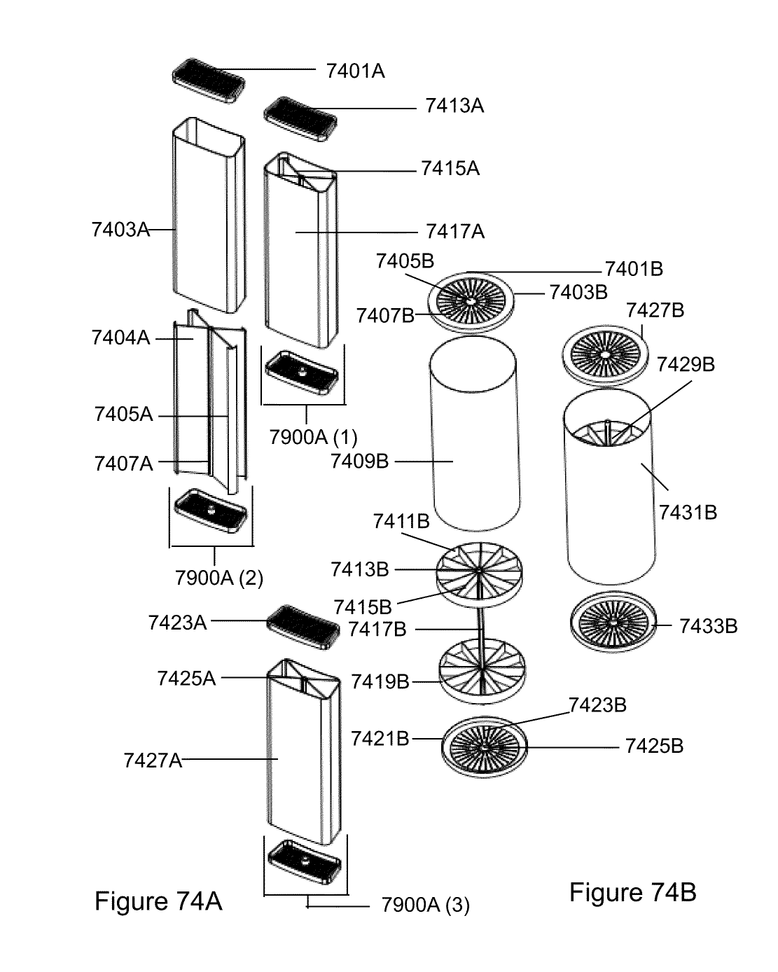

FIG. 74A

7401A Top Lid of Lattice assembly
7403A Unassembled Frontal View of Lattice Bag assembly, which perforations are shown in a soluble coated state
7404A X-Shaped Reinforcement Structure for Lattice Bag or Structure with Radius End Point Wings. The X shape if sealed to the interior Bags and manufactured of a permeable material such as graphene can act as an a separation or amendment chamber, or as a method to reinforce the Bag and transfer loads from the MDM into the structure.
7405A X-Shaped Reinforcement Structure Wing which can be glued into the structure, and which assists in load transfers and the integrity of the Lattice Bag assembly
7407A Center tube of X-Shaped Wing Structure, which if hollow could have perforations to help adsorption
7413A Top Lid of assembly in a state where 7404A has been inserted
7415A 7404A has been inserted
7417A View of Bag post insertion of 7404A
7423A Top Lid with Solubly Coated Material Covering Perforations
7425A Inserted X Wing assembly shown
7427A Front Panel of Reinforced Bag without perforations
7900A (1) Vacuum Chuck in Bottom Lid assembly with Solubly Coated Material covering Perforations or Permeable Material
7900A (2) Vacuum Chuck in Bottom Lid assembly with Solubly Coating covering Perforations or Permeable Material
7900A (3) Vacuum Chuck in Bottom Lid assembly with Solubly Coating covering Perforations or Permeable Material

FIG. 74B

7401B Top Lid of Lattice assembly

### 7403B Flange of Lid

### 7405B Hole for 7417B

### 7407B Large Visible Perforations

7409B Unassembled Frontal View of Lattice Bag assembly which perforations are shown in a soluble coated state
7411B Spoke Shaped Reinforcement Structure which can be glued into the structure, and which assist in load transfers and the integrity of the Lattice Bag assembly
7413B Center tube of Spoke Shaped Reinforcement Structure, which if hollow could have perforations to help adsorption

### 7415B Spoke

### 7417B Column for 7411B

### 7419A Edge of Spoke Shaped Reinforcement Structure

### 7421B Flange of Lid

### 7423B Perforations

### 7425B Hole for 7417B

### 7427B Flange of Lid

### 7429B Spoke Shaped Reinforcement Structure

7431B Lattice Bag in a state where 7411B has been inserted

### 7433B Bottom Lid

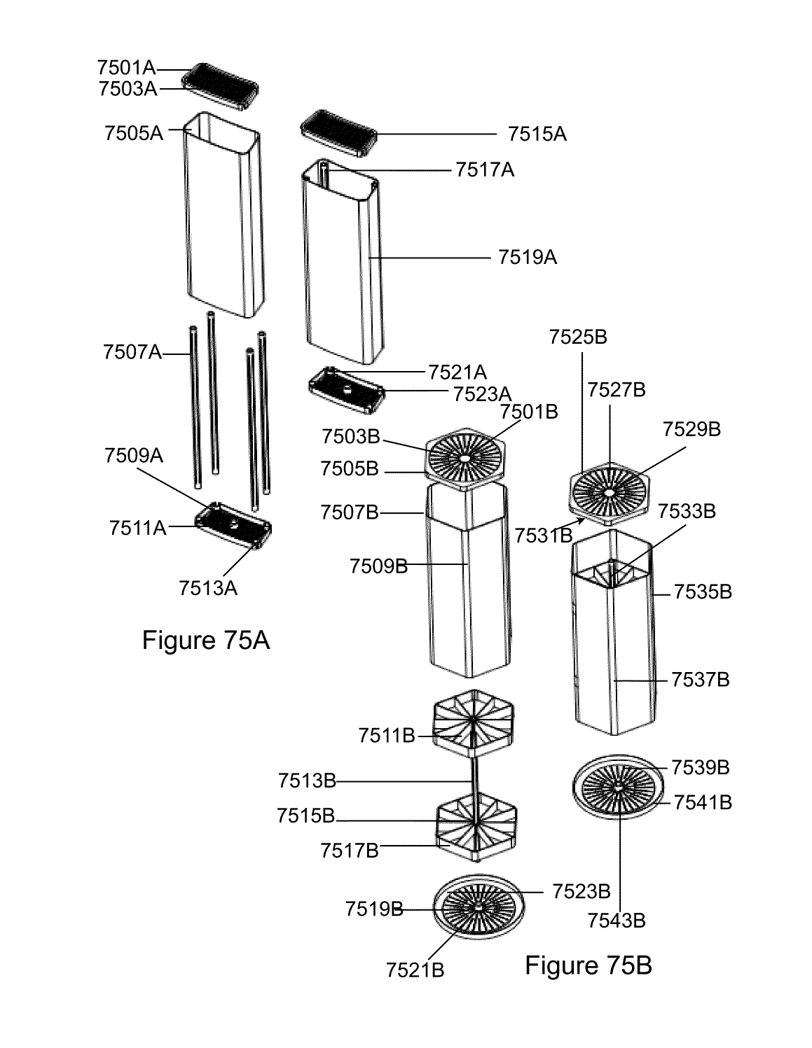

FIG. 75A

7501A Top Lid that can be photo etched. In this view the Bag perforations have been coated or laminated with a soluble material or coating

### 7503A Edge of Lid

7505A Top of Keystone Lattice Bag with optional removable laminate covering perforations that can be peeled
7507A Rods for Bag reinforcement and load transfers; additionally the insert can act as a heating element if made from a thermal conductive material

### 7509A Orifice For Rod Reinforcement

### 7511A Bottom Lid

### 7513A Orifice For Rod Reinforcement

### 7515A Orifice For Rod Reinforcement

7517A In place Rod originally shown on 7507A
7519A Laminate that covers keystone walls of that is peeled away post evacuation and after position placement in Cartridge

### 7521A Orifice For Rod Reinforcement

7523A Bottom Lid with Rod Orifices and Vacuum Chuck

FIG. 75B

### 7501B Center Orifice for Rail Shown in 7513B

### 7503B Tear Shaped Orifices

7505B Hexagon Top Lid of Lattice assembly with elongated tear shaped Openings, which could act to enhance circulation and/or adsorption in conjunction with an impeller

### 7507B Top Lip or Edge of Lattice Bag or Structure

7509B Side Edge that is reinforced by 7533B
7511B One of twelve wing reinforcements
7513B Rod or Rail which may be hollow with perforations or solid
7515B Orifice filled with Rod

### 7517B Flange for 2nd Reinforcement Structure

### 7519B Vacuum Chuck

7521B Bottom Lid with Rod and/orifices
7523B Bottom Lid Rim for fit into or onto Lattice Bag assembly
7525B Hexagon Top Lid of Lattice assembly with elongated tear shaped Openings, which could act to enhance circulation and/or adsorption in conjunction with an impeller

### 7527B Tear Shaped Orifices

### 7529B Center Orifice for Rail Shown in 7513B

### 7531B Flange for Top Lid or Cap

7533B Assembled Lattice Without MDM but with inserted Hexagon Lattice Reinforcement Structure

### 7535B Side Wall Hexagon Lattice Reinforcement Structure Point

### 7537B Side Wall Hexagon Lattice Reinforcement Structure Point

7539B Tear Shaped Orifices that if made as an insert into 7505B could spin
7541B Bottom Lid Exterior Rim for fit into or onto Lattice Bag assembly
7543B Vacuum Chuck and/or Orifice For Rod Reinforcement

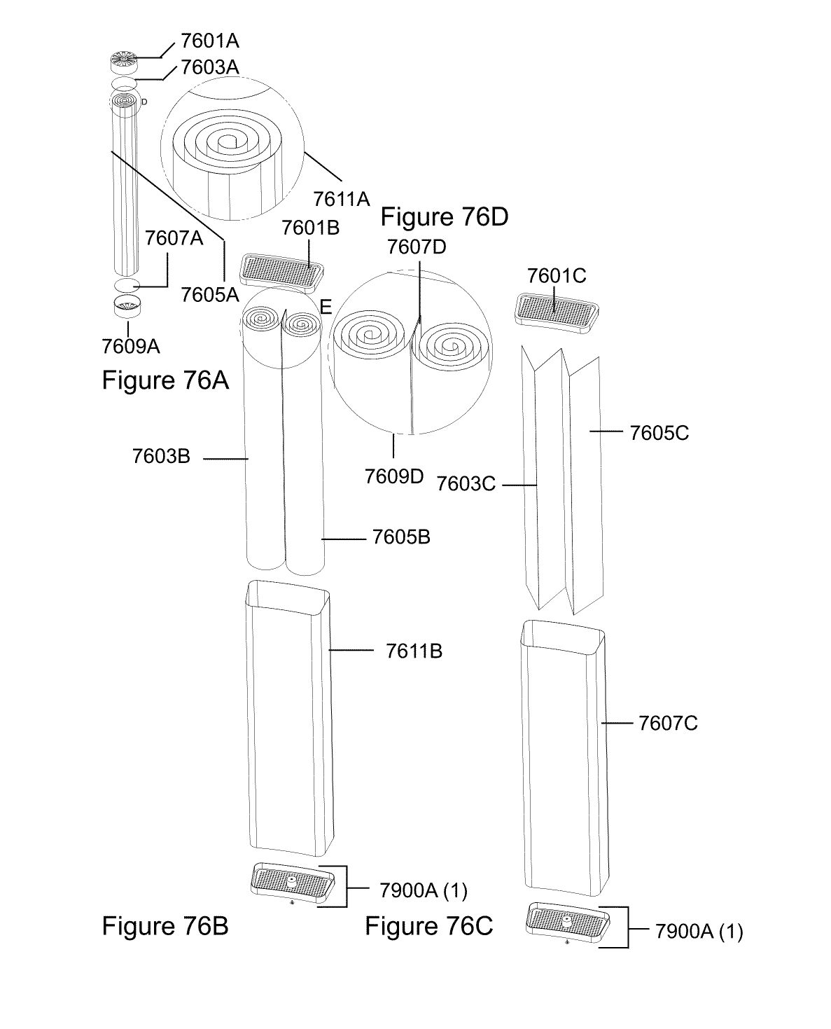

FIG. 76A

7601A Top End Cap Lid that is micro perforated made from permeable materials

### 7603A Spline

7605A Roll that when 7607A and 7609A are affixed may be filled with MDM

### 7607A Spline

7609A Bottom End Cap that is micro perforated made from permeable materials

FIG. 76B

### 7601B Top Lid

7603B First Roll of Double Roll Insert that may be filled with MDM post affixing of 7611B to 7900A (1)
7605B Second Roll of Double Roll Insert that may be filled with MDM post affixing of 7611B to 7900A (1)

### 7611B Flexible Bag or Rigid Bag

7900A (1) A Bottom Lid assembly of a Lattice Bag or structure

FIG. 76C

### 7601C Top Lid

### 7603C Support Angle of Tented Insert

### 7605C Tented Insert

### 7607C Flexible Bag or Rigid Bag

7900A (1) A Bottom Lid assembly of a Lattice Bag or structure

FIG. 76D

### 7607D Top View of 7603B

### 7609D Close-up of 7603B and 7605B

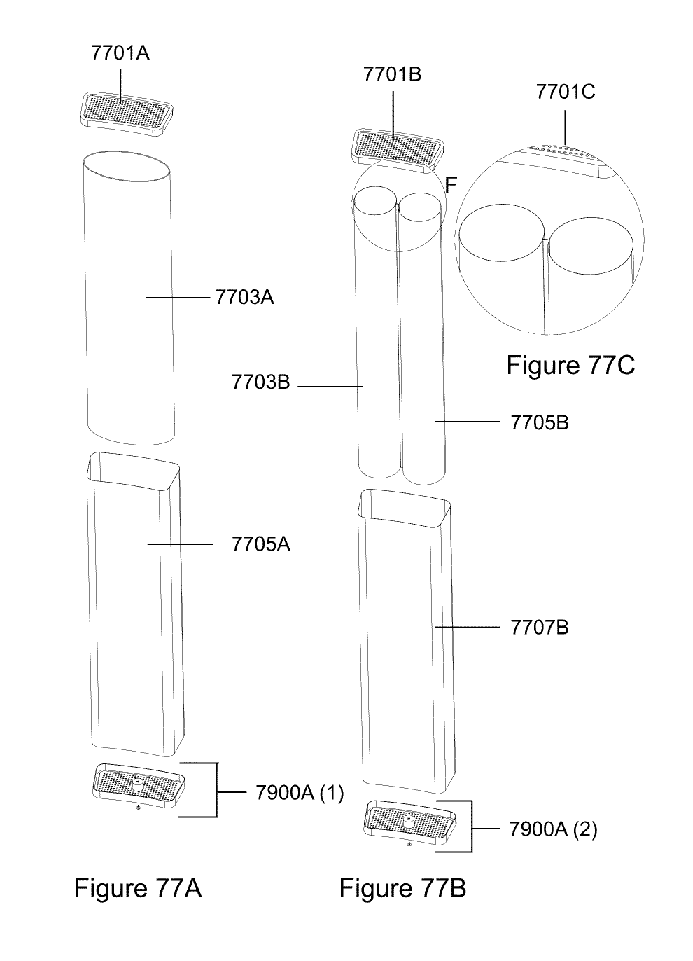

FIG. 77A

### 7701A Top Lid of Lattice Bag

7703A Insert in the shape of an oval

### 7705A Flexible Bag or Rigid Bag

7900A (1) A Bottom Lid assembly of a Lattice Bag or structure

FIG. 77B

### 7701B Top Lid of Lattice Bag

7703B Left Hollow Tube that could house MDM
7705B Right Hollow Tube that could house MDM

### 7707B Flexible Bag or Rigid Bag

7900A (2) A Bottom Lid assembly of a Lattice Bag or structure

FIG. 77C

### 7701C Double Tube Insert

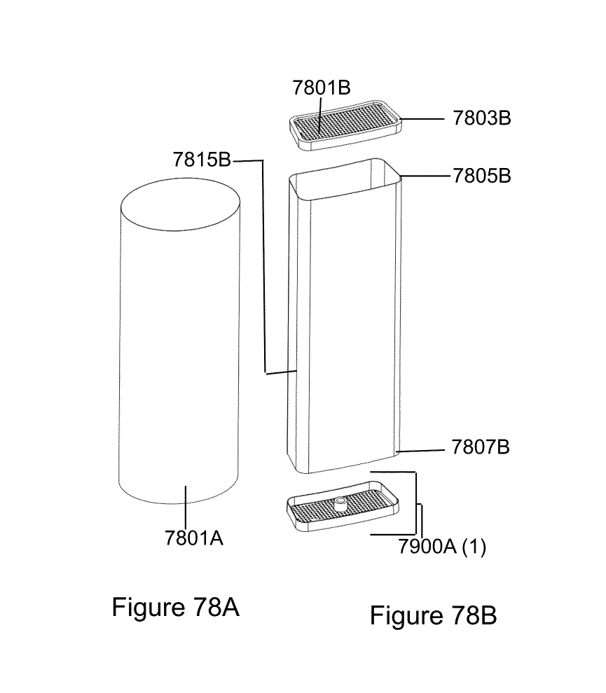

FIG. 78A

7801A Unshaped tube prior to shaping

FIG. 78B

7801B Molded hole pattern for adsorption and/or circulation. Molded Holes are limited to the size MDM particle that will not pass through it

### 7803B Injection Molded Top Cap

7805B Perimeter Bond Area Bonds to 7803B via adhesives or thermal weld
7807B Perimeter Bond Area Bonds to 7900A (1) via adhesives or thermal weld

### 7815B Extruded Perforated Film Bag

7900A (1) A Bottom Lid Assembly of a Lattice Bag or structure

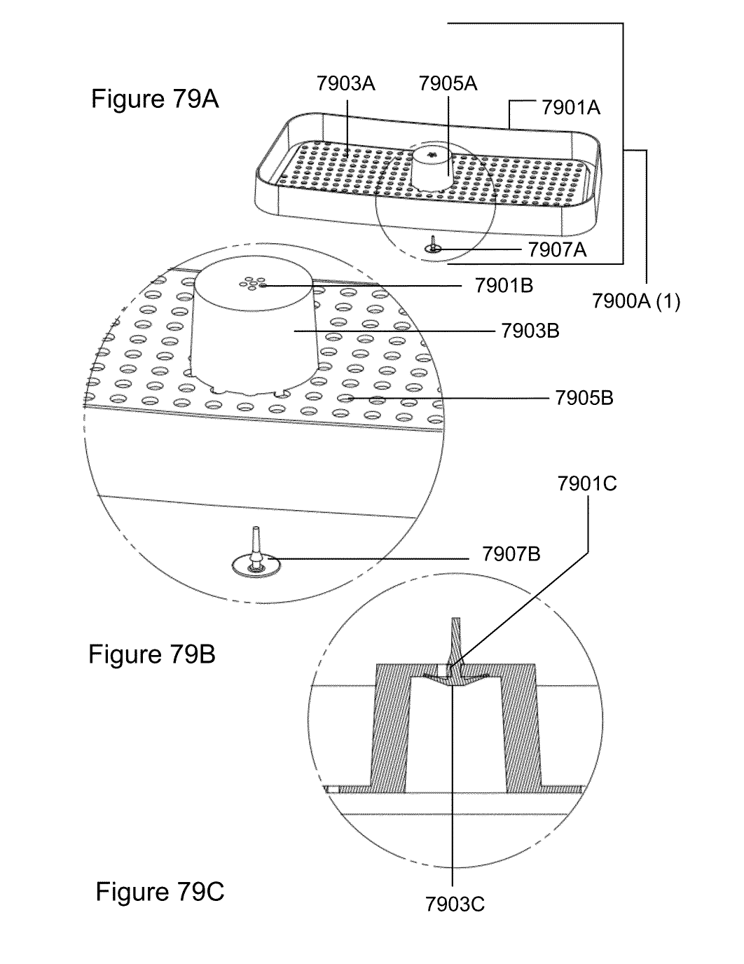

FIG. 79A

7900A (1) A Bottom Lid Assembly of a Lattice Bag or structure
7903A Micro Perforation Void filled with soluble coating

### 7905A Vacuum Chuck

### 7907A Umbrella Valve

FIG. 79B

7901B Circulation holes for vacuum chuck
7903B Body of Vacuum chuck
7905B Voids filled with soluble coating

### 7907B Closeup of Umbrella Valve

FIG. 79C

7901C Prongs of Umbrella Valve Affixed to Inner area of Chuck

### 7903C Installed Umbrella Valve in a Sealed Non Vacuum State

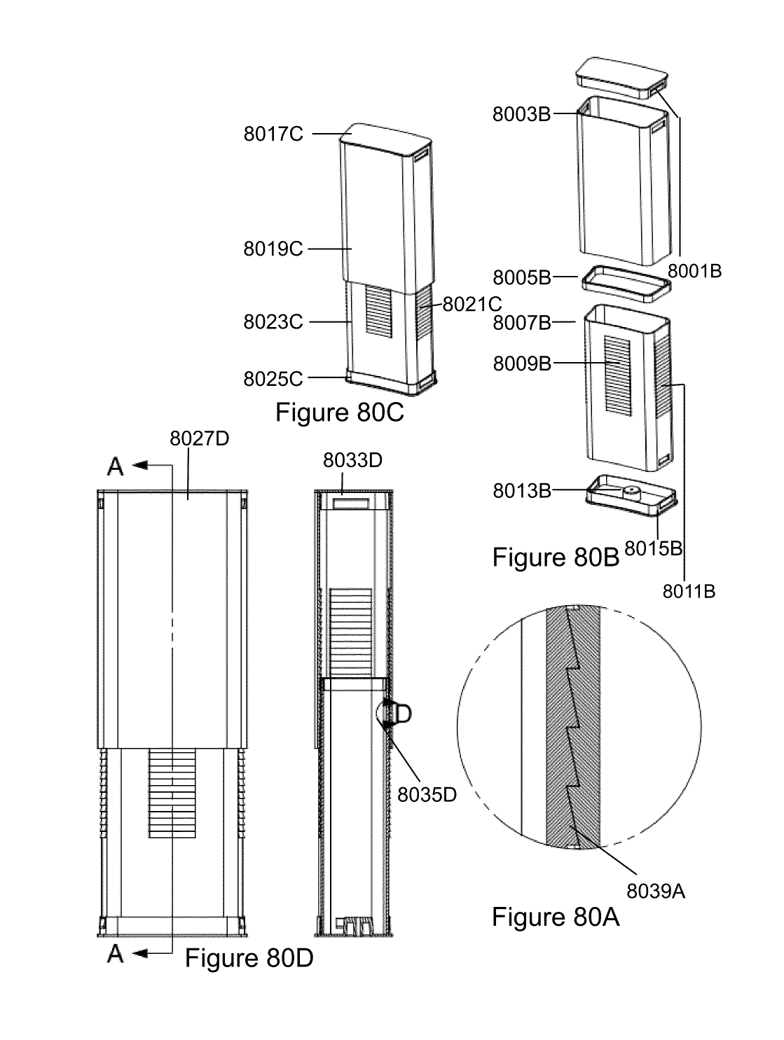

FIG. 80A

8039A Closeup of Side Ratchets as they are enabled in assembly to lower

FIG. 80B

8001B A lid with a snap fit feature, that is perforated but coated in this illustration with a soluble coating
8003B Snap fit feature on Top of Lattice Structure
8005B Gasket made of Silicone, Urethane, or other sealant elastic type of material
8007B Top of bottom Lattice Structure which 8005 fits into. It is also perforated but coated in this illustration with a soluble coating, or in another iteration it could be laminated with a soluble material such as EVOD.
8009B Front Incline Plane for Ratchet. It is also perforated but coated in this illustration with a soluble coating, or in another iteration it could be laminated with a soluble material such as EVOD.
8011B Side Incline Plane for Ratchet. It is also perforated but coated in this illustration with a soluble coating, or in another iteration it could be laminated with a soluble material such as EVOD.
8013B A vacuum chuck as first seen in FIG. 79C
8015B Bottom Lid with a snap fit feature, which is perforated but coated in this illustration with a soluble coating

FIG. 80C

8017C As first seen in 8001B is an assembled snap fit lid
8019C As first seen in 8003B is an assembled Top Lattice Structure with Lid in place and ready to lower to appropriate level of evacuation, determined by the variable crush point of the MDM material that is loaded
8021C Side Ratchets as they are enabled in assembly to lower
8023C Front Panel of Lower assembly with Ratchets as they are enabled in assembly ready to lower to evacuation target ratchet
8025C Bottom Lid for Lattice Structure which 8005B fits into. It is also perforated but coated in this illustration with a soluble coating, or in another iteration it could be laminated with a soluble material such as EVOD.

FIG. 80D

8027D Section Line Designation of assembly
8033D Side View Section AA of assembly with Lid in place
8035D Side View of Side Ratchets as they are enabled in assembly to lower

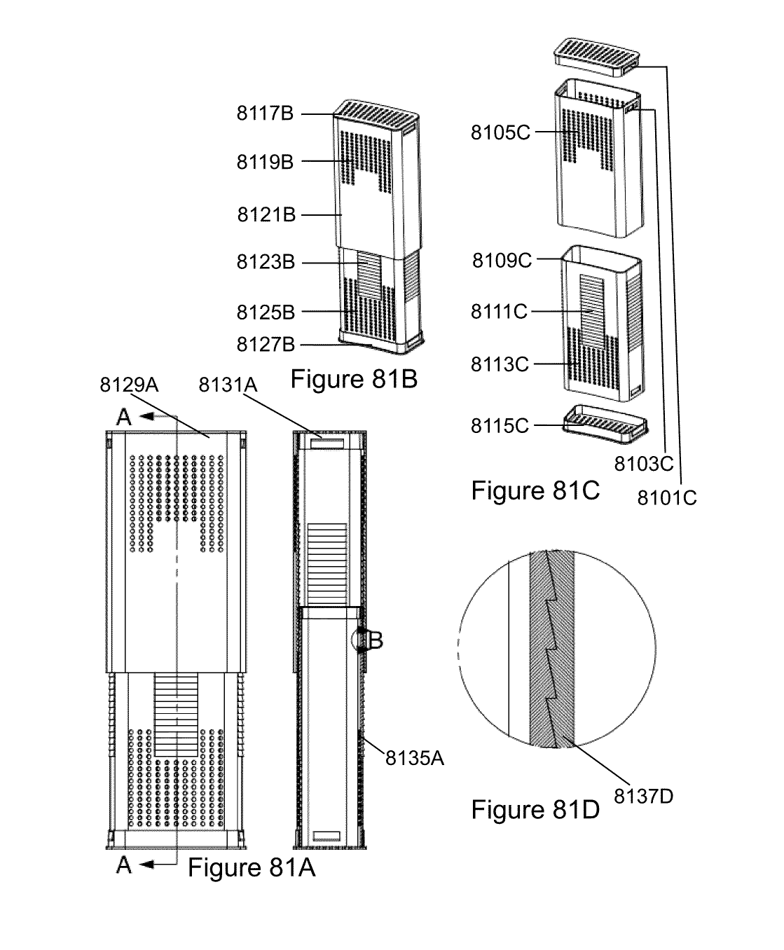

FIG. 81A

8129A Section Line Designation of assembly
8131A Section AA of assembly

### 8135A Ratchet Mechanism

FIG. 81B

8117B Top lid with a snap fit feature, that is populated with micro holes to enable compression and adsorption of constituents post deployment
8119B Perforations as described in 8105
8121B Front of Top Lattice assembly of Incline Plane Exterior

### 8123B Incline Plane for Ratchet

8125B Lower assembly of Incline Plane Exterior perforations
8127B Assembled Bottom Snap Fit Lid for Lattice Structure which bottom of 8109C fits into

FIG. 81C

8101C A lid with a snap fit feature, that is populated with micro holes to enable compression and adsorption of constituents post deployment
8103C Snap fit feature on Top of Lattice Structure
8105C Cad knife, laser or water jet micro, photo etched or stamped or molded holes in the Lattice assembly
8109C Top of bottom Lattice Structure which 8105C fits into. It is also perforated but coated in this illustration with a soluble coating, or in another iteration it could be laminated with a soluble material such as EVOD.
8111C Front Incline Plane for Ratchet. Ratchet would only advance to the variable point so as not to crush or damage the MDM.
8113C Lower Lattice Bag part, which has perforations cut by CAD knife, laser or water jet micro holes that is a component of the lower Lattice assembly
8115C Bottom Snap Fit Lid for Lattice Structure which bottom of 8109C fits into. Lid is interchangeable and could have an optional vacuum chuck.

FIG. 81D

### 8137D Close-up of Ratchet in 8135A

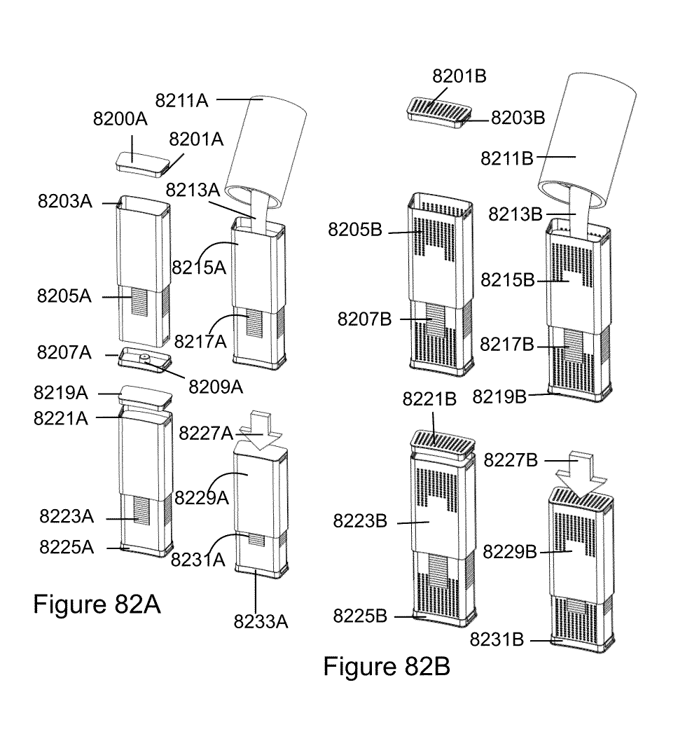

FIG. 82A

8200A Snap Fit Feature on Top Lid that can be affixed by soluble coating or if permanent, epoxy adhesive
8201A Snap Fit Feature that fits to the side of Bag
8203A Snap Fit Feature on the side of Bag Structure
8205A Ratchet Ramp (an inclined plane)
8207A Snap Fit Feature on Bottom Lid that can be affixed by soluble coating or if permanent, thermal cycled epoxy adhesive
8209A One Way Exit Valve for escaping air when compressing MDM
8211A Showing container of MDM bulk materials
8213A Showing filling of MDM material Will not fill all the way to the top, variable volume according to the density of the material, so as not to the damage the material. One manufactured solution for different density materials to avoid crushing the material.
8215A Top portion of Body
8217A Ratchet Ramp (an inclined plane)
8219A Having been filled prior to compressing Lid is not affixed at this point or at 8227A but prior to compression vibration option may be deployed if specific MDM will not be damaged.
8221A Snap Fit Feature on the side of Bag Structure
8223A Ratchet Ramp (an inclined plane)

### 8225A 8207A Affixed

8227A 8219A Affixed and force motion is deployed by hand/or machine
8229A Top Section of Structure in motion on 8231A
8231A Ratchet Ramp inclined plane descending to maximum density level

### 8233A Lower Lid Assembled

FIG. 82B

8201B Injection Molded or Cut or photo etched Holes in Top Lid
8203B Snap Fit Feature on Top Lid that can be affixed by soluble coating or if permanent epoxy adhesive

### 8205B Injection Molded Holes in Top Portion of Ratchet Lattice Structure

8207B Ratchet Ramp (an inclined plane)
8211B Showing container of MDM bulk materials
8213B Showing filling of MDM material. Will not fill all the way to the top, vary volume according to the density of the material, so as not to the damage the material. One manufactured solution for different density materials to avoid crushing the material.
8215B Top Body Component of Ratchet Lattice assembly
8217B Ratchet Ramp (an inclined plane)
8219B Snap Fit Bottom Lid that can be affixed by soluble coating or if permanent epoxy adhesive
8221B Post MDM filling Lid is ready to be affixed
8223B Top Component of Ratchet Lattice assembly
8225B Snap Fit Bottom Lid that can be affixed by soluble coating or if permanent epoxy adhesive
8227B 8219A is affixed and force motion is deployed by hand/or machine
8229B Top Component of Ratchet Lattice assembly Descending to maximum density level using a Ratchet Ramp (an inclined plane)
8231B Snap Fit Bottom Lid that can be affixed by soluble coating or if permanent, thermal cycled epoxy adhesive, which can also fit into or on top of a vibration table.

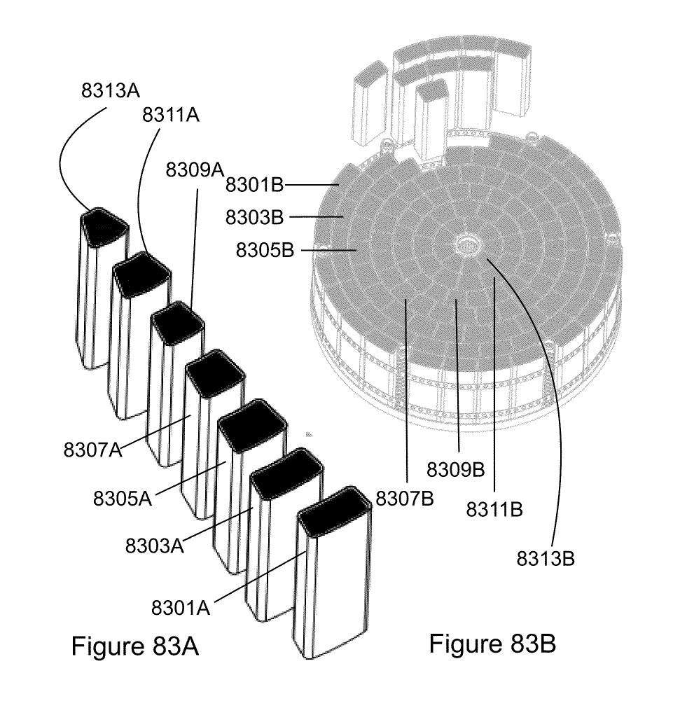

FIG. 83A

8301A Perimeter Rounded Rectangle Lattice Seventh Row that is repeatable twenty-four times within the row, and repeatable into multiple Cartridges of different shapes. Position is identified in FIG. 83B 8301B.
8303A Rounded Rectangle Lattice Sixth Row that is repeatable twenty-four times within the row, and repeatable into multiple Cartridges of different shapes. Position is identified in FIG. 83B 8303B.
8305A Keystone Lattice Fifth Row that is repeatable twenty-four times within the row, and repeatable into multiple Cartridges of different shapes. Position is identified in FIG. 83B 8305B.
8307A Keystone Lattice Fourth Row that is repeatable twenty-four times within the row, and repeatable into multiple Cartridges of different shapes. Position is identified in FIG. 83B 8307B.
8309A Keystone Lattice Third Row that is repeatable twenty times within the row, and repeatable into multiple Cartridges of different shapes. Position is identified in FIG. 83B 8309B.
8311A Keystone Lattice Second Row that is repeatable twelve times within the row, and repeatable into multiple Cartridges of different shapes. Position is identified in FIG. 83B 8311B.
8313A Keystone Lattice First Row that is repeatable nine times within the row, and repeatable into multiple Cartridges of different shapes. Position is identified in FIG. 83B 8313B.

FIG. 83B

### 8301B Lattice Bag or Structure for Seventh Repeatable Row (Perimeter Row)

### 8303B Lattice Bag or Structure for Sixth Repeatable Row

### 8305B Lattice Bag or Structure for Fifth Repeatable Row

### 8307B Lattice Bag or Structure for Fourth Repeatable Row

### 8309B Lattice Bag or Structure for Third Repeatable Row

### 8311B Lattice Bag or Structure for Second Repeatable Row

### 8313B Lattice Bag or Structure for First Repeatable Row (Inner Row)

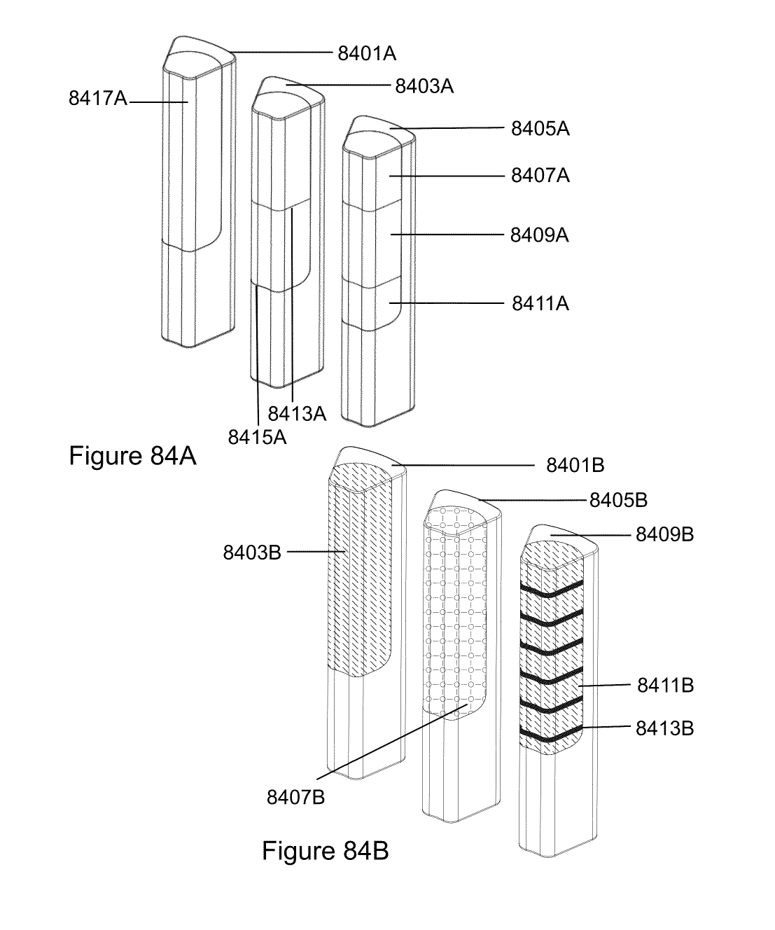

FIG. 84

8401A Lattice Bag or Structure which could be in any of the shapes of FIG. 130, or any of the Lattice Structures shown within this patent
8403A Second Lattice Bag or Structure which could be in any of the shapes of FIG. 130, or any of the Lattice Structures shown within this patent
8405A Third Lattice Bag or Structure which could be in any of the shapes of FIG. 130, or any of the Lattice Structures shown within this patent
8407A Within the 8405A three strata levels with this level (levels are dependent upon assay and associated placement, which can have another variable of multiple layers of different strata that could be targeted by multiple layers of specific MDM). In this illustration it is indicating MDM type at third from lowest gravitational strata level.
8409A Within the 8405A three strata levels with this level indicating MDM type at second from lowest gravitational strata level
8411A Within the 8405A three strata levels with this level indicating MDM type at the lowest gravitational strata level
8413A Within the 8403A two strata levels with this level (levels are dependent upon assay and associated placement, which can have another variable of multiple layers of different strata that could be targeted by multiple layers of specific MDM). In this illustration it is indicating MDM type at second from lowest gravitational strata level.
8415A Within the 8403A two strata levels with this level indicating MDM type at the lowest gravitational strata level
8417A Indicating a Lattice filled within 8401A of one volume of specific MDM which could be deployed at a specific strata

FIG. 84B

8401B Lattice Bag or Structure which could be in any of the shapes of FIG. 130, or any of the Lattice Structures shown within this patent
8403B Ceramic Material for functions such as insulation or cooling
8405B Second Lattice Bag or Structure which could be in any of the shapes of FIG. 130, or any of the Lattice Structures shown within this patent
8407B Floating inserts that promote buoyancy such as hollow spheres, which could be made from materials such as ceramic or biodegradable plastic or polyamide
8409B Third Lattice Bag or Structure which could be in any of the shapes of FIG. 130, or any of the Lattice Structures shown within this patent

### 8411B MDM

8413B Dosed or Doped Additives for specific functions such as Cu that can act as a biocide

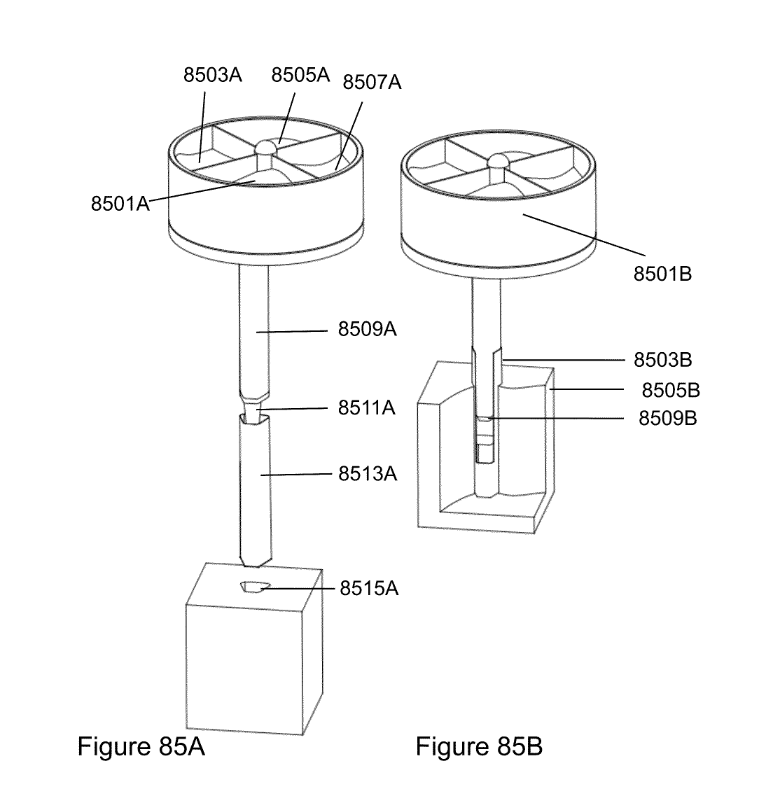

FIG. 85A

### 8501A First Container or Type of MDM Material

### 8503A Second Container or Type of MDM Material

### 8505A Third Container or Type of MDM Material

### 8507A Fourth Container or Type of MDM Material

### 8509A Turret Funnel Spout

### 8511A MDM

### 8513A Lattice Bag or Structure

### 8515A Bag Shaping Molds

FIG. 85B

### 8501B Multiple Container or Type of MDM Material

8503B Lattice Bag inside Turret Funnel Spout

### 8505B Mold

8509B Turret Funnel Spout that tamps and fills

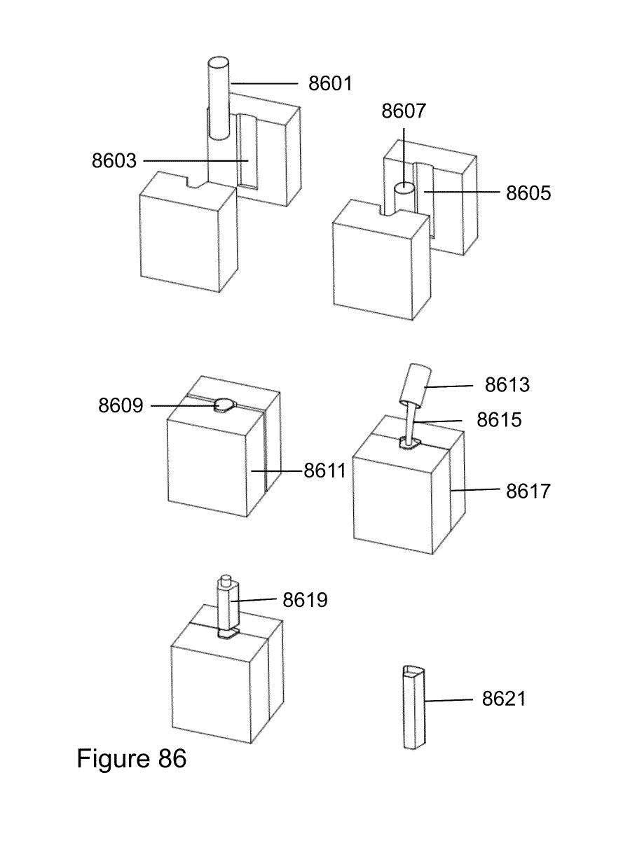

FIG. 86

### 8601 Cylinder Shape Pliable Material

### 8603 Keystone Shape Mold Female Component

8605 Insertion of cylinder into Male and Female Mold Parts
8607 Cylinder as described in 8601

### 8609 MDM Material Container

### 8611 Closed Mold

### 8613 MDM

### 8615 Filling Lattice Bag

### 8617 Closed Mold

### 8619 Tamping Mechanism

### 8621 Filled Lattice Bag

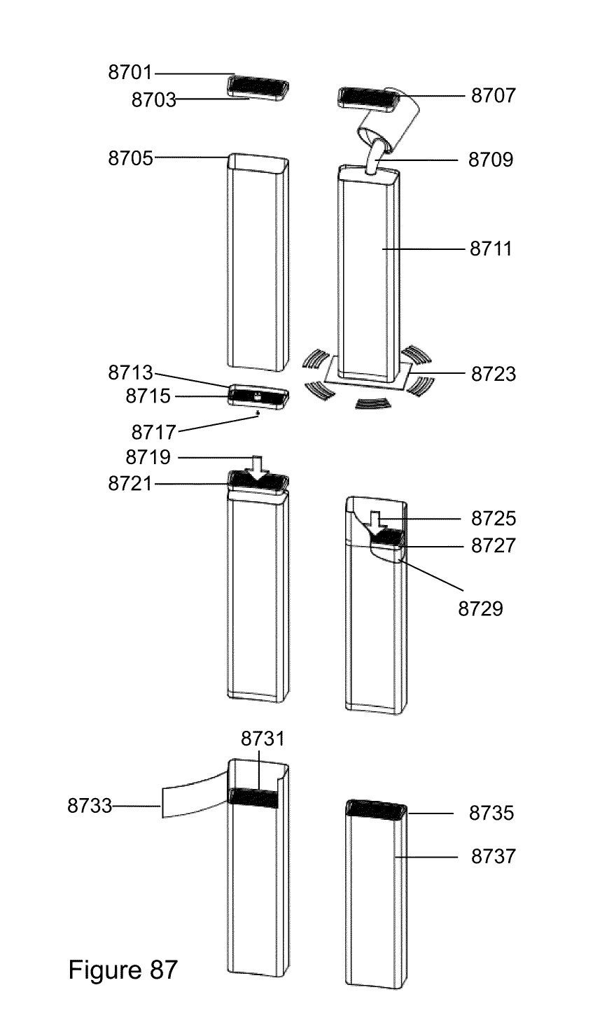

FIG. 87

8701 A Top Lid containing micro holes which has soluble coated or laminate application to fill holes that were cut via laser, water jet or CAD knife
8703 Tapered Cap-Lid that fits inside the Lattice Bag or Structure that enables it to flow down the Bag as the air in the material exits

### 8705 Top of Lattice Bag

### 8707 Tapered Cap-Lid

### 8709 MDM Material Filling Lattice Bag

8711 Front View of Lattice Bag, with 8715 bond welded or adhesive or thermal welded to the Lattice assembly
8713 A Bottom Lid containing Vacuum Chuck and Umbrella Valve, which has soluble coated or laminate application to fill holes that were cut via laser, water jet or CAD knife
8715 A Vacuum Chuck as first seen in FIG. 79A 7905A. Chuck can act as a one way valve if pressure is exerted instead of evacuation.
8717 An umbrella valve for the chuck as first seen in FIG. 79B 7907B
8719 Is representative of a Tamp that has minimum or no force and acts as a guide down the side walls to keep the tapered lid parallel with the side walls of the Lattice Bag or Structure
8721 Taper on Side Walls of Lid that contacts inner walls of the Lattice Bag
8723 Optional Variable Force Vibration Plate System for MDM materials where vibration force will not damage material but enable packing density concentration
8725 A plate that can be a holder with minimum pressure or if MDM density allows then a pressure plate for compression
8727 A cut through representing the area to be bonded, showing the Tapered Lid descending into the assembly as the air is evacuated and/or pressure is applied
8729 Cut-away that shows MDM inside Lattice Bag

### 8731 Fully Descended Tapered Lid

8733 Cut Away of Excess Lattice Bag material
8735 Trimmed Lattice Bag, with weld sealed Lattice cap

### 8737 Assembled Lattice Bag

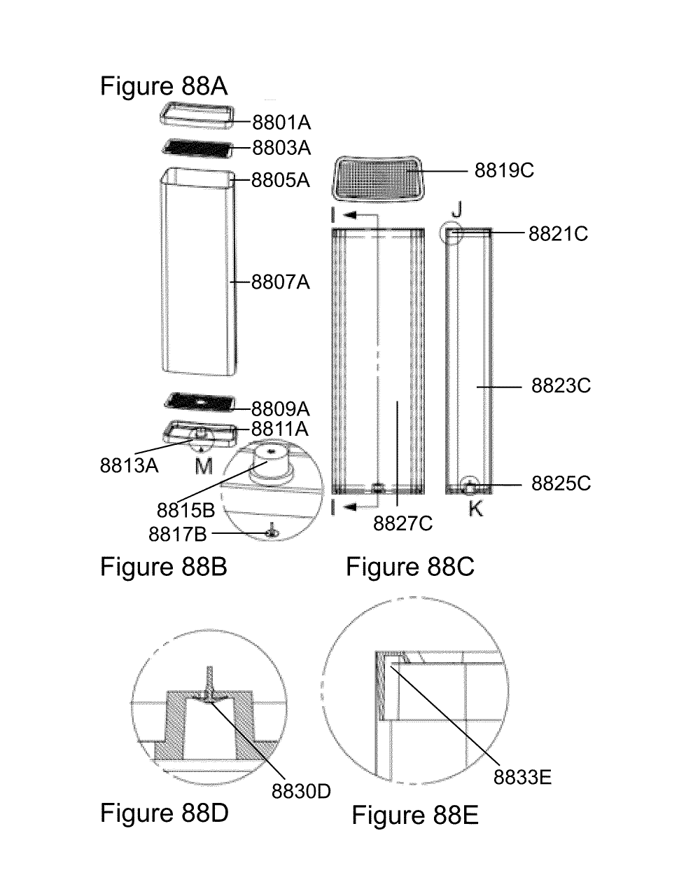

FIG. 88A

8801A A Top Lid with formed inset structure for film in 8803A, that force fits on the inside of 8805A
8803A Top Lid Film Inset that is micro perforated but filled with a soluble coating, in some deployments perforations may not be micro
8805A A film or metal plate insert that is photo-etched
8807A Lattice Bag that is perforated and either laminated with soluble coating or filled with soluble coating
8809A Bottom Lid Film Inset that is micro perforated but filled with a soluble coating. In some deployments perforations may not be micro; it also has an orifice for vacuum chuck to fit.
8811A Frame for bottom lid that 8809A fits into
8813A Vacuum Chuck that is shown in a closeup in 8815B

FIG. 88B

### 8815B Closeup of Vacuum Chuck

### 8817B Umbrella Valve

FIG. 88C

8819C Frontal View of assembled 8801A and 8803A
8821C Side View of Assembled Lattice Bag and Lid which lid is featured in 8833E

### 8823C Cross Section of View 8827C of Lattice Bag

### 8825C Umbrella Valve and Chuck Structure

### 8827C Front View of an Orthographic Projection of Lattice Bag

FIG. 88D

### 8830D Closeup of Umbrella Valve and Chuck Structure

FIG. 88E

8833E Film that is to the inside of the lid

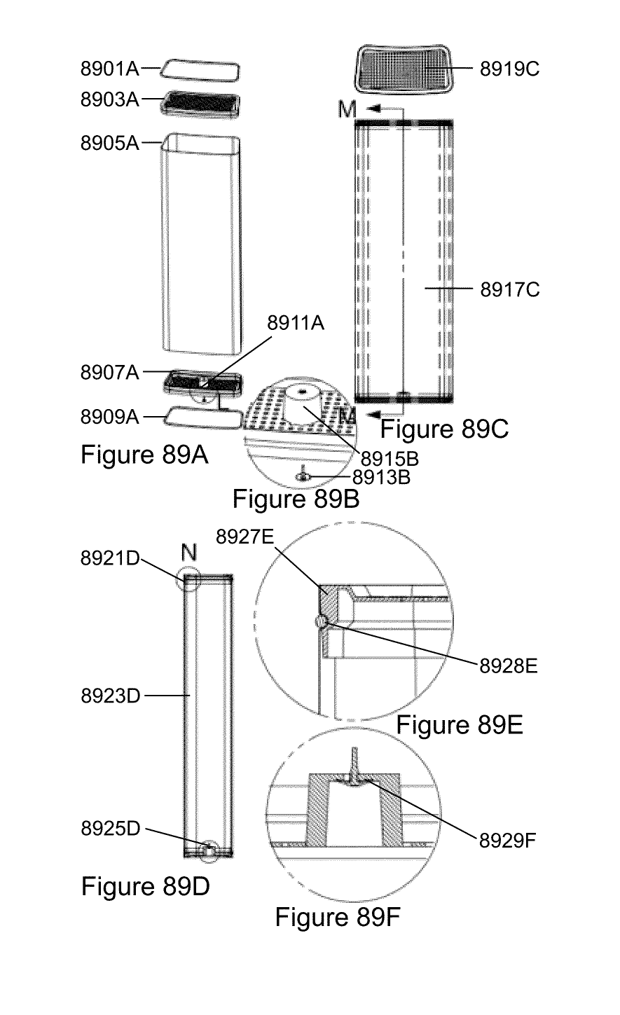

FIG. 89A

8901A Spline Band that holds 8903A in place within 8905A
8903A Top Lid with Coated Perforated Holes
8905A Lattice Bag that is perforated and either laminated with soluble coating or filled with soluble coating
8907A Bottom Lid Film Inset that is micro perforated but filled with a soluble coating; in some deployments perforations may not be micro. It also has an orifice for vacuum chuck to fit.
8909A Spline Band that holds 8907A in place within 8905A
8911A Vacuum Chuck with Umbrella Valve

FIG. 89B

### 8913B Umbrella Valve

8915B Closeup of Vacuum Chuck and Lid with Groove for 8909

FIG. 89C

### 8917C Front View of an Orthographic Projection of Lattice Bag

8919C Orthographic view of Top Lid with Elastic Band Assembled

FIG. 89D

### 8921D Orthographic Side View of Top Lid

### 8923D Orthographic Side View of Assembled Lattice Bag and Lid

### 8925D Orthographic Side View of Chuck

FIG. 89E

8927E Close-up of elastic band that holds the film to the lid showing a taper variation in the lid shown at 8921D

### 8928E Spline

FIG. 89F

8929F Closeup of Umbrella Valve and Chuck Structure with structural prongs inserted

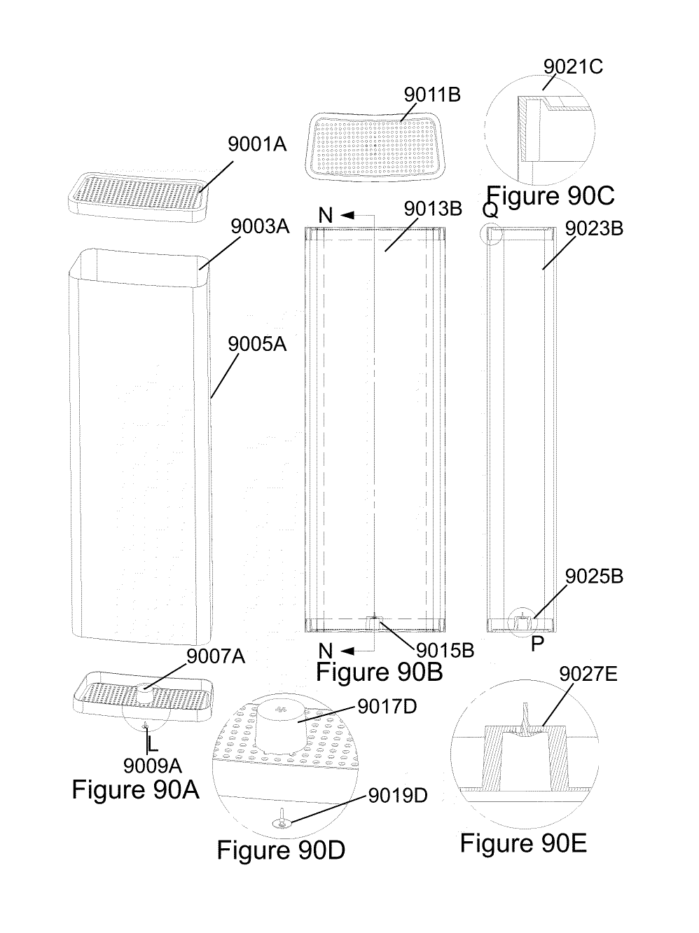

FIG. 90A

9001A Top Lid with Coated Perforated Holes, which could have been photo-etched, air cut, machined or cut with a jet laser or water

### 9003A Top of Lattice Bag

### 9005A Side Wall of Lattice Bag

### 9007A Vacuum Chuck

### 9009A Umbrella Valve

FIG. 90B

9011B Orthographic view of Top Lid with coated perforations

### 9013B Front View of an Orthographic Projection of Lattice Bag

### 9015B Vacuum Chuck

### 9023B Orthographic Side View of Assembled Lattice Bag and Lid

9025B Exemplary Vacuum Chuck in this case shown with optional Umbrella Valve

FIG. 90C

9021C Closeup of Lid fit of force fit

FIG. 90D

### 9017D Closeup of Vacuum Chuck

### 9019D Closeup of Umbrella Valve

FIG. 90E

9027E Closeup of Umbrella Valve and Chuck Structure with structural prongs inserted

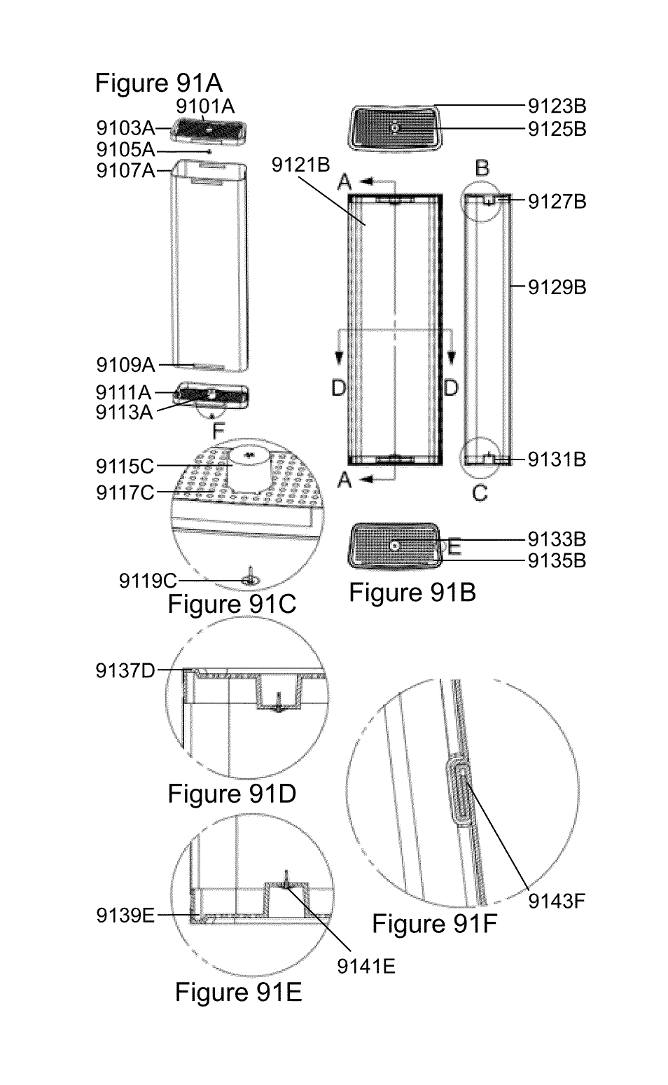

FIG. 91A

9101A Top Lid with Coated Perforated Holes and a Chuck

### 9103A Snap Fit Feature of Top Lid

### 9105A Umbrella Valve

9107A Top of Lattice Bag Structure with Snap Fit Feature
9109A Snap Fit Feature on bottom of Lattice Bag Structure, which has been perforated and then laminated with soluble material or coated with soluble coating

### 9111A Snap Fit Feature of Bottom Lid

### 9113A Chuck

FIG. 91B

### 9121B Front View of an Orthographic Projection of Lattice Bag

9123B Orthographic view of Top Lid with solubly coated perforations, and a vacuum chuck

### 9125B Vacuum Chuck in Top Lid

9127B Vacuum Chuck in Top Lid shown assembled with lid affixed

### 9129B Orthographic Side View of Assembled Lattice Bag and Lid

9131B Vacuum Chuck in Bottom Lid shown assembled with lid affixed
9133B Orthographic view of Top Lid with solubly coated perforations, and a vacuum chuck

### 9135B Vacuum Chuck in Top Lid

FIG. 91C

### 9115C Closeup of Vacuum Chuck

9117C Coated or Laminated Soluble material on perforations

### 9119C Closeup of Umbrella Valve

FIG. 91D

9137D Top Lid Incline Snap Fit Close-up on Top Lid with Vacuum Chuck and Umbrella Valve

FIG. 91E

9139E Bottom Lid Incline Snap Fit Close-up on Top Lid with Vacuum Chuck and Umbrella Valve

### 9141E Umbrella Valve

FIG. 91F

### 9143F Closeup of Rolled Form Interlocking Hem

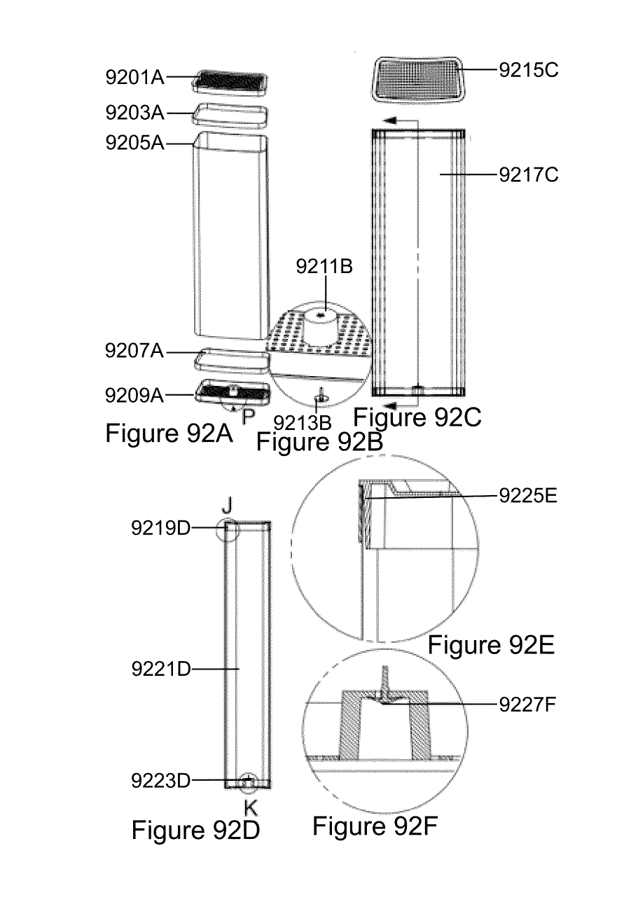

FIG. 92A

9201A Top Lid with Coated or Laminate Perforated Holes

### 9203A Aluminum Sleeve or Injection Interference Fit Ring

### 9205A Top of Lattice Bag Structure

### 9207A Gasket for 9209A

9209A Bottom Lid of Lattice Bag Structure, which has been perforated and then laminated with soluble material or coated with soluble coating and houses a Chuck

FIG. 92B

### 9211B Close-up of Chuck in 9209A

### 9213B Umbrella Valve

FIG. 92C

### 9215C Front View of an Orthographic Projection of Top Lid

### 9217C Front View of an Orthographic Projection of Lattice Bag

FIG. 92D

9219D Sectional Side view showing ferrule creating a compression fit between the film and lid

### 9221D Orthographic Side View of Assembled Lattice Bag and Lids

9223D Orthographic Side view showing chuck

FIG. 92E

9225E Close-Up detail view of Sectional Side View showing ferrule creating a compression fit between the film and lid

FIG. 92F

### 9227F Close-up of Vacuum Chuck and Umbrella Valve

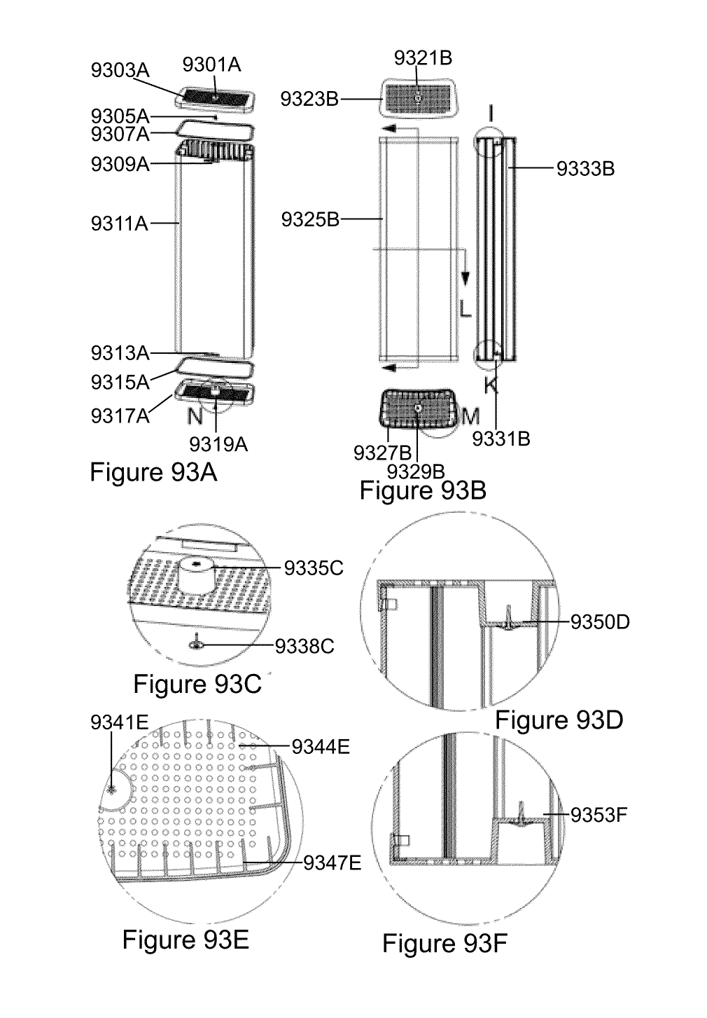

FIG. 93A

### 9301A Vacuum Chuck

9303A An extruded Lattice cap with chuck that snaps into plate within the extrusion, with perforations

### 9305A Umbrella Valve

### 9307A Silicone Sealing Gasket

9309A Top of Lattice Bag Structure that 9307A and 9303A fit into

### 9311A Lattice Bag or Structure

### 9313A Machine Slot for Snap Locking Tab

### 9315A Gasket for 9317A

9317A Bottom Lid with Solubly Coated or Laminated Perforations

### 9319A Vacuum Chuck on Bottom Lattice Top Lid

FIG. 93B

9321B Vacuum Chuck that snaps into the Top Lid Plate

### 9323B Front View of an Orthographic Projection of Lattice Structure Bag

### 9325B Front View of an Orthographic Projection of Top Lid

9327B Front View of an Orthographic Projection of Bottom Lid with Solubly Coated or Laminated Perforations

### 9329B Front View of Bottom Lid Vacuum Chuck

### 9331B Side View of Bottom Lid Vacuum Chuck

9333B Orthographic Side view of Lattice Structure featuring two Chucks

FIG. 93C

### 9335C Close-up of Vacuum Chuck

### 9338C Close-up of Umbrella Valve

FIG. 93D

### 9350D Top Lid Closeup of Vacuum Chuck and Umbrella Valve

FIG. 93E

### 9341E Holes in Vacuum Chuck

9344E Bottom Lid with Solubly Coated or Laminated Perforations
9347E Aluminum Extrusion Fins to transfer heat that also act as an interference fit for the lid

FIG. 93F

### 9353F Bottom Lid Closeup of Vacuum Chuck and Umbrella Valve

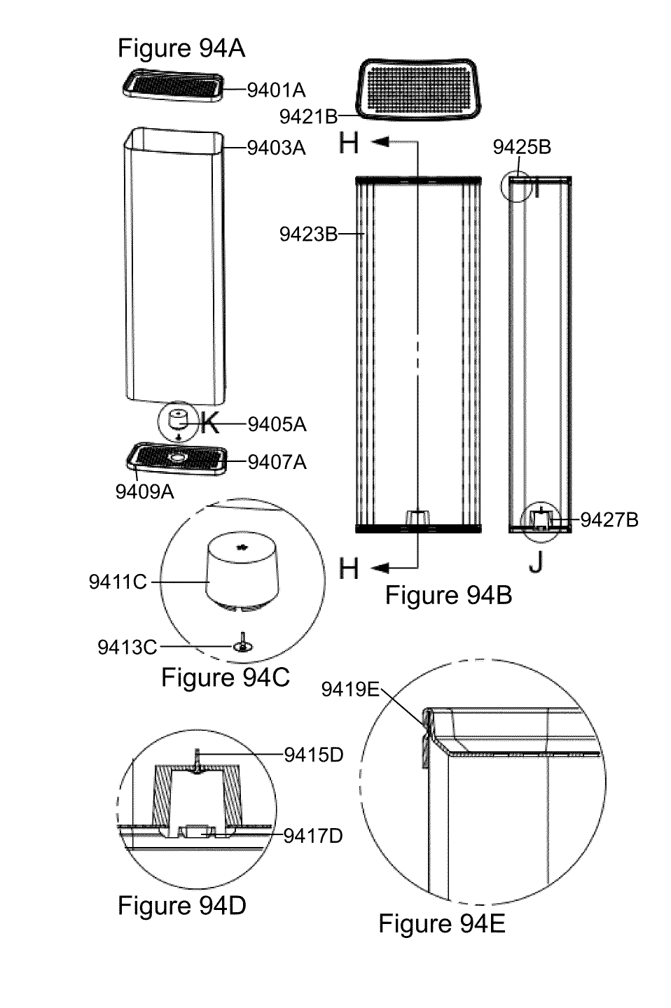

FIG. 94A

9401A Top Lid with Solubly Coated or Laminated Perforations
9403A Top of Lattice Bag Structure that 9401A fits into
9405A Vacuum Chuck that snaps into the orifice in 9407A
9407A Bottom Lid with Solubly Coated or Laminated Perforations
9409A Roll over edge of metal lid for crimping seal

FIG. 94B

9421B Front View of an Orthographic Projection of Top Lid with Solubly Coated or Laminated Perforations
9423B Front View of an Orthographic Projection of Lattice Structure or Bag with Solubly Coated or Laminated Perforations

### 9425B Reverse Can Opener Crimp Seal of 9401A

### 9427B Inserted Side View of 9415D and 9417D

FIG. 94C

9411C Close-up of Vacuum Chuck that is separately molded that snaps into either lid 9401A or 9409A

### 9413C Close-up of Umbrella Valve

FIG. 94D

### 9415D Inserted Close-up of Umbrella Valve

### 9417D Inserted Close-up of Vacuum Chuck

FIG. 94E

### 9419E Reverse Can Opener Crimp Seal of 9401A and 9409A

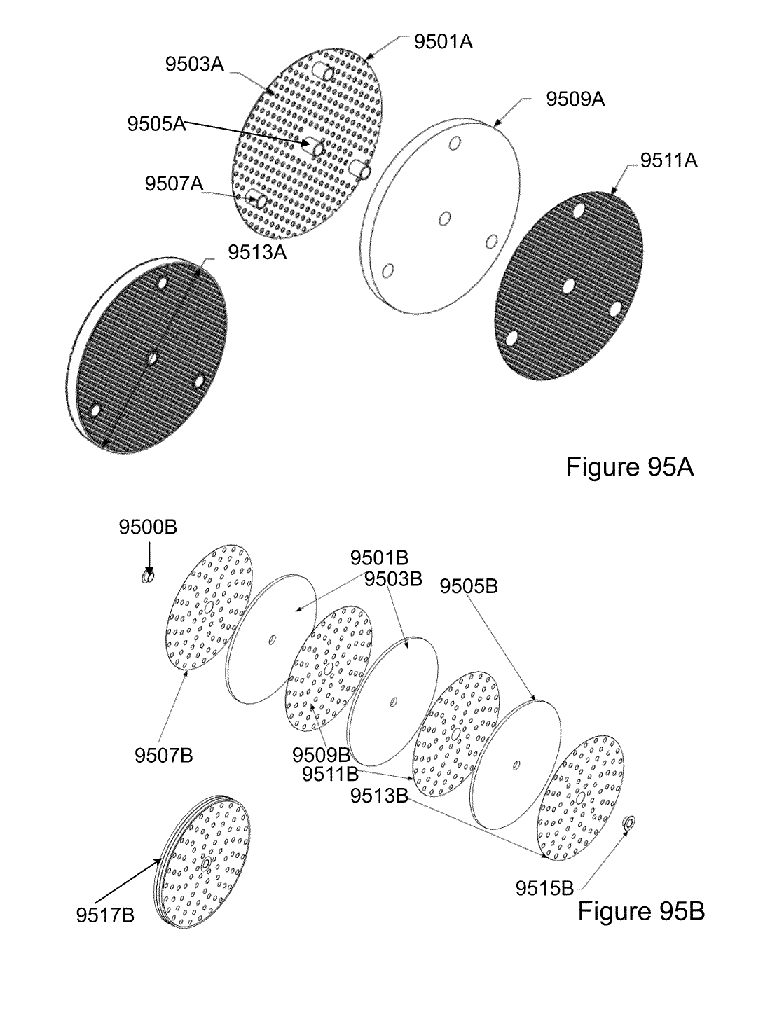

FIG. 95A

Like our Lattices, these forms do not depend on binders which provides the advantage of not damaging the material by the addition of the binder and avoids the expense, the added weight and added volume of the binder, which is subtractive from the total volume of potential adsorption capacity of the populated Vessel.

9501A Aluminum Lifting, Heating, and Structural Lifting Plate. Plate enables MDM to be ejected from mold without breaking Hole Pattern for gas flow and MDM retainment
9503A Perforation holes in plate
9505A Orifice for bushing gas flow
9507A Lifting Tubes Help retain MDM to plate

### 9509A MDM

9511A Metal or Polyamide Mesh Outer. Helps retain MDM, and assists adsorption and circulation and can act as a thermal conduit if made from a conductive metal. It can be a thermal conduit or if made from a transition metal then it can also facilitate catalysis.
9513A Assembled MDM Structure with Screen of Mesh that acts to reinforce the MDM (disc with holes) and assists adsorption and circulation and can act as a thermal conduit if made from a conductive metal. It can be a thermal conduit or if made from a transition metal then it can also facilitate catalysis.

FIG. 95B

### 9500B Back Lifting Bushing

### 9501B Compressed MDM

### 9503B Compressed MDM

### 9505B Compressed MDM

9507B Screen of Mesh that acts to reinforce the MDM (disc with holes) and assists adsorption and circulation and can act as a thermal conduit if made from a conductive metal. It can be a thermal conduit or if made from a transition metal then it can also facilitate catalysis.
9509B Screen of Mesh that acts to reinforce the MDM (disc with holes) and assists adsorption and circulation and can act as a thermal conduit if made from a conductive metal. It can be a thermal conduit or if made from a transition metal then it can also facilitate catalysis.
9511B Screen of Mesh that acts to reinforce the MDM (disc with holes) and assists adsorption and circulation and can act as a thermal conduit if made from a conductive metal. It can be a thermal conduit or if made from a transition metal then it can also facilitate catalysis.
9513B Screen of Mesh that acts to reinforce the MDM (disc with holes) and assists adsorption and circulation and can act as a thermal conduit if made from a conductive metal. It can be a thermal conduit or if made from a transition metal then it can also facilitate catalysis.
9515B Lifting Bushing threaded together after molding
9517B An assembled mold with MDM in center

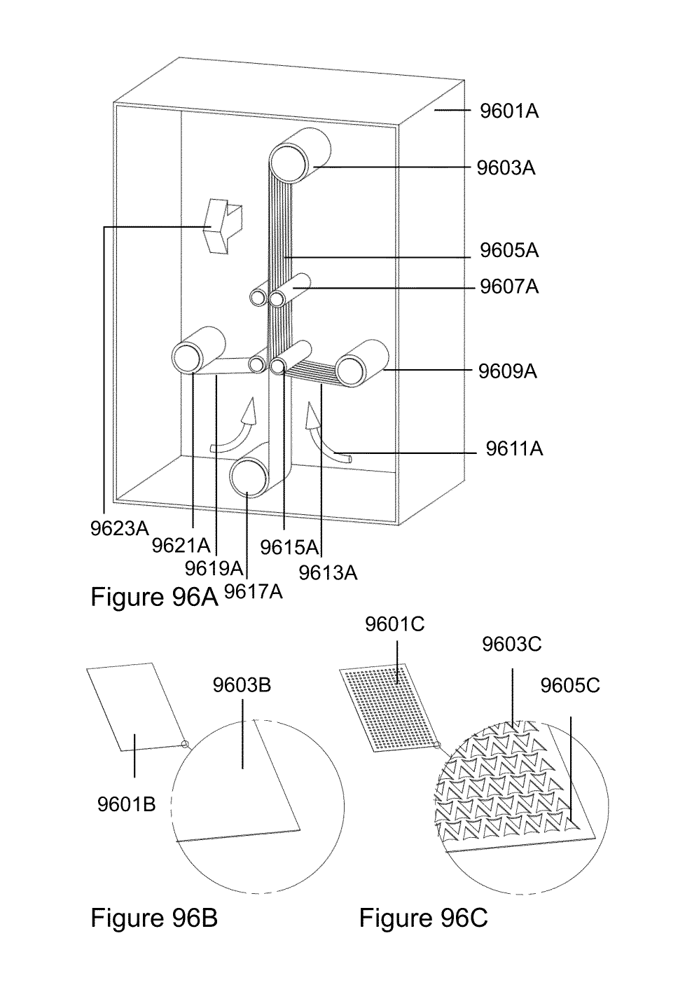

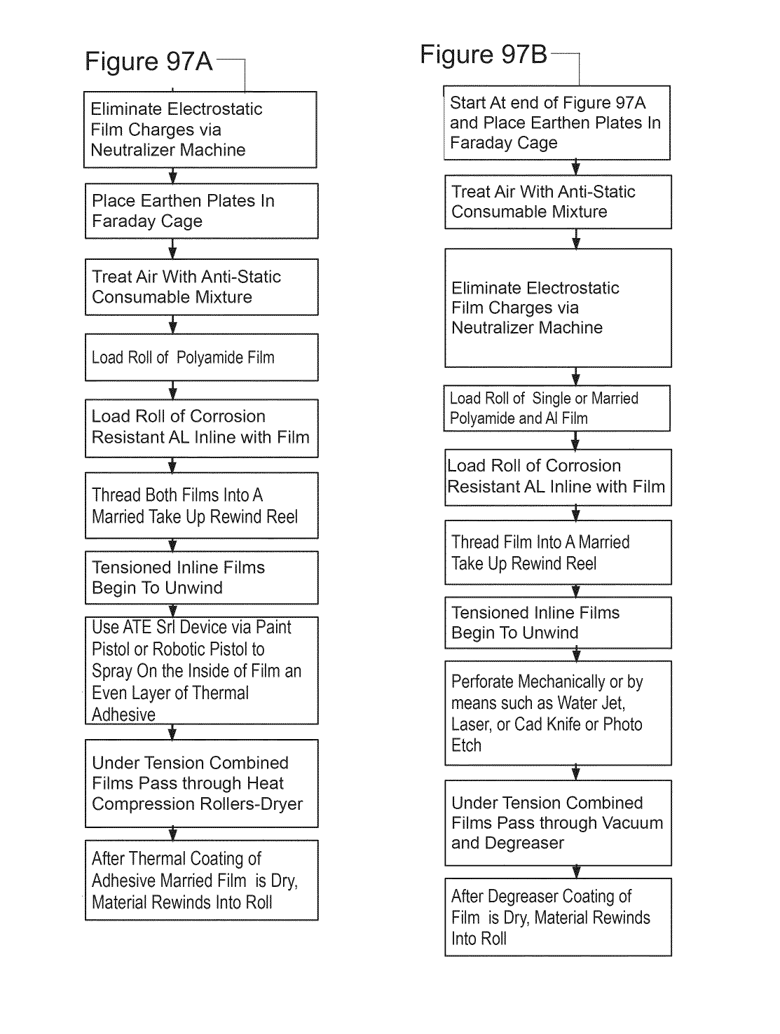

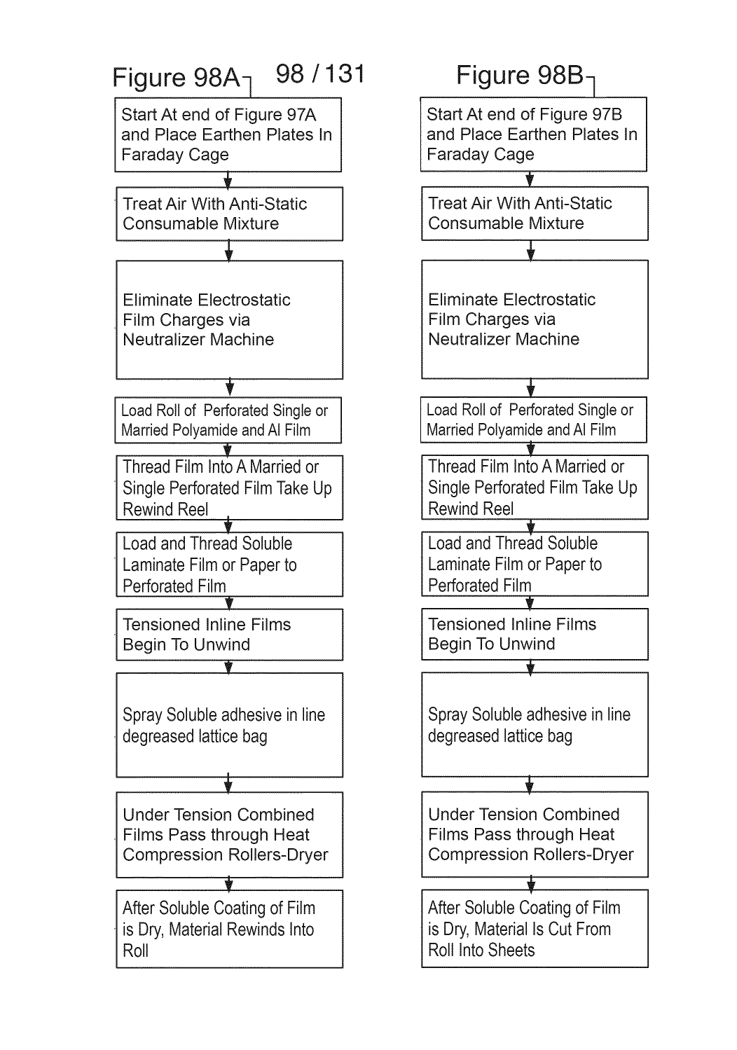

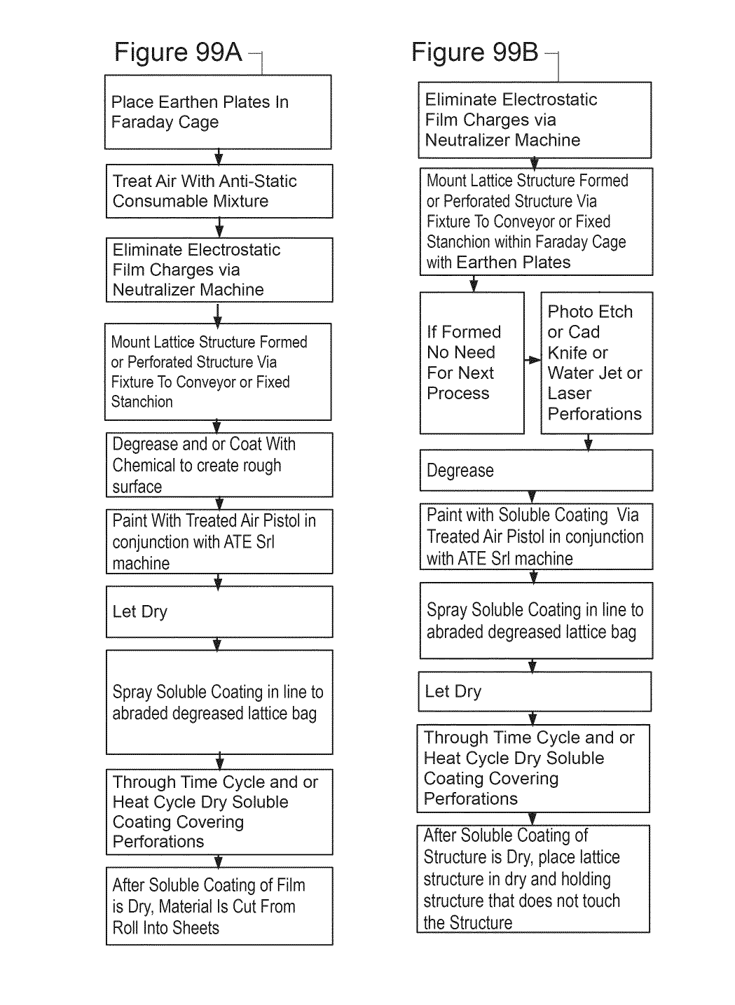

FIG. 96A

9601A Faraday cage

### 9603A Final Rolled Product of Laminate Films

9605A Final adhered laminate film
9607A Pressure and heat roller assembly
9609A Film such as corrosion-resistant Aluminum as thermal device or Cu as a biocide
9611A Heat from laminate rollers
9613A Pressure and heat roller assembly
9615A Pressure and heat roller assembly
9617A Primary Substrate film
9619A Outer layer of new laminate from roll of film such as EVOD
9621A Roll of film such as EVOD
9623A Conditioned Air that has mitigated electrostatic friction of the air and the films such as polyamide, metallic and other films that are prone to static electricity in the manufacturing process

FIG. 96B

9601B Sheet of Film that could have come off a continuous roll from FIG. 96A or could have been a pre-formed rigid structure or a panel inset of film that is manually, mechanically, or robotically coated.
9603B Close-up of a sheet segment of Final Rolled Product of Laminate Films with perforations. Soluble coated, which could also have been accomplished by methods such as dipping, spraying, and printing.

FIG. 96C

9601C Sheet of Film that could have come off a continuous roll from FIG. 96A
9603C Close-up of perforations or micro perforations of films or other material such as plastics or metals, that are perforated by such means as mechanical, laser, water jet, cad knife, or photo etching. The close-up is shown without coated perforations. Soluble coated, which could also have been accomplished by methods such as dipping, spraying, and printing.
9605C Perforations can act as a surface tension device depending on the environment, to allow adsorbed constituent to enter and the material to stay within the Lattice structure. The shape of the perforations dependent on the MDM can act as a keying mechanism to also further inhibit the MDM from leaving the Lattice structure.

A Mesh Screen can be laminated and soluble coated so perforations needs to be defined also as any permeable material, such as aramid textiles, metallic cloth, or porous glass.

FIG. 100A

10001A Lattice Cartridge Fastener that holds the Lattice Bags, Films, or MDM Sheets. Lattice Cartridge Fasteners are in different lengths to match MDM widths so that the entire Vessel may be filled with maximum material. The Lattice Fastener is machined from a rod of material such as a composite, a steel, or an aluminum
10003A Is the MDM material coated with soluble coating so perforations are not seen in the MDM material, or Lattice Bags. If film then perforations are not necessary
10004A Bottom of Hanging Lattice with two white spots that can be weights, functioning as positioning guides and as thermal conductors
10006A Represents a series of Lattice Structures within the Vessel
10007A A Rim receptacle that allows 10001A Lattice Cartridge Fastener Structure to nest and not drop into the Vessel
10009A A pillow Vessel, which could be in any of the Vessel shapes

FIG. 100B

10001B Is a Lattice Cartridge Fastener that holds the Lattice Bags or Films. Lattice Fasteners may be made out of transitional metals which may act as a catalyst, and are in different lengths to match MDM widths so that the entire Vessel may be filled with maximum material. The Lattice Fastener is machined from a rod of material such as a composite, a steel, or an aluminum
10003B The Catalysts, Transitional Metals and MDM material with perforations in the metal and the MDM material or Lattice Bags
10004B Bottom of Hanging Lattice with two white spots that can be weights, functioning as positioning guides and as thermal conductors
10005B Represents a series of Lattice Structures within the Vessel
10007B A Rim receptacle that allows 10001B Lattice Fastener Structure to nest and not drop into the Vessel
10009B A pillow Vessel, which could be in any of the Vessel shapes

FIG. 100C

10011C Close-up of MDM material and metal

### 10012C Metal or Transitional Metal Plate

### 10013C Close-up of Lattice Fastener Locking Fixture

10015C Close-up of Lattice Bag(s) Fasteners in an open position

FIG. 100D

10019D Close-up of Lattice Cartridge Fastener Fixture in Closed Position which could hang in other exemplars such as a Grid
10021D Locking Fixture or Screw that is in place

FIG. 100E

### 10011E Close-up of MDM Film, or MDM Sheets or MDM Lattice Bags

### 10013E Close-up of Lattice Fastener Locking Fixture

### 10015E Close-up of Lattice Bag(s) Fasteners

FIG. 100F

10019F Close-up of Lattice Cartridge Fastener Fixture in Closed Position which could hang in other exemplars such as a Grid
10021F Locking Fixture or Screw that is in place

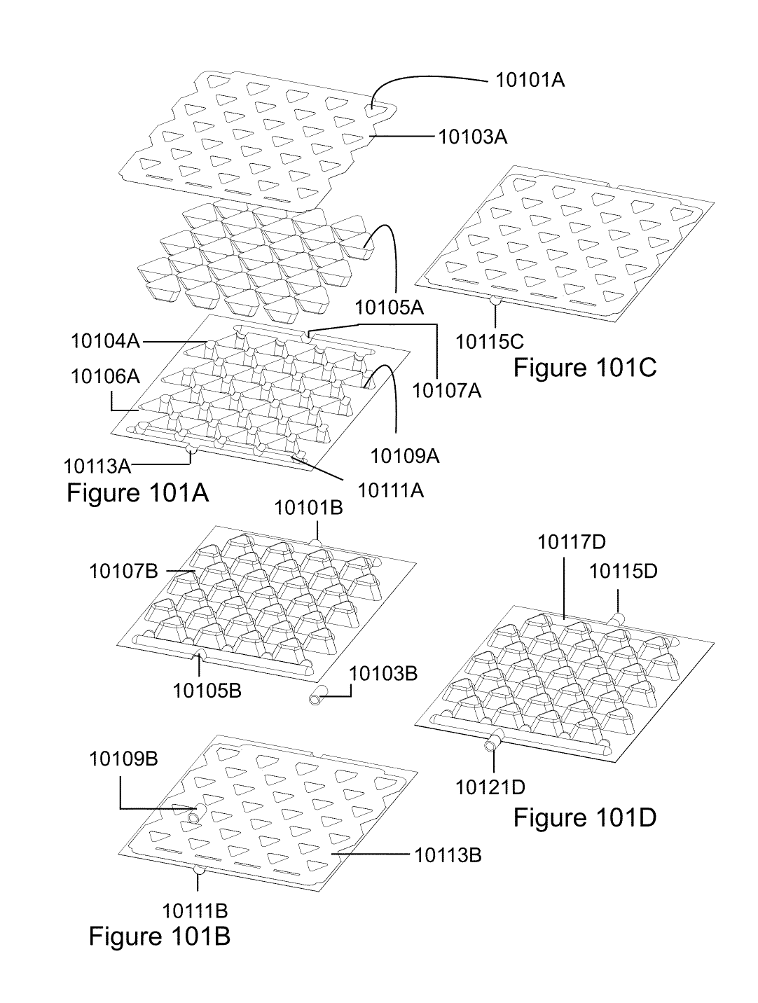

FIG. 101A

### 10101A Hole Pattern

10103A Film sheet that bonds to 10106A

### 10104A Constituent Passageway

### 10105A MDM

### 10106A Sheet Formed Lattice

### 10107A Outlet Nipple Groove

### 10109A Cup for MDM

### 10111A Manifold

### 10113A Inlet Nipple Groove

FIG. 101B

### 10101B Outlet Nipple Groove

### 10103B Outlet Nipple

### 10105B Inlet Nipple Groove

10107B Top of Dimple Cup Sheet Formed Lattice with 10103A Bonded to underside

### 10109B Inlet Nipple

### 10111B Inlet Nipple Groove

10113B assembly of Bottom Pressurized Sheet Form Dimple Cup Lattice and Lattice Film Sheet

FIG. 101C

10115C assembly of 10103A, 10105A, 10106A

FIG. 101D

10115D Outlet Nipple Bonded in place
10117D Pressurized Sheet Form Dimple Cup Lattice assembly of 10107B and 10113B
10121D Inlet Nipple Bonded in place

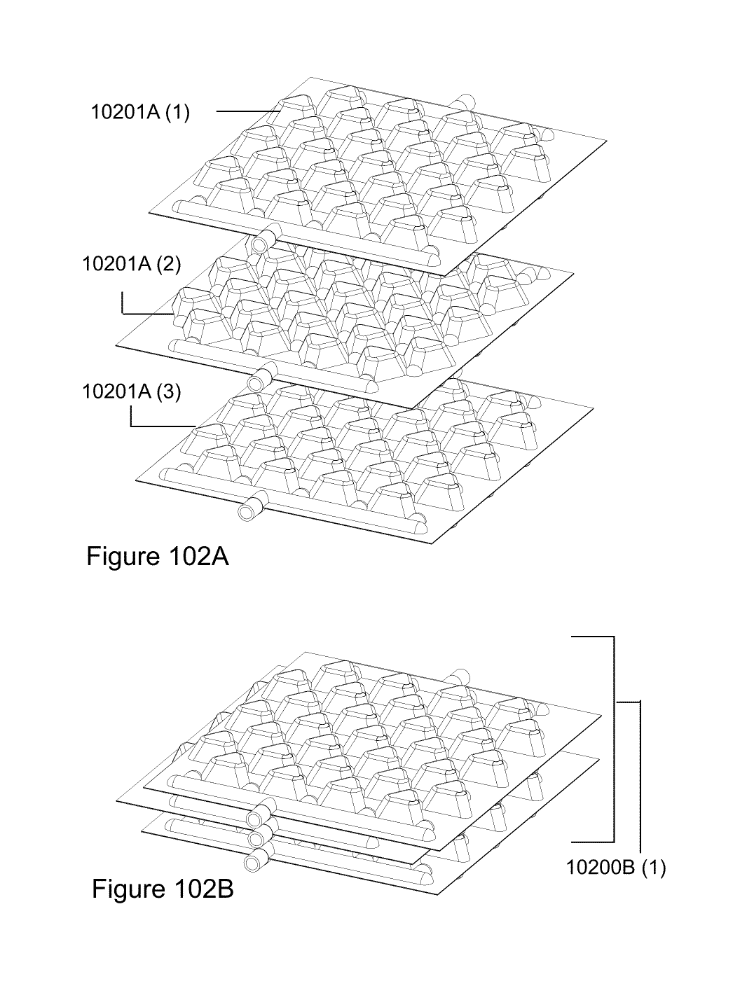

FIG. 102A

10201A (1) Pressurized Dimple Cup Sheet Form Lattice assembly
10201A (2) Pressurized Dimple Cup Sheet Form Lattice assembly
10201A (3) Pressurized Dimple Cup Sheet Form Lattice assembly

FIG. 102B

10200B (1) Nested Pressurized Dimple Cup Sheet Form Lattice assembly

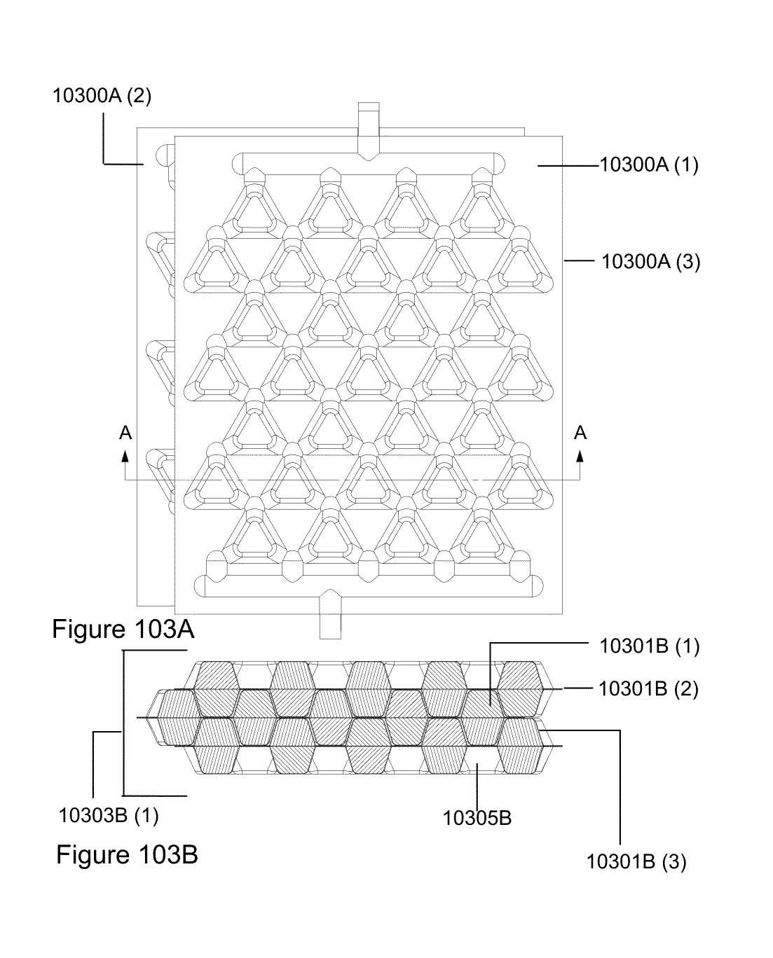

FIG. 103A

10300A (1) Pressurized Dimple Cup Sheet Form Lattice assembly
10300A (2) Pressurized Dimple Cup Sheet Form Lattice assembly
10300A (3) Pressurized Dimple Cup Sheet Form Lattice assembly (Hidden)

FIG. 103B

10301B (1) Pressurized Dimple Cup Sheet Form Lattice assembly
10301B (2) Pressurized Dimple Cup Sheet Form Lattice assembly
10301B (3) Pressurized Dimple Cup Sheet Form Lattice assembly
10303B (1) Nested assembly of 10301B (1), 10301B (2), 10301B (3)
10305B Mating Nest Surface For Pressurized Dimple Cup Sheet Form Lattice assembly

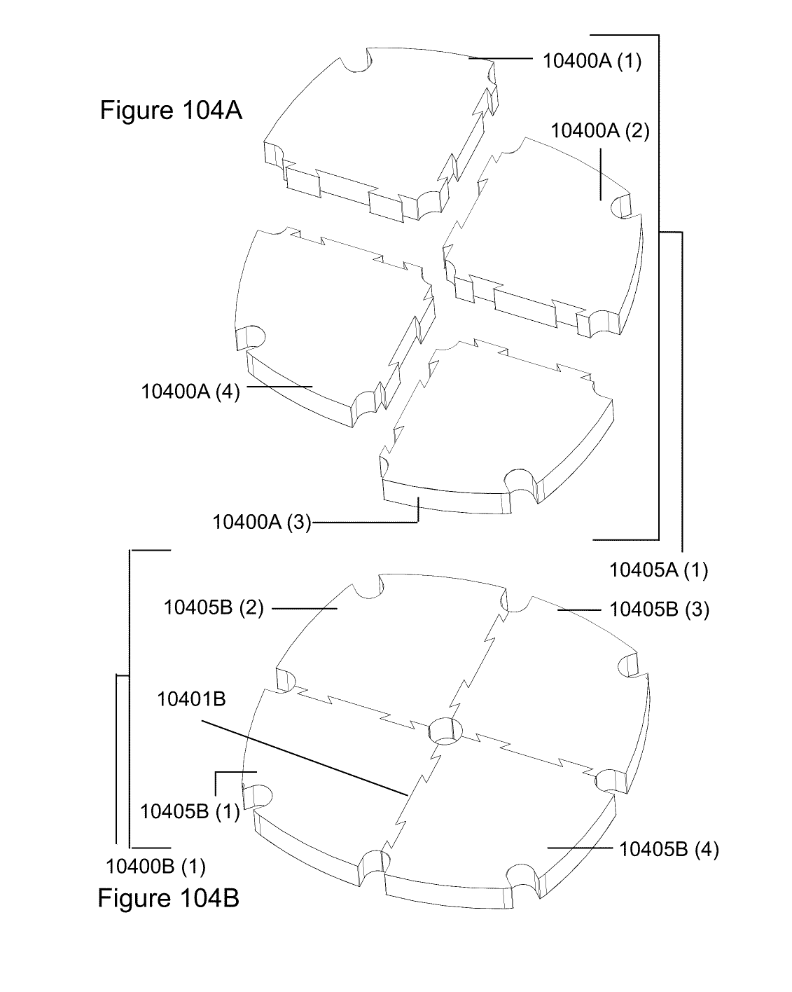

FIG. 104A

10400A (1) Populated Repeating Structural cage Pallet assembly
10400A (2) Populated Repeating Structural cage Pallet assembly
10400A (3) Populated Repeating Structural cage Pallet assembly
10400A (4) Populated Repeating Structural cage Pallet assembly
10405A (1) assembly of 10400A (1), 10400A (2), 10400A (3), and 10400A (4), Repeating Structural cage Pallet Assemblies lock together utilizing puzzle joints as seen in 10401B

FIG. 104B

10400B (1) assembly of 10405B (1), 10405B (2), 10405B (3), 10405B (4)
10405B (1) Populated Repeating Structural cage Pallet assembly
10405B (2) Populated Repeating Structural cage Pallet assembly
10405B (3) Populated Repeating Structural cage Pallet assembly
10405B (4) Populated Repeating Structural cage Pallet assembly

### 10401B Interlocking Puzzle Joint

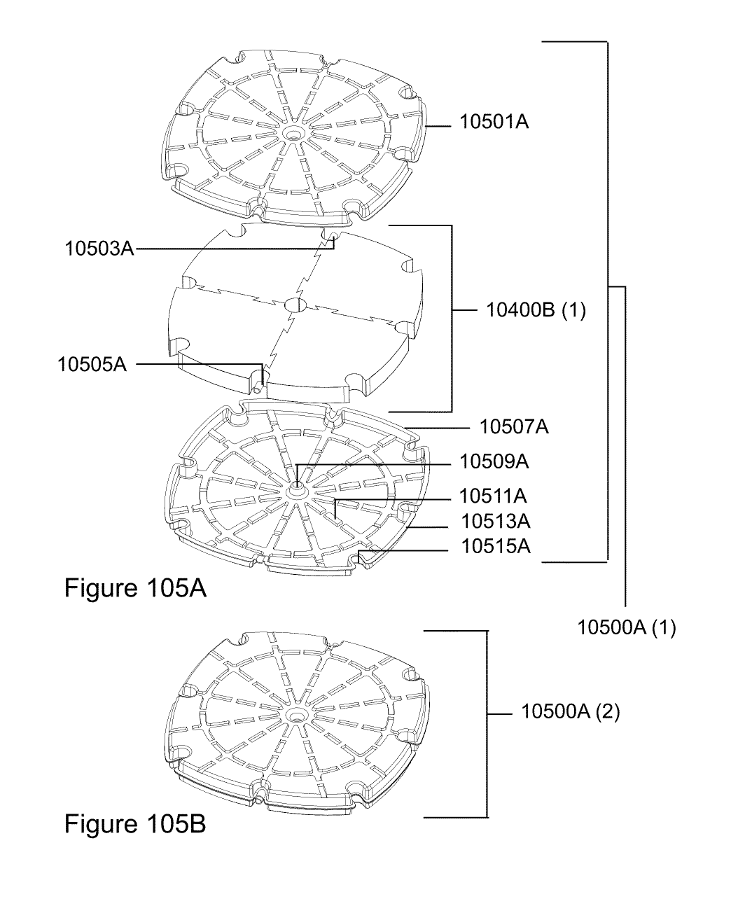

FIG. 105A

10500A (1) Populated assembly of FIG. 104B 10400B (1), 10501A, 10503A, 10505A, 10507A

### 10501A Upper Vessel Lid, Bonds to 10507A

### 10503A Nipple Outlet

### 10505A Nipple Inlet

10507A Lower Vessel Lid, bonds to 10501A

### 10509A Bonding Boss

### 10511A Raised Land Area

### 10513A Bond Flange

10515A Notch for optional structural column and support Cartridge

FIG. 105B

### 10500A (2) An Assembled 10500A (1)

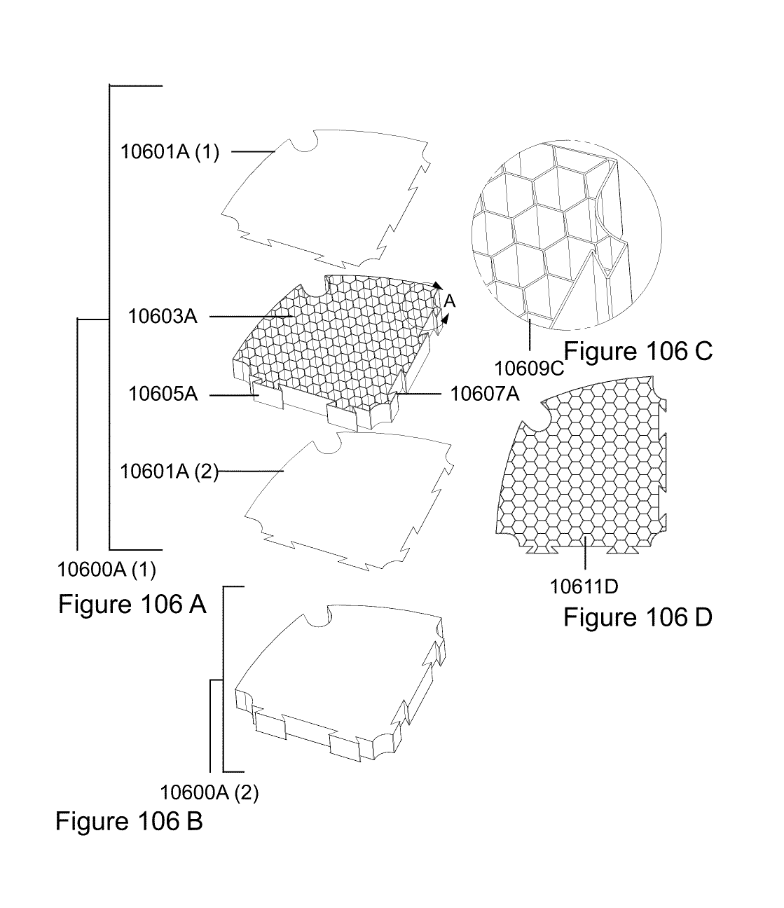

FIG. 106A

10600A (1) Populated assembly of 10601A (1), 10603A, 10601A (2),

### 10601A (1) Permeable or Perforated Film

### 10601A (2) Permeable or Perforated Film

10603A Populated Structural cage Pallet

### 10605A Male Puzzle Joint

### 10607A Female Puzzle Joint

FIG. 106B

10600A(2) An Exemplary Populated Repeating Structural cage Pallet assembly

FIG. 106C

### 10609C An Exemplary Close-up of FIG. 106A 10603A

FIG. 106D

### 10611D An Exemplary Top View of FIG. 106A 10603A

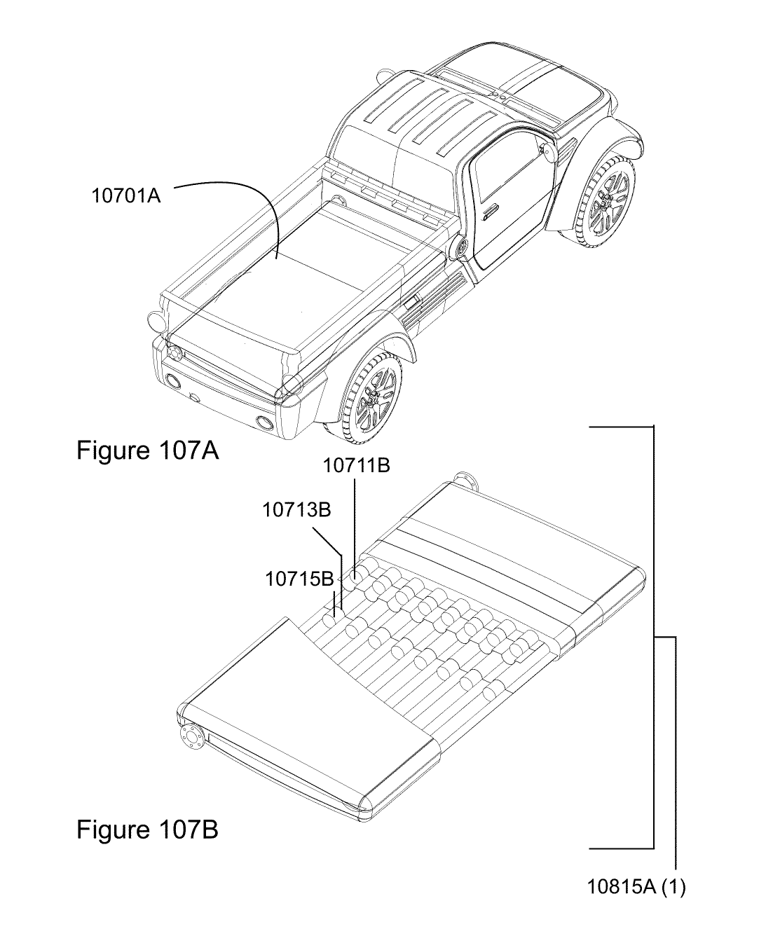

FIG. 107A

10701A Phantom view of Vehicle Vessel in Vessel under Vehicle Bed

FIG. 107B

10815A (1) Vehicle Vessel in Vessel assembly

### 10711B MDM in a Continuous Lattice Bag

10713B Exterior of an internal Vessel Chamber which could be made from processes such as Stamped if Metal or SFL if plastic, or a composite such as polyamide, aramid and graphene.

### 10715B MDM in a Continuous Lattice Bag

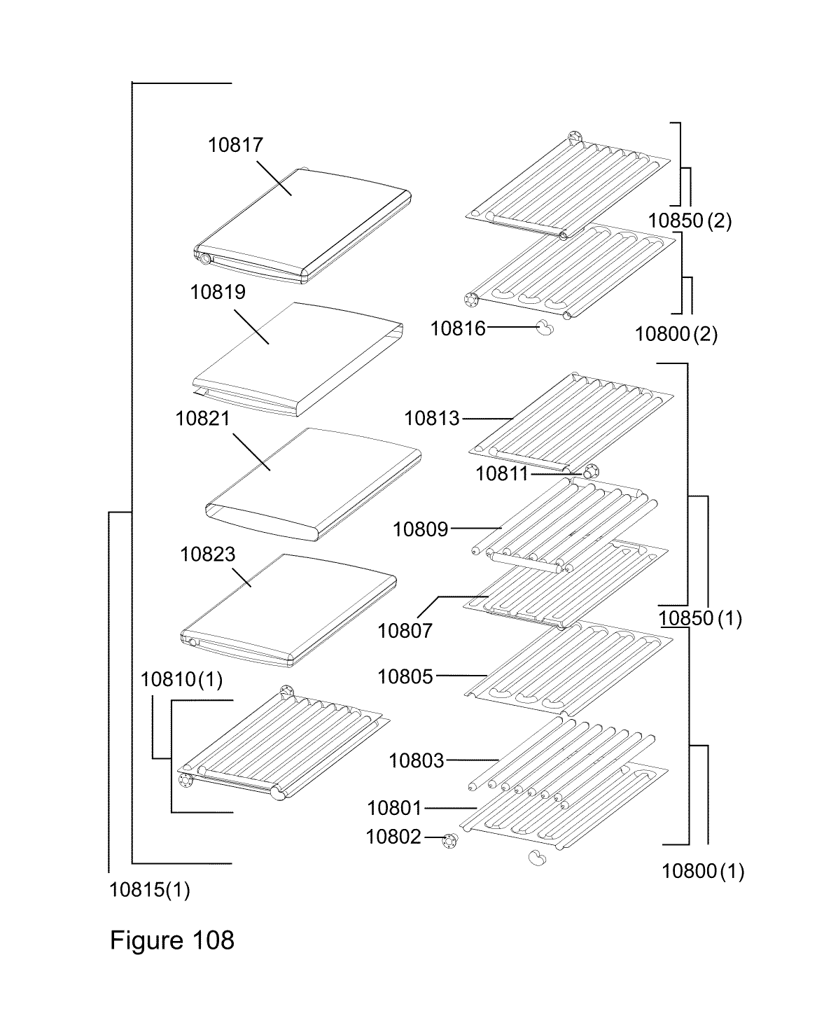

FIG. 108

10800 (1) Bonded assembly
10800 (2) Bonded assembly of 10802, 10801, 10805, with 10803 sandwiched in between 10810 (1) Bonded assembly of 10850 (2), and 10800 (2)
10850 (1) Bonded assembly
10850 (2) Bonded assembly of 10807, 10811, 10813 with 10809 sandwiched in between 10815 (1) Multipart Multi-Molded Insert assembly composed of 10810 (1), 10817, 10819, 10821, and 10823.
10801 Bottom Half of an internal Vessel Chamber which could be made from processes such as stamped if metal, or SFL if plastic, or a composite such as polyamide, aramid and graphene. Bonds to 10805A

### 10802 Inlet Nozzle

10803 MDM in a Continuous Lattice Bag that form fits to formed channels in 10805 and 10801.
10805 Top Half of an internal Vessel Chamber which could be made from processes such as stamped if Metal, or SFL if plastic, or a composite such as polyamide, aramid and graphene. Bonds to 10801.
10807 Bottom Half of an internal Vessel Chamber which could be made from processes such as stamped if metal, or SFL if plastic, or a composite such as polyamide, aramid and graphene. Bonds to 10813
10809 MDM in a Continuous Lattice Bag that form fits to formed channels in 10807 and 10813.

### 10811 Outlet Nozzle

10813 Top Half of an internal Vessel Chamber which could be made from processes such as stamped if metal, or SFL if plastic, or a composite such as polyamide, aramid and graphene. Bonds to 10807

### 10816 Connector Pipe Bonds to 10800 (2) and 10850 (1)

### 10817 Outer Resin Jacket

### 10819 Braided Aramid Sleeve

### 10821 Braided Aramid Sleeve

### 10823 Molded Rigid Foam

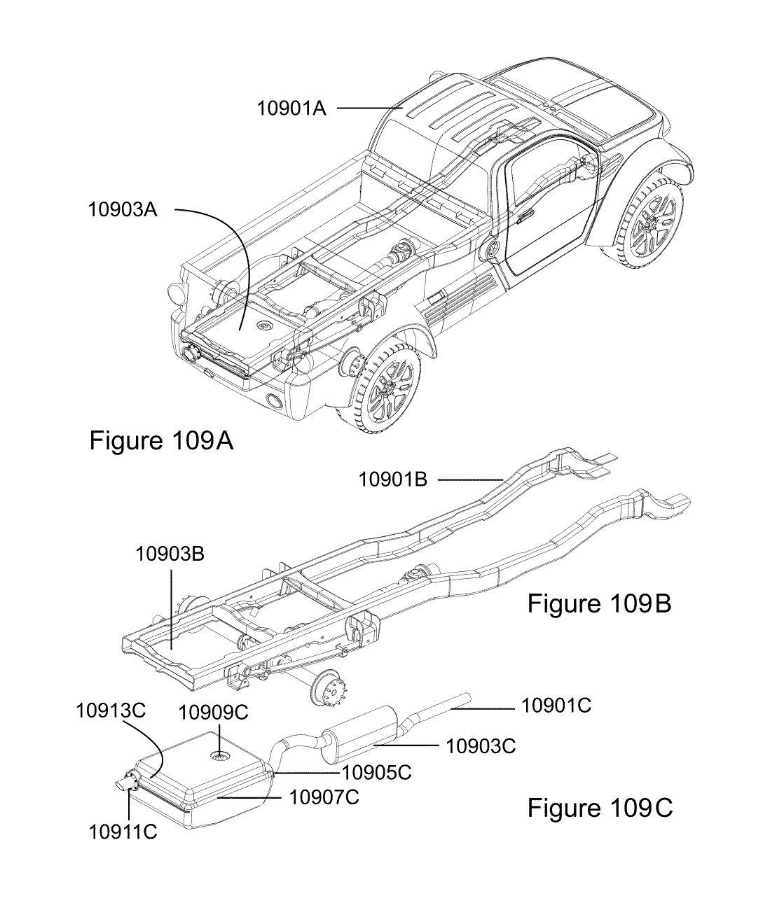

FIG. 109A

### 10901A Motor Vehicle

10903A Cut through showing a Placement under bed of truck

FIG. 109B

### 10901B Chassis

10903B one possible placement of irregular shaped Cartridge with optional heating assembly within a Vessel

FIG. 109C

### 10901C Exhaust Pipe

### 10903C Muffler

10905C Exhaust Pipe Leading into Vessel heating system

### 10907C Sealed Vessel

### 10909C Inlet and Outlets

### 10911C Exhaust

### 10913C Insulation

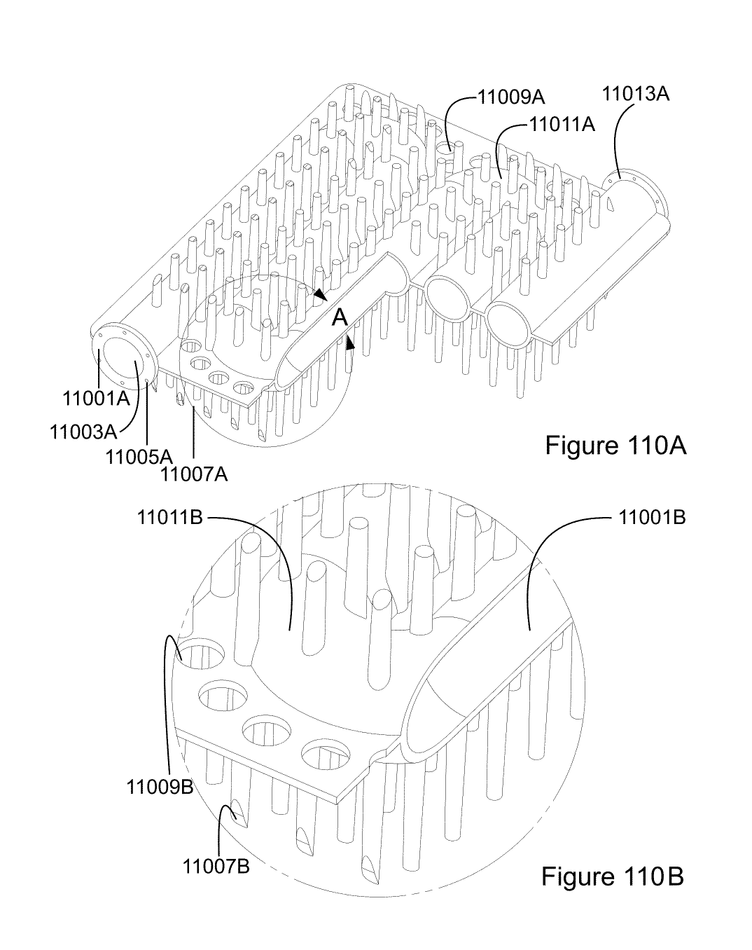

FIG. 110A

### 11001A Bolt Flange Exhaust Outlet

### 11003A Exhaust Outlet Tube

### 11005A Bolt Hole

### 11007A Bottom Thermal Transfer Bosses

### 11009A Voids for Gas Circulation

### 11011A Exhaust Tube

### 11013A Bolt Flange Exhaust Tube

FIG. 110B

### 11001B Exhaust Gas Tube

11007B Bottom Boss for heating MDM

### 11009B Voids for Gas Circulation

### 11011B Exhaust Gas Tube

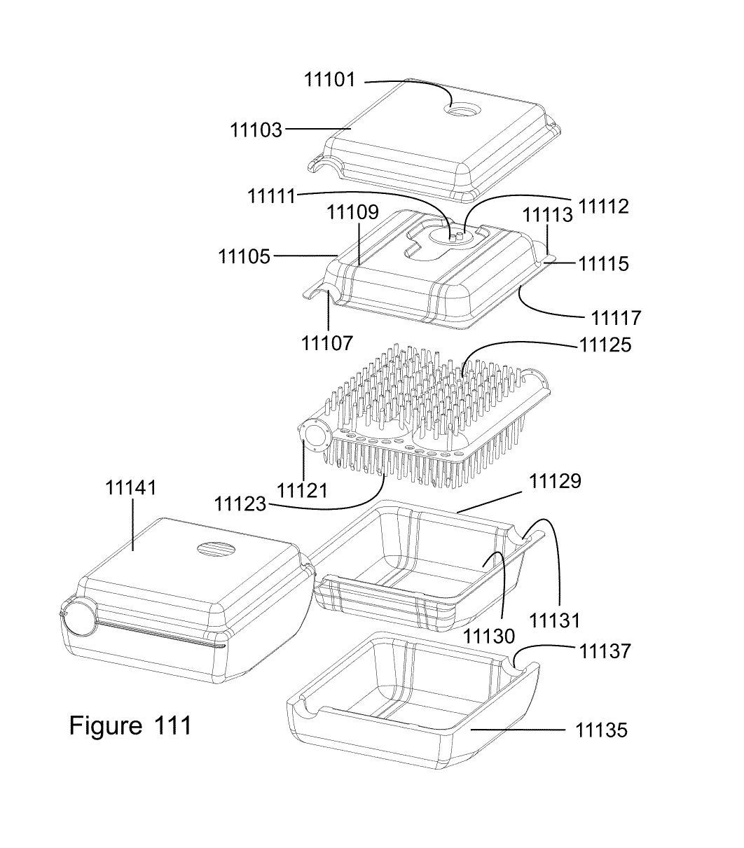

FIG. 111

11101 Insulation for Vessel and/or padding
11103 Area for Kevlar Braid Socks above Insulation Frame for Vessel and/or padding

### 11105 Bevel Top to Side Wall of Vessel

11107 Top portion of Orifice Flange for heating system

### 11109 Reinforcement Bands

### 11111 Orifice for Inlet Gas

### 11112 Orifice for Outlet Gas

11113 Top portion of Orifice Flange for heating system
11115 Flange to weld or adhesive seal top of Vessel to bottom of Vessel
11117 Top Vessel Cartridge Pan to hold MDM

### 11121 Bolt Flange Exhaust Outlet

11123 Bottom Section Bosses for heating MDM
11125 Bosses for MDM heating system
11129 Area for Kevlar Braid Socks above Insulation Frame for Vessel and/or padding or Carbon Wrapping
11130 Bottom Vessel Cartridge Pan to hold MDM
11131 Flange to weld or adhesive seal top of Vessel to bottom of Vessel
11135 Bottom portion of Insulation for Vessel and/or padding
11137 Flange to adhesive seal top of Vessel to bottom of Vessel
11141 Completed assembly of irregularly-shaped Vessel assembly

FIG. 112A

### 11201A Inlet Filling Port

### 11203A ISO Protective Dock

### 11205A Latches for Optional Heating Unit For Gas

### 11207A Exhaust

11209A Exhaust Heat Exchanger Unit that ties into 11211A

### 11211A Optional Heating Unit For Gas

FIG. 112B

11201B Fuel Tank With Assembled MDM-populated Lattice and Cartridge with associated Heating Unit for Gas

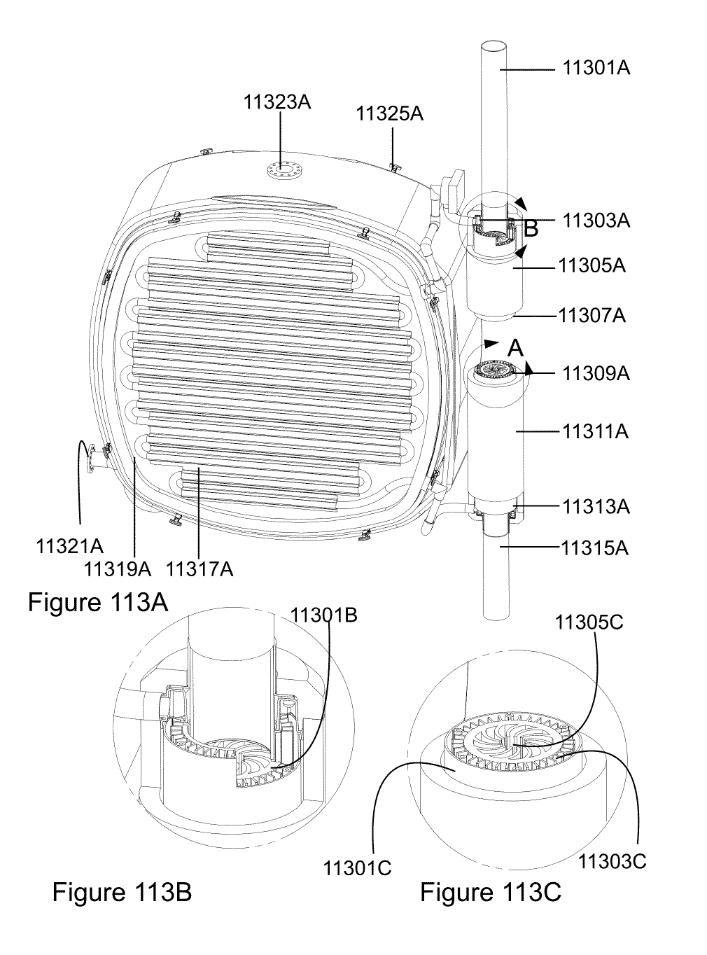

FIG. 113A

### 11301A Truck Exhaust Stack

11303A Orifice Inlet Nipple which connects to the tube out which is 11421A, which connects to
11415A Electric Recirculating pump

### 11305A Insulation Jacket

### 11307A Extruded Heat Exchanger, Cut Away View

### 11309A FIG. 113C

### 11311A Insulation Jacket

11313A Orifice Inlet Nipple which connects to the tube out which is 11429A, which connects to
11447A Electric Recirculating pump

### 11315A Truck Exhaust Stack

### 11317A Heat Exchanger Plate

### 11319A Heating Fluid Tube

### 11321A Gas Outlet Flange

11323A Gas inlet flow
11325A Latch for First Heating Transfer System in front of Vessel

FIG. 113B

11301B Cutaway of exhaust within the gasket. The Extrusion of the heat exchanger is machined in those areas to create a joint to the steel tubes carrying the exhaust heat. Top of the gasket looking into the gasket. The gasket becomes a cup, the pipe is a bigger OD than the gasket, and the gasket may have O-Ring Seals molded within the gasket. Side wall and the bottom of the gasket create a double seal and a stronger joint.

FIG. 113C

### 11301C Extrusion for the Heat Exchanger

11303C Fins for Channel of the Liquid Side of the Heat Exchange, with six channels, which could be populated by such materials as ethylene glycol or thermal oil; the fins are within the liquid flowing heat bath.

### 11305C Heat Exchanger Exhaust Fins

FIG. 114

### 11401 Exhaust Stack

11403 Insulation Cap which could be foam or compressed fiberglass or polyamide or ceramic or ceramic skin with urethane core
11405 Bolts that hold 11407 to 11417
11407 Fabricated Stainless Collar that is welded or compression fit flange
11409 High Temperature Gasket that forms an air tight seal between 11407 and 11417
11411 Screws and Washers that hold 11417 to 11423 Insulation Jacket
11413 Orifice Inlet Nipple which connects to the tube out which is 11421
11415 Electric Recirculating pump or Turbine

### 11417 Aluminum Die Cast Manifold

11419 Gasket that makes a seal between 11417 and 11423
11421 Hose that connects to 11413

### 11423 Aluminum Extrusion Heat Exchanger

### 11425 Insulation Jacket

### 11427 Aluminum Extrusion Heat Exchanger

11429 A Return Hose that connects to 11447
11431 Gasket that makes a seal between 11427 and 11433

### 11433 Aluminum Die Cast Manifold

11435 Screws and Washers that hold 11427 to 11433 Exhaust Manifold
11437 High Temperature Gasket that forms an air tight seal between 11433 and 11439
11439 Fabricated Stainless Collar that is welded or compression fit flange
11441 In place screws and washers that hold 11427 to 11433

### 11443 Aluminum Extrusion Heat Exchanger

11445 Insulation Cap which could be foam or compressed fiberglass or polyamide or ceramic or ceramic skin with urethane core
11447 Orifice Inlet Nipple which connects to the tube out which is 11429
11449 Orifice Inlet Nipple which connects to the tube out
11451 Edge of Heater assembly

### 11453 Heating Element

11455 Latch For First Heating Transfer System in front of Vessel

### 11457 Heating Fluid Conduits

### 11459 Gas Outlet Pipe

### 11461 Gas Outlet Flange

### 11463 Gas Inlet

11465 Latch For Second Heating Transfer System in front of Vessel

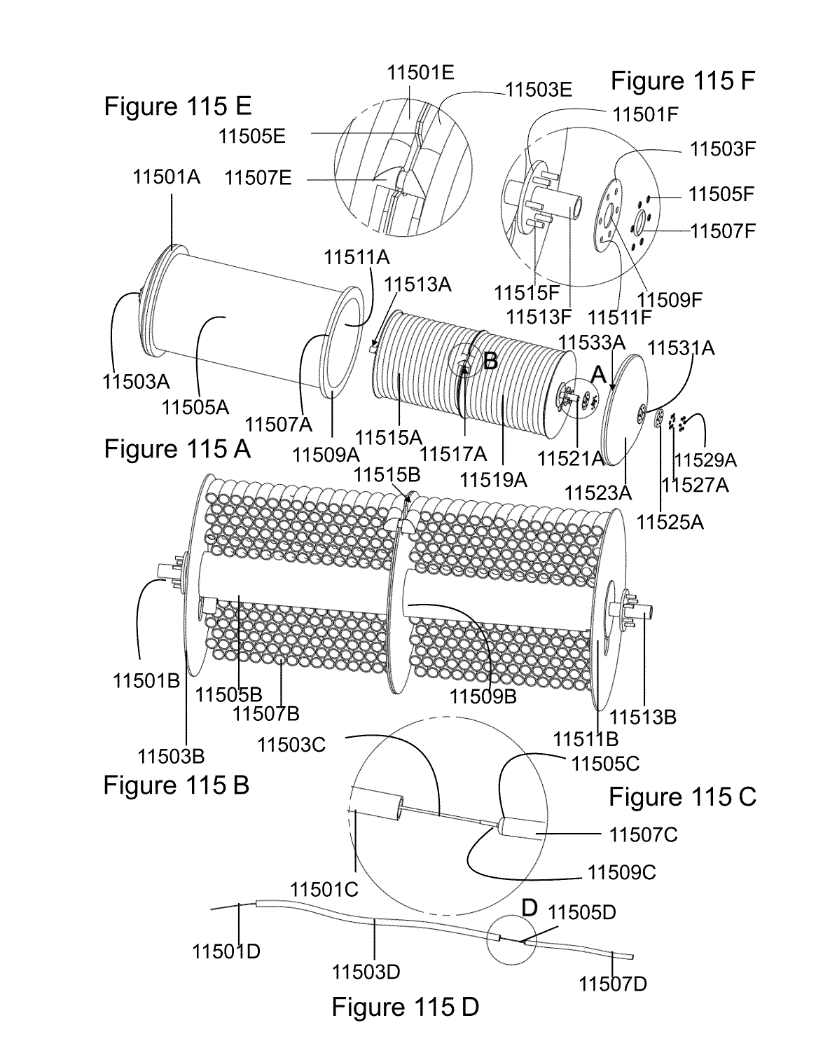

FIG. 115A

### 11501A Flange on Vessel

### 11503A Knucklehead

### 11505A Exterior of Vessel

### 11507A Edge of Flange

### 11509A Flat Face of Flange on Vessel

### 11511A Interior of Vessel

### 11513A Gas Inlet or Cascade Connector

11515A Second Vessel in the form of a polyamide conduit that is populated with MDM or MDM Lattice(s)
11517A Connector Series as shown in 11501E through 11505E
11519A Third Vessel in the form of a polyamide conduit that is populated with MDM or MDM Lattice(s).
11521A Inlet or Outlet assembly as seen in close-up form in 11501F through 11515F

### 11523A Knucklehead

11525A Gasket helping make the gas tight connection between the shaft and the holes going through the knucklehead
11527A is large ferrule holding 11525A the gasket
11529A is a small ferrule

### 11531A Outlet Inlet Orifices

### 11533A Rim of Cap or Knucklehead

FIG. 115B

### 11501B Gas Inlet or Cascade Connector

### 11503B Vessel Reel Wall

11505B Vessel Reel Orifice to accommodate connectors between Vessels

### 11507B Cut-Through Showing Vessel Without Snaked or Loaded MDM

11509B Edge of Vessel Reel Orifice to accommodate connectors between Vessels
11511B Vessel Reel Orifice to accommodate connectors between Vessels

### 11513B Gas Inlet or Cascade Connector or Outlet

11515B Notch Cutaway in Vessel Reel Wall to accommodate 11507E

FIG. 115C

### 11501C Outer Jacket of Pipe or Vessel

11503C MDM snaked through the Pipe or Vessel

### 11505C MDM Film Lattice

### 11507C Outer Jacket of Pipe or Vessel

11509C Male threaded connector to pull MDM

FIG. 115D

11501D MDM snaked through the Pipe or Vessel

### 11503D Outer Jacket of Pipe or Vessel

11505D Cut-Through Close-Up of 11501C through 11509C

### 11507D Outer Jacket of Pipe or Vessel

FIG. 115E

### 11501E End of Vessel

### 11503E Beginning of 2nd Vessel

11505E Notch in reel walls

### 11507E Vessel Connector

FIG. 115F

### 11501F Flange Plate

### 11503F A Gasket

11505F small ferrule
11507F is large ferrule holding the gasket helping make the gas tight connection between the shaft and the holes going through the knucklehead
11509F holes for ferrule and conduit
11511F holes for ferrule and bolts

### 11513F Outlet Conduit

11515F Bolts are not threaded the full body of the bolt to enable a gas tight fit with the ferrule or it could be welded.

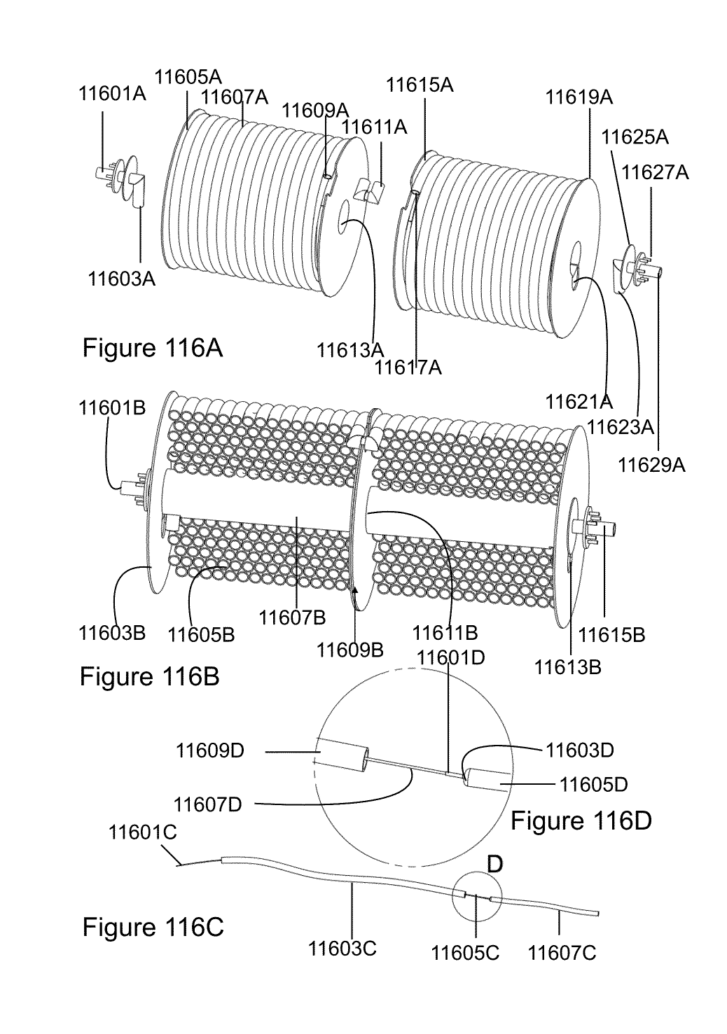

FIG. 116A

### 11601A Gas Inlet or Cascade Connector

### 11603A Connector to Beginning of Vessel

### 11605A Vessel Reel Wall

### 11607A Vessel

11609A End of Vessel which connects to 11611A
11611A Connector accommodate End of Vessel Cascade Connector to Manifold Outlet or Cascade to Connector to beginning of next Vessel
11613A Orifice to accommodate End of Vessel Cascade Connector or Outlet

### 11615A Vessel Reel Wall

11617A Beginning of Vessel which connects to 11611A

### 11619A Vessel Reel Wall

### 11621A End of Vessel

### 11623A Connector to End of Vessel

### 11625A Flange Gasket or Flange Ferrule

### 11627A Bolts

### 11629A Outlet

FIG. 116B

11601B Inlet or Cascade Manifold assembly

### 11603B Edge of Vessel Reel Wall

### 11605B Cut-Through Showing Vessel Without Snaked or Loaded MDM

11607B Vessel Reel Orifice to accommodate connectors between Vessels

### 11609B Edge of Vessel Reel Wall

11611B Edge of Vessel Reel Orifice to accommodate connectors between Vessels

### 11613B End of Vessel

11615B Inlet or Outlet or Cascade Manifold assembly

FIG. 116C

11601C Snake String for pulling/loading MDM

### 11603C Outer Jacket of Pipe or Vessel

11605C Snake String for pulling—loading MDM

### 11607C Outer Jacket of Pipe or Vessel

FIG. 116D

11601D Male threaded connector to pull MDM

### 11603D MDM

### 11605D Outer Jacket of Pipe or Vessel

11607D Snake String for pulling/loading MDM

### 11609D Outer Jacket of Pipe or Vessel

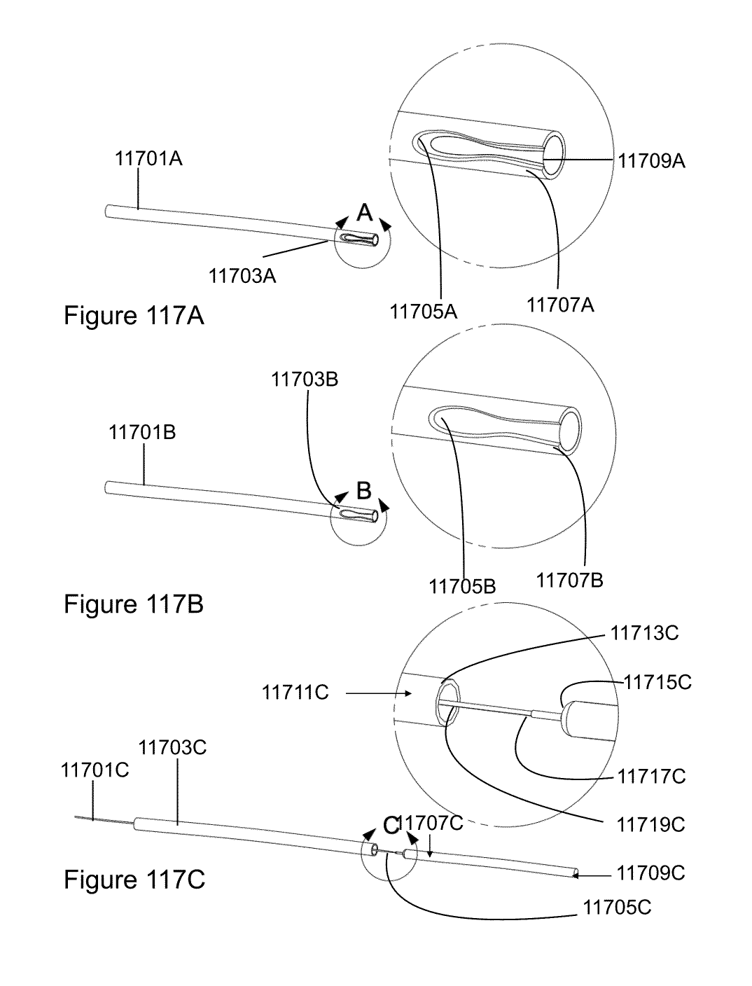

FIG. 117A

11701A Thin Walled external Vessel
11703A Cut through showing material
11705A Internal film Vessel of materials such as polyamide Film Lattice can be bonded to the pipe that may have a foil laminate if necessary to heat MDM

### 11707A External Vessel

### 11709A MDM

FIG. 117B

11701B Thin Walled external Vessel
11703B Cutaway showing MDM
11705B MDM Continuous Tube of Strand that is connected to the next Strand of MDM. Metal or Plastic Female Thread which screws onto a male thread in the MDM Lattice surround. Or cinch it around the wire and place adhesive tape or semi removable adhesive tape.

### 11707B Outer Jacket of Pipe or Vessel

FIG. 117C

11701C Snake String for pulling/loading MDM

### 11703C Outer Jacket of Pipe or Vessel

11705C Cutaway of 11711C through 11719C

### 11707C Outer Jacket of Pipe or Vessel

### 11709C ID of Pipe or Vessel

### 11711C Outer Jacket of Pipe or Vessel

### 11713C OD of Pipe or Vessel Wall

11715C MDM which is a continuous flat piece of film, placed under tension. Drop a bead of MDM in the middle of the film, it would through a series of rollers which like a cigarette would be rolled and the seam then welded, or bonded with a thermoset epoxy, into a cylinder form, by placing living hinges and/or extruded connectors. Any shape of FIG. 130 can also be created.
11717C Male threaded connector to pull MDM
11719C MDM snaked through the Pipe or Vessel

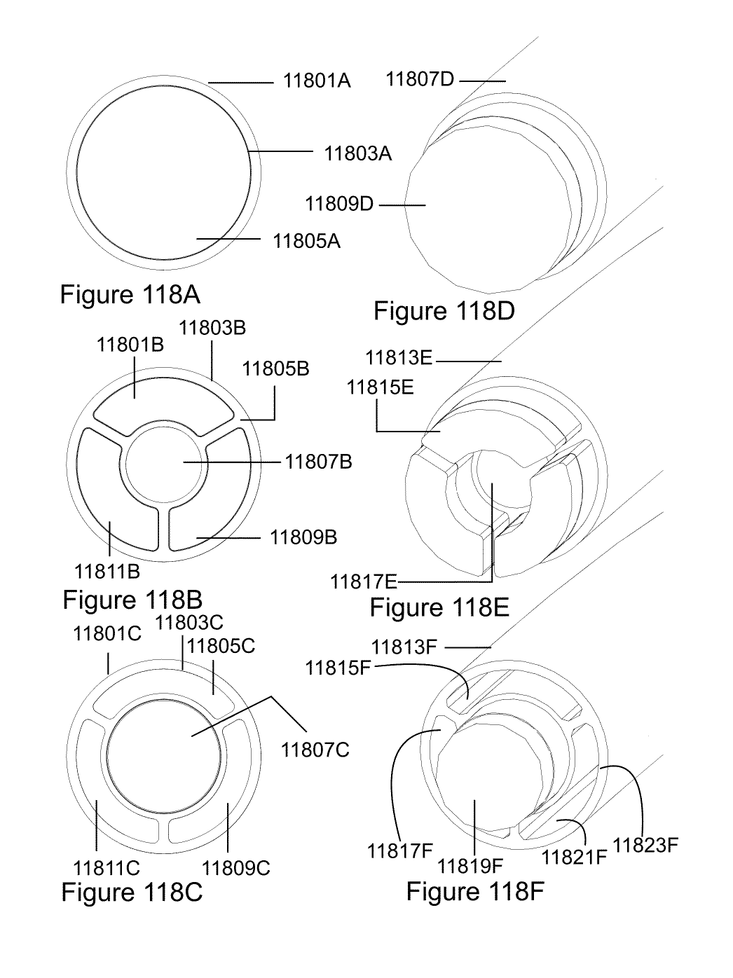

FIG. 118A

### 11801A Exterior Wall of Vessel

### 11803A Interior Wall of Vessel

### 11805A Chamber for MDM Lattice Bag

FIG. 118B

### 11801B Lattice Chamber for MDM

### 11803B Exterior Wall of Vessel

### 11805B Interior Chamber Wall

### 11807B Chamber for Heating Fluid

### 11809B Lattice Chamber for MDM

### 11811B Lattice Chamber for MDM

FIG. 118C

### 11801C Exterior Wall of Vessel

### 11803C Chamber for Heating Fluid

### 11805C Chamber for Heating Fluid

### 11807C Populated Lattice Bag

### 11809C Chamber for Heating Fluid

### 11811C Chamber for Heating Fluid

FIG. 118D

### 11807D Exterior Wall of Vessel

### 11809D Populated Lattice Bag

FIG. 118E

### 11813E Exterior Wall of Vessel

### 11815E Lattice Chamber for MDM

### 11817E Chamber for Heating Fluid

FIG. 118F

### 11813F Exterior Wall of Vessel

### 11815F Chamber for Heating Fluid

### 11817F Chamber for Heating Fluid

### 11819F Lattice Chamber for MDM

### 11821F Chamber for Heating Fluid

### 11823F Interior Chamber Wall

FIG. 119A

11901A Heating assembly
11903A Heating assembly

FIG. 119B

11905B Close-Up of Cross-Section of Heating assembly Fluid Channels and Structural Pallet assembly

FIG. 119C

### 11907C Inlet for Constituent

### 11909C Inlet for Constituent

### 11911C Inlet for Constituent

### 11913C Exterior Vessel Wall

FIG. 119D

### 11915D Close-Up of Cross-Section of Heating Fluid Channel

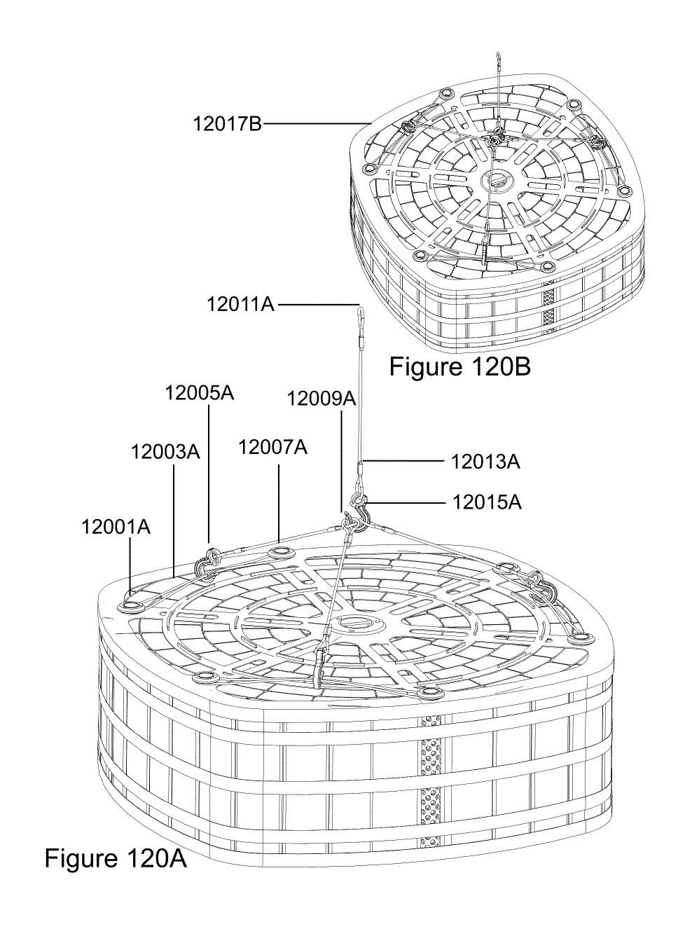

FIG. 120A

12001A Nut with Shoulder; 12003A loops under Nut and can be tightened via spanner wrench

### 12003A Braided Cable

### 12005A Hook

12007A Nut with Shoulder; 12003A loops under Nut and can be tightened via spanner wrench

### 12009A Eyelet for Lifting Harness

### 12011A Eyelet for Lifting Harness

### 12013A Pressure Fit Clamp

### 12015A Hook

FIG. 120B

12017B Populated Cartridge assembly with Harness connected to Lifting Fixtures

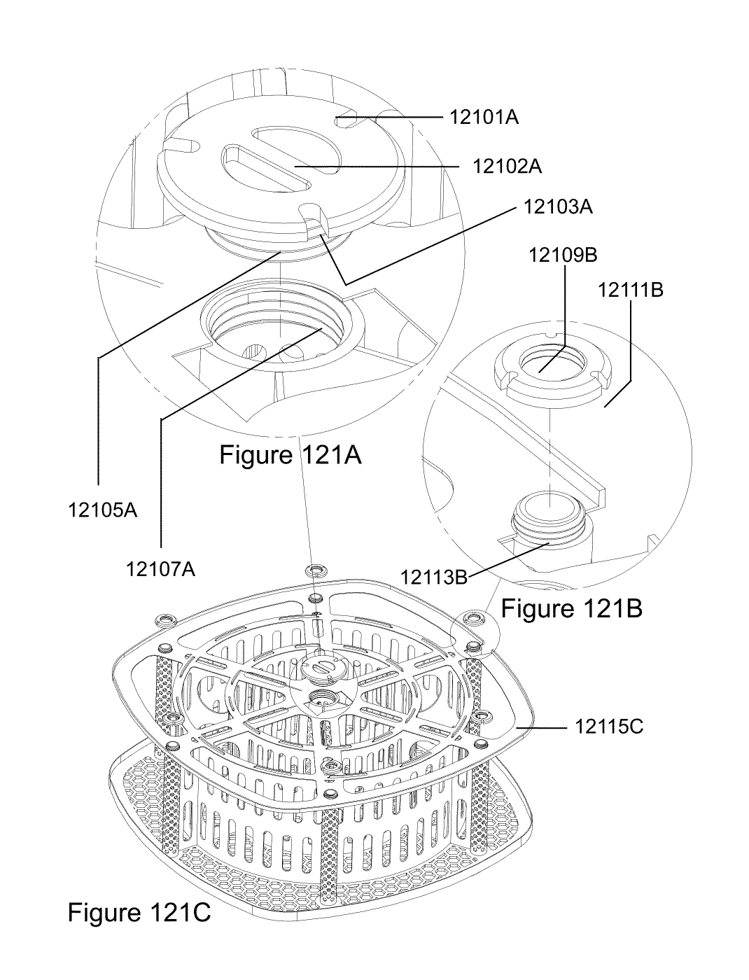

FIG. 121A

### 12101A Lifting Fixture

### 12102A Lifting Bar

### 12103A Slot or Hole for Spanner Wrench

### 12105A Male Thread

### 12107A Female Thread

FIG. 121B

### 12109B Female Thread

### 12111B Slot or Hole for Spanner Wrench

### 12113B Male Thread With Shoulder

FIG. 121C

12115C Cartridge assembly

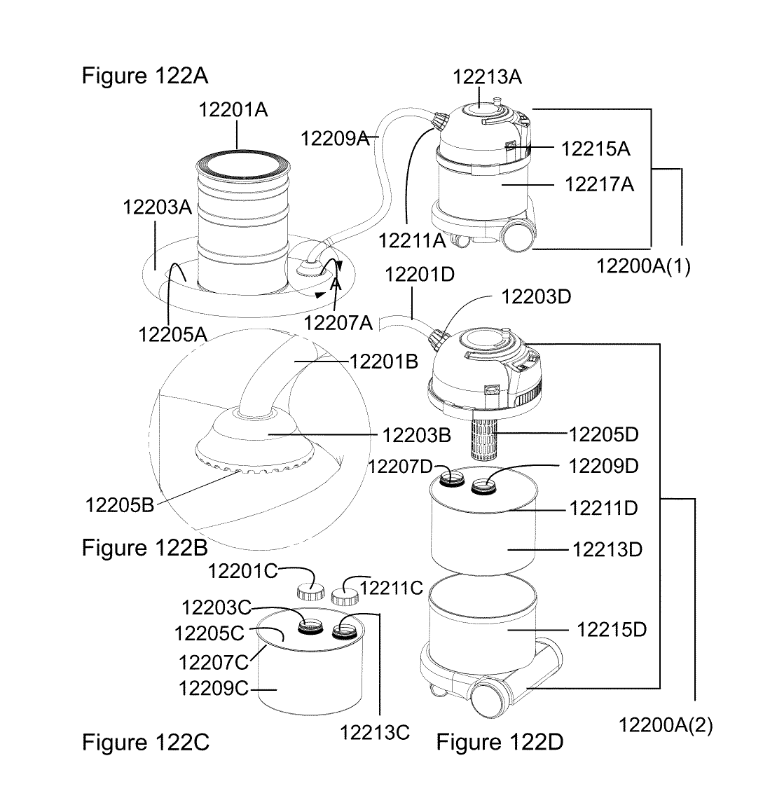

FIG. 122A

12200A (1) Complete Lattice and Vessel assembly
12200A (2) Exploded View of complete Lattice and Vessel assembly
12201A Barrel or Drum or Vessel or Container that leaks or could leak

### 12203A Air Berm

### 12205A Bottom Membrane

### 12207A Suction Attachment Tool

### 12209A Suction Tube or Hose

### 12211A Suction Vacuum Fixture

### 12213A Top of Wet Vacuum

### 12215A On/Off Switch Wet Vacuum

### 12217A Vessel

FIG. 122B

### 12201B Suction Hose

### 12203B Top of Weighted Suction Fixture

12205B Weighted Suction Fixture, points that are off the pool surface so it does not suction the membrane

FIG. 122C

### 12201C Threaded Lid

12203C Male Threaded Orifice that 12201C affixes to
12205C The fixed flange fitted lid or cap, not shown could be removable with ferrule or threaded seal
12207C Flange feature
12209C Removable Vessel which could have its own liner

### 12211C Threaded Lid

12213C Male Threaded Orifice that 12211C affixes to

FIG. 122D

### 12201D Suction Hose

### 12203D Top of Weighted Suction Fixture

12205D Cage with a Float
12207D Male Threaded Orifice that 12201C affixes to
12209D Male Threaded Orifice that 12211C affixes to
12211D Flange feature
12213D Removable Vessel which could have its own liner

### 12215D Fixed Outer Vessel for 12213D

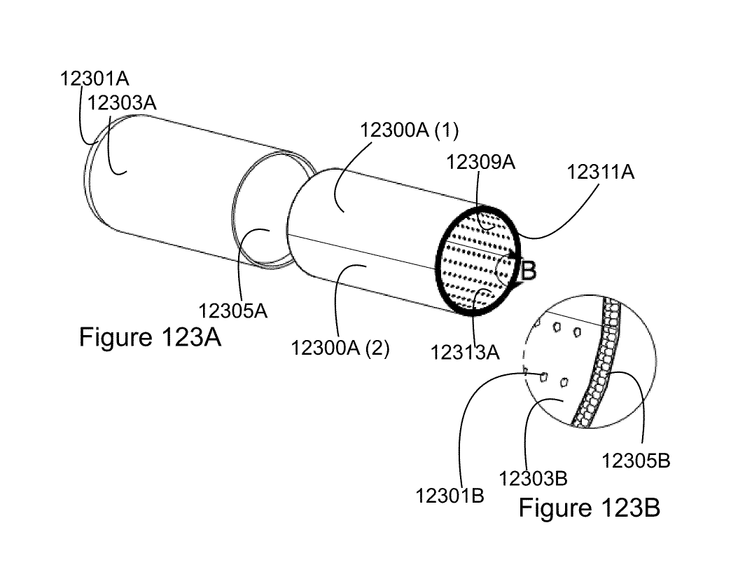

FIG. 123A

12300A (1) Top Half of Vessel Liner assembly
12300A (2) Bottom Half of Vessel Liner assembly

### 12301A Vessel End Cap or Male Tapered End of Pipe

### 12303A Exterior of Pipe or Vessel

### 12305A Interior of Pipe or Vessel

12309A Interior of Liner With Optional Perforations. Perforations are shown without optional soluble coating or applied soluble laminate

### 12311A MDM Liner Filling

### 12313A Non Perforated Portion of Interior of Liner

FIG. 123B

12301B Interior of Liner with Perforations in a non-soluble coated state

### 12303B Non Perforated Portion of Interior of Liner

### 12305B MDM Liner Filling

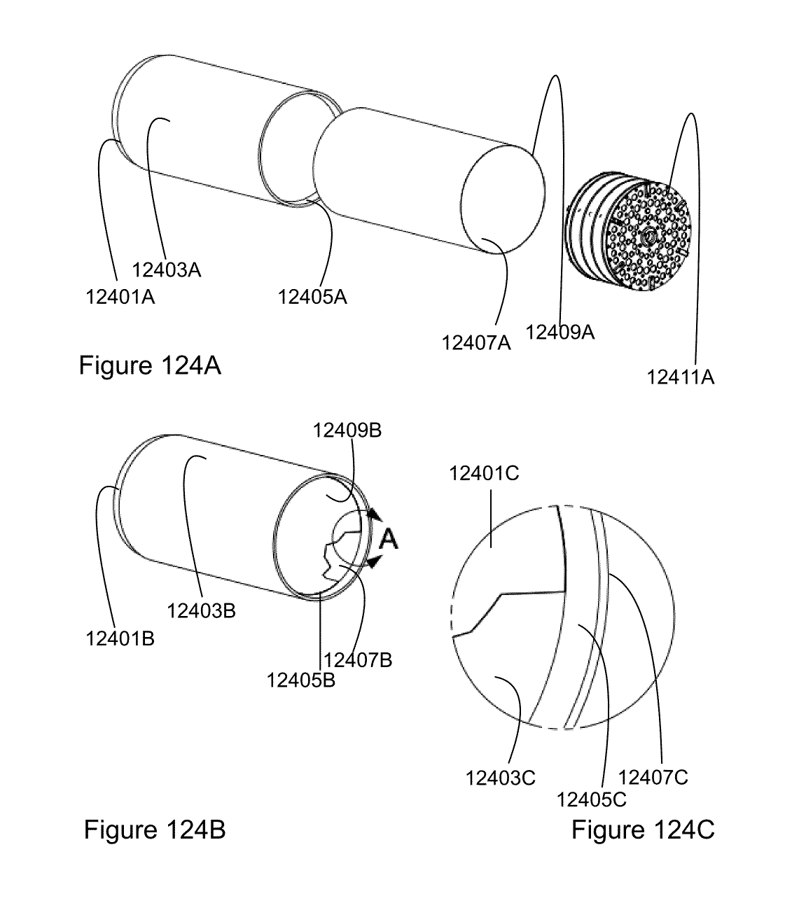

FIG. 124A

### 12401A Vessel End Cap or Male Tapered End of Pipe

### 12403A Pipe or Vessel

### 12405A Inset Flange

12407A Liner in which the Interior of Liner could be anti-stick polymer to aid in loading of 12411A, or it could be made of copper to aid as a biocide, or tungsten to add strength, or a non-conductive ceramic insulator heat and/or spark shield, or a thermal conductive material to enable heat transfers or ceramic for insulation or to inhibit thermal transfers. Liner can act as a shield to MDM if welding is necessary within the assembly or as part of the Vessel assembly.
12409A Exterior or Interior of Liner (could be made of a coating such as Teflon to aid in loading of 12411A)
12411A Populated MDM Lattice and Cartridge assembly

FIG. 124B

### 12401B Vessel End Cap or Male Tapered End of Pipe

### 12403B Pipe or Vessel

### 12405B Inset Flange

12407B Cutaway of which FIG. 124C is a closeup

### 12409B Interior of Liner

FIG. 124C

12401C Closeup of interior wall of Liner

### 12403C Interior Wall of Vessel or Pipe

### 12405C Flange of Vessel or Pipe

12407C Front face of Flange of Vessel or Pipe

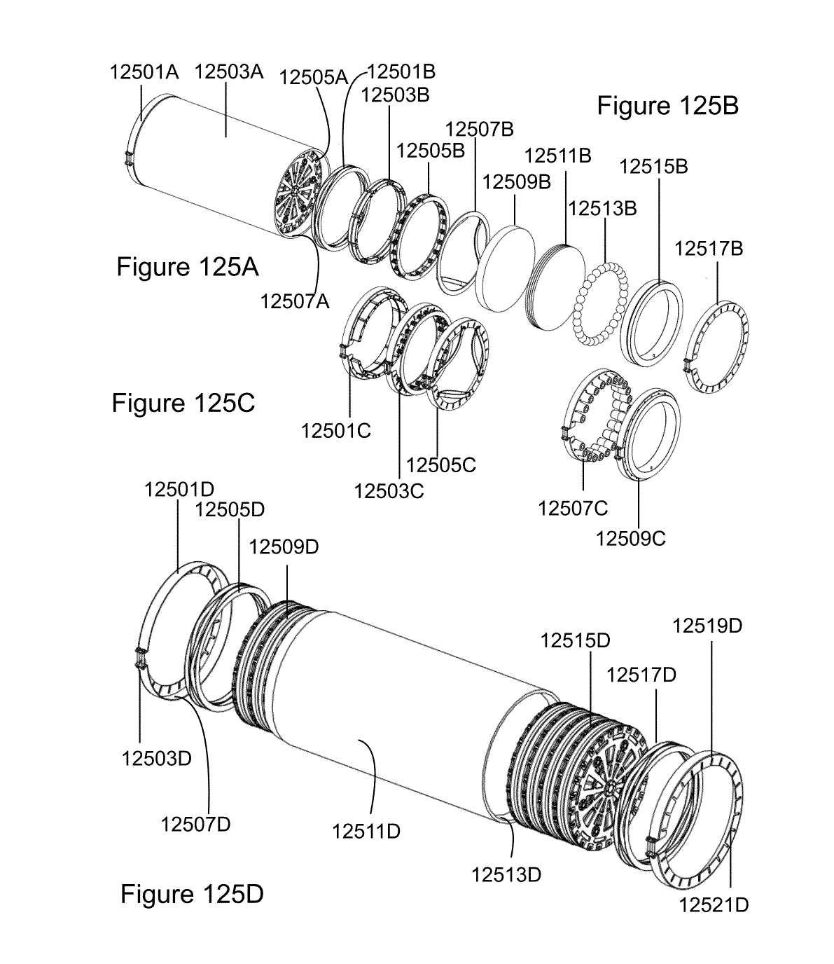

FIG. 125A

### 12501A Steel Compression Ring

### 12503A Pipe or Vessel

12505A MDM-populated Lattice and Cartridge assembly

### 12507A Interior of Pipe or Vessel

FIG. 125B

### 12501B Wave Washer

### 12503B TPE Bumper on Steel Ring

### 12505B Steel or Fiberglass Spring

### 12507B Composite Spring

### 12509B Disk of Rigid Foam Single Density

### 12511B Disk of Rigid Foam Multiple Densities

### 12513B Impact Adsorbing TPE Balls Threaded Fiberglass Rod

### 12515B Inflatable

### 12517B Steel Compression Ring

FIG. 125C

12501C Bumper Ring with Rubber Links
12503C Bumper Ring with Coil Springs
12505C Bumper Ring with Leaf Springs or One Wave Washer
12507C Bumper Ring with Rubber Orb Segments
12509C Bumper Ring with Inflated Tubular Insert

FIG. 125D

### 12501D Steel Compression Ring

### 12503D Locking Fixture for Steel Compression Ring

### 12505D Wave Washer

### 12507D Lip Flange for Steel Compression Ring

12509D Partially Inserted MDM-populated Lattice and Cartridge assembly

### 12511D Pipe or Vessel

### 12513D Interior of Pipe or Vessel

12515D MDM-populated Lattice and Cartridge assembly

### 12517D Wave Washer

### 12519D Steel Compression Ring

### 12521D Steel Compression Ring Face With Compression Fit Slits

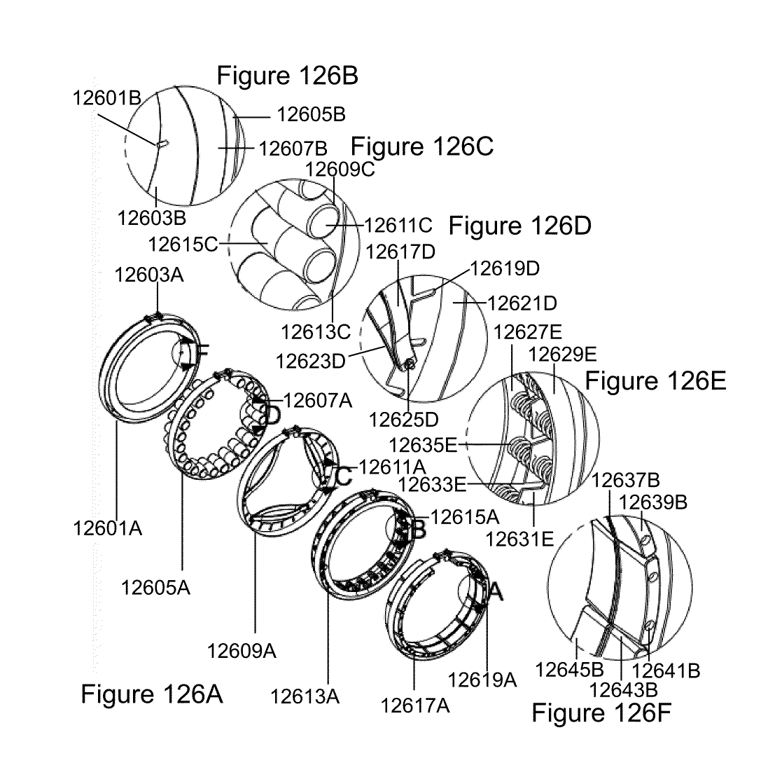

FIG. 126A

### 12601A Inflatable Ring

### 12603A Locking Fixture

### 12605A TPE Bumper on Steel Ring, Impact Adsorbing TPE Balls Threaded Fiberglass Rod

12607A Bumper shown in 12609C through 12615C

### 12609A Notched Metal Ring

12611A Leaf Spring assembly

### 12613A Notched Metal Ring

12615A Coil Spring assembly

### 12617A Notched Metal Ring

12619A Links that form a Rubber Bumper

FIG. 126B

### 12601B Nipple

### 12603B Inner Tube or Solid Tire With No Inner Tube But Inflatable

### 12605B Outer Radial Compression Ring

12607B Side Wall of Solid Tire With No Inner Tube But Inflatable which touches the inner wall of the tank and the Cartridge assembly

FIG. 126C

### 12609C Chamfer or Bevel Edge of Injection Molded or Extruded Bumper Elements

12611C Injection Molded and if no draft they could be extruded Bumper Elements touch the interior of the pipe or Vessel

### 12613C Band

12615C The entire rubber bumper

FIG. 126D

### 12617D Top Leaf Spring

12619D Notches for Steel or Aluminum to create the flange which would be extruded then rolled form or rolled formed out of a sheet

### 12621D Ring

### 12623D Bottom Leaf Spring

12625D Bolt and Nut to affix to flange or Rivet

FIG. 126E

### 12627E Bottom Plate

### 12629E Top Plate

12631E Circular Formed Plate with notches
12633E Relief Notches to form the metal into a circular shape

### 12635E Coil Spring

FIG. 126F

12637B Threaded Metal for reinforcement

### 12639B Injection Molded or Extruded Rubber Bumpers

12641B Hole for fastener or rivet
12643B Radius Edge so it can conform to the circle and easier to mold, less material to minimize weight
12645B Reversible other side of the bumper

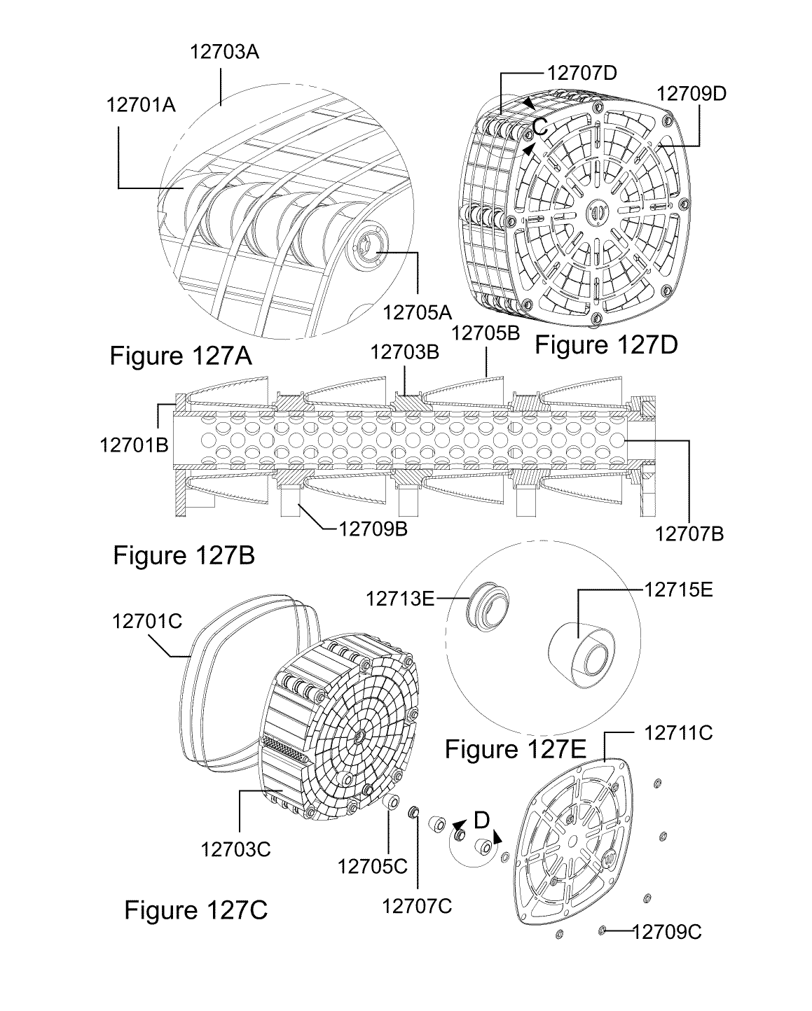

FIG. 127A

12701A Shock Absorber made of composite materials such as carbon fibers, polyamide, and aramid

### 12703A Close-Up of 12707D

12705A Nut with Shoulder Feature

FIG. 127B

### 12701B Bottom Plate

12703B Shock Absorber Spacer, close-up of Mating Flange

### 12705B Shock Absorber

### 12707B Structural Column

### 12709B Cross-Section of a Band

FIG. 127C

### 12701C Band

12703C Lattice assembly with Shock Absorbers

### 12705C Shock Absorber

12707C Shock Absorber Spacer with small mating flange for 12701C Bottom Plate

### 12709C Nut

### 12711C Top Plate

FIG. 127D

### 12707D Shock Absorber

12709D Populated Cartridge assembly with Shock Absorbers

FIG. 127E

12713E Shock Absorber Spacer with small mating flange for 12701C

### 12715E Shock Absorber

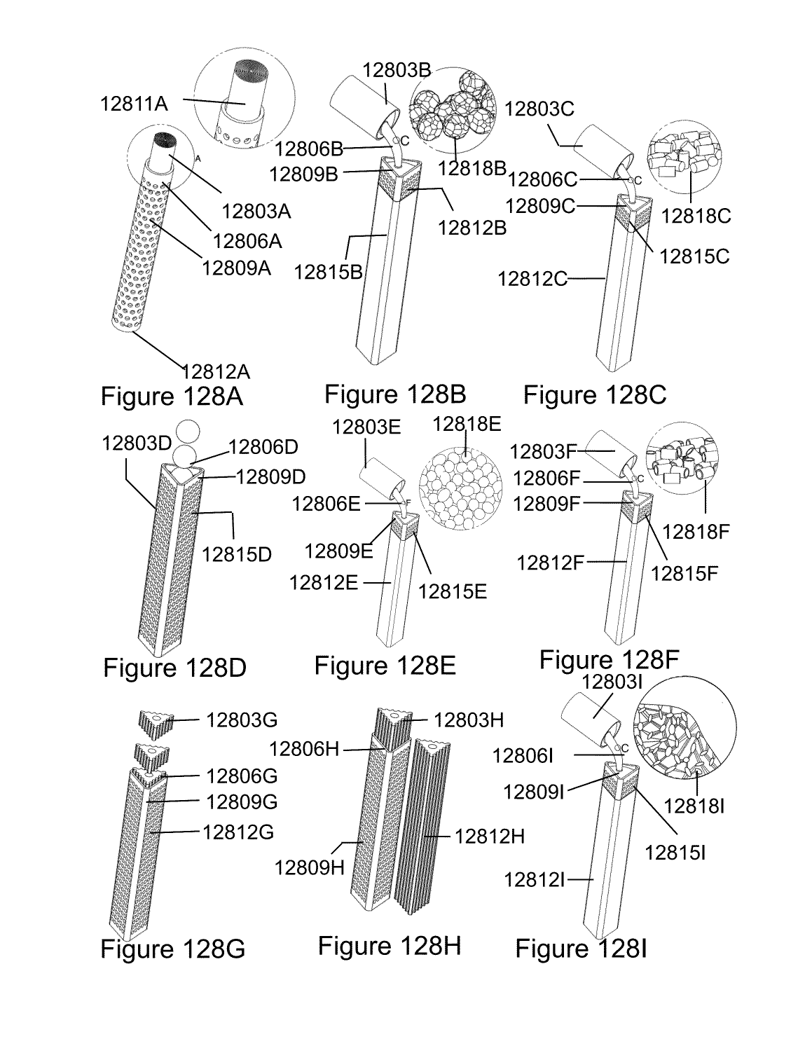

FIG. 128A

12803A Rolled MDM film or MDM adhered to film showing partial insertion
12806A Top of Lattice cylinder Column
12809A Void patterns for the flow of gas or liquids through MDM films which could be created through processes such as machining, photo-etching, air jet, water jet or laser
12811A Close-up of 12803A in which a rolled MDM film or MDM adhered to film showing partial insertion is shown
12812A Bottom base of cylinder

FIG. 128B

12803B MDM granulated material container
12806B MDM granulated material being poured into Lattice Structure
12809B Top of Lattice Structure that can be closed with any of the Caps in FIG. 9
12812B The perforation holes can be photo etched or created by air, water jet, cad knife, laser, plunge rolled, or perforated die.
12815B By placing the Lattice sleeve which has a function to enhance the volume of material with its placement on the exterior structure the quantity of material increases by both the sleeve thickness and the perforations in the Lattice structure being populated. The holes in the fixed structure cannot be cut economically unless they are larger.
12818B Closeup of granulated micro material

FIG. 128C

12803C Container for MDM solid tubed shaped materials
12806C MDM solid tube-shaped materials being poured into Lattice Structure
12809C Top of Lattice Structure that can be closed with any of the Caps in FIG. 9
12812C By placing the Lattice sleeve which has a function to enhance the volume of material with its placement on the exterior structure the quantity of material increases by both the sleeve thickness and the perforations in the Lattice structure being populated. The holes in the fixed structure cannot be cut economically unless they are larger. The Lattice sleeve on the exterior may act as a permeable membrane, allowing some liquids to pass through.
12815C The perforation holes can be photo etched or created by air, water jet, cad knife, laser, plunge rolled, or perforated die.
12818C Closeup of MDM solid tube-shaped materials

FIG. 128D

12803D Container for MDM sphere or any shaped materials and/or shapes such as balls, cubes, fullerons made of ceramics or metals or plastics or other types of spheres or shapes that have MDM coatings or injections of MDM
12806D MDM pre-formed sphere-shaped materials being poured into Lattice Structure
12809D Top of Lattice Structure that can be closed with any of the Caps in FIG. 9
12815D The perforation holes can be photo etched or created by air, water jet, cad knife, laser, plunge rolled, or perforated die.

FIG. 128E

12803E Container for MDM pellet shaped materials or small Spheres of Pellets made from materials such as metals or ceramics that are coated with MDM or impregnated with MDM.
12806E MDM pre-formed pellet shaped materials being poured into Lattice Structure
12809E Top of Lattice Structure that can be closed with any of the Caps in FIG. 9
12812E By placing the Lattice sleeve which has a function to enhance the volume of material with its placement on the exterior structure the quantity of material increases by both the sleeve thickness and the perforations in the Lattice structure being populated. The holes in the fixed structure cannot be cut economically unless they are larger. The Lattice sleeve on the exterior may act as a permeable membrane, allowing some liquids to pass through.
12815E The perforation holes can be photo etched or created by air, water jet, cad knife, laser, plunge rolled, or perforated die.
12818E Closeup of MDM pellet shaped materials which could also be MDM spheres or any shaped materials and/or pellet shapes such as balls, cubes, fullerons made of ceramics or metals or plastics or other types of spheres or shapes that have MDM coatings or injections of MDM

FIG. 128F

12803F Container for MDM hollow tube-shaped materials such as zeolites
12806F Container for MDM hollow tube-shaped materials such as zeolites being poured into Lattice Structure
12809F Top of Lattice Structure that can be closed with any of the Caps in FIG. 9
12812F By placing the Lattice sleeve which has a function to enhance the volume of material with its placement on the exterior structure the quantity of material increases by both the sleeve thickness and the perforations in the Lattice structure being populated. The holes in the fixed structure cannot be cut economically unless they are larger. The Lattice sleeve on the exterior may act as a permeable membrane, allowing some liquids to pass through.
12815F The perforation holes can be photo etched or created by air, water jet, cad knife, laser, plunge rolled, or perforated die.
12818F Closeup of MDM hollow tubed shaped materials

FIG. 128G

12803G MDM triangular shaped materials
12806G Partially inserted MDM triangular shaped material into Lattice Structure
12809G Top of Lattice Structure that can be closed with any of the Caps in FIG. 9
12812G The perforation holes can be photo etched or created by air, water jet, cad knife, laser, plunge rolled, or perforated die.

FIG. 128H

12803H Partially inserted MDM triangular shaped BAR material into Lattice Structure
12806H Top of Lattice Structure that can be closed with any of the Caps in FIG. 9
12809H The perforation holes can be photo etched or created by air, water jet, cad knife, laser, plunge rolled, or perforated die.
12812H MDM triangular shaped BAR

FIG. 128I

12803I Any MDM foam material dispensing container
12806I MDM foam materials
12809I Top of Lattice Structure that can be closed with any of the Caps in FIG. 9
12812I By placing the Lattice sleeve which has a function to enhance the volume of material with its placement on the exterior structure the quantity of material increases by both the sleeve thickness and the perforations in the Lattice structure being populated. The holes in the fixed structure cannot be cut economically unless they are larger.
12815I The perforation holes can be photo etched or created by air, water jet, cad knife, laser, plunge rolled, or perforated die.
12818I Closeup of MDM foam material

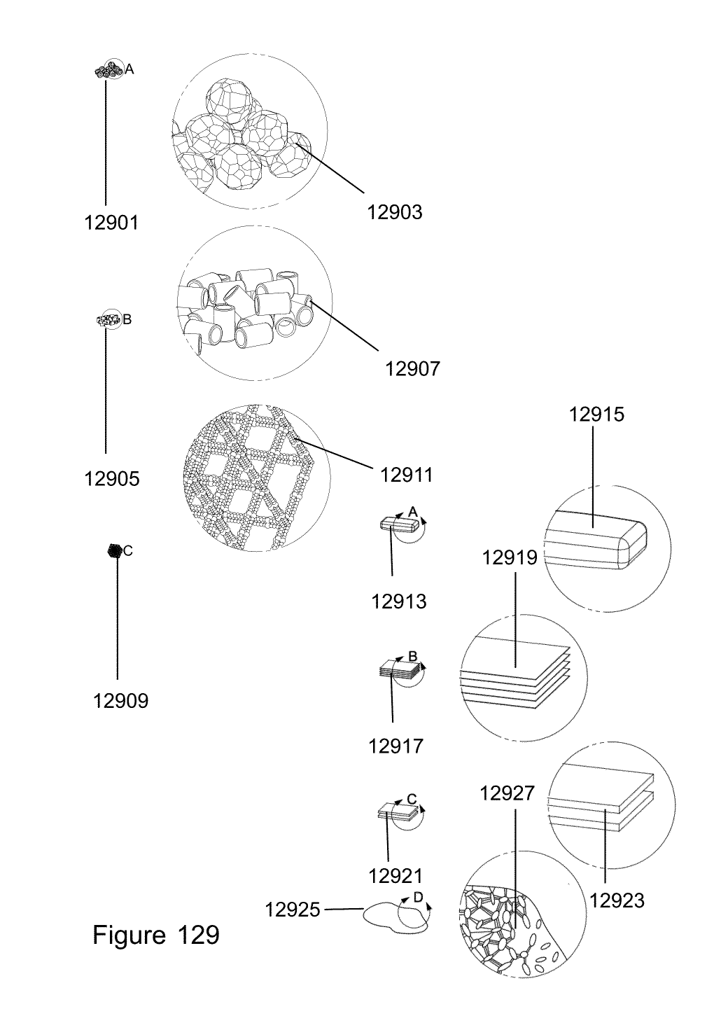

FIG. 129

12901 Particulate such as Carbon or Upsalite or any MDM particulate
12903 Particulate close-up of 12901
12905 Formed tubes such as Zeolites
12907 Close-up of formed tubes in 12905
12909 Particulate of a Metal Organic Framework or Crystalline MDM type structure
12911 Closeup of Particulate of a Metal Organic Framework or Crystalline MDM type structure in 12909
12913 Monolith pre-formed or rigid foam MDM
12915 Closeup of Monolith pre-formed or rigid foam MDM in 12913
12917 Thin sheets of MDM or MDM Films or Adhesive with MDM that are a single ply
12919 Closeup of Thin sheets of MDM or MDM Films or Adhesive with MDM in 12917
12921 Thicker sheets of MDM or MDM Films or Adhesive with MDM that are multiple plies
12923 Closeup of Thicker sheets of MDM or MDM Films or Adhesive with MDM
12925 Foam or Gel of MDM material
12927 Closeup of Foam or Gel of MDM material in 12925

FIG. 130

201 A circle
203 A double circle
205 An ellipse
207 A half circle
209 A triangle, equilateral or Isosceles
211 Right angle triangle
213 Triangle with arc base and concave sides
215 Triangle with concave base and convex side

### 217 Hexagon

219 Octagon with rounded edges
221 Modified Octagon with Convex Sides
223 Modified Octagon with Concave Sides
225 Square and when rotated a diamond

### 227 Rectangle

### 229 Diamond

231 Diamond with Convex and/or Concave Sides

### 233 Rounded Rectangle

### 235 More Pronounced Round Rectangle

237 Polygon rectangle
239 Rectangle with Concave Sides and Rounded Corners

### 241 Cross

### 243 Crescent

### 245 Trapezoid

247 Rectangle with 2 Horizontal Convex or Concave Arcs and 2 Vertical Straight Lines with or without corner radii, and/or 2 Horizontal Convex or Concave and 2 Vertical Convex or Concave Arcs with corner rounds with or without corner radii, and/or a Squircle

### 249 Keystone

251 Keystone with arc cap
253 Keystone with horizontal convex or concave arc cap and base and non-vertical equal or unequal length sides
255 Keystone with one horizontal straight side and 2 equal or unequal length non-vertical sides and 2 equal or non-equal additional sides

### 257 Pentagon

259 Pentagon with equal length, convex or concave, sides
261 Pentagon with un-equal length, convex or concave, sides
263 Another example of a Pentagon with un-equal length, convex or concave, sides
265 Heptagon, 7 equal length sides
267 Octagon, 8 equal length sides
269 Nonagon, 9 equal length sides
271 Decagon, 10 equal length sides
273 Dodecagon, 12 equal length sides
277 Rule that can be straight or at an angle as a perforation
279 Round Dotted Rule that can be straight or at an angle as a perforation
281 Rectangle Dotted Rule that can be straight or at an angle as a perforation
283 Small Circle Scale 1 for purposes of showing scalability of any of the shapes in FIG. 130
285 Small Circle Scale 2 for purposes of showing scalability of any of the shapes in FIG. 130
287 Small Circle Scale 3 for purposes of showing scalability of any of the shapes in FIG. 130
289 Small Circle Scale 4 for purposes of showing scalability of any of the shapes in FIG. 130

FIG. 131A

### 13101A Squircle Shaped Vessel

13103A(1) assembly of 9 Conventional Cylindrical Vessels
13103A(2) assembly of 9 Conventional Cylindrical Vessels
13105A(1) Squircle Shaped Vessel cutaway

FIG. 131B

13103A(3) assembly of 9 Conventional Cylindrical Vessels in cross section superimposed inside of a Squircle Shaped Vessel
13105A(2) Squircle Shaped Vessel in cross section

What is claimed is:

1. A system for containing, loading, storage, delivery, and retrieval of gases, fluids, liquids, or mixtures thereof, comprising:
a molecular density adsorbent/absorbent material;
one or more lattices each containing the molecular density adsorbent/absorbent material; wherein each of the one or more lattices permits circulation of air flow from more than two sides to allow for adsorption, absorption or desorption of a constituent in the gases, fluids, liquids, or mixture thereof; and
wherein the one or more lattices is housed within a vessel.

2. The system of claim 1, wherein the molecular density adsorbent/absorbent material comprises, organic materials, charred organic materials, carbon materials, charcoal, clay, carbon nanotubes, catalysts, graphene, metal organic frameworks, silica, silica gels, zeolites, or a combination thereof.

3. The system of claim 1, wherein the lattices comprises rigid, semi-rigid, or flexible bag made from plastic, coated plastic, fiber-reinforced plastic, metal-reinforced plastic, metal, metalized plastic, composite of plastic and metal, continuous strands of fibers, woven fabric, or a combination thereof.

4. The system of claim 1, wherein the lattice is permeable, equipped with one or more perforations, equipped with an inlet and an outlet, or a combination thereof.

5. The system of claim 1, wherein the lattices comprises a continuous sheet having a substrate attached thereto is one or more pockets, wherein the pocket is perforated, or having an inlet and an outlet, or a combination of both, and wherein the pocket is packed with the molecular density adsorbent/absorbent material.

6. The system of claim 5, wherein the substrate is a perforated film, made from plastic, coated plastic, fiber-reinforced plastic, metal-reinforced plastic, metal, metalized plastic, composite of plastic and metal, continuous strands of fibers, woven fabric, or a combination thereof.

7. The system of claim 1, wherein the lattices comprises one or a plurality of dimple cups, wherein the plurality of dimple cups are nested in an interlocking repeatable pattern.

8. The system of claim 7, wherein the dimple cup is made from plastic, coated plastic, fiber-reinforced plastic, metal-reinforced plastic, metal, metalized plastic, composite of plastic and metal, continuous strands of fibers, woven fabric, or a combination thereof.

9. The system of claim 7, wherein dimple cup is equipped with one or more perforations, equipped with an inlet and an outlet, or a combination thereof.

10. The system of claim 1, wherein the molecular density adsorbent/absorbent material in the lattice can be vibrated, evacuated, compressed, heated, or a combination thereof.

11. The system of claim 1, wherein the vessel is a permanently sealed container cable of being oriented in any physical position to suit the need, wherein the vessel has an orifice that can be repeatedly opened and closed for loading and retrieving a lattice or a cartridge.

12. The system of claim 1, wherein the vessel houses the lattice and can be vibrated, evacuated, compressed, heated, or a combination thereof.

13. The system of claim 1, wherein the vessel is anticorrosive and is made from metal, polyamide, polyamide grapheme composite, carbon steel, or a combination thereof.

14. A system for containing, loading, storage, delivery and retrieval of gases, fluids, liquids, or mixtures thereof, comprising:
a molecular density adsorbent/absorbent material; and
one or more lattices each containing the molecular density adsorbent/absorbent material; wherein the one or more lattices is housed within a cartridge, and wherein the cartridge is placed within a vessel.

15. The system of claim 14, wherein the molecular density adsorbent/absorbent material comprises, organic materials, charred organic materials, carbon materials, charcoal, clay, carbon nanotubes, catalysts, graphene, metal organic frameworks, silica, silica gels, zeolites, or a combination thereof.

16. The system of claim 14, wherein each of the one or more lattices permits circulation of air flow from more than two sides to allow for adsorption, absorption or desorption of a constituent in the gases, fluids, liquids, or mixture thereof

17. The system of claim 14, wherein the lattices comprises rigid, semi-rigid, or flexible bag made from plastic, coated plastic, fiber-reinforced plastic, metal-reinforced plastic, metal, metalized plastic, composite of plastic and metal, continuous strands of fibers, woven fabric, or a combination thereof.

18. The system of claim 14, wherein the lattice is permeable, equipped with one or more perforations, equipped with an inlet and an outlet, or a combination thereof.

19. The system of claim 14, wherein the lattices comprises a continuous sheet having a substrate attached thereto is one or more pockets, wherein the pocket is permeable, perforated, has an inlet and an outlet, or a combination thereof, and wherein the pocket is packed with the molecular density adsorbent/absorbent material.

20. The system of claim 19, wherein the substrate is a perforated film, made from plastic, coated plastic, fiber-reinforced plastic, metal-reinforced plastic, metal, metalized plastic, composite of plastic and metal, continuous strands of fibers, woven fabric, or a combination thereof.

21. The system of claim 14, wherein the lattices comprises one or a plurality of dimple cups, wherein the plurality of dimple cups are nested in an interlocking repeatable pattern.

22. The system of claim 21, wherein the dimple cup is made from plastic, coated plastic, fiber-reinforced plastic, metal-reinforced plastic, metal, metalized plastic, composite of plastic and metal, continuous strands of fibers, woven fabric, or a combination thereof.

23. The system of claim 21, wherein dimple cup is permeable, equipped with one or more perforations, equipped with an inlet and an outlet, or a combination thereof.

24. The system of claim 14, wherein the molecular density adsorbent/absorbent material in the lattice can be vibrated, evacuated, compressed, heated, or a combination thereof.

25. The system of claim 14, wherein the vessel is a permanently sealed container cable of being oriented in any physical position to suit the need, wherein the vessel has an orifice that can be repeatedly opened and closed for loading and retrieving a lattice or a cartridge.

26. The system of claim 14, wherein the vessel houses the lattice and can be vibrated, evacuated, compressed, heated, or a combination thereof.

27. The system of claim 14, wherein the vessel is anticorrosive and is made from metal, polyamide, polyamide grapheme composite, carbon steel, or a combination thereof.

28. The system of claim 14, wherein the cartridge has a base plate, a continuous or discontinuous vertical side-wall support located around the outer peripheral of the base plate, wherein the continuous vertical sidewall support is permeable, perforated, equipped with an inlet and an outlet, or a combination thereof.

29. The system of claim 14, wherein the lattices comprised one or a plurality of dimple cups, wherein the plurality of dimple cups are nested in an interlocking repeatable pattern.

30. The system of claim 29, wherein the dimple cup is made from plastic, coated plastic, fiber-reinforced plastic, metal-reinforced plastic, metal, metalized plastic, composite of plastic and metal, continuous strands of fibers, woven fabric, or a combination thereof.

31. The system of claim 29, wherein the dimple cup is equipped with one or more perforations, equipped with an inlet and an outlet, or a combination thereof.

32. The system of claim 14, wherein the molecular density adsorbent/absorbent material in the lattice can be vibrated, evacuated, compressed, heated, or a combination thereof.

33. The system of claim 14, wherein the vessel is a permanently sealed container cable of being oriented in any physical position to suit the need, wherein the vessel has an orifice that can be repeatedly opened and closed for loading and retrieving a lattice or a cartridge.

34. The system of claim 14, wherein the vessel houses a lattice or a cartridge and can be vibrated, evacuated, compressed, heated, or a combination thereof.

35. The system of claim 14, wherein the vessel is anti-corrosive and is made from metal, polyamide, polyamide grapheme composite, carbon steel, or a combination thereof.

36. An in situ system for containing, loading, storage, delivery and retrieval of gases, fluids, liquids, or mixtures thereof, comprising:
a molecular density adsorbent/absorbent material;
one or more retractable lattices each containing the molecular density adsorbent/absorbent material; wherein each of the one or more lattices permits circulation of air flow from more than two sides to allow for adsorption, absorption or desorption of a constituent in the gases, fluids, liquids, or mixture thereof; and
wherein the one or more lattices are housed within a vessel open to the atmosphere.

37. The system of claim 36, wherein the molecular density adsorbent/absorbent material comprises, organic materials, charred organic materials, carbon materials, charcoal, clay, carbon nanotubes, catalysts, graphene, metal organic frameworks, silica, silica gels, zeolites, or a combination thereof.

38. The system of claim 36, wherein the lattices comprises rigid, semi-rigid, or flexible bag made from plastic, coated plastic, fiber-reinforced plastic, metal-reinforced plastic, metal, metalized plastic, composite of plastic and metal, continuous strands of fibers, woven fabric, or a combination thereof.

39. The system of claim 36, wherein the lattice is permeable, equipped with one or more perforations, equipped with an inlet and an outlet, or a combination thereof.

40. The system of claim 36, wherein the lattices comprises a continuous sheet having a substrate attached thereto is one or more pockets, wherein the pocket is perforated, having an inlet and an outlet, or a combination thereof, and wherein the pocket is packed with the molecular density adsorbent/absorbent material.

41. The system of claim 40, wherein the substrate is a perforated film, made from plastic, coated plastic, fiber-reinforced plastic, metal-reinforced plastic, metal, metalized plastic, composite of plastic and metal, continuous strands of fibers, woven fabric, or a combination thereof.

42. The system of claim 36, wherein the lattices comprises one or a plurality of dimple cups, wherein the plurality of dimple cups are nested in an interlocking repeatable pattern.

43. The system of claim 36, wherein the dimple cup is made from plastic, coated plastic, fiber-reinforced plastic, metal-reinforced plastic, metal, metalized plastic, composite of plastic and metal, continuous strands of fibers, woven fabric, or a combination thereof.

44. The system of claim 42, wherein dimple cup is equipped with one or more perforations, equipped with an inlet and an outlet, or a combination thereof.

45. The system of claim 35, wherein the molecular density adsorbent/absorbent material in the lattice can be vibrated, evacuated, compressed, heated, or a combination thereof.

46. The system of claim 35, wherein the vessel is a permanently sealed container cable of being oriented in any physical position to suit the need, wherein the vessel has an orifice that can be repeatedly opened and closed for loading and retrieving a lattice or a cartridge.

47. The system of claim 35, wherein the vessel houses the lattice and can be vibrated, evacuated, compressed, heated, or a combination thereof.

48. The system of claim 35, wherein the vessel is anticorrosive and is made from metal, polyamide, polyamide grapheme composite, carbon steel, or a combination thereof.

49. An in situ system for containing, loading, storage, delivery and retrieval of gases, fluids, liquids, or mixtures thereof, comprising:
a molecular density adsorbent/absorbent material;
one or more retractable cartridges each containing the molecular density adsorbent/absorbent material; wherein each of the one or more cartridges permits circulation of air flow from more than two sides to allow for adsorption, absorption or desorption of a constituent in the gases, fluids, liquids, or mixture thereof; and
wherein the one or more cartridges are housed within a vessel open to the atmosphere.

50. The system of claim 49, wherein the molecular density adsorbent/absorbent material comprises, organic materials, charred organic materials, carbon materials, charcoal, clay, carbon nanotubes, catalysts, graphene, metal organic frameworks, silica, silica gels, zeolites, or a combination thereof.

51. The system of claim 49, wherein the cartridge is permeable, equipped with one or more perforations, equipped with an inlet and an outlet, or a combination thereof.

52. The system of claim 49, wherein the molecular density adsorbent/absorbent material in the cartridge can be vibrated, evacuated, compressed, heated, or a combination thereof.

53. The system of claim 49, wherein the vessel is a permanently sealed container cable of being oriented in any physical position to suit the need, wherein the vessel has an orifice that can be repeatedly opened and closed for loading and retrieving a lattice or a cartridge.

54. The system of claim 49, wherein the vessel houses the cartridge and can be vibrated, evacuated, compressed, heated, or a combination thereof.

55. The system of claim 49, wherein the vessel is anticorrosive and is made from metal, polyamide, polyamide grapheme composite, carbon steel, or a combination thereof.

56. A system for containing, loading, storage, delivery and retrieval of gases, fluids, or both, comprising:
a molecular density adsorbent/absorbent material,
one or more hose spiral each containing the molecular density adsorbent/absorbent material, wherein the one or more hose spirals is stored in a hose reel, or within a vessel.

57. The system of claim 56, wherein the molecular density adsorbent/absorbent material comprises, organic materials, charred organic materials, carbon materials, charcoal, clay, carbon nanotubes, catalysts, graphene, metal organic frameworks, silica, silica gels, zeolites, or a combination thereof.

58. The system of claim 56, wherein the hose spiral is made from plastic, coated plastic, fiber-reinforced plastic, metal-reinforced plastic, metal, metalized plastic, composite of plastic and metal, continuous strands of fibers, woven fabric, or a combination thereof.

59. The system of claim 56, wherein the hose spiral has an open inlet and an open outlet, perforation on a wall of the hose spiral, or a combination thereof.

60. The system of claim 56, wherein an outer wall of the hose spiral has a channel for flowing a heating fluid.

61. The system of claim 56, wherein the molecular density adsorbent/absorbent material in the hose spiral can be vibrated, evacuated, compressed, heated, or a combination thereof.

62. The system of claim 56, wherein the vessel is a permanently sealed container cable of being oriented in any physical position to suit the need, wherein the vessel has an orifice that can be repeatedly opened and closed for loading and retrieving a lattice or a cartridge.

63. The system of claim 56, wherein the vessel is anti-corroded and made from metal, polyamide, polyamide grapheme composite, carbon steel, or a combination thereof.

64. The system of claim 56, wherein the hose spiral in the vessel can be vibrated, evacuated, compressed, heated, or a combination thereof.
